(19) United States
(12) Patent Application Publication
(10) Pub. No.: US 2006/0100912 A1
(43) Pub. Date: May 11, 2006

(54) Real-time insurance policy underwriting and risk management

(75) Inventors: C. Suresh Kumar, Ladera Ranch, CA (US); David Neil Dyrnaes, Laguna Beach, CA (US); Tim A Von Kaenel, Cota De Caza, CA (US); Jonathan D Goodwin, Laguna Niguel, CA (US); Jared P Wayman, Aliso Viejo, CA (US); Craig Evan Trivelpiece, Newport Beach, CA (US); Joseph Mihalich, Rancho Santa Margarita, CA (US); Anthony Page Jenkins, Aliso Viejo, CA (US)

Correspondence Address: MEADWESTVACO CORPORATION, REGIONAL OFFICE BUILDING, PO BOX 118005, CHARLESTON, SC, 29423-8005, US

(73) Assignee: QUESTERRA LLC., Charlottesville, VA (US)

(21) Appl. No.: 10/537,636

(22) PCT Filed: Dec. 16, 2003
(86) PCT No.: PCT/US03/39972

§ 371 Date: Jun. 3, 2005

Related U.S. Application Data
(60) Provisional application No. 60/433,597, filed on Dec. 16, 2002.
(60) Provisional application No. 60/437,990, filed on Jan. 6, 2003.
(60) Provisional application No. 60/449,601, filed on Feb. 26, 2003.

(30) Foreign Application Priority Data
Mar. 14, 2003 (US) 10/388666

(51) Int. Cl. G06Q 40/00

(52) U.S. Cl. 705/4

(57) ABSTRACT

Provided is a technique for evaluating risk associated with underwriting an insurance policy (FIG. 1). At least one location to be covered under the insurance policy is received (FIG. 3, block 320). Risk associated with the location is automatically assessed (FIG. 3, block 338). It is determined whether to underwrite the location based on the assessed risk (FIG. 3, block 340). Also provided is a technique for proximity analysis (FIG. 54). Selection of a proximity center is received (FIG. 55). A function is executed with the proximity center to determine target data items that fall within a proximity area around the proximity center. The target data items are spatially represented.

### BACKGROUND OF THE INVENTION

1. Field of the Invention

The present invention relates to real time insurance policy underwriting and risk management.

2. Description of the Related Art

Insurance companies may insure against personal harm, property damage, and business interruption caused by a specified peril. By way of example, such perils (or perilous events) may include a natural disaster (e.g., a tornado, a hurricane, an earthquake, a flood, etc.), a manmade disaster (e.g. a release of hazardous material from an industrial plant, a terrorist attack, arson, etc.), and the like. Before underwriting a new or renewing an existing insurance policy, an insurance company may receive information from an existing or prospective customer from which an evaluation may be made about the appropriateness of underwriting the policy.

When an insurance agent receives a request for an insurance policy, the agent may receive existing or prospective customer data from the policy such as: 1) the name and address of the requesting entity (e.g. an individual or a company and the address of the property to be covered); 2) the requested coverage type (e.g. life insurance or property insurance for a specified peril); 3) the desired amount of coverage, deductible, and premium; and 4) any other information that the insurance company may use in evaluating whether to underwrite the policy.

An insurance company may then evaluate such existing or prospective customer data to determine whether underwriting the requested insurance policy is appropriate. For example, an insurance company may consider how accepting the proposed insurance policy will affect their: 1) total revenue (e.g. an additional policy should increase the insurance company's total revenue by the policy's premium); 2) total exposure (e.g., an additional policy should increase the insurance company's total exposure by the policy's loss coverage); 3) probable maximum loss (PML) (e.g., an additional policy should increase the insurance company's PML, the amount of loss expected based on the total exposure underwritten for a specified zone and perilous event times a predetermined PML loss factor).

Those skilled in the insurance industry know that a PML loss factor may vary based on an estimated likelihood that a specified peril (e.g., a tornado) may occur in a specified zone (e.g., Dallas, Tex.) to cause a specified degree of damage (e.g., 10 million). It is also known to those skilled in the art that a PML loss factor may vary for various areas within a specified high risk zone (e.g. an area within a zone may have had far more tornadoes than other areas within the same zone). Moreover, to estimate a PML loss factor, those skilled in the art may consider such issues as the type of peril, the particular area of the country where the perilous event may occur, the time of year for the perilous event, the type of construction for the potentially-effected structures, etc.

The insurance company may base its evaluation on a predetermined standard, such as PML for a specified peril in a specified high risk zone not exceeding a specified PML limit. For example, if accepting a prospective policy would (by adding one or more locations for coverage for a specified peril in a specified high risk zone) increase the PML for this zone and peril above a predetermined PML limit (also known as CAP limit), then the policy may be presumptively denied. Alternatively, if accepting a prospective policy would not (by adding one or more locations for coverage for a specified peril in specified high risk zone) increase the PML for this zone and peril above the CAP limit, then the policy may be presumptively accepted.

To make such an evaluation, the insurance company may wish to determine where the locations to be covered reside with respect to the specified high risk zone (e.g., in the zone, out of the zone, or near the zone). As discussed below, the process presently used by the insurance companies to determine where locations to be covered reside in relation to a specified high risk zone and evaluate based on such a determination whether to underwrite a policy is manually-intensive, very slow, and often produces inconsistent and inaccurate results.

There are presently two general approaches that may be taken. In one approach, using geospatial analysis techniques, a geographic information system (GIS) specialist uses a conventional GIS application, such as Arc Info from ESRI, Inc. of Redlands, Calif., to determine whether locations from a prospective policy are geographically located within a high risk zone, while the other general approach may not even make such a determination and does not employ a GIS application. The GIS-based approach may provide a more well-reasoned evaluation (compared to a non-GIS-based approach) but, as discussed below, is generally a manually-intensive, slow, and inconsistent process. Because the GIS-based approach is so slow, insurance companies may not use it other than for their largest policies or possibly not at all. Consequently, many insurance companies presently underwrite numerous policies, assuming risk without the knowledge that may be gleaned from the GIS-based approach.

One factor that slows GIS-based evaluations is the fact that although GIS software applications are indeed available, such applications require interactive manual operation by a specially trained GIS operator. The number of trained GIS operators is limited compared to the number of insurance underwriters drafting policies for evaluation.

Even assuming that an insurance company has access to a GIS operator, other issued contribute to the slowness of the GIS-based approach. For instance, before a GIS operator may consider an existing or prospective customer's address, the address must be “encoded.” Gooding is a well-known GIS process performed by conventional programs that, among other things, associate a specific geographic location, such as a geospatial coordinate (e.g. latitude and longitude), with an address so that the location of the address may be displayed on a display device over a spatial (e.g., a map) image, which may include other geospatial information such as state or county boundaries, building locations, etc. A GIS operator may then observe on a GIS application's display the location of the encoded address from the prospective policy.

However, before encoding an existing or prospective customer's address, it is desirable to obtain a comprehensive list of all relevant addresses to be covered by the prospective policy. For instance, the existing or prospective customer may be a company owning several subsidiary companies, which together have hundreds of business locations to be covered under the policy. Before encoding, someone (typically not the GIS operator) may wish to obtain the addresses of all the locations to be covered. Thus, the GIS operator may have to wait for other personnel to create a comprehensive list of addresses for the prospective policy, assuming that such a list is prepared at all. Presently, crating a comprehensive list of relevant addresses is, at best, inconsistently performed in the insurance industry.

Before encoding, it is also desirable to perform an “address cleansing process,” regardless of whether a comprehensive address list is first created. At present, address cleansing is also, at best, inconsistently performed in the insurance industry. Address cleansing, a well-known process in the GIS field, generally involves comparing the address entries for a prospective policy against a reliable master address database to ensure that a final list of all addresses is accurate and, preferably, expressed, in a standard form before encoding. Such address cleansing may be useful when, for example, a customer-provided address (e.g., the Plaza Building) may fail to accurately identify a street address for a particular business location. Such failure may prevent the GIS operator and/or other insurance company evaluators from understanding the impact of underwriting a policy that includes an unrecognized high-risk business location. For example, if a prospective business address is incorrect, not corrected through address cleansing, and as a result placed outside a high risk zone (using the incorrect address), the policy may be accepted because the related business address appears to be outside of the high risk area, though in reality it may actually be inside the high risk area.

Assuming that a comprehensive list of prospective addresses has been cleansed and encoded, processes which may consume considerable time, the GIS operator can begin work. The basic task of the GIS operator is to display a prospective address location and determine whether it is in a zone of high risk, such as on the San Andreas Fault. To do this, the operator selects a prospective address for display on a GIS application screen and also selects a high risk zone for display from a database of predefined high risk zones. Utilizing conventional spatial query techniques, the GIS operator is able to identify the spatial intersection of the location of the address and the high risk zone, in relation to the earth, utilizing, for example, longitude and latitude information. It is now possible for the operator to determine whether the address's location and the high risk zone intersect. If the selected address is not in the selected high risk zone, then there is a relative low risk that the peril associated with the selected high risk zone will affect the location being insured (e.g. if the selected address is outside of the selected high risk zone where, for example, tornadoes, are historically likely to hit, then the selected address is less likely of being affected by a tornado) and it may be presumptively accepted for coverage.

Alternatively, if the selected address is in the selected high risk zone, then there may be a higher risk with the business location at the selected address. The GIS operator may then wish to identify the existing policies with business locations in the selected high risk zone, as they represent the current level of risk for the specified zone (e.g., PML for the specified zone and peril). For example, if the selected address is located in a predefined high risk zone including the San Andreas Fault, the GIS operator may wish to identify the existing policies with locations that have earthquake coverage in the same high risk zone. The insurance company may evaluate the propriety of accepting a prospective policy from such a baseline list, which, as known to those with ordinary skill in the art, may be evaluated by itself or in conjunction with other relevant information, such as the added exposure and premium for the prospective policy.

However, the GIS operator may also wish to identify existing policies that are not precisely within the selected high risk zone, but perhaps within some reasonable proximity to it, as the insurance company evaluators may wish to consider these policies too in deciding whether to accept a prospective policy. Thus, the GIS operator may vary the size and shape of the evaluation zone to consider existing policies outside but in proximity to a predefined high risk zone. The GIS operator may experiment in other ways to provide the insurance company with the best possible list of existing policies (the existing risk) from which an evaluation can be made as to whether to accept a prospective policy.

What is most relevant about the GIS operator's task is that it generally takes considerable time for the GIS operator to provide a list of relevant existing policies for the insurance company to use in considering whether to underwrite a prospective policy. Moreover, because there are several optional processes both preceding and coinciding with the GIS operator's task (e.g., whether or not to use: 1) a comprehensive prospective address list 2) address cleansing, or 3) any particular GIS operator technique), the evaluation results may vary widely depending on the selected options and the GIS operator.

Moreover, even after the GIS operator has analyzed the data, the insurance company may use this date with predetermined standard (e.g., will the PML with the prospective policy included exceed a PML CAP limit that the company may want to stay under, such as $50 million, for the specified zone and peril, such as earthquake exposure in a predefined zone including San Francisco) to evaluate whether to accept a prospective policy. Such evaluation may take significant time, particularly when, as presently performed, it involves an insurance company representative manually entering the GIS operator data into a spreadsheet or an algorithm that embodies the company's predetermined evaluation standard.

Moreover, the present process for evaluating whether to underwrite an insurance policy cannot be completed in real-time. Consequently, it is not possible for the process described above to result in a real-time evaluation result being returned to the user who submitted the evaluation request. Instead, the process that is followed by insurance companies today either takes days or weeks to return results to the user who submitted the evaluation request, or the GIS-based process does not occur at all.

Thus, there is a need for more efficiently and consistently evaluating the risk associated with underwriting an insurance policy in real-time.

### BRIEF DESCRIPTION OF THE DRAWINGS

Referring now to the drawings in which like reference numbers represent corresponding parts throughout:

FIG. 1 illustrates a computing environment in which certain implementations of the invention are implemented.

FIG. 2 illustrates, in a block diagram, a workflow through a computing environment in accordance with certain implementations of the invention.

FIG. 3 illustrates logic for generating a report for an insurance policy request in accordance with certain implementations of the invention.

FIG. 4A illustrates a landmark, FIG. 4B illustrates risk rings, and FIG. 4C illustrates logic for identifying risk rings for a landmark in accordance with certain implementations of the invention.

FIG. 5 illustrates an initial screen displayed by an enterprise spatial system in accordance with certain implementations of the invention.

FIG. 6 illustrates a setup screen for events and landmarks in accordance with certain implementations of the invention.

FIG. 7 illustrates a setup events screen in accordance with certain implementations of the invention.

FIG. 8 illustrates a setup event ring attributes screen in accordance with certain implementations of the invention.

FIG. 9 illustrates a setup event damage rates screen in accordance with certain implementations of the invention.

FIG. 10 illustrates a setup PML rating details screen in accordance with certain implementations of the invention.

FIG. 11 illustrates a setup landmarks screen in accordance with certain implementations of the invention.

FIG. 12 illustrates logic for a user interface flow for an underwriting system 132 in accordance with certain implementations of the invention.

FIG. 13 illustrates a screen provided by an underwriting system for uploading of information from a file in accordance with certain implementations of the invention.

FIG. 14 illustrates a screen provided by an underwriting system for entering address information in accordance with certain implementations of the invention.

FIG. 15 illustrates a screen provided by an underwriting system for mapping fields from a spreadsheet to an enterprise spatial system format in accordance with certain implementations of the invention.

FIG. 16 illustrates a screen provided by an underwriting system for entering a company name in accordance with certain implementations of the invention.

FIG. 17 illustrates a screen provided by an underwriting system with encoded results in accordance with certain implementations of the invention.

FIG. 18 illustrates a screen provided by an underwriting system for address resolution in accordance with certain implementations of the invention.

FIG. 19 illustrates a screen provided by an underwriting system for address resolution for non-encoded locations in accordance with certain implementations of the invention.

FIG. 20 illustrates a screen provided by an underwriting system for a spatial interface to manually correct a genocide in accordance with certain implementations of the invention.

FIG. 21 illustrates a screen provided by an underwriting system for searching by address in accordance with certain implementations of the invention.

FIG. 22 illustrates a screen provided by an underwriting system for searching by company name in accordance with certain implementations of the invention.

FIG. 23 illustrates an ambiguous results screen provided by an underwriting system in which company name, city, and state are displayed in accordance with certain implementations of the invention.

FIG. 24 illustrates a screen provided by an underwriting system for searching by policy number for an existing business in accordance with certain implementations of the invention.

FIG. 25 illustrates a screen provided by an underwriting system for quick search by ZIP code in accordance with certain implementations of the invention.

FIG. 26 illustrates a screen provided by an underwriting system for multi-peril rating results in accordance with certain implementations of the invention.

FIG. 27 illustrates a screen provided by an underwriting system for rating result details by location and by peril in accordance with certain implementations of the invention.

FIG. 28 illustrates a screen provided by an underwriting system for exporting rating results to a file in accordance with certain implementations of the invention.

FIG. 29 illustrates a screen provided by an underwriting system for saving results for a temporary period of time in accordance with certain implementations of the invention.

FIG. 30 illustrates a screen provided by an underwriting system displaying selected rating results on a map in accordance with certain implementations of the invention.

FIG. 31 illustrates a screen provided by an underwriting system displaying selected rating results on a map when risk manager functionality is available in accordance with certain implementations of the invention.

FIG. 32A illustrates a location specific PML flow in accordance with certain implementations of the invention.

FIG. 32B illustrates a location specific PML flow in accordance with certain alternative implementations of the invention.

FIG. 33 illustrates a screen provided by an underwriting system for location specific PML calculations in accordance with certain implementations of the invention.

FIG. 34 illustrates a screen provided by an underwriting system to provide a summary of locations for individual analysis in accordance with certain implementations of the invention.

FIG. 35 illustrates a screen provided by an underwriting system to provide a summary of location specific PML calculations in accordance with certain implementations of the invention.

FIG. 36 illustrates a screen provided by an underwriting system for displaying location specific PML results in accordance with certain implementations of the invention.

FIG. 39 illustrates a screen provided by an underwriting system for displaying rating results for a user with an external role in accordance with certain implementations of the invention.

FIG. 40 illustrates a main approver/reviewer screen provided by an underwriting system in accordance with certain implementations of the invention.

FIG. 41 illustrates a screen provided by an underwriting system after an approval process is continued from FIG. 40 in accordance with certain implementations of the invention.

FIG. 42 illustrates a screen provided by an underwriting system to allow writing or rejection of a policy in accordance with certain implementations of the invention.

FIG. 43 illustrates a screen provided by an underwriting system with summary report status in accordance with certain implementations of the invention.

FIG. 44 illustrates an architecture diagram in accordance with certain implementations of the invention.

FIG. 45 illustrates process flow in accordance with certain implementations of the invention.

FIG. 46 illustrates an enterprise spatial system schema and a generic insurance (GI) schema that are provided in accordance with certain implementations of the invention.

FIGS. 47A and 47B illustrate logic for proximity analysis in accordance with certain implementations of the invention.

FIG. 48 illustrates an insurance solution flow in accordance with certain implementations of the invention.

FIG. 49 illustrates a screen showing proximity analysis with rings at different distances from an epicenter in accordance with certain implementations of the invention.

FIG. 50 illustrates proximity analysis process in accordance with certain implementations of the invention.

FIG. 51 illustrates a proximity analysis screen in accordance with certain implantations of the invention.

FIG. 52 illustrates manual point tools in accordance with certain implementations of the invention.

FIG. 53 illustrates a screen showing a sample selection of an XY coordinate in accordance with certain implementations of the invention.

FIG. 54 illustrates an initial proximity analysis screen for generic proximity analysis in accordance with certain implementations of the invention.

FIG. 55 illustrates a second proximity analysis screen for generic proximity analysis in accordance with certain implementations of the invention.

FIG. 56 illustrates a third proximity analysis screen for generic proximity analysis in accordance with certain implementations of the invention.

FIG. 57 illustrates a third proximity analysis screen with summary options for generic proximity analysis in accordance with certain implementations of the invention.

FIG. 58 illustrates a screen provided by the proximity analysis manager with a proximity analysis full report in accordance with certain implementations of the invention.

FIG. 59 illustrates a screen provided by the proximity analysis manager with a point n′ view report in accordance with certain implementations of the invention.

FIG. 60 illustrates a screen provided by the proximity analysis manager with a proximity summary in accordance with certain implementations of the invention.

FIG. 61A illustrates a table provided by the proximity analysis manager of landmark proximity analysis totals in accordance with certain implementations of the invention.

FIG. 61B illustrates a table provided by the proximity analysis manager of proximity aggregates in accordance with certain implementations of the invention.

FIG. 62 illustrates a proximity summary provided by the proximity analysis manager in accordance with certain implementations of the invention.

FIG. 63 illustrates a screen of a details report in accordance with certain implementations of the invention.

FIG. 64 illustrates an initial screen for an event driven wizard in accordance with certain implementations of the invention.

FIG. 65 illustrates a second screen for an event driven wizard that shows the addition of a landmark option in accordance with certain implementations of the invention.

FIG. 66 illustrates a third screen for an event driven wizard in accordance with certain implementations of the invention.

FIG. 67 illustrates a proximity summary in accordance with certain implementations of the invention.

FIG. 68 illustrates a layer control provided by the proximity analysis in accordance with certain implementations of the invention.

FIG. 69 illustrates proximity analysis menus in accordance with certain implementations of the invention.

FIG. 70 illustrates a screen provided by the proximity analysis manager to allow selection of a proximity analysis for editing in accordance with certain implementations of the invention.

FIGS. 71A and 71B illustrate screens provided by the proximity analysis manager to allow deletion of a proximity analysis for editing in accordance with certain implementations of the invention.

FIG. 72 illustrates a screen provided by the proximity analysis manager to save a proximity analysis in accordance with certain implementations of the invention.

FIG. 73 illustrates a screen provided by the proximity analysis manager that allows selection of users for assigning access privileges in accordance with certain implementations of the invention.

FIG. 74 illustrates a screen provided by the proximity analysis manager for Saving To a layer in accordance with certain implementations of the invention.

FIG. 75 illustrates a screen provided by the proximity analysis manager for inputting information for the Save To option in accordance with certain implementations of the invention.

FIG. 76 illustrates proximity analysis for an insurance industry scenario in accordance with certain implementations of the invention.

FIG. 77 illustrates customer specific inputs for a formula for generating PML in accordance with certain implementations of the invention.

FIG. 78 illustrates a center point and a selected point for which a policy may be issued in accordance with certain implementations of the invention.

FIG. 79A illustrates a stepped relationship in accordance with certain implementations of the invention.

FIG. 79B illustrates a linear relationship in accordance with certain implementations of the invention.

FIG. 79C illustrates a logarithmic relationship in accordance with certain implementations of the invention.

FIG. 80 illustrates a NAC structure that is used to determine a NAC in accordance with certain implementations of the invention.

FIG. 81 illustrates a rating process in accordance with certain implementations of the invention.

FIG. 82 illustrates metadata used to implement ring analysis in accordance with certain implementations of the invention.

FIG. 83 illustrates metadata to support proximity analysis functionality for a customer in the insurance business in accordance with certain implementations of the invention.

FIG. 84 illustrates a sample handle table 8400 in accordance with certain implementations of the invention.

FIG. 85 illustrates a representation of a Handle Manager class in accordance with certain implementations of the invention.

FIG. 86 illustrates a sequence diagram that describes the client and ESS server interaction for proximity image/proximity summary generation in accordance with certain implementations of the invention.

FIG. 87 illustrates an ESS system service context diagram in accordance with certain implementations of the invention.

FIG. 88 illustrates a new business approval process in accordance with certain implementations of the invention.

FIG. 89 illustrates a policy renewal process in accordance with certain implementations of the invention.

FIG. 90 illustrates a process 9000 of an annual in force book of business review in accordance with certain implementations of the invention.

FIG. 91 illustrates an additional data entry process in accordance with certain implementations of the invention.

FIG. 92 illustrates an ETL process in accordance with certain implementations of the invention.

FIG. 93 illustrates a map view in accordance with certain implementations of the invention.

FIG. 94 illustrates a screen with event information, ring information, and ring weighting in accordance with certain implementations of the invention.

FIG. 95 illustrates a portal entry screen in accordance with certain implementations of the invention.

FIG. 96 illustrates a portal menu application service site map in accordance with certain implementations of the invention.

FIG. 97 illustrates a sample of a Portal Menu application service main page and subsequent screen flow based on user selections in accordance with certain implementations of the invention.

FIG. 98 illustrates a screen of a selected map image with a map summary in accordance with certain implementations of the invention.

FIG. 99 illustrates a screen of a selected map image with an analysis summary in accordance with certain implementations of the invention.

FIG. 100 illustrates a point n′ view tool in accordance with certain implementations of the invention.

FIG. 101 illustrates a full report screen in accordance with certain implementations of the invention.

FIG. 102 illustrates an analysis summary in accordance with certain implementations of the invention.

FIG. 103 illustrates a sample network implementation to connect a client data center and an enterprise spatial system secure data facility to enable real-time access to ESS system services in accordance with certain implementations of the invention.

FIG. 104 illustrates an internet connectivity diagram in accordance with certain implementations of the invention.

FIG. 105 illustrates a system architecture in accordance with certain implementations of the invention.

FIG. 106 illustrates a table of application services in accordance with certain implementations of the invention.

FIG. 107 illustrates a table of portal application service assignments in accordance with certain implementations of the invention.

FIG. 108 illustrates a top-level portal site map in accordance with certain implementations of the invention.

FIG. 109 illustrates a screen of a set of features available for the corporate risk manager user in accordance with certain implementations of the invention.

FIG. 110 illustrates a screen that shows the reporting menu page and its associated links in accordance with certain implementations of the invention.

FIG. 111 illustrates a screen that shows an ESS admin menu page and its associated links in accordance with certain implementations of the invention.

FIG. 112 illustrates a screen in accordance with certain implementations of the invention.

FIG. 113 illustrates a table of data layers in accordance with certain implementations of the invention.

FIG. 114 illustrates a table of landmark location fields in accordance with certain implementations of the invention.

FIG. 115 illustrates a table of policy location fields in accordance with certain implementations of the invention.

FIG. 116 illustrates a ring analysis wizard screen in accordance with certain implementations of the invention.

FIG. 117 illustrates screen 2 in accordance with certain implementations of the invention.

FIG. 118 illustrates a screen in which the Ring Attributes section is disabled in accordance with certain implementations of the invention.

FIG. 119 illustrates a screen with the expanded Show Options link in accordance with certain implementations of the invention.

FIG. 120 illustrates a table of different scenarios that may be requested by a user in accordance with certain implementations of the invention.

FIG. 121 illustrates a ring analysis Results and Summary screen in accordance with certain implementations of the invention.

FIG. 122 illustrates a screen in accordance with certain implementations of the invention.

FIG. 123 illustrates a screen of a save landmark address example in accordance with certain implementations of the invention.

FIG. 124 illustrates a screen of a save landmark latitude/longitude example in accordance with certain implementations of the invention.

FIG. 125 illustrates a table of landmark ring analysis totals in accordance with certain implementations of the invention.

FIG. 126 illustrates a table of landmark ring analysis by ring totals in accordance with certain implementations of the invention.

FIG. 127 illustrates a screen in accordance with certain implementations of the invention.

FIG. 128 illustrates an underwriter application service screen flow in accordance with certain implementations of the invention.

FIG. 129 illustrates a main underwriter application service screen, which is a location list screen, in accordance with certain implementations of the invention.

FIG. 130 illustrates a table of four combinations of user data entered for a Find Company Query in accordance with certain implementations of the invention.

FIG. 131 illustrates a table of columns for a Company Name List in accordance with certain implementations of the invention.

FIG. 132 illustrates a company location search results dialog in accordance with certain implementations of the invention.

FIG. 133 illustrates a table of columns for a location Results List in accordance with certain implementations of the invention.

FIG. 134 illustrates a encoding process Results dialog that is used to display results of a encoding process in accordance with certain implementations of the invention.

FIG. 135 illustrates a screen displaying location records in accordance with certain implementations of the invention.

FIG. 136 illustrates a table describing a data source for a location list columns in accordance with certain implementations of the invention.

FIG. 137 illustrates a table listing columns of data that may be exported in accordance with certain implementations of the invention.

FIG. 138 illustrates a sample CSV file in accordance with certain implementations of the invention.

FIG. 139 illustrates a reporting application service screen flow in accordance with certain implementations of the invention.

FIG. 140 illustrates a total book of business by landmark report in accordance with certain implementations of the invention.

FIG. 141 illustrates a new business by landmark report in accordance with certain implementations of the invention.

FIG. 142 illustrates a new business by landmark report in accordance with certain implementations of the invention.

FIG. 143 illustrates a table of columns for a policy detail in accordance with certain implementations of the invention.

FIG. 144 illustrates an admin application service custom screen flow in accordance with certain implementations of the invention.

FIG. 145 illustrates a screen for setting up landmarks in accordance with certain implementations of the invention.

FIGS. 146 and 147 illustrate a screen for setting up events in accordance with certain implementations of the invention.

FIG. 148 illustrates an admin application service business table screen flow in accordance with certain implementations of the invention.

FIG. 149 illustrates an admin application service ESS delegated screen flow in accordance with certain implementations of the invention.

FIG. 150 illustrates a table for policy data access rights in accordance with certain implementations of the invention.

FIG. 151 illustrates a primary table in accordance with certain implementations of the invention.

FIG. 152 illustrates a table of views of a client data store in accordance with certain implementations of the invention.

FIG. 153 illustrates a table of physical and logical layers in accordance with certain implementations of the invention.

FIG. 154 illustrates a ETL process in accordance with certain implementations of the invention.

FIG. 155 illustrates a data integration services flow in accordance with certain implementations of the invention.

FIGS. 156A and 156B illustrate administration scenarios 1 and 2 in accordance with certain implementations of the invention.

FIGS. 157A, 157B, and 157C illustrate data integration services scenario 3 in accordance with certain implementations of the invention.

FIGS. 158A, 158B, and 158C illustrate another data integration services scenario in accordance with certain implementations of the invention.

FIG. 159 illustrates screen with a list of existing known data sources for a given customer in accordance with certain implementations of the invention.

FIG. 160 illustrates a screen with an example of a possible treatment for how to add a new data source in accordance with certain implementations of the invention.

FIG. 161 illustrates a preference menu in accordance with certain implementations of the invention.

FIG. 162 illustrates a screen with a list of data sources available to a give data admin in accordance with certain implementations of the invention.

FIG. 163 illustrates an example of a screen used for a batch type data source in accordance with certain implementations of the invention.

FIG. 164 illustrates an example of a screen used for a transaction type data source.

FIG. 165 illustrates a screen with advanced edit menus in accordance with certain implementations of the invention.

FIG. 166 illustrates a table of editing extension points in accordance with certain implementations of the invention.

FIG. 167 illustrates how overlapping polygons may be modified in different ways in accordance with certain implementations of the invention.

FIGS. 168A and 168B illustrate objects split by selection and/or intersection in accordance with certain implementations of the invention.

FIG. 169 illustrates objects to be split by a drawn line in accordance with certain implementations of the invention.

FIG. 170 illustrates multi-polygons in accordance with certain implementations of the invention.

FIG. 171 illustrates examples of shapes that cannot be represented by a single multi-polygon in accordance with certain implementations of the invention.

FIG. 172 illustrates a screen for shaded area thematic mapping in accordance with certain implementations of the invention.

FIG. 173 illustrates a screen for sized symbols thematic mapping in accordance with certain implementations of the invention.

FIG. 174 illustrates a screen for shaded symbols thematic mapping in accordance with certain implementations of the invention.

FIG. 175 illustrates an architecture of a computer system that may be used in accordance with certain implementations of the invention.

### DETAILED DESCRIPTION

In the following description, reference is made to the accompanying drawings which form a part hereof and which illustrate several implementations of the present invention. It is understood that other implementations may be utilized and structural and operational changes may be made without departing from the scope of implementations of the present invention.

### A. OVERVIEW

Certain implementations of the invention enable a more efficient and consistent evaluation of whether an insurance company should underwrite an insurance policy. Moreover, certain implementations of the invention may utilize conventional geospatial query techniques to provide in real-time, rather than in days or weeks, the results of the evaluation back to a user who submitted the request for evaluation. To this end, certain implementations of the invention may permit a user to submit existing or prospective customer data, such as a company name and address, and promptly receive an evaluation report recommending acceptance or denial of the request for insurance coverage, or requesting the user to contact the insurance company for further consideration of a prospective policy. Unlike past practice, certain implementations of the invention provide an automated technique to more efficiently and consistently evaluate existing or prospective customer data provided by the user and report back to the user an appropriate answer (e.g., the policy may be accepted, denied, or further consideration is merited) in real time, such as a matter of seconds as opposed to days or weeks.

Certain implementations of the invention also enable an insurance company to define high risk zones, based on a selected landmark (a landmark may be a specified point, such as a predefined point of a building or structure, or a specified area, such as a flood zone). The user may also define and select a perilous event for the landmark, such as an explosion, a fire, a release of hazardous material, a flood, etc. For the selected landmark and perilous event, the user may also define zones in proximity to the landmark that have variable user-defined loss factors. Such user-defined high risk zones, including associated perils and loss factors, may be added to a data store for use in evaluation whether an insurance company should underwrite an additional insurance policy that may involve covering locations in a specified high risk zone for a specified peril. Such data may be made available to a user of a client application connected to a continuously-running server without having to shut down the server, and without requiring the user to log onto the server again to gain access to newly-entered high risk zones (and their associated perils and loss factors) for real-time evaluations.

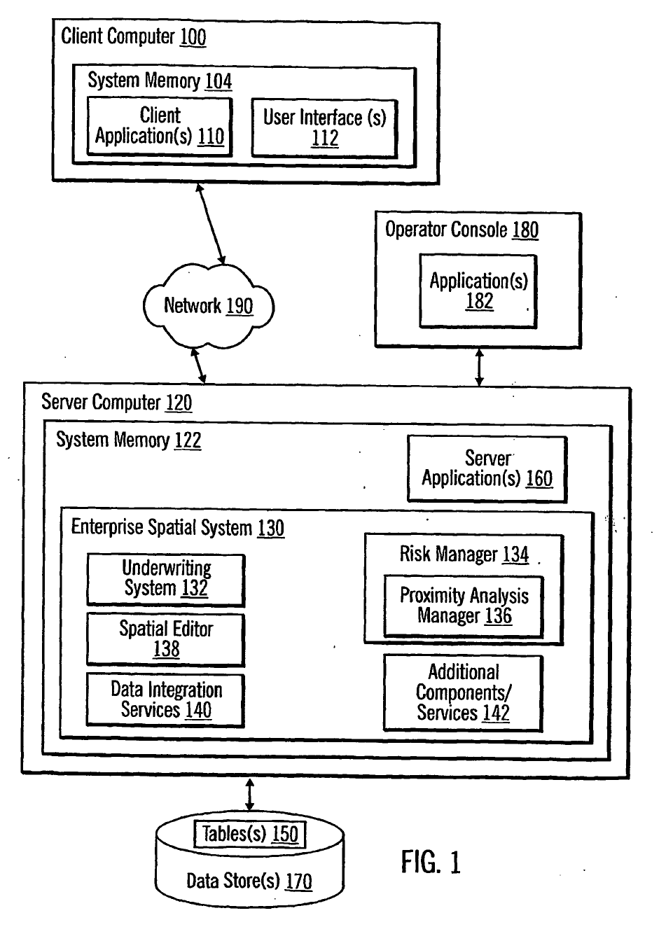

FIG. 1 illustrates a computing environment in which certain implementations of the invention are implemented. A client computer 100 is connected via a network 190 to a server computer 120. The client computer 100 may comprise any computing device known in the art, such as a server, mainframe, workstation, personal computer, hand held computer, laptop telephony device, network appliance, etc.

The network 190 may comprise any type of network, such as, for example, a Storage Area Network (SAN), a Local Area Network (LAN), Wide Area Network (WAN), the Internet, an Intranet, etc. The client computer 100 includes system memory 104, which may be implemented in volatile and/or non-volatile devices. One or more client applications 110 may execute in the system memory 104. Additionally, user interfaces 112 may be displayed by components of the enterprise spatial system 130 at server computer 1200.

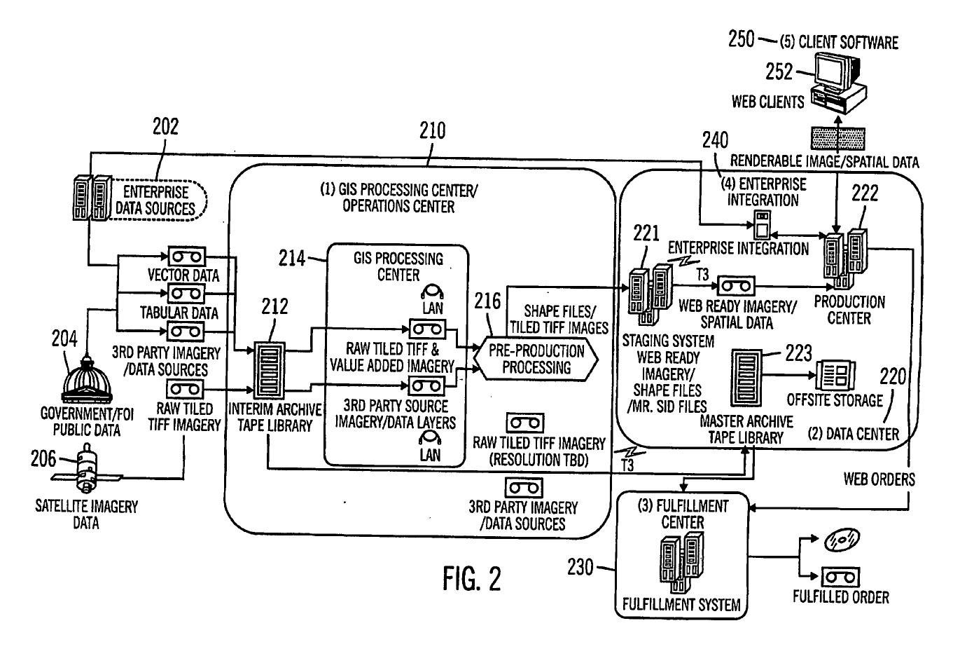

The server computer 1200 includes system memory 122, which may be implemented in volatile and/or non-volatile devices. An enterprise spatial system 130 executes in the system memory 122. In certain implementations of the invention, the enterprise spatial system 130 includes an underwriting system 132, a risk manager 134 that includes a proximity analysis manager 136, a spatial editor 138, and data integration services 140 (also referred to as Extraction, Transformation, and Loading (ETL)). Additional components and/or services 142 may also be provided by the enterprise spatial system 130 (e.g., those depicted in FIG. 2)

Although components 132, 136, 134, 138, and 140 are illustrated as separate components within an enterprise spatial system 130, the functionality of the components 132, 136, 134, 138, and 140 may be implemented in fewer or more or different components than illustrated. Additionally, the functionality of the components 132, 136, 134, 138, and 140 may be implemented at a Web application server computer or other server computer that is connected to the server computer 1200. Additionally, one or more server applications 160 may execute in system memory 122.

The server computer 1200 provides the client computer 100 with access to data in one or more data stores 170 (e.g., data stores). Although data store 170 is illustrated as directly connected to server computer 1200, tables 150 and other data (e.g., the locations for an insurance company's existing policies and other policy details) in data store 170 may be stored in data stores at other computers connected to server computer 1200. Although tables 150 are referred to herein for ease of understanding, other types of structures may be used to hold the data that is described as being stored in tables 150.

Also, an operator console 180 executes one or more applications 182 and is used to access the server computer 1200 and the data store 170.

The data store 170 may comprise an array of storage devices, such as Direct Access Storage Devices (DASDs), Just a Bunch of Disks (JBOD), Redundant Array of Independent Disks (RAID), virtualization device, etc.

FIG. 2 illustrates, in a block diagram, workflow through a computing environment in accordance with certain implementations of the invention. FIG. 2 represents a system data work flow diagram for simultaneously integrating enterprise data with third party data using a processing center and a live data center, processing spatially referenced data, and providing access to the data.

FIG. 2 illustrates several additional components of an enterprise spatial system provided by certain implementations of the invention, including (1) a Geographical Information System (GIS) processing center/operations center 210, (2) a data center 220, (3) a fulfillment center 230, (4) enterprise integration 240 (which may be part of the data center 220), and (5) client software 250 (e.g., one or more client applications). The client software 250 executes on a client system 252, which has a display screen on which a UI screen or other data may be displayed for viewing by, for example, a user. Although, one client system 252 is illustrated, it is to be understood that many client systems may access data in the production center 222 at any time, including other server systems acting as clients to the enterprise spatial system. Certain implementations of the invention provide a 24/7 live system that integrates and offers on-demand data (e.g., superior quality geographical imagery, associated industry or enterprise specific data, such as, sales information), and analysis tools to enterprises, government, industry, and the general public.

Prior to implementations of the invention, conventional systems provided no interactive GIS tools for users to access dynamic enterprise data at run time and integrate third party data hosted by a data center. That is, with implementations of the invention, users may access the GIS processing center/operations center 210, which processes data (e.g., converting Tagged Image File Format (TIFF) to Joint Photographic Expert Group (JPEG) format) at run time, and makes the processed data available at run time to users without disrupting the data center 220 operations.

Referring to FIG. 2, enterprise data sources 202, government/Freedom of Information (FOI) public data 204, and satellite imagery data 206 is input to the GIS processing center/operations center 210 in the form of vector data, tabular data, third party imagery, and/or raw tiled TIFF imagery. Although not shown, other types of data may also be input into the enterprise spatial system. In certain implementations, the satellite imagery data 206 is obtained using airplanes flying over areas and taking photographs with cameras that provide high resolution images. The data is stored in an interim archive tape library 212. As a part of processing data, the GIS processing center 214 retrieves data from the interim archive tape library and forwards the data to pre-production processing 216. Ultimately, the data is stored in the production center 222 for client software 250 access.

The GIS processing center/operations center 210 handles many different operations in pre-production processing 216 due to irregularities in GIS data from various sources. For example, the GIS Processing Center performs data compression (e.g., of image data) at run time during the data transformation stage. Compressing data is important because some data (e.g., GIS image data) cannot be accessed over the Internet due to the size of the data. For example, some image data is in a graphical data format called TIFF. TIFF, as understood by those skilled in the art, is a tag-based image file format that is designed to promote the interchange of digital image data. TIFF provides a multi-purpose data format and is compatible with a wide range of scanners and image-processing applications. It is device independent and is used in most operating environments, including Windows®, Macintosh®, and UNIX®. TIFF is one of the most popular and flexible of the current public domain raster file formats. To be able to use GIS image data that may be transferred over the Internet, implementations of the invention convert large image data to a compressed data format, such as JPEG. There are many reasons for using the JPEG file format. JPEG permits a greater degree of compression than other image formats, such as TIFF, enabling quicker downloading times for larger graphics. Furthermore, JPEG documents appear to retain almost complete image quality for most photographs.

There are several important stages in data processing at the GIS processing center 214. The following demonstrate four of the different stages and functions of each stage: (a) data acquisition stage; (b) data extraction stage; (c) data transformation state; and, (d) GIS product inventory creation stage. The data acquisition state procures data from various sources (e.g., enterprise data 202, government/FOI public data 204, and satellite imagery data 206). Data acquisition is an important function of the GIS processing center 214. In the data extraction stage, data is staged for use, the data integrity is verified, and data quality control is provided. In the data transformation stage, the following actions occur on data: color fusion, histograms, matching, misaiming, re-sampling, tiling, and compression, which are well known in the art. In the GIS product inventory creation stage, the following actions occur: metadata is created for the data layers, different data layers are described using metadata, data (e.g., vector, raster or tabular data) is stored in spatial data store, and GIS data is uploaded to the data center 220 for deployment.

The data center 220 includes a staging system 221. Data from the staging system 221 is sent to the production center 222. Data from the staging system 221 may also be stored at a master archive tape library 223 and sent to offsite storage 224. The staging system 221 provides a replica of the production center 222 and is used to test the client software, enterprise spatial system software (e.g., server software at servers in the enterprise spatial system), and data. The staging system 221 is used to ensure that a new version of client software and/or data will work correctly when deployed to the production center 222. The production center 222 is used to store data accessed by users via client software 250.

The data center 220 supports many operations. For example, the data center 220 hosts raster data, vector data, and tabular data for users to access using various client software 250 (e.g., client applications such as, a browser client, a thin client, or an enterprise client). Various techniques of accessing data (e.g., tabular data of sales information) from an enterprise data store and geocoding non-spatially referenced data are supported. In particular, although geocoding may be performed in the GIS processing center/operations center 210, the data center 220 also supports functions that require geocoding in the production center 222. The data center 220 also manages network communications between enterprise users and the data center 220. The data center 220 supports linear scalability to be able to expand the enterprise spatial system provided by implementations of the invention to handle larger data sets (i.e., larger amounts of data) at run time.

The data center 220 provides security and access controls to enterprise users to securely access their enterprise data, allows enterprise users to simultaneously access dynamic data from their enterprise data store 202 and the data center 220, and processes requests from, for example, client applications by supporting client applications' functionality. The data center 220 also supports different types of analytical functions, such as querying for data, generating data reports, retrieving data layers, accessing data, and sharing and/or collaborating with multiple users.

The fulfillment center 230 receives orders for data (e.g., particular data, a particular image or a set of images), prepares the data (e.g., creates or collects the appropriate data), and delivers the data to a requested location. Further details of order fulfillment are provided below.

Enterprise integration 240 allows users to access securely their enterprise data that is stored outside of the data center 220. Enterprise integration 240 also determines whether enterprise data are pre-geocoded or not, and, if the enterprise data is not pre-geocoded, the enterprise data is parsed and geocoding information is provided by determining the proper longitude and latitude information to be associated with the enterprise data elements (e.g., records). The enterprise integration technology 240 also provides the ability to interact with and retrieve data from third party applications using various Application Programming Interfaces (API) exposed by the third party applications and makes the data available to the client systems of the data center 220. The enterprise integration technology 240 also provides various Application Programming Interfaces (API) to third party applications so that different third party applications, including enterprise applications, can access production data from the data center 220. The APIs provide defined function calls to third party applications so that users can interact with the enterprise spatial system provided by implementations of the invention to utilize stored data (e.g., raster data, vector data, and tabular data) for spatially analyzing enterprise data. In addition to accessing data, the APIs also allow third party applications to utilize the various analysis functions provided by the enterprise spatial system.

The client software 250 (e.g., client applications) allows users to manipulate spatial data interactively by making dynamic data requests from the data center 220. The client software 250 includes, for example, browser-based clients, thin clients, thick clients, and enterprise clients. The client software 250 handles all user actions promptly and retrieves spatial data from the data center 220 in a timely manner. To achieve this goal, the client software 250 and the data center 220 rely on using a multiple data layering mechanism. That is, unlike legacy GIS software, the data center 220 does not combine multiple data layers as one composite image when transmitting spatial data to users over a network. Instead, the data center 220 retrieves proper spatial data layers from various data stores based on client requests and converts the data layers to individual images. Then, rather than combining multiple spatial data layers as one raster file or vector file (e.g., JPEG, ASCII Extensible Markup Language (XML) or other forms of binary file), the data center 220 sends the images separately to the client software 250. The client software caches the images for the different spatial data layers to avoid generating new image files every time users change back and forth between different spatial data layers. The client software may combine multiple images to form a composite image that is displayed to a user.

Thus, the enterprise spatial system includes components illustrated in FIG. 1 as well as components illustrated in FIG. 2. The components illustrated in FIG. 2 are used to provide interactive maps for use by the components illustrated in FIG. 1.

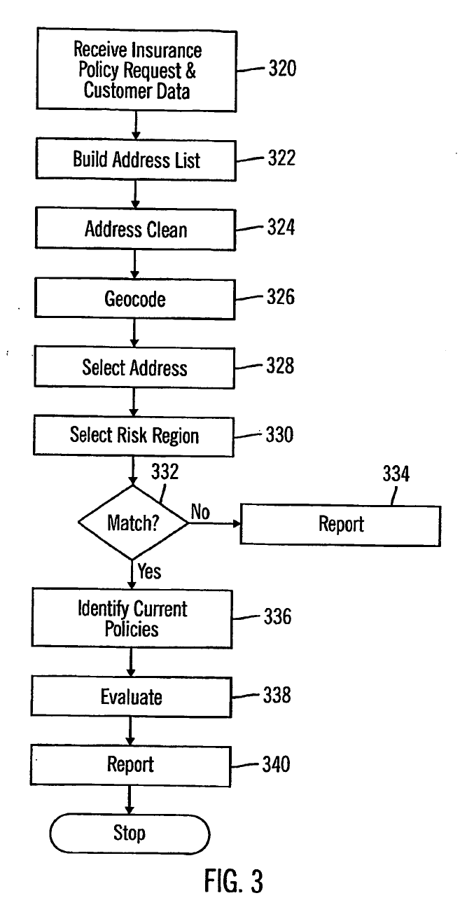

FIG. 3 illustrates logic for generating a report for an insurance policy request in accordance with certain implementations of the invention. At block 320, an insurance agent may receive a request for an insurance policy for coverage against terrorism and/or some other peril. The agent may also receive existing or prospective customer data for the desired policy such as: 1) the name and address of the entity seeking coverage (e.g. an individual or a company name and the address of the property to be covered); 2) the requested coverage type (e.g., property insurance for a loss resulting from a terrorist attack and/or some other peril); and 3) the desired amount of coverage, deductible and premium. The request and the existing or prospective customer data may be submitted to the insurance agent, or any other insurance company representative, using any conventional means.

At block 322, the insurance company representative, such as the underwriter, using the request and the existing or prospective customer data reported in block 320, may activate a conventional Web browser or any other client application on client computer 100 to access server computer 120 and build a comprehensive address list.

To build a comprehensive address list, the representative may enter on client computer 100 one or more addresses that were provided. Additionally, the representative may enter on client computer 100 a search query consisting of an estimated spelling for the entity (e.g., in case the correct spelling is unknown to the representative). Server computer 120 may then access one or more commercially available data stores 170, such as, the U.S. Marketing File data store from Dun & Bradstreet, to return for display on client computer 100 a list of entity names that begin with the representative's search query. Using client computer 100, the representative may then select the correct entity. If the insurance company representative knows the correct entity name, then such an entity name search may be skipped.

When the representative enters or selects an entity name, the representative may be prompted to select search criteria for a data store search for related entities. The representative may select from search criteria including: 1) whether to search for related entities (e.g., subsidiaries, affiliates, and the like for the entity; presumably, for an individual entity, as opposed to a business entity, no such search would be desired); and 2) if a related entity search is requested, whether any geographical, or other, restrictions apply.

The representative may enter on client computer 100 the search criteria, and server computer 120 may access one or more commercially available data stores 170, such as the U.S. Marketing File data store from Dum & Bradstreet, and employ a conventional search routine to identify the sought-after entities in data store 170. Server computer 120 may then obtain the sought-after entities located in the entity-name-based search of data store 170.

The representative may also enter on client computer 100 additional relevant addresses not originally provided by the existing or prospective customer or located in the entity-name-based search. For example, data store 170 employed for the entity-name-based search may not be up to date to include the latest business locations for a given entity.

Thus, at block 322 a comprehensive address list may be built for the existing or prospective customer, which may include: 1) addresses originally provided by the existing or prospective customer; 2) addresses found in the entity-name-based search, such as related entities; and 3) any other addresses for entities that are related to the existing or prospective customer but not found in the entity-name-based search.

At block 322, the representative may also enter on client computer 100 any remaining existing or prospective customer data for the desired policy such as: 1) the requested coverage type (e.g., property insurance for a loss resulting from a terrorist attack and/or some other peril); 2) the desired amount of coverage, deductible, and premium; and 3) any other information that the insurance company wants to consider in evaluating whether to underwrite the requested insurance policy.

At block 324, server computer 120 cleanses the addresses in the comprehensive address list by executing any well-known address cleansing process, such as the common address matching technology of the Address Broker software from Sagent, Inc. of Mountain View, Calif. In executing the address cleaning process, server computer 120 may compare the addresses in the comprehensive address list with addresses in a reliable master address data store 170, such as the USPS Address Matching address data store from the U.S. Postal Service. From the comparison, server computer 120 may correct addresses in the comprehensive address list that were incorrect prior to the address cleansing.

Alternatively, data store 170 that may be utilized with block 322 to build a comprehensive address list may be “precleansed.” Specifically, an address cleansing process, such as described in block 324, may be performed on the addresses in data store 170 that may be utilized in block 322 to build a comprehensive address list. The address cleansing of data store 170 may be performed before a user employs system 10. Consequently, run-time address cleansing, such as block 324, may be skipped.

At block 326, server computer 120 geocodes the addresses in the comprehensive address list by executing any well-known geocoding process, such as that performed by Address Broker from Sagent Technology, Inc. of Mountain View, Calif. As those skilled in the art appreciate, the geocoding process may associate with each address in the comprehensive address list a unique geographic identifier, such as a latitude and a longitude value. As such, each address location may be evaluated with any spatial query techniques well-known to those skilled in the GIS arts to determine the address's location relative to any other geocoded data sets (e.g., whether a geocoded address location intersects with a geocoded high risk zone).

Alternatively, data store 170 that may be utilized with block 322 to build a comprehensive address list may be “pregeocoded.” Specifically, a geocoding process, such as described in block 326, may be performed on the addresses in data store 170 that may be utilized in block 322 to build a comprehensive address list. The geocoding of data store 170 may be performed before a user employs system 10. Consequently, run-time geocoding, such as block 326, may be skipped.

At block 328, server computer 120 may select an address (now cleansed and geocoded) from the comprehensive address list. The list may include a single address, if, for example, the existing or prospective customer requested coverage for a single location. Alternatively, the list may include several addresses, if the existing or prospective customer requested coverage of a number of locations. In the latter case, server computer 120 may select one or more addresses at a time from the comprehensive address list for processing, as discussed below in blocks 332-340.

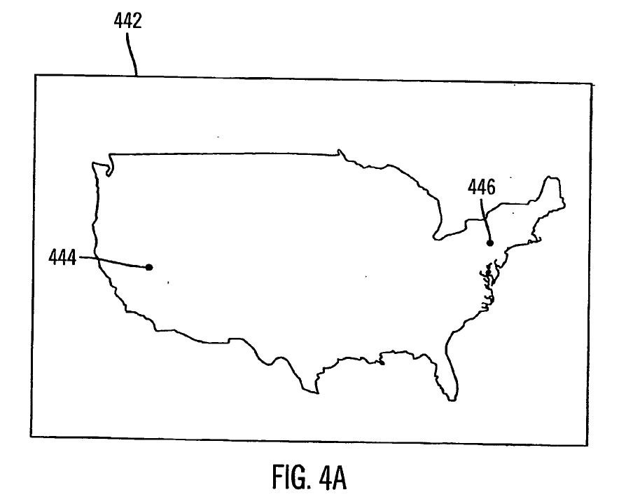

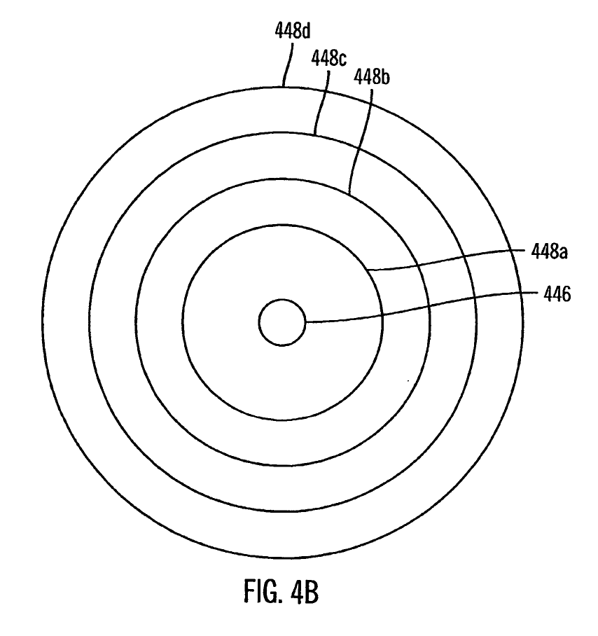

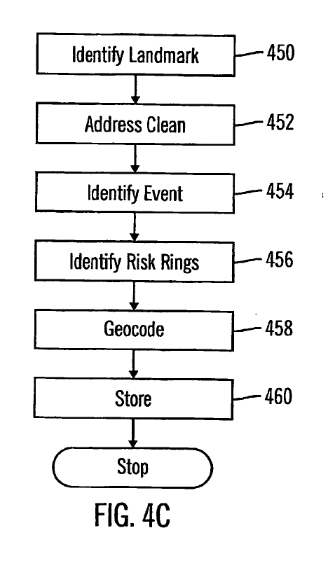

At block 330, server computer 120 may retrieve the requested coverage type (e.g., property insurance, including coverage for a loss resulting from a tornado) previously entered at block 320. Utilizing any well-known spatial query techniques, server computer 120 may then access data store 170, which may contain predefined high risk zones. Each predefined high risk zone may be associated with a predetermined peril (e.g., a tornado) and a predetermined zone where the perilous event has a specified probability of occurring (e.g., specified counties in the Midwestern United States known as Tornado Alley), as known to those skilled in the art. Moreover, a predetermined high risk zone may cover one or more geographically discrete areas for the predetermined peril. For example, there may be a predetermined tornado risk zone that coves only Tornado Alley, and there may be another predetermined tornado risk zone that covers not only Tornado Alley, but other statistically-relevant tornado risk areas in the United States. Data store 170 may also include one or more predefined high risk zones for terrorism-based perils. FIG. 4C illustrates logic for building high risk zones for such terrorism-based and other perils. Moreover, in certain implementations, block 330 is not limited to selecting a single predefined high risk zone; multiple high risk zones may be selected for evaluation.

Those skilled in the art understand that it may be necessary for server computer 120 to be conventionally programmed to query data store 170 using any well-known spatial query techniques to retrieve, for example: 1) high risk zones; 2) any specific area within a high risk zone (such as an area with an elevated loss factor due to, for example, historical data indicating elevated risk); and 3) existing policies within a high risk zone that may also contain the same spatial coordinates as one or more of the address(3s) selected in block 328. Those skilled in the art also understand that it may be necessary to geocode the high risk zones and the locations for the existing policies either prior to the processing of block 330 or during the processing of block 330.

Server computer 120 may select a predefined high risk zone that matches the requested coverage type. For example, if the requested coverage type was for storm damage anywhere in the United States, server computer 120 may retrieve a predefined high risk zone for tornadoes in the United States.

Utilizing any well-known spatial query techniques at block 332, server computer 120 may compare one or more selected addresses with the selected high risk zone to determine whether any prospective address location(s) are within the selected high risk zone. Geocoding of the addresses and the high risk zones may facilitate this comparison. Moreover, the matching process of block 332 may alternatively consider a modification of a selected high risk zone (e.g. it may be expanded by some predefined quantity to encompass nearby locations that may not otherwise be in the zone or it may be reduced by some predefined quantity to encompass fewer locations than would otherwise be in the zone).

If there is only one prospective address and the prospective address is not within the selected high risk zone, at block 334 a report may be made indicating to the insurance company representative that underwriting the insurance policy is acceptable (because the prospective address is not in the selected high risk zone). Alternatively, if the prospective address is within the selected high risk zone, then at block 336 server computer 120 may utilize any well-known spatial query techniques to retrieve from data store 170 the existing policies and associated covered locations that are also located within the selected high risk zone. Those skilled in the art understand that it may be necessary for server computer 120 to be conventionally programmed to query data store 170 using any well-known spatial query techniques to identify the high risk zones that include the longitude and latitude values for one or more selected address(es) of the submitted policy, as well as to identify all the existing policies and associated covered locations whose longitude and latitude values are also within the identified high risk zones.

At block 338, server computer 120 may make an evaluation using any predetermined insurance company standard. For example, server computer 120 and/or data store 170 may be conventionally programmed to determine a revised PML (including the new policy) and whether the revised PML exceeds a predetermined PML limit. If the PML limit is not exceeded, at block 340 a report may be sent back to client computer 100 to the insurance company representative to indicate that the new policy may be issued. Alternatively, if the PML limit is exceeded, at block 340 a report may be sent back to client computer 100 to indicate to the insurance company representative that the new policy may not be issued or that further information may be considered before the policy may be accepted. However, those skilled in the art appreciate that the predetermined insurance company standard for the evaluation of block 338 is not limited to the example described above (whether the revised PML exceeds a predefined PML limit). Those skilled in the art understand that server computer 120 may be conventionally programmed to make an evaluation of whether to underwrite a policy using any predetermined standard desired by the insurance company.

Alternatively, if there is more than one prospective address and none of them are within the selected high risk zone, at block 334 a report may be made to the insurance company representative to indicate that underwriting the insurance policy is acceptable. However, if any of the prospective addresses are within the selected high risk zone, then at block 336 server computer 120 may retrieve from data store 170 those policies that are also located within the selected high risk zone. A report may also be made to indicate to the insurance company representative that underwriting the insurance policy is acceptable for the prospective addresses that are not within the selected high risk zone.

At block 338, server computer 120 may make an evaluation using any predetermined insurance company standard. For example, server computer 120 may be conventionally programmed to determine a revised PML and whether the revised PML exceeds a predetermined PML limit. In determining a revised PML, server computer 120 may consider prospective addresses in the high risk region either individually or in one or more groups. Assuming single-address consideration, if the PML limit is not exceeded for the considered address, at block 340 a report may be sent back to client computer 100 to indicate to the insurance company representative that the new policy may be issued for that address location. Alternatively, if the PML limit is exceeded for the single address location, at block 340 a report may be sent back to client computer 100 to indicate to the insurance company representative that the location may not be covered by the policy or that further information may be considered before the policy may be accepted. Thus, a policy for multiple addresses may be accepted for some locations and not accepted for others (e.g., if a single branch office of a multi-branch bank is deemed to be too high or a risk to insure, it may be excluded from the policy covering the other branch offices for the particular business).

FIG. 4A illustrates a landmark, FIG. 4B illustrates risk rings, and FIG. 4C illustrates logic for identifying risk rings for a landmark in accordance with certain implementations of the invention. With this method, an insurance company representative may use a Web browser on client computer 100 to custom design a high risk zone, such as a perceived terrorist target. The custom-designed high risk zone may then be stored in data store 170 for use with the method described for FIG. 3.

Referring to the flowchart of FIG. 4C, the user at block 450 identifies a landmark 446, which is shown by way of example in FIG. 4A. FIG. 4A represents a map display 442 that may show on client computer 100 a user-selected image 444 that may include landmark 446, which may correspond to a high risk zone, such as a perceived terrorist target.

To identify landmark 446 at block 450, the user may enter on client computer 100 the address for landmark 446, which is reported to server computer 120 for display on client computer 100. Alternatively, using a mouse, the user may point to user-selected image 444, zoom into an appropriate resolution (to show landmarks, such as buildings), and select with the mouse the desired landmark 446.

At block 452, the address for the identified landmark may be conventionally cleansed as discussed above with reference to block 424 in the method of FIG. 3.

At block 454, the user may identify on client computer 100 a perilous event, such as specified type of terrorist attack on landmark 446 (e.g., a conventional bomb with specified characteristics, a biological weapon with specified characteristics, a chemical weapon with specified characteristics, etc.). Server computer 120 may have a number of such perilous events predefined for the user to select with client computer 100. Additionally, the user may enter with client computer 100 any desired perilous event and define its characteristics, as desired.

At block 456, the user may identify on client computer 100 risk rings for the selected landmark 446, as depicted in FIG. 4B. Each risk ring 448a-448d represents an area in proximity to the landmark 446. The user may select for each risk ring 448a-448d an expected loss factor. Thus, for one type of perilous event (e.g., a conventional bomb of specified strength), the user can enter a loss factor for each risk ring 448a-448d based on the expected damage for the selected perilous event. For example, a user may expect a 2,000 pound conventional bomb to destroy 90 percent of the value of the property within risk ring 448a, 80 percent of the value of the property within risk ring 448b, etc. Block 456 may permit the user to create on client computer 100 specified loss profiles for a specified perilous event, as well as to edit existing high risk zones. Risk rings 448a-448d need not be circular, as shown in FIG. 4B, and may take any desired shape.

At block 458, the high risk zone identified in blocks 450-556 is conventionally geocoded and stored at block 460 in data store 170 for use with the logic of FIG. 3.

Once a new high risk zone has been created with its related perilous event and loss factors, it may be stored on data store 170 for immediate use in evaluating insurance policies, as described by the logic of FIG. 3. Moreover, server computer 120 does not need to be shut down and restarted and client computer 100 does not need to be interrupted in any way before the new high risk zones may be accessed for such evaluation. This allows insurance companies to dynamically and in real-time add, change, or delete additional high risk zones, peril events and loss factors without having to shut down system 10 and interrupt the method of real-time insurance policy evaluation of FIG. 3.

### B. INSURANCE UNDERWRITING AND RISK MANAGEMENT

Insurance underwriting is a dynamic business that requires intimate knowledge of the book of business and company-specified thresholds for accumulated risk based on natural and manmade perils. A peril may be described as a specific risk or cause of loss covered by an insurance policy. In general, underwriting is the process of insuring someone for something. An underwriter's primary responsibility is to produce, underwrite, and quote new and renewal business for their company. Being location aware is an integral component of underwriting. A location may be described as a physical location that may be tied to a policy. By having immediate knowledge of policyholders' locations and their proximity to catastrophe zones or targets allows underwriters to distribute risk.

With services provided by the underwriting system 132, the guesswork is taken out of the equation when underwriting insurance. Underwriters are provided with access to real-time location assessment and prospect approval workflow with the underwriter system. Starting with an address, the underwriting system 132 is a sophisticated underwriting service that allows users to quickly and easily input location information and determine whether to write, investigate or not write policies based on, for example, peril, coverage type (i.e., a type of insurance policy) or line of business. The underwriting system 132 provides several techniques to input location or policy details and quickly determine whether the location is in proximity to perils and appropriately set or adjust pricing premiums. A premium may be described as an amount the policyholder pays for insurance coverage. To have a clear understanding of impact on current book of business, the underwriting system 132 provides company specific ratings and exposes location verification, audit, and assessment prior to writing, renewing or terminating business.

The underwriting system 132 provides an easy to use technique for rating new business against perils, such as terrorist events. In order to accommodate the workflow of underwriters who are working with multiple lines of business and multiple perils, the underwriter system provides underwriters with an interactive process to determine whether to write, renew or reject business.

The underwriting system 132 provides several interactive techniques for inputting prospective policyholder details, including the ability to upload records from a file, input an individual address, and search by company. The underwriting system 132 allows underwriters to input policy details and save prospective information for a company-specified period of time. Underwriters are provided with the ability to perform peril-specific queries to determine whether prospective policies are in man made, natural catastrophe, or company-specified peril zones. A peril zone may be described as a specific peril territory that is defined by, for example, a point, a line, or a polygon. The underwriting system 132 includes natural catastrophe zone data for several catastrophes, such as terrorism, hail, wind, flood, hurricane, and earthquake.

The underwriting system 132 interacts with the geocoding service available in the enterprise spatial system in both interactive and batch modes prior to rating locations. Location ratings are driven by company-specific business rules, and rating results are configurable on a company-by-company basis. The ability to drilldown from individual rating results to location details is supported by the underwriting system 132. The underwriting system 132 also provides users with the option to view locations on a map. This option is configurable (e.g., through a customer administration tool provided by the enterprise spatial system).

The underwriting system 132 supports approval of prospective policies as unbound business and creates location-specific PMLs that are applied to the current book of business so that users have a real-time snapshot of their percentage of CAP at any given time. A PML may be described as an estimated monetary loss (e.g., expressed as a percentage of total value) experienced by a structure or a collection of structures when subjected to a natural or manmade peril of a certain magnitude or with a given probability of occurrence in a stated time period. A CAP may be described as a capacity or the supply of insurance available to meet demand. Capacity depends on the financial ability to accept risk. CAP for an individual insurance company is the maximum amount of risk that can be underwritten based on the insurance company's financial company. Lists of rated locations may be exported or saved for a given period of time for further investigation. This process reduces the need to input information multiple times and improves the underwriter's efficiency. The underwriting system 132 determines location-specific exposure so that underwriters have knowledge of accumulated exposure at an individual location. This allows an underwriter to appropriately spread risk.

The underwriting system 132 also provides role-based access to location details. For example, this allows internal users to have detailed views into prospective policies and external agents to have a write or reject view. An agent may be an individual who works for an insurance company or may be an individual who works for multiple insurance companies and who sells insurance policies.

In certain implementations, Web services are provided to enable use of the underwriting system 132 via the Web.

The underwriting system 132 increases efficiency of the underwriting process for writing, renewing or changing policies. In particular, the underwriting system 132 identifies locations that are in high risk areas or areas of overexposure, provides immediate feedback on what action to take for a given policy, compares how prospective business impacts current bound business, review high risk policies or locations by management, cleanses addresses for locations and provides feedback regarding the level of address match.

The underwriter system supports business requirements to enable underwriters to write, renew or terminate business based on proximity to natural or manmade perils and the impact to the current book of business. The underwriter system provides users with the ability for real-time batch uploads or individual entries of location addresses. The underwriter system provides users with the ability to quickly verify whether there are any associated perils, either man-made or natural, that are in the vicinity of the location. The underwriter system supports business rules for distance to perils that are company specific.

The underwriter system provides a spatial reference (e.g., geocode) for location information.

The underwriter system supports company-specific thresholds that are configurable for acceptable geocodes. The underwriter system provides the ability to store company-specific business rules for resolving ambiguous addresses in both interactive and batch geocoding of locations. The underwriter system provides users with a technique to resolve non-geocoded or ambiguous addresses. The underwriter system provides the ability to store and reference whether geocodes are system-generated or manually entered. The underwriter system allows data input fields to be company-specific. The underwriter system provides users with the option to audit location information against a third party business data store (e.g., a Dun & Bradstreet data store), provided they have a licensed copy of the data store. The underwriter system provides users with the option to verify location information against a third party business data store (e.g., a Dun & Bradstreet data store), provided they have a licensed copy of the data store.

The underwriter system provides users with the flexibility to check locations against pre-defined (e.g., defined by the enterprise spatial system or by a company) peril zones and returns which zones apply to each location.

The underwriter system provides users with the ability to do cursory checks of geographic areas to determine whether there are any company-defined perils in the area or whether they are free and clear to proceed without any further investigation. The underwriter system stores a list of company-specific peril zones (e.g. Hot Zones). The underwriter system enables rating calculations and results to be configurable by company. The underwriter system enables probable peril-based loss calculations to be configurable by company. The underwriter system enables probable peril-based loss calculations for individual prospects or policies to be generated dynamically and then applied to current CAPs.

The underwriter system enables users to approve business that will be written or renewed. The underwriter system enables users to add unbound policies to a latest snapshot of bound policy data until the unbound policies are bound. When unbound policies become bound, the unbound policies are purged from a temporary storage file, as they are uploaded with the current policy batch. The underwriter system enables users to reject business. The underwriter system provides users with the ability to save, store and retrieve pending business for a company-specific period of time. The underwriter system enables purging of unbound policies after a company-set period of time.

The underwriter system provides users with the option to view locations on a map for further investigation. The underwriter system enables users to compare prospective policies to current book of business. The underwriter system provides users with the ability to add approved policies to the current running percentage of CAP total.

The underwriter system allows users to export a location list of rated locations. The underwriter system allows users to export an entire location list with both rated and non-rated locations. For locations that surpass a company-specified threshold, company-defined warnings may be returned.

The underwriter system provides underwriters with summary reports regarding transactions and status of work in progress during a given period of time (e.g. daily, weekly, monthly). The underwriter system provides users with the ability to view rating results and drill into location details such as ring, distance from peril epicenter, liability, probable loss, current rating. The underwriter system provides users with the ability to input company-specific policy, coverage, and location-level details to assess impact against CAP at the location level for locations that do not pass a set threshold.

The underwriter system provides company-specific views for rating results. For example, rating results may be sorted by line of business, coverage type, or peril. Also, the underwriter system enables setting business rules for thresholds by line of business. A six digit latitude/longitude coordinate is returned with each location populated in the rating results. The latitude/longitude coordinates for locations are included in data exports.

The underwriter system provides role-based views into location information. For example, internal underwriters may desire to have more detailed views into the data than outside agents.

The underwriter system determines the impact of prospects against in force business at the same location. The underwriter system aggregates prospective and in force policies at the same location to understand impact of writing the business.

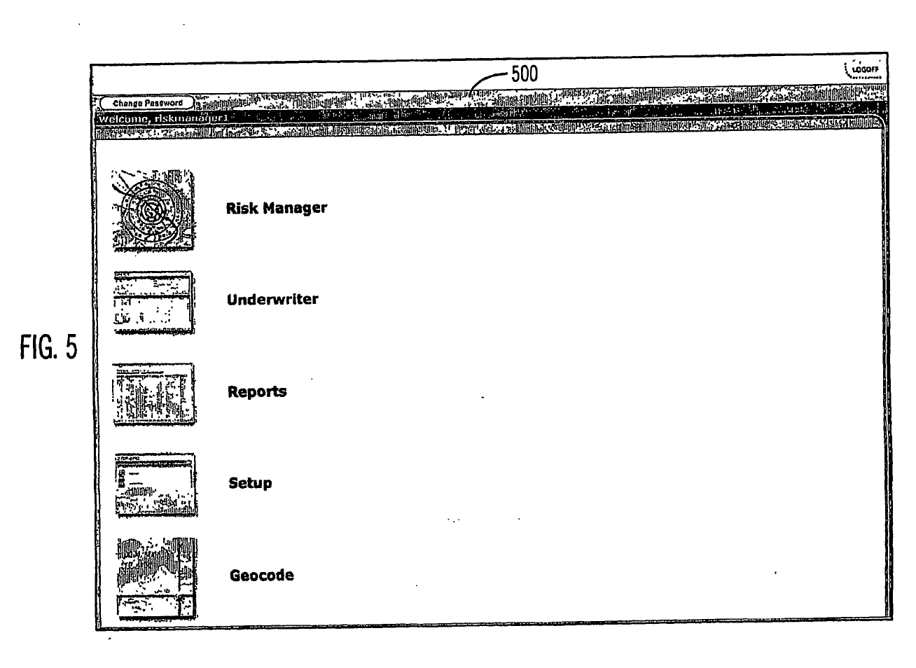

FIG. 5 illustrates an initial screen 500 displayed by the enterprise spatial system 130 in accordance with certain implementations of the invention. From the initial screen 500, a user may select risk manager, underwriter for underwriting assistance, reports to obtain reports, setup to modify (e.g., add, update or delete) events and landmarks, or geocode to geocode data.

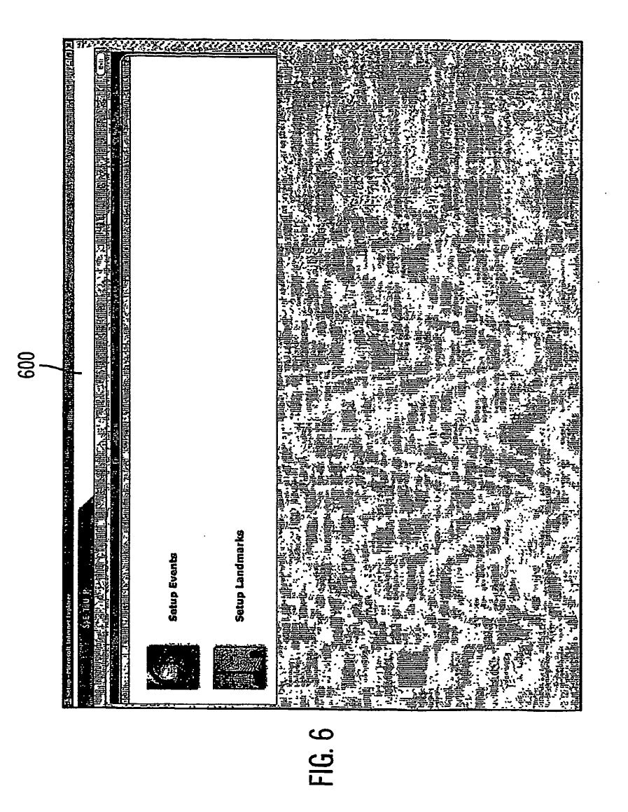

If setup is selected, a setup screen 600 is displayed. FIG. 6 illustrates a setup screen 600 for events and landmarks in accordance with certain implementations of the invention. For changes to event details, a user selects setup events, and for changes to landmarks, a user selects setup landmarks.

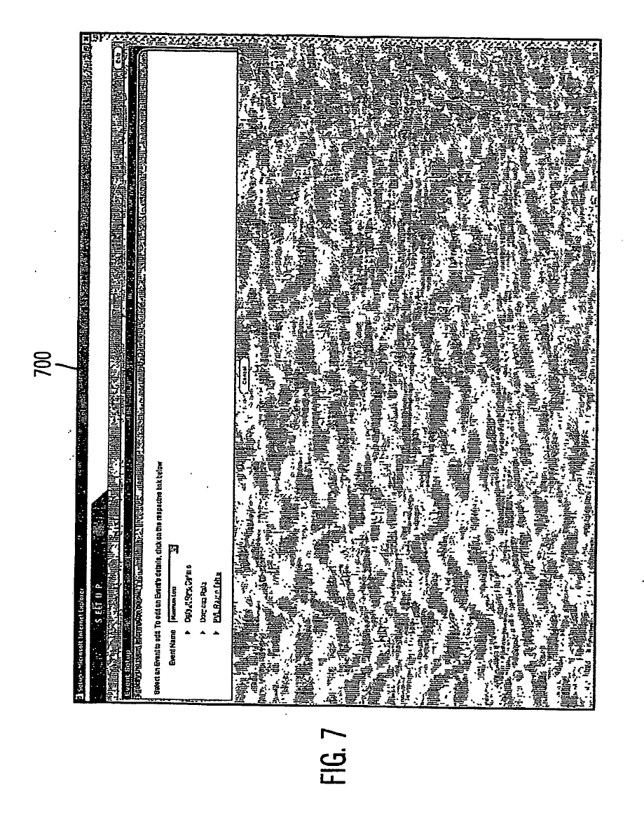

If setup events is selected, a setup events screen 700 is displayed. FIG. 7 illustrates a setup events screen 700 in accordance with certain implementations of the invention. A user may select an event type (such as maximum loss, building collapse, etc.) and then select ring details, damage rate or PML rating tables to edit the selected data.

If ring details is selected, a setup event ring attributes screen 800 is displayed. FIG. 8 illustrates a setup event ring attributes screen 800 in accordance with certain implementations of the invention. A user may make changes to the number of rings and ring distances for a particular event type.

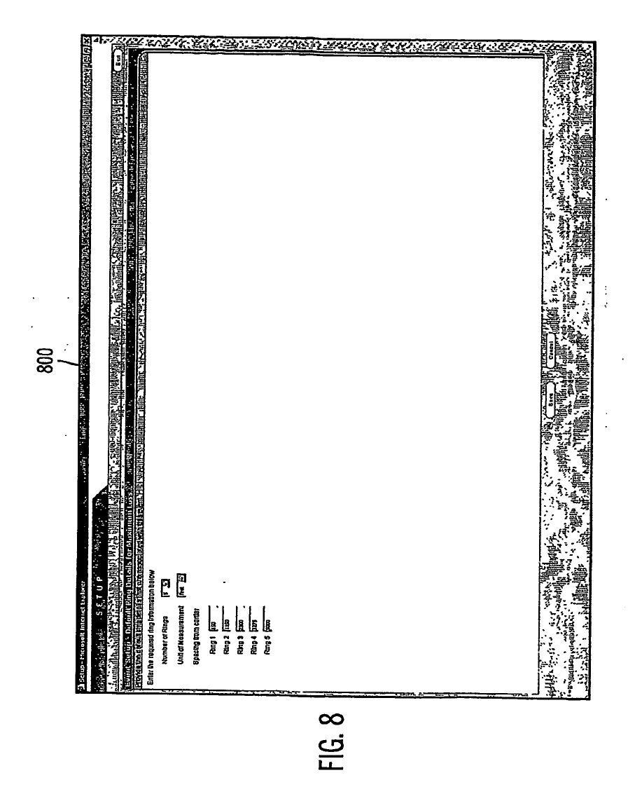

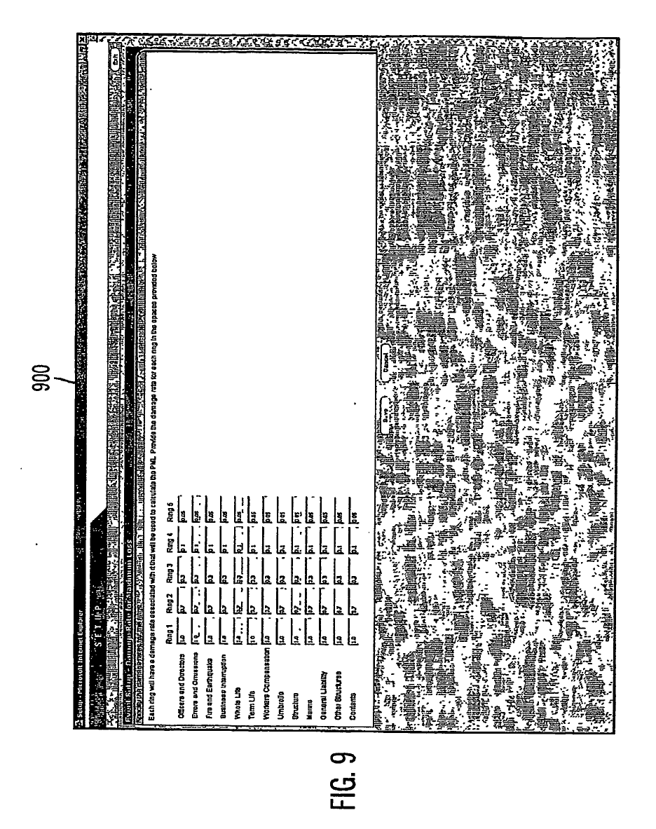

If damage rate is selected, a setup event damage rates screen 900 is displayed. FIG. 9 illustrates a setup event damage rates screen 900 in accordance with certain implementations of the invention. A user may make changes to damage rates by ring and coverage type for a particular event type.

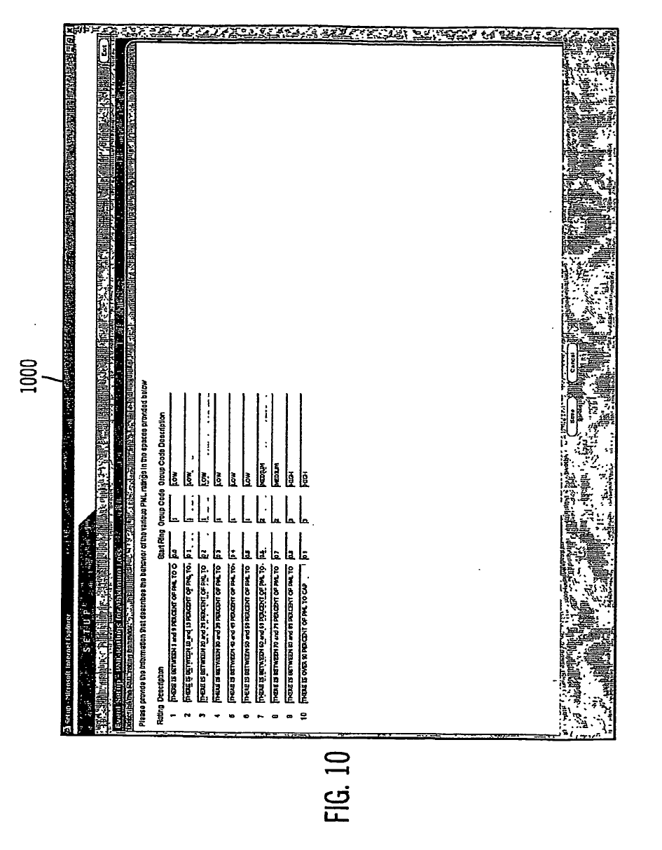

If PML rating tables are selected, a setup PML rating details screen 1000 is displayed. FIG. 10 illustrates a setup PML rating details screen 1000 in accordance with certain implementations of the invention. A user may make changes to PML rating descriptions, group codes, and ring information for a particular event. A group code may be described as a code for a rating that can be described as high, medium, low or other customer-defined designation.

From the setup screen 600, if setup landmarks is selected, a setup landmarks screen 1100 is displayed. FIG. 11 illustrates a setup landmarks screen 1100 in accordance with certain implementations of the invention. A user may enter new landmarks, enable landmarks, and add financial details (e.g., landmark CAP) for a landmark.

For ease of understanding, some usage scenarios for underwriting will be described herein. However, these usage scenarios are examples of applications of the invention and are not intended to limit the invention in any manner.

For the use cases, an underwriter works at an insurance company. The underwriter uses the underwriting system 132 to write a new policy for an existing account, to change an existing account, to write renewals, to write new business, to write a policy for an individual peril, to write a policy for a multi-peril, to resolve ambiguous addresses, to view selected locations on an interactive map, to save locations to a company, and to review and/or approve a prospective policyholder. A policyholder may be described as an entity (e.g., an individual or a company) who buys an insurance policy.

As for writing a new policy for an existing account, the underwriter has an existing account for a customer, who wants to add Worker's Comp to the current Property Insurance the customer has with the insurance company. The underwriter wants to quote a new policy for the customer. The underwriter verifies information related to the account. Using the underwriter system, the underwriter runs a check against each location to see whether any fall within the company defined peril zones to determine whether or not to write the new policy. In this example, none of the locations come up with a “Do Not Write” status. The underwriter adds a price premium for three locations that fall within high risk areas and quotes the cost of the insurance to the customer.

Changes to an existing account include, for example, deleting something from a policy or adding something to the policy. For example, a company has consolidated their business due to lower than expected sales volume and has closed six store locations. The underwriter uses the underwriting system 132 to adjust the existing policy to drop these locations. With the underwriting system 132, the underwriter uses the policy number as a unique identifier to retrieve the policy, deletes the six locations, and reassesses the risk rating to determine the change in premium.

On the other hand, a company may acquire 15 new locations throughout the country. The underwriter uses the underwriting system 132 to adjust the existing policy to cover these additional locations. With the underwriting system 132, the underwriter uses the policy number as a unique identifier to pull up the existing policy. The underwriter has a spreadsheet with the additional locations accessible for rating. While rating the new locations, the underwriter runs into two high-risk locations and assesses how the location's individual risk compares to the company's current overall risk prior to adding the locations to the existing policy, using the underwriting system 132. Additionally, with the underwriting system 132, the underwriter also determines an adjusted pricing for the policy.

As for writing renewals, when an underwriter has an existing policy that is up for renewal, the underwriter assesses whether or not to renew the policy based upon the underwriting guidelines set by the insurance company. With the underwriting system 132, the underwriter uses the policy number as the unique identifier for reviewing the policy and checks the policy against company-defined peril zones to determine whether to write the policy. Depending on whether the locations related to the policy clear the rating process, the underwriter either writes the policy for renewal, increases the premium or declines to renew the policy.

As for writing new business, the underwriter receives a request from a company that is looking to switch insurance providers and needs property and casualty insurance for its business. Using the underwriting system 132, the underwriter collects information relating to the locations that would be a part of the policy as well as information related to the policy and coverage needed. The underwriter uses the underwriting system 132 to determine whether writing this new policy is beneficial to the insurance company. The underwriter reviews each location to be included in the policy against perils, such as terrorism, hail, wind, flood, hurricane, and earthquake.

As for writing a policy for an individual peril, the underwriter uses the underwriting system 132 to determine whether or not the underwriter can underwrite an account for a peril, such as terrorism. The underwriter gathers the appropriate account and location information. With the underwriting system 132, each location in the policy is run against the insurance company business rules to determine whether or not any of these locations may put the insurance company over a specified cap. The underwriter quotes the policy and receives affirmation of whether the policy may be accepted. The underwriter submits the policy as bound business so that the paperwork may be prepared.

As for writing a policy for multi-perils, the underwriter uses the underwriting system 132 to determine whether or not the underwriter can underwrite an account for multiple perils, such as terrorism, hail, wind, flood, hurricane, and earthquake. The underwriter gathers the appropriate account and location information. With the underwriting system 132, each location in the policy is run against the insurance company business rules to determine whether or not any of these locations may put the insurance company over specified caps. In certain implementations, the underwriting system 132 establishes caps at the portfolio, line, organization structure, and peril levels. In this example, four of the locations come up as falling in a high-risk area. The underwriter reviews these accounts individually to determine how each individual account affects the caps. The underwriter finds two locations that put the insurance company over one or more caps. The underwriter may submits the information for management review.

As for resolving ambiguous addresses, an agent sends the underwriter a list of 67 locations to review for a new prospective policy. The underwriter uses the underwriting system 132 to verify the validity of the address information contained in the list. In particular, the underwriter submits the addresses for geocoding to verify whether there is a valid match. Eight of the 67 addresses are returned by the underwriting system 132 with multiple results that could potentially be the correct location. The underwriter reviews the suggestions for each of the eight addresses and selects a desired location.

As for viewing selected locations on an interactive map, once the underwriter has input addresses for a policy, the underwriter may select any of the locations the underwriter wishes to view on a map. The underwriting system 132 presents the underwriter with an interactive map on which the underwriter may turn on and off corporate, non-corporate and peril-specific layers and perform further visual analysis of clusters and intersections of risk. When exiting the map view, the underwriter may be returned to a ratings screen.

As for saving locations to a company, when reviewing a prospective policy, the underwriter may realize that there additional information should be collected before running a location specific PML on one of the locations that fell within a high-risk zone. Rather than rerun all the locations once the underwriter gets in contact with the policyholder for additional information, the underwriter uses the underwriting system 132 to save all of the information related to the current review of the account. At another time, the underwriter may reopen the saved account to complete a review (e.g., once the underwriter has the additional information).

In certain implementations, as for review and/or approval of a prospective policyholder, the insurance company may have an underwriting management team that receives requests from underwriters to review policies that appear to put the company at risk of overexposure in a particular area or where locations are in high-risk areas. A manager on the team may then be responsible for reviewing the account and providing the underwriter with a decision on whether to write or decline the business.

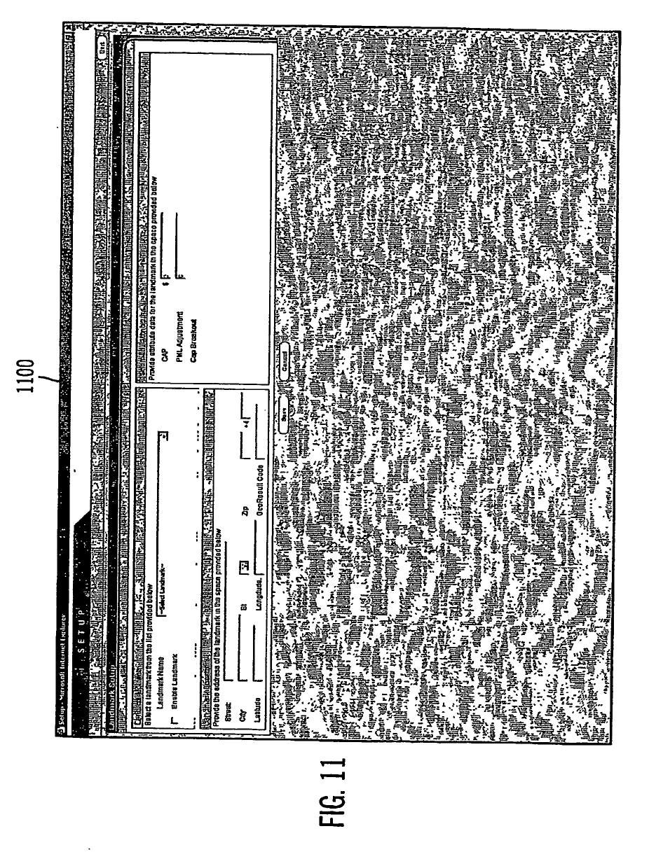

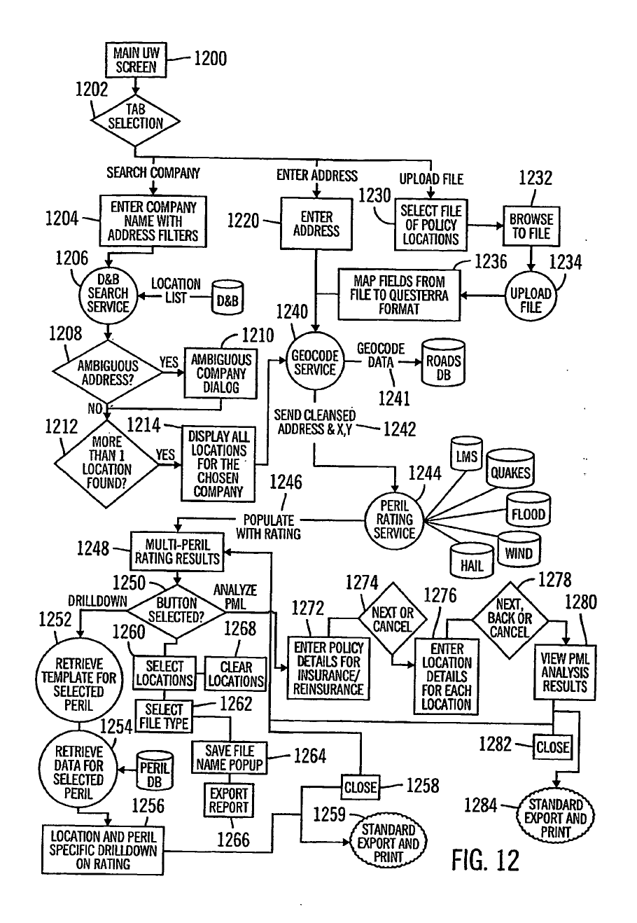

FIG. 12 illustrates logic for a user interface flow for an underwriting system 132 in accordance with certain implementations of the invention. Control begins at block 1200 with a main underwriting system screen being displayed. From the main screen, a user may select tab 1202. The tab may represent a search company option, an enter address option or an upload file option. If a search company option is selected, processing continues to block 1204, and a user enters a company name with address filters. In block 1206, a business data search may be performed (e.g., a Dun and Bradstreet (D&B) data store search) that checks the validity of one or more addresses in a location list (i.e., a list of addresses). In block 1208, if there is an ambiguous address, processing continues to block 1210, otherwise, processing continues to block 1212. In block 1210, an ambiguous company dialog box may be displayed to allow the user to select one of multiple possible correct addresses for a desired location. In block 1212, if more than one location was found, processing continues to block 1214. In block 1214, all locations for the chosen company are illustrated and processing continues to block 1240.

In block 1202, if the enter address tab is selected, processing continues to block 1220. In block 1220, the user may enter an address and processing continues to block 1240.

In block 1202, if the upload file tab is selected, processing continues to block 1230. In block 1230, a user may select a file of policy locations. In block 1232, the user may browse to select the file (e.g., from a directory or a list of files). In block 1234, the file is uploaded. In block 1236, fields from the file may be mapped to the format of the data stored for the underwriting system 132 and processing continues to block 1240.

In block 1240, the geocode service geocodes data (block 1241). In block 1242, cleansed address data and latitude/longitude coordinates are sent to a peril rating service. In block 1244, the peril rating service, which has access to data on various perils (e.g., earthquakes, flood, wind, hail, etc.) rates the perils for at least one location. In block 1246, a screen is populated with rating data. In block 1248, multi-peril rating results are displayed for the user.

In block 1250, a user may select drilldown, export or analyze PML. If a user selects drilldown of a particular peril from the multi-peril rating results, processing continues to block 1252. In block 1252, a template for a selected peril is retrieved. In block 1254, data for the selected peril is retrieved. In block 1256, location and peril specific drilldown is displayed for the rating results. From this display, a user may close the display window (block 1258) and return to the multi-peril rating results (block 1248) or may export or print data (1259).

From block 1250, if the user selects export, processing continues to block 1260. In block 1260, a user may select one or more locations. If the user, would like to deselect locations, the user may clear locations (1268). Once location selection is complete, processing continues to block 1262. In block 1262, the user may select a file type. In block 1264, the user may select a file name. In block 1266, the report is exported.

From block 1250, if the user selects analyze PML, processing continues to block 1272. In block 1272, a user enters policy details for insurance or reinsurance. In block 1274, a user may select next to continue to block 1276 or cancel to return to block 1272. In block 1276, a user may enter location details for each location for which PML analysis is to be performed. In block 1278, a user may select next to continue to block 1280. Additionally, a user may select cancel or back to return to block 1276. In block 1280, a PML analysis results are displayed. From this display, a user may close the display window (block 1282) or may export or print data (block 1284).

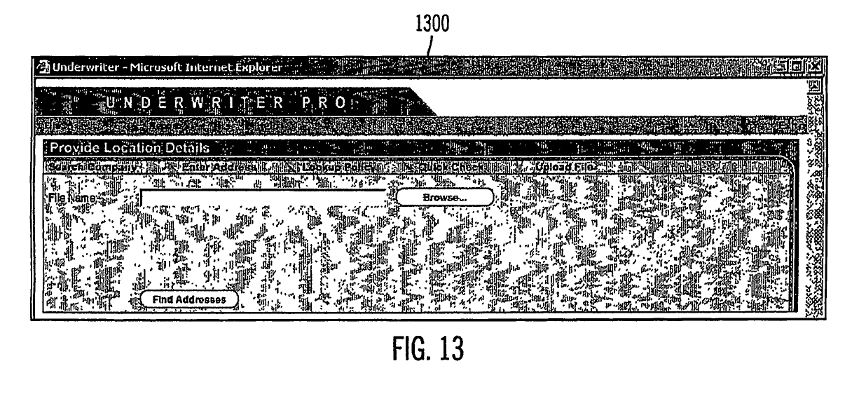

The underwriting system 132 supports the ability to input prospective policy location information and real-time imports of company locations and associated policy details from a file. FIG. 13 illustrates a screen 1300 provided by the underwriting system 132 for uploading of information from a file in accordance with certain implementations of the invention. In FIG. 13, a user selects an Upload File tab, browses to select a file, and uploads a file. The user may map fields to the enterprise spatial system format. Also, the underwriting system 132 geocodes locations and resolves or exports geocodes that do not meet company-specific threshold. The user may then select locations for rating.

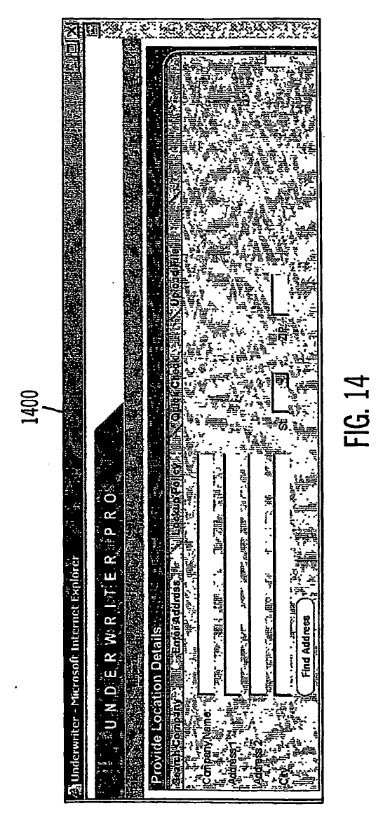

The underwriting system 132 also supports entering of address information on the fly. FIG. 14 illustrates a screen 1400 provided by the underwriting system 132 for entering address information in accordance with certain implementations of the invention. In FIG. 14, a user selects the Enter Address tab and enters address information.

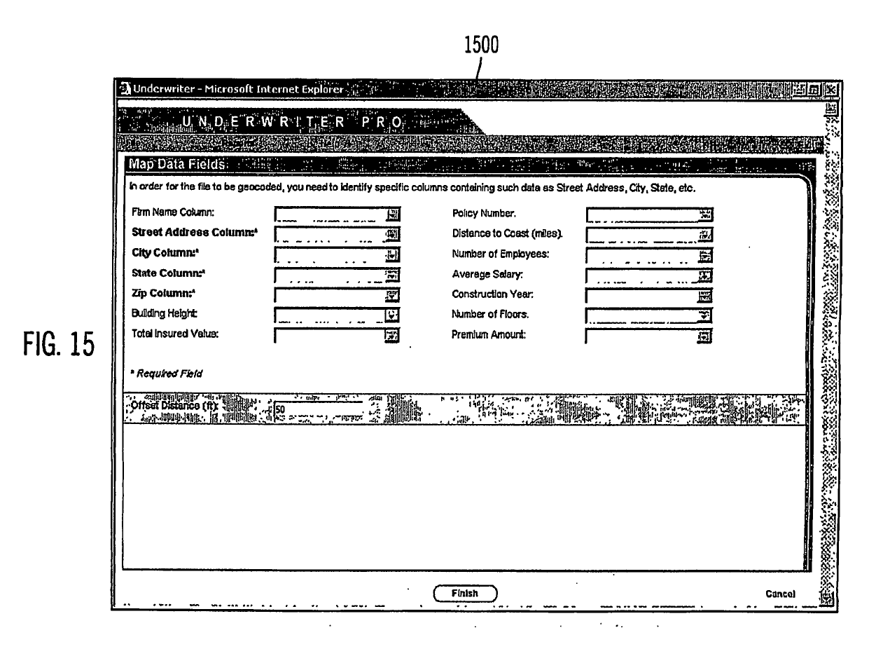

FIG. 15 illustrates a screen 1500 provided by the underwriting system 132 for mapping fields from a spreadsheet to the enterprise spatial system format in accordance with certain implementations of the invention. In FIG. 15, a user maps fields for geocoding by entering information into the appropriate fields (e.g., street address, city, etc.). Address information may include, for example, any combination of address, city, state, and ZIP code (e.g., all four items, address with city and state or address with ZIP code. The underwriter system provides an option to set a default for users to either map fields once and set them as the default for future uploads or to map each input file individually. The user may be prompted to fill in additional details, such as Account Name(Name Insured) and Line of Business. The underwriting system 132 supports the option to audit address or location information against a third party data store (e.g., a Dun & Bradstreet data store, infoUSA, etc.). When matched against third party data, any results that do not match to an acceptable level are flagged, and the user is given the option to export unmatched addresses and resolve these offline.

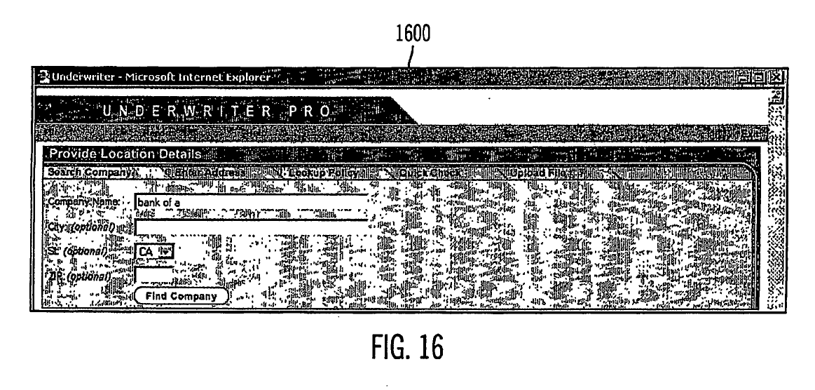

The underwriter system supports the ability to search with a company name. FIG. 16 illustrates a screen 1600 provided by the underwriting system 132 for entering a company name in accordance with certain implementations of the invention. In FIG. 16, a user selects the Search Company tab and enters a partial or fill company name to search for that company.

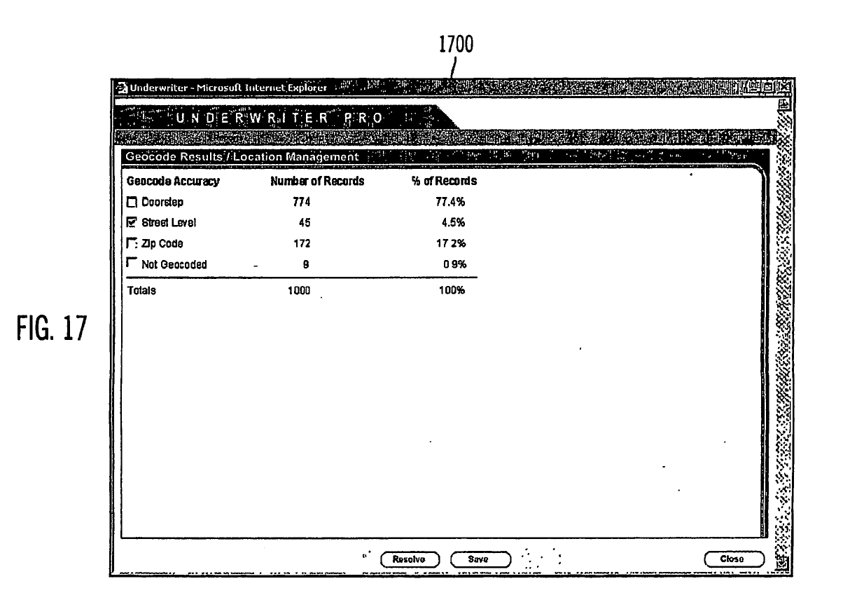

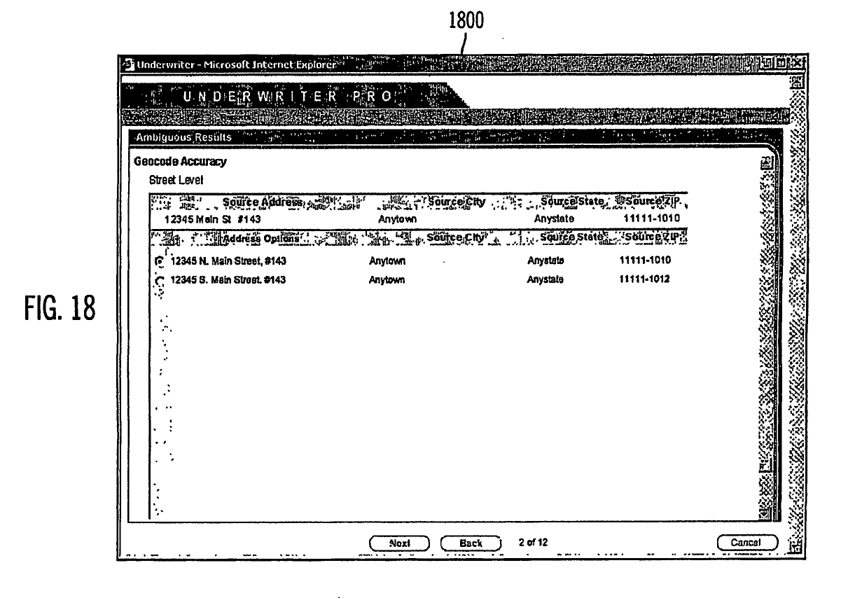

Each location, whether entered individually or uploaded as a batch, is geocoded (e.g., to at least a six-digit latitude/longitude coordinate, such as, 40.597285/−96.595166). Each geocoded location has an associated field to define whether the geocoding result was system generated or manually generated. For those locations that do not geocode to a company specified threshold, a list of locations with scorecard results are returned to the user. These locations may be exported and saved to a file for correction and future upload and/or included with the rating results as ‘unrated’. FIG. 17 illustrates a screen 1700 provided by the underwriting system 132 with geocoded results in accordance with certain implementations of the invention. In FIG. 17, a user is presented with geocoding results that indicate a geocoding accuracy (e.g., street level), a number of records at that level, and a percentage of records at that level. A user may select Resolve to resolve ambiguous addresses (i.e., locations for which there are multiple similar addresses, such as a street address with North and South locations), and the underwriting system 132 attempts to resolve the address using, for example, third party data (e.g., a Dun & Bradstreet data store). FIG. 18 illustrates a screen 1800 provided by the underwriting system 132 for address resolution in accordance with certain implementations of the invention. In FIG. 18, the underwriting system 132 displays ambiguous address results (i.e., a list of possible address matches for a single location at a time), and the user selects an appropriate address to be selected as the correct address. Then, the user may select the Next button to resolve another address. Returning to FIG. 17, if there are no addresses to resolve, a user is automatically taken to a rating screen. The user may also select Save to save addresses, corresponding latitudes and longitudes, and geocoding result codes to a file. The user may select Close to return to the location selection screen and continue to rate locations.

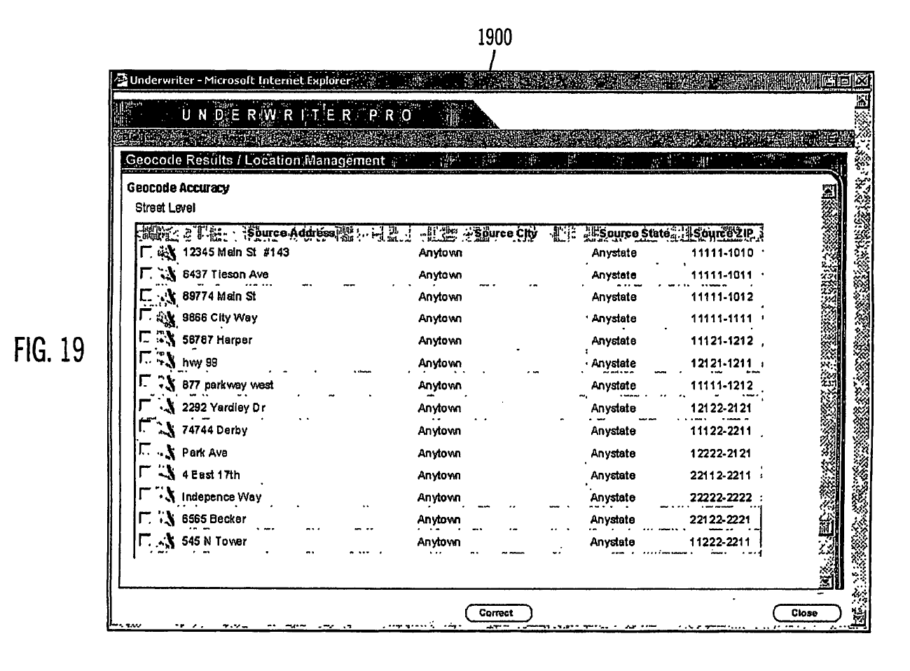

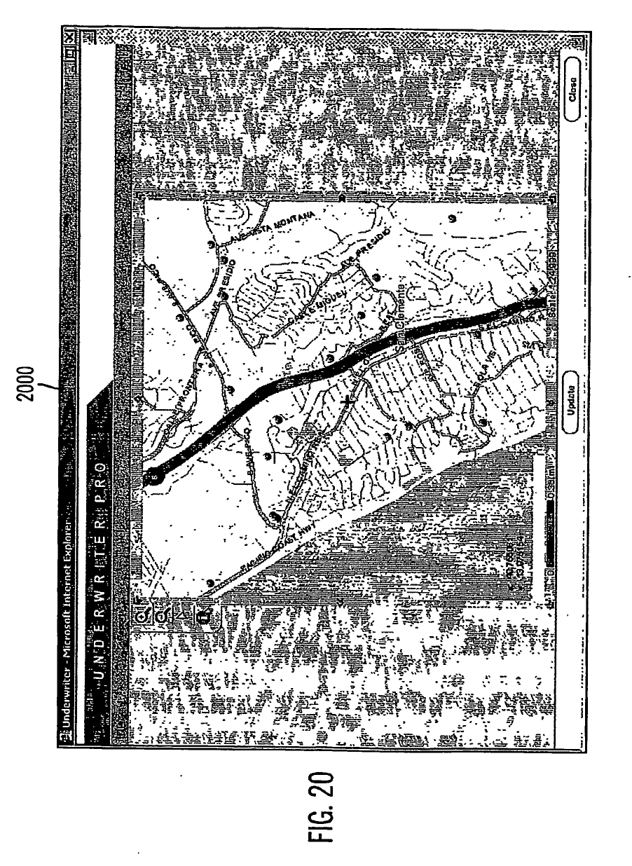

Address resolution options are presented for both individual and batch records. For example, FIG. 18 provides a user interface with ambiguous options for the user to select from to resolve an address. Also, the underwriting system 132 provides the ability to use a map interface to resolve non-geocoded or ambiguous addresses. In certain implementations, this may be a separate service that is provided for records that are exported for address resolution. FIG. 19 illustrates a screen 1900 provided by the underwriting system 132 for address resolution for non-geocoded locations in accordance with certain implementations of the invention. FIG. 20 illustrates a screen 2000 provided by the underwriting system 132 for a spatial (e.g., map) interface to manually correct a geocode in accordance with certain implementations of the invention. In FIG. 19, a user imports a list of locations or manually enters locations for address resolution by the geocoding system. Then, a user may select Correct locations individually by choosing the selection tool and manually correcting the location on a map (illustrated in FIG. 20). Then, the location of the address is corrected. Also, once a user completes correcting locations, the location list may be exported for re-import into the underwriting system 132. In FIG. 20, once a user selects the selection tool (e.g., a map icon) for a location from FIG. 19, the user is presented with an interactive map centered on a current geocode result. The user may zoom and pan the map and uses a selection tool to move the visual indicator of the current longitude and latitude to a new position on the map. The user may select Update to save the new location. The location is flagged by the underwriting system 132 as manually generated. During new uploads of locations, an option is provided by the underwriting system 132 to either include or overwrite the manually generated geocoding results. Moreover, address resolution is a configurable option.

The underwriting system 132 supports the option to audit location information to ensure correctness and completeness of location information and any accompanying location details, such as address, number of employees at location, average salary, etc. This information may be verified, for example, against a third party business directory data store. Any locations that do not meet the company-specified level of acceptable addresses may be saved to a file for further investigation. This is a configurable option.

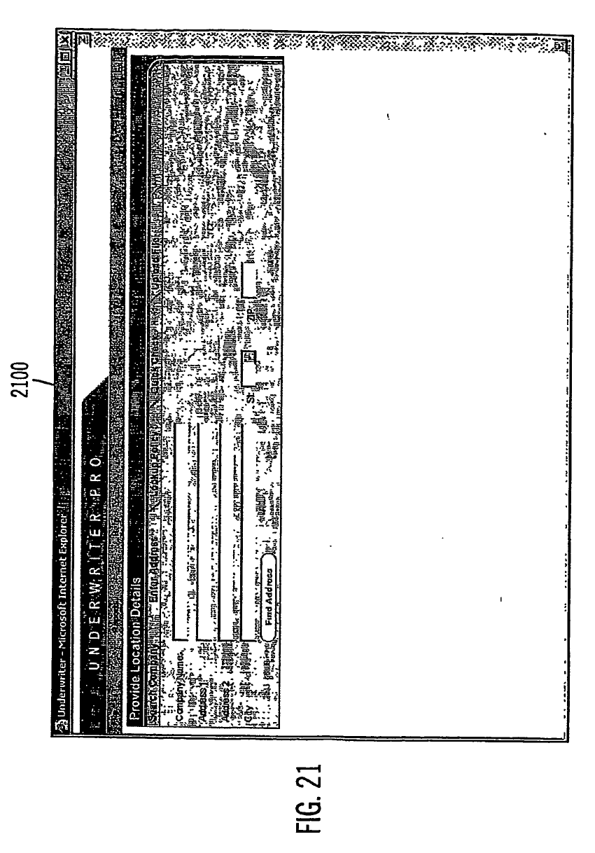

The underwriting system 132 supports various techniques of searching for location information. FIG. 21 illustrates a screen 2100 provided by the underwriting system 132 for searching by address in accordance with certain implementations of the invention. In certain implementations, this search supports one or more of the following fields: company name, address, city, state, and/or ZIP code. In FIG. 21, a user selects the Enter address tab, enters address details, and selects the Find Address button. If an address is ambiguous, the underwriting system 132 provides the user with a list of possible address matches (i.e., ambiguous results list) and allows the user to select a desired address. The underwriting system 132 also geocodes addresses and rates locations.

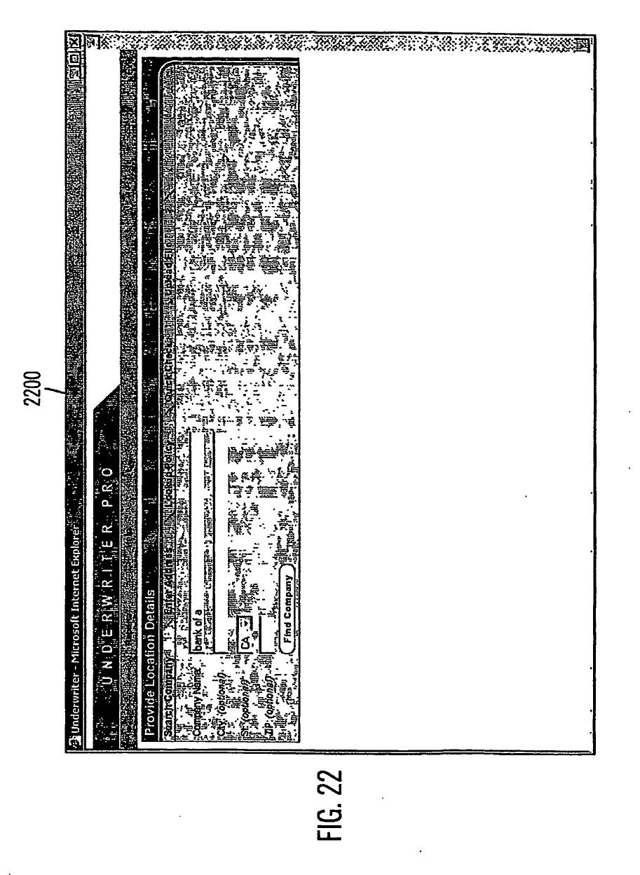

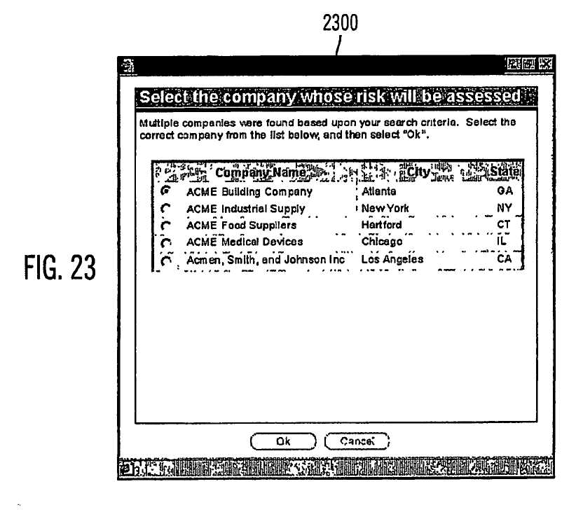

FIG. 22 illustrates a screen 2200 provided by the underwriting system 132 for searching by company name in accordance with certain implementations of the invention. A user selects a Search Company tab and enters a partial or full company name, along with any address details to be used for filtering by the underwriting system 132. In certain implementations, the company name search may be filtered by city, state, ZIP code or any combination of the three. The underwriting system 132 may also check the entered company name against third part business location data, in which locations may be geocoded. The underwriting system 132 may return ambiguous results for locations that have multiple entries matching the input criteria or a list of locations for a company in case a company has multiple locations. FIG. 23 illustrates an ambiguous results screen 2300 provided by the underwriting system 132 in which company name, city, and state are displayed in accordance with certain implementations of the invention. From the list of locations, the user may select one or more locations for ratings and submit a request for ratings. In certain implementations, the search by company name feature is optional.

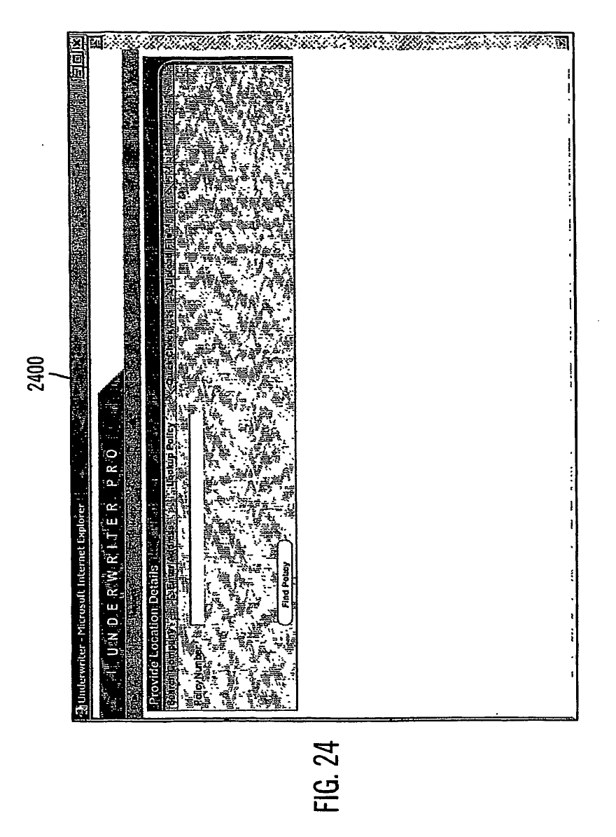

FIG. 24 illustrates a screen 2400 provided by the underwriting system 132 for searching by policy number for an existing business in accordance with certain implementations of the invention. A user selects a Lookup Policy tab, enters a policy number, and selects a Find Policy button. The search by policy number allows the user to enter an existing policy number and then submit an identified policy for rating. The user is able to renew a policy with no changes, add locations to an existing policy, exclude locations from a policy, and/or analyze a location impact on the policy. In certain implementations, the search by policy number feature is an optional feature that is configurable during setup.

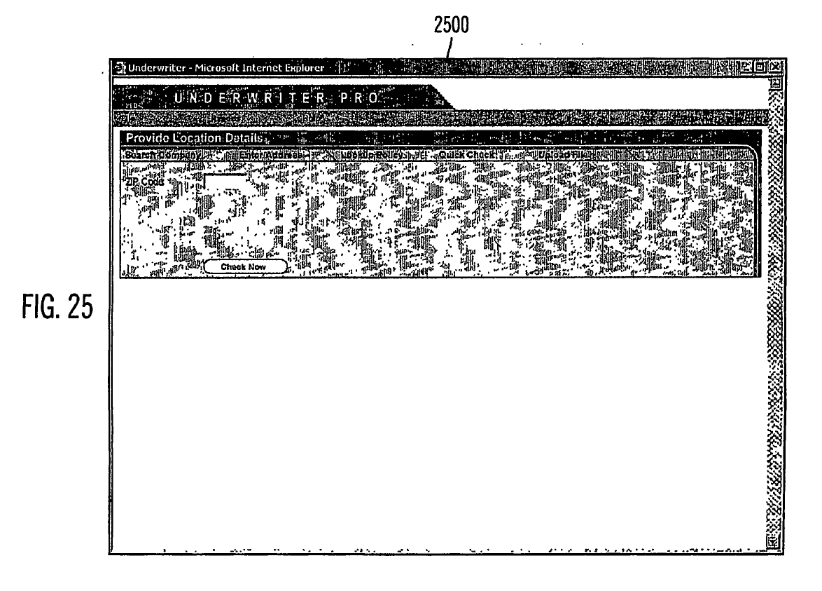

FIG. 25 illustrates a screen 2500 provided by the underwriting system 132 for quick search by ZIP code in accordance with certain implementations of the invention. In FIG. 25, a use selects a Quick Check tab, enters a ZIP code, and selects the Check Now button. In certain implementations, a quick search is provided that may include a search by some administrative boundary, such as ZIP code, block group, census tract or county. This search will check to see if the prospective location or locations fall within any supported peril zone that is configured for a given company. The quick search feature is an optional feature that is configurable during setup.

The search screens are capable of clearing individually selected results or all results, provide options to start a new search, and may store the results of multiple searches in rating results until results are cleared. Also, the number of search options are configurable on a company-by-company basis. (e.g. Company 1 may have ‘Upload File’ and ‘Enter Address’ and Company 2 may have all of the available search options).

Additionally, the underwriting system 132 include the following system defined nationwide peril zones for the United States, including, for example, flood zones, seismic earthquake zones, earthquake fault lines, hail zones, wind zones, and tornado zones. The peril zones are configurable for each company during company setup with the underwriting system 132. Also, the underwriting system 132 allows customers to configure company-specific peril zones (e.g., hot zones, target landmarks, target cities, etc.). The underwriting system 132 stores company-specific peril zones so that they may be queried when determining rating results.

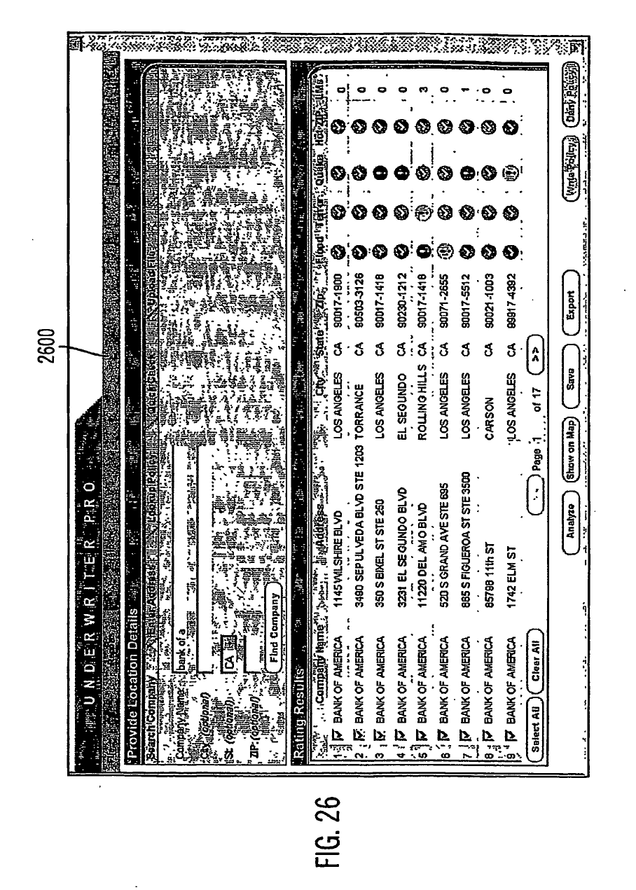

The underwriting system 132 supports the ability to define which peril zones a location falls within. This includes system defined and company-defined peril zones. This information is returned in the rating results. FIG. 26 illustrates a screen 2600 provided by the underwriting system 132 for multi-peril rating results in accordance with certain implementations of the invention. In particular, a user receives rating results for multiple submitted locations by peril.

The underwriting system 132 supports company-specific business rules for determining rating calculations.

The calculations may be peril-specific. There may be an overall rating that takes into consideration all peril zones that a location falls within. Rating results are configurable by company. Also, rating results may include an image to depict write, reject, escalate, a numeric value and/or a textual description. The underwriting system 132 is capable of displaying warnings for prospective policies that pass a company-specified threshold (e.g., escalate to supervisor, flag for reinsurance, flag for premium, etc.). Reinsurance may be described as insurance that one insurance company provides to another insurance company as a hedge against catastrophic loss. The underwriting system 132 also supports drilldowns by number of landmarks for certain peril zones (e.g., terrorism peril zones and displays the landmarks associated with a selected location, sorted by rating from highest to lowest.

Rating of locations is specific to an individual company (i.e., policyholder). Locations that pass the company-specified threshold for geocoding are rated and returned in a rating results window. The count for the number of locations rated is returned in the rating results window (e.g., 530 locations rated). The rating results may be sorted by column headings from highest to lowest/lowest to highest or alphabetically. The location data attributes that are returned in the initial rating results are configured during the company configuration and setup period. The underwriting system 132 supports several fields in the rating results window, including, for example, company name, address, city, state, ZIP code, latitude, longitude, rating, peril zone pass/fail/escalate, and/or number of landmarks. Also, additional fields may be included during upload of files that are used for location-specific PML calculations, such as, line of business, coverage type, layer limit deductibles (i.e., the amount of loss paid by policyholders in dollar amount, as a percentage of a claim amount, or specified as an amount of time that elapses before benefits are paid), number of employees, and/or CAP.

Each location within the rating results includes: 1) a visual indicator that depicts which peril zones affect this particular policy will be supported, and the indicator may be tied to company-specific business rules that are based on the percent of existing CAP they are at for a given peril and 2) a rating (and a separate rating field may be used for cases where there is a unique value that takes into account all perils that a location may fall within). The visual indicator may or may not be associated with the rating.

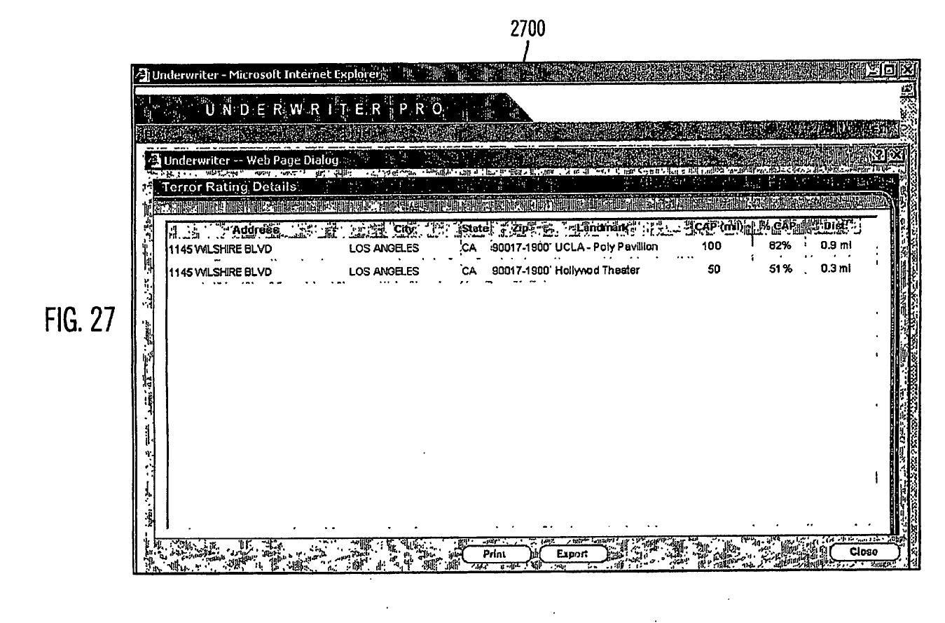

FIG. 27 illustrates a screen 2700 provided by the underwriting system 132 for rating result details by location and by peril in accordance with certain implementations of the invention. A user may drill down on location-specific peril details by clicking on the peril icon. A user may also print, export or close drill down details. Drilldown may be performed for each location. Also, location details for drilldowns are flagged during company data configuration and setup. Location details may include data, such as company name, address, peril name/type (e.g. landmark name or wind zone), distance to peril epicenter (50 feet, 100 yards or 2.2 miles), ring number (which refers to a “ring” around the peril, such as ring 2), buffer zone for area or line data, and/or additional information about the peril zone (e.g. 500 year flood zone).

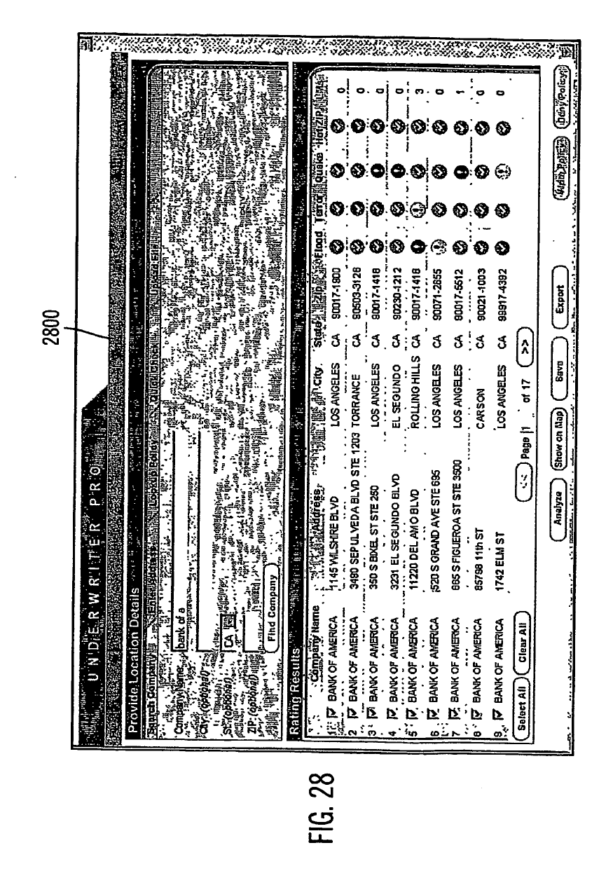

The underwriting system 132 supports the ability to export rating results. FIG. 28 illustrates a screen 2800 provided by the underwriting system 132 for exporting rating results to a file in accordance with certain implementations of the invention. A user may select one or more rated locations and select Export. The underwriting system 132 exports the rated locations and associated information to a file. In FIG. 28, for each address and type of peril (e.g., flood, terror, quake or hot ZIP (i.e., a type of hot zone)), an indication of the level of the peril is provided (e.g., with check marks and exclamation marks in circles with clear or colored backgrounds).

If the company has been configured to include all results, even those that are not rated in the rating results, the company may export all rating results. If the company wishes to only export those results that have a rating, the company may sort based on rating, select the rated results, and choose the export button on the screen. When exporting results, the user has the option to export to various file formats (e.g., .xls, .csv, .pdf and .rtf file formats). The latitude/longitude coordinates for each location are included as part of the export.

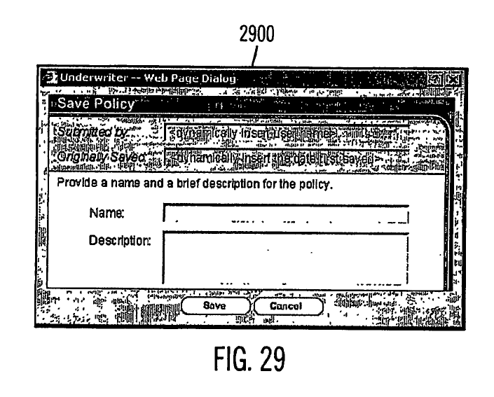

The underwriting system 132 supports the ability to save unbound policies for a company-specified (e.g., up to ‘x’ days/months) period of time. FIG. 29 illustrates a screen 2900 provided by the underwriting system 132 for saving results for a temporary period of time in accordance with certain implementations of the invention. A user selects the Save button to save rating results. The underwriting system 132 prompts the user to enter a name and description. The underwriting system 132 also captures the user login name and the date the details were saved. The user may open saved results by selecting an Open submenu from the File menu and by selecting from a list of saved rating results.

The underwriting system 132 saves location details by company name, user name (e.g., system generated logon name for user), and date saved (e.g., an effective date). Authorized users may open saved work during the temporary storage timeframe. If saved results are submitted for approval, an option is provided to no longer consider the results as saved and to delete the results from a Saved Locations screen. Once the temporary storage timeframe has expired, the locations are purged from the data store. If the policy is bound prior to the temporary storage limit expiry, the policyholder is flagged or deleted from the temporary storage.

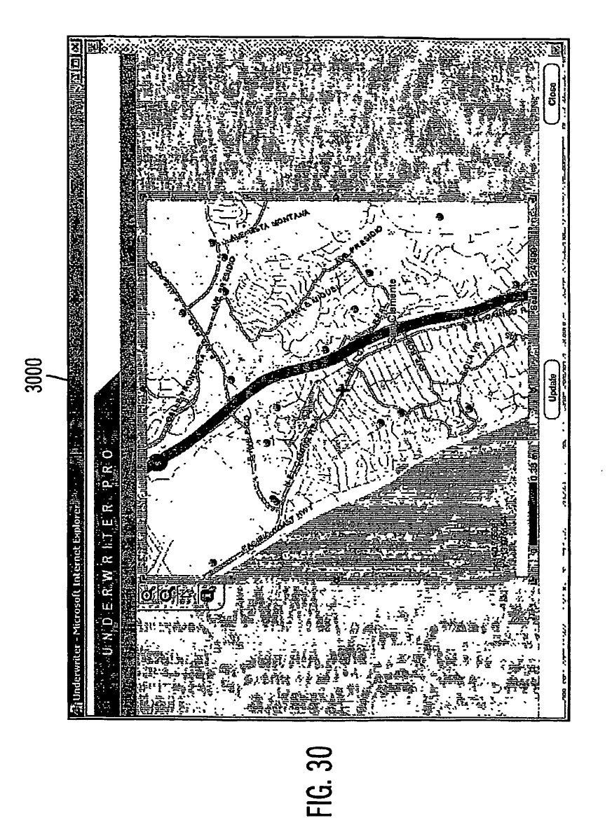

The underwriting system 132 supports the option for rating results to be displayed on an interactive map. FIG. 30 illustrates a screen 3000 provided by the underwriting system 132 displaying selected rating results on a map in accordance with certain implementations of the invention. The user selects a Show on Map button from the rating results screen to access the screen in FIG. 30. A map of selected locations is displayed on an interactive map. The map is available for the users session and may be saved. The user may pan or zoom to obtain location details by using an information tool. The user may print or same the map or close the map view and return to the rating results.

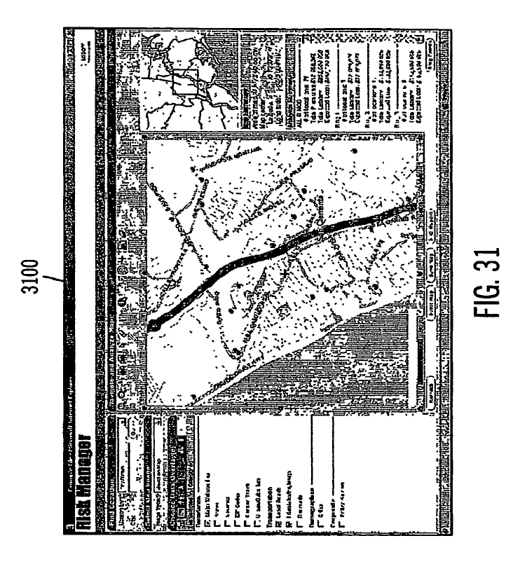

FIG. 31 illustrates a screen 3100 provided by the underwriting system 132 displaying selected rating results on a map when risk manager 134 functionality is available in accordance with certain implementations of the invention. A user selects a Show on Map button from the rating results screen to access the screen in FIG. 31. If the user has access to the risk manager 134, the map is displayed by the risk manager 134. The user may then perform risk manager 134 functions that are configured for the company. The map is available for the users session and may be saved. The user may print or same the map or close the map view and return to the rating results.

In FIGS. 30 and 31, the map extent reflects a best fit of locations plotted on the map. The user is able to print or same the map to a file. The user may also pan, zoom, and point and view locations on the map. The rendering details for locations plotted on the map are set during initial company configuration, and locations plotted on the map are specific to individual sessions. The underwriting system 132 supports a link from the mapping interface back to the rating results screen that were previously displayed. The interactive map is a configurable option.

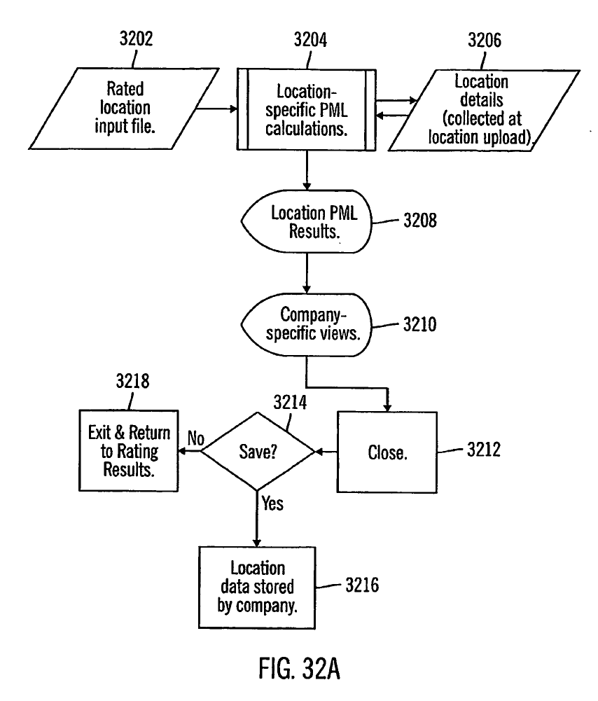

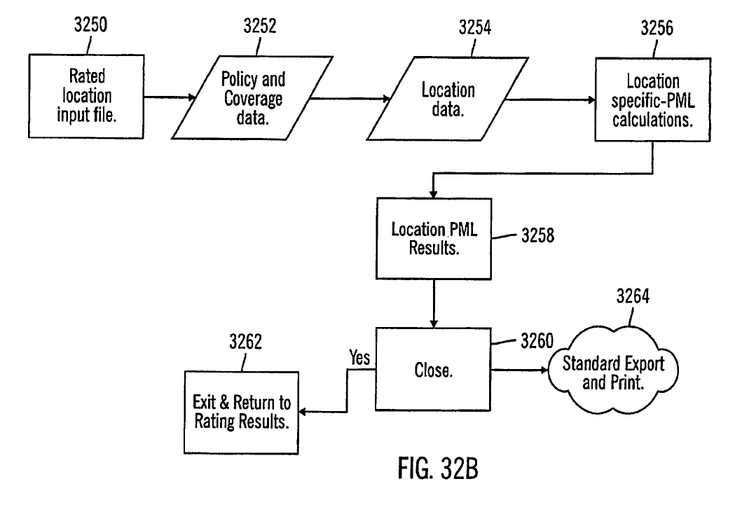

Once the rating results are returned and initial peril checks are cleared, the user may run a location-specific PML for any prospective locations for that company. FIG. 32A illustrates a location specific PML flow in accordance with certain implementations of the invention. In FIG. 32A, a rated location input file 3202 is input, and location specific PML calculations are performed in block 3204. For the calculations, location details 3206 are also input, and these location details 3206 may be collected at location upload time. Location PML results 3208 are output by the calculations in block 3204 and displayed in company specific views 3210. When the view 3210 are closed, it is determined whether a save option was selected (block 3214). If a save option was selected, the location data is stored by company (block 3216), otherwise, the underwriting system 132 exits the company specific views and returns to the rating results screen (block 3218).

FIG. 32B illustrates a location specific PML flow in accordance with certain alternative implementations of the invention. A rated location input file 3250 is input to policy and coverage data 3252, which is input to location data 3254, which is input to location specific PML calculations 3256. The output is location PML results 3258. Upon the user wanting to close a screen (3260), the underwriting system 132 exits the current view and returns to another screen (3262). Additionally, export and print (3264) are available upon close.

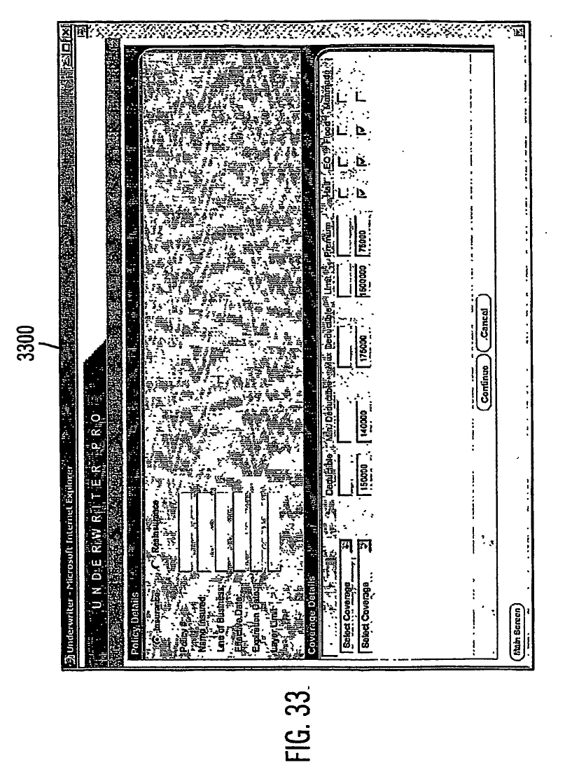

In particular, the user selects locations that a location-specific PML is to be run against. Location-specific PMLs compare locations for a prospective policyholder and compare against an existing CAP (e.g. Landmark CAP). Policy details, location details, peril, and coverage type for any prospective policy are defined prior to running location-specific PMLs. FIG. 33 illustrates a screen 3300 provided by the underwriting system 132 for location specific PML calculations in accordance with certain implementations of the invention. A user may select either insurance or reinsurance. The coverage fields may change for reinsurance. The user inputs policy specific information and policy level coverage details. The user also determines which perils apply at the policy level. The user then selects Continue to enter location specific details.

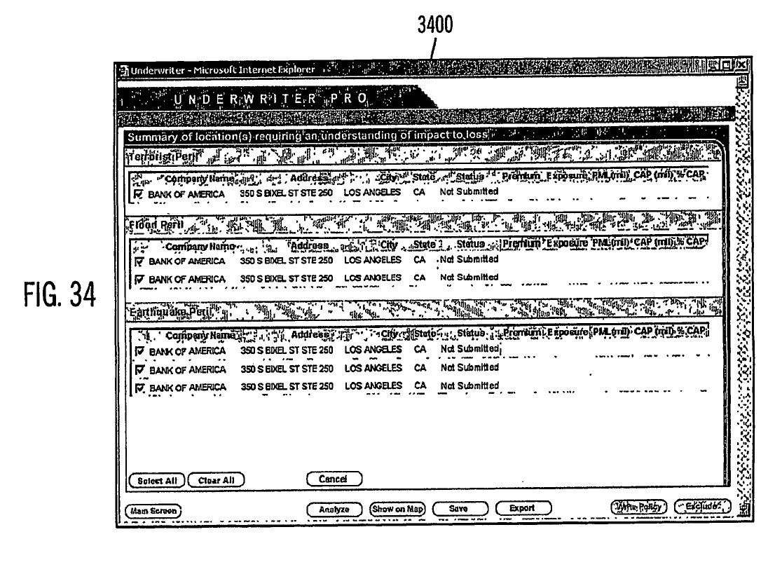

The user may enter policy details that are coverage and peril specific. Policy level details may include, for example, policy number, name insured, line of business, coverage, effective date, expiration date, premium, blanket deductible, minimum deductible, maximum deductible, layer limit (reinsurance), attachment point (reinsurance), and/or ceded percentage (reinsurance). FIG. 34 illustrates a screen 3400 provided by the underwriting system 132 to provide a summary of locations for individual analysis in accordance with certain implementations of the invention. In particular, a user selects locations that individual PML calculations are to be run against, and the user selects Analyze. The underwriting system 132 then performs individual PML analysis.

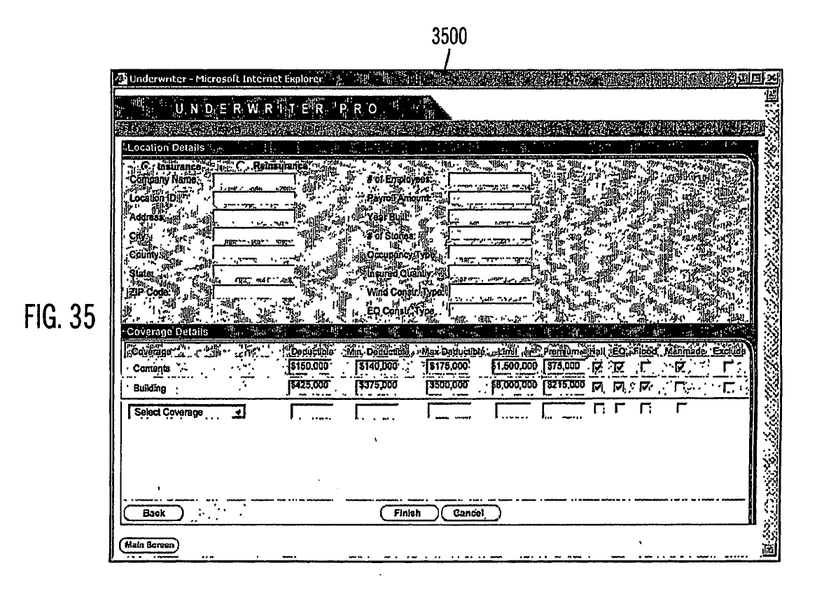

FIG. 35 illustrates a screen 3500 provided by the underwriting system 132 to provide a summary of location specific PML calculations in accordance with certain implementations of the invention. The user may enter location details that are coverage and peril specific. Location level details may include, for example, company, address, city, county, state, ZIP code, total insured value, premium, limit, deductible, minimum deducible, maximum deductible, coverage, number of employees, payroll amount, location ID, year built, number of stories, occupancy type, insured quantity, wind construction type, earthquake construction type (e.g., soil type, liquefaction code, landslide code, crest zone), and/or distance to coast. The user inputs location specific information in the screen of FIG. 35. The underwriting system 132 returns policy level information, and the user may edit the peril zone by coverage, enter a new location specific coverage, exclude a location or select the Finish button. The supplied policy and location information is used to determine location specific PMLs.

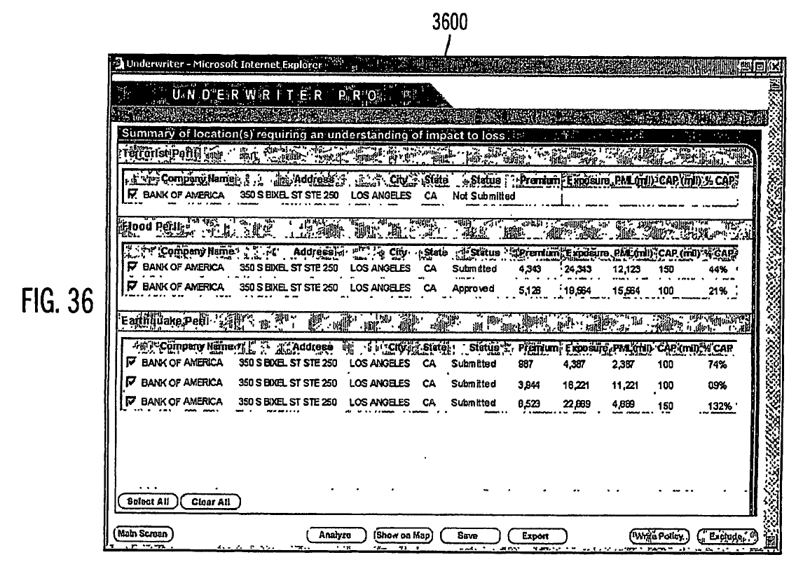

In certain implementations, location-specific PMLs follow pre-set business rules that are company specific. FIG. 36 illustrates a screen 3600 provided by the underwriting system 132 for displaying location specific PML results in accordance with certain implementations of the invention. In particular, the underwriting system 132 displays selected locations that were flagged by the user for location specific PML calculations by location and peril. The user may select locations for further investigation for impact to the CAP and then selects the Analyze button to continue. Fields affecting location-specific PMLs may be established during the company configuration process for validation that certain data is entered. These fields may be auto-populated as part of the file upload process or entered manually by the user, especially in the case of individual entries.

Customer-specific definitions for policy, location, coverage and peril zones may be defined in a configuration document during customer deployment. This information may be used for input to location-specific PMLs and output for detailed report views.

FIG. 37 illustrates a screen 3700 provided by the underwriting system 132 for displaying a detailed customer-specific multi-dimensional report in accordance with certain implementations of the invention. A user may view, save, export or close such a report. Detailed views into the resulting policy details (i.e., post location-specific PMLs) are company specific. Certain views of the reports may include displays by policy and location, by coverage and by peril zone, etc.

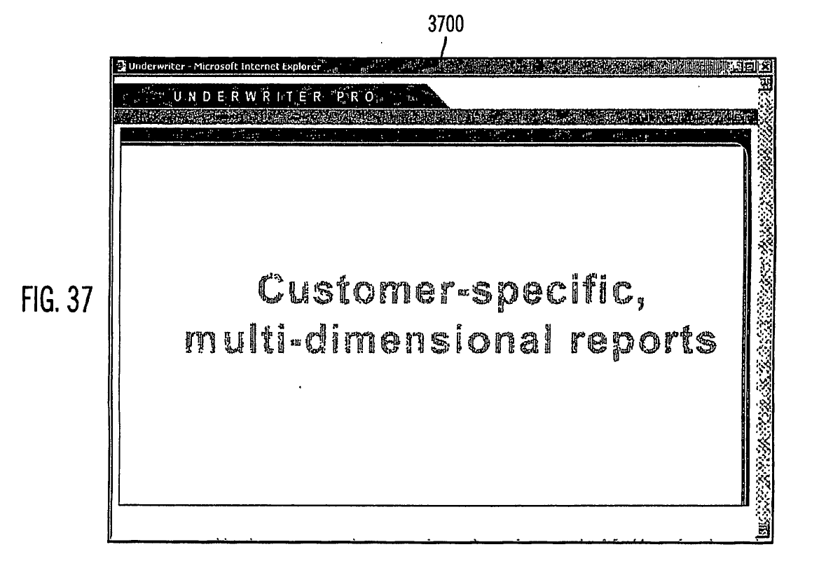

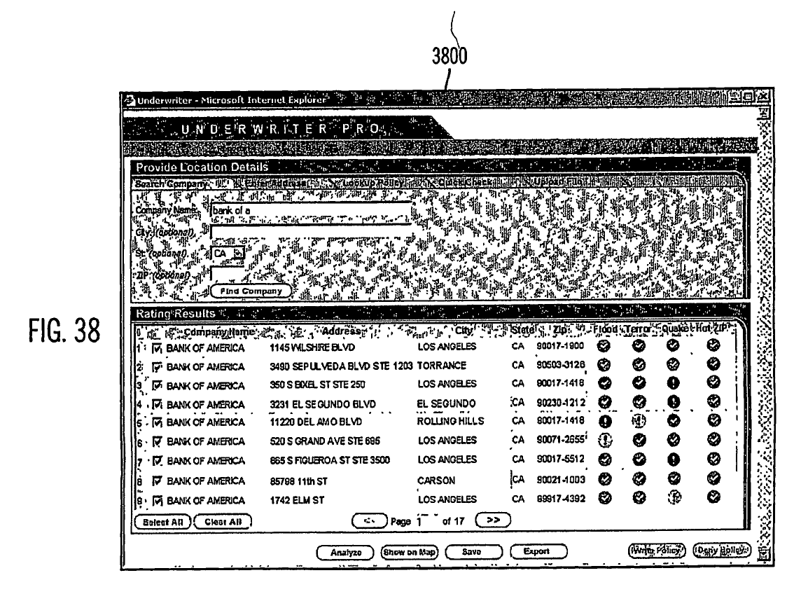

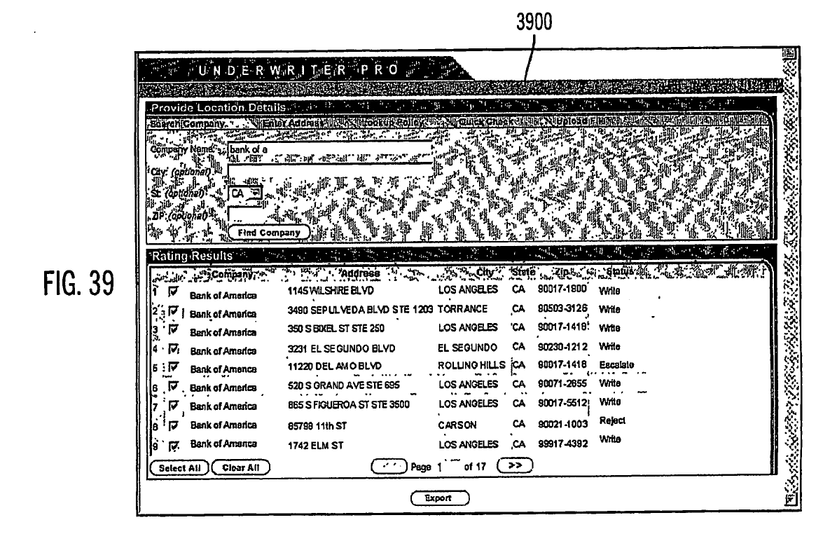

Role-based access allows some users with an internal role (e.g., company employees) to have detailed views into the rating results and some users with an external role (e.g., external agents) to have a write/reject new business view. FIG. 38 illustrates a screen 3800 provided by the underwriting system 132 for displaying rating results for a user with an internal role in accordance with certain implementations of the invention. Users with an internal role have access to view full details and have drilldown capability. FIG. 39 illustrates a screen 3900 provided by the underwriting system 132 for displaying rating results for a user with an external role in accordance with certain implementations of the invention.

The underwriting system 132 accumulates risk by line of business or peril type for a single location (e.g., a latitude/longitude coordinate). This aggregation takes into account either a) in force business or b) prospective policies combined with in force business, at a given physical location, number of locations, liability, and/or percent of CAP. The underwriting system 132 uses company specific business rules to set rejection or price premium thresholds by line of business, coverage type or peril.

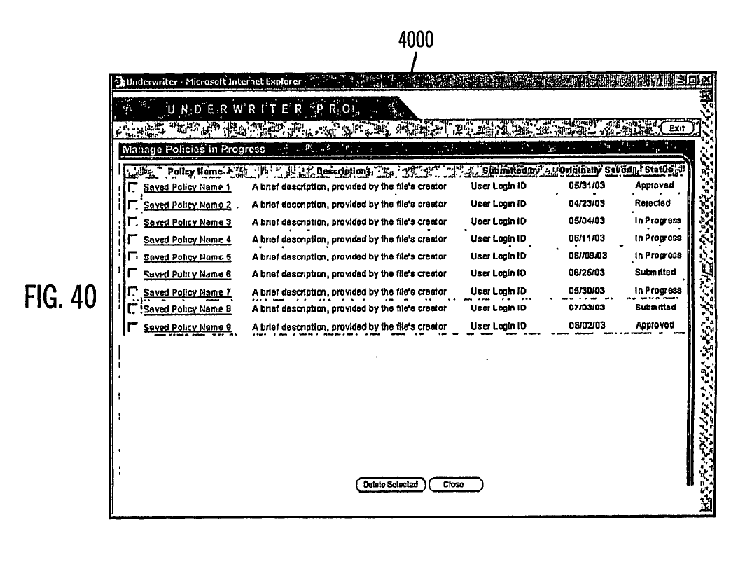

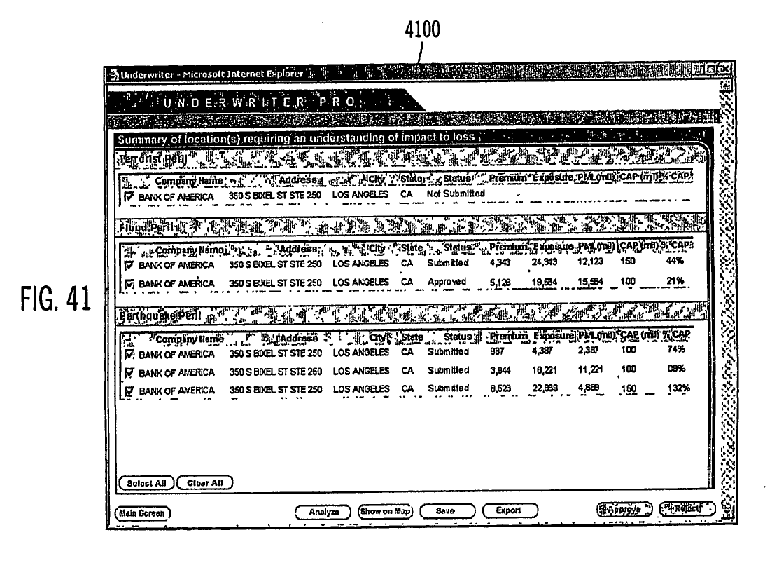

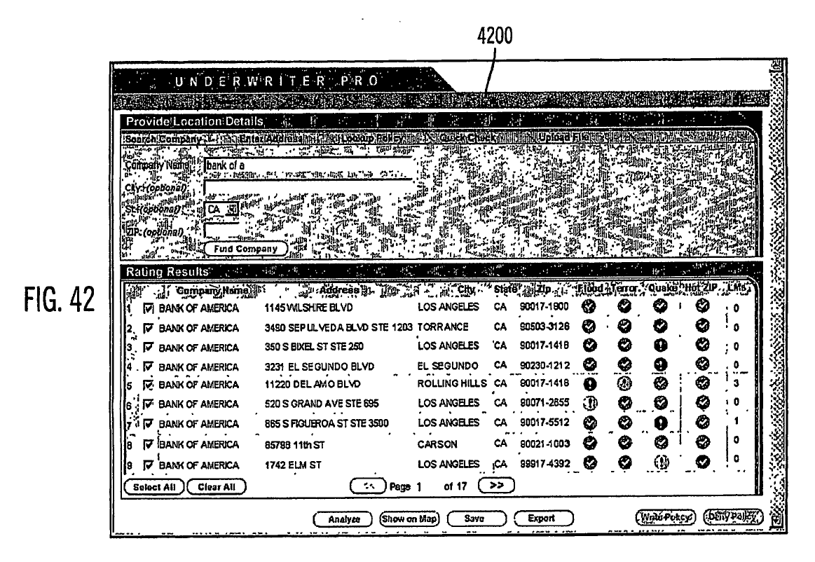

The underwriting system 132 also provides the ability to write new business. When new business is underwritten or renewed, the unbound business is submitted for review or approval. FIG. 40 illustrates a main approver/reviewer screen 4000 provided by the underwriting system 132 in accordance with certain implementations of the invention. In particular, an approver may open saved policies. An approver may also select a poly by poly name and continue with the approval process. FIG. 41 illustrates a screen 4100 provided by the underwriting system 132 after the approval process is continued from FIG. 40 in accordance with certain implementations of the invention. In particular, once an approver has selected a policy, the approver is presented with a list of locations that did not clear the initial rating process. The approver may approve or decline locations for the prospective policy, may return to the Main Screen (FIG. 40) to select another prospective policy, or may view on map, save, or export the locations. FIG. 42 illustrates a screen 4200 provided by the underwriting system 132 to allow writing or rejection of a policy in accordance with certain implementations of the invention. In particular, a user may write or reject a policy from the rating results screen.

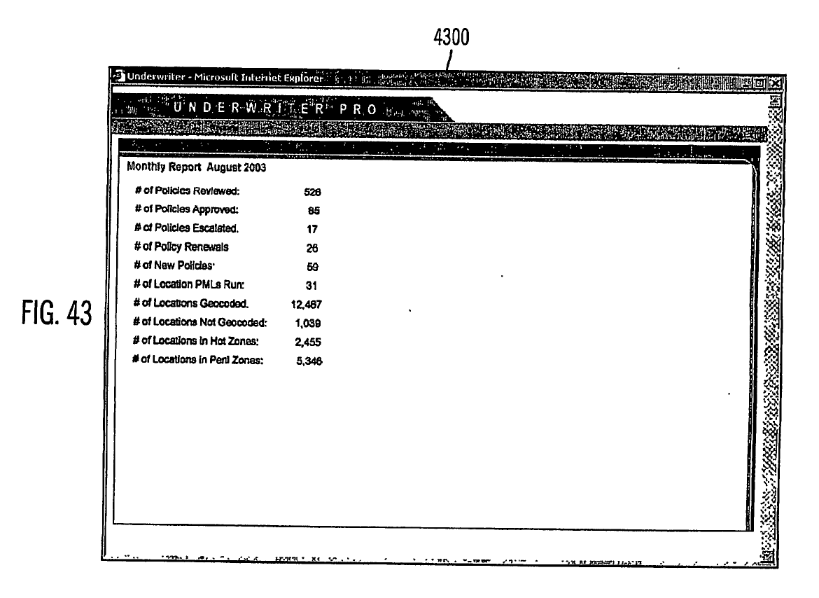

The underwriting system 132 tracks the status of unbound policies. Also, summary reports for underwriting transactions may be generated on a monthly basis. FIG. 43 illustrates a screen 4300 provided by the underwriting system 132 with summary report status in accordance with certain implementations of the invention. Reports may also be compiled at the individual user level and may be accessible by said user. In certain implementations, reports include number of policies reviewed, number of policies approved, number of policies escalated, number of policy renewals, number of new policies, number of locations with location-specific PMLs generated, number of locations geocoded, number of locations not geocoded, number of locations in hot zones, and number of locations in peril zones. Summary reports are a company configurable option.

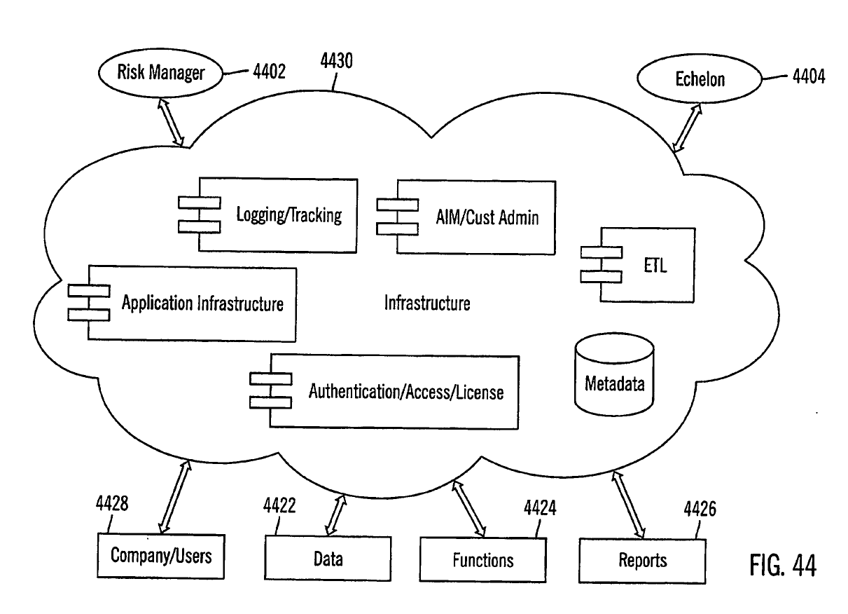

FIG. 44 illustrates an architecture diagram in accordance with certain implementations of the invention. A risk manager 134 4402 and an underwriting system 132 4404 are provided by the enterprise spatial system. The enterprise spatial system manages a set of entities such as data 4422, functions 4424, reports 4426, and company/users 4428. Additionally, the enterprise spatial system provides services and data 4430, such as authentication/access/license management, logging/tracking, metadata management through customer admin services, ETL functions to manage data, and an application infrastructure to manage applications.

The risk manager 134 4402 presents data, functions and reports to users in a particular user presentation. The underwriting system 132 4404 exposes a different presentation from the same underlying data, functions and reports structure. In certain implementations, a same infrastructure is used to build the risk manager 134 4402 and the underwriting system 132 4404. For example, both may be accessed and manipulated similarly.

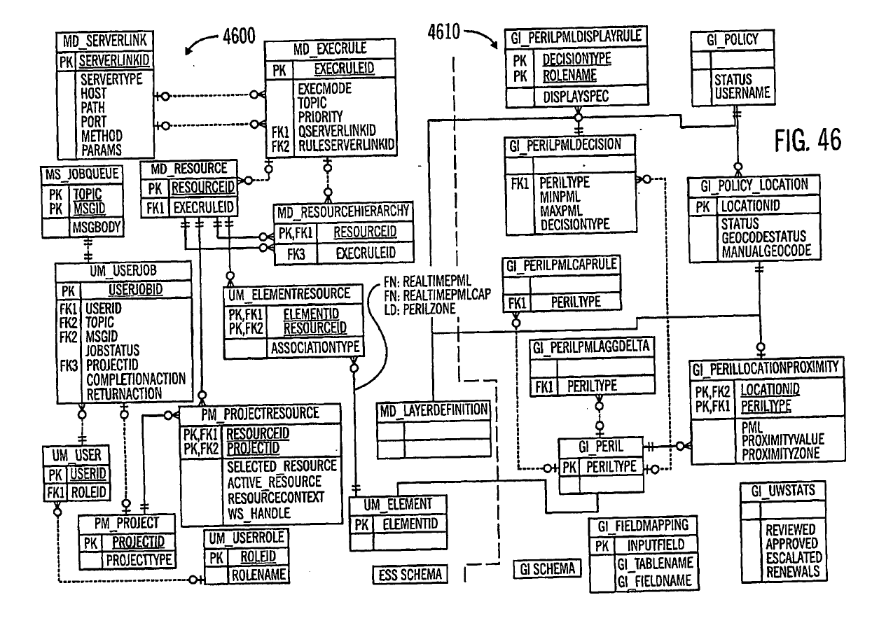

In addition, the underwriting system 132 4404 provides a set of UI functions (Upload file, Company Search, Address Search etc.), a set of customer specific server functions (such as PML procedures and proximity procedures) and a set of reports (such as Rating Report, Rating Drilldown report etc.). The functions, custom server functions and reports are defined in an ESS schema (FIG. 46). The data uploaded from a file or entered manually by the user is stored in the customer specific schema. For the insurance customers this will be the Generic Insurance schema (FIG. 46). The data in the customer specific schema is accessed through metadata layer definitions in the ESS schema. The functions and reports are associated with field definitions for the data layers.

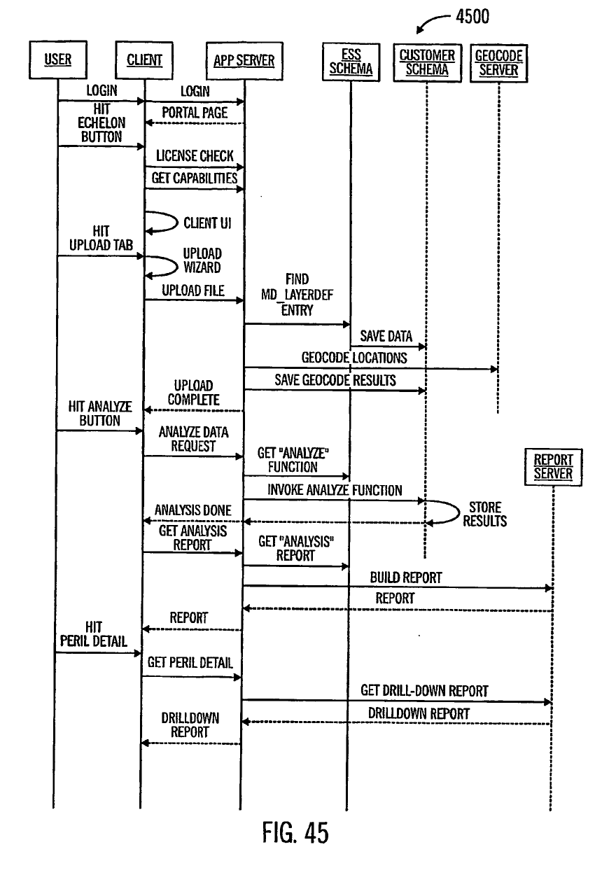

FIG. 45 illustrates process flow 4500 in accordance with certain implementations of the invention. For example, a user may select the underwriting system 132 functions, upload data, analyze data, or get details about peril data. The user submits requests at a client computer, which forwards the requests to an ESS server. The ESS server includes an enterprise spatial system that includes the underwriting system 132 and the risk manager 134.

FIG. 46 illustrates an enterprise spatial system schema 4600 and a generic insurance (GI) schema 4610 that are provided in accordance with certain implementations of the invention. The ESS schema may be described as a set of tables, views, and other data store objects used to store information that controls the functions and behavior of the enterprise storage system 130 services and components. For example, the tables contain metadata related to users, roles, functions, locations of data, reports and other data objects. These data store objects, tables, and views are uniquely related to each other in a way that allows the easily retrieval and saving of information. Similarly, the GI schema may be as a set of tables, views, and other data store objects designed specifically to store insurance related data. The tables are configured to allow for flexibility and performance. These tables, views, and objects may be used in conjunction with customer specific tables to provide a location to store a complete set of customer information.

### C. PROXIMITY ANALYSIS

The risk manager 134 includes a proximity analysis manager 136 for use, for example, with the insurance industry. The proximity analysis manager 136 may also be used in a non-insurance situation. In certain implementations, the proximity analysis manager 136 performs analysis for one or multiple buffers around a feature. In certain implementations, the buffers are formed by “rings” or circles, but in other implementations, the buffers may take other forms.

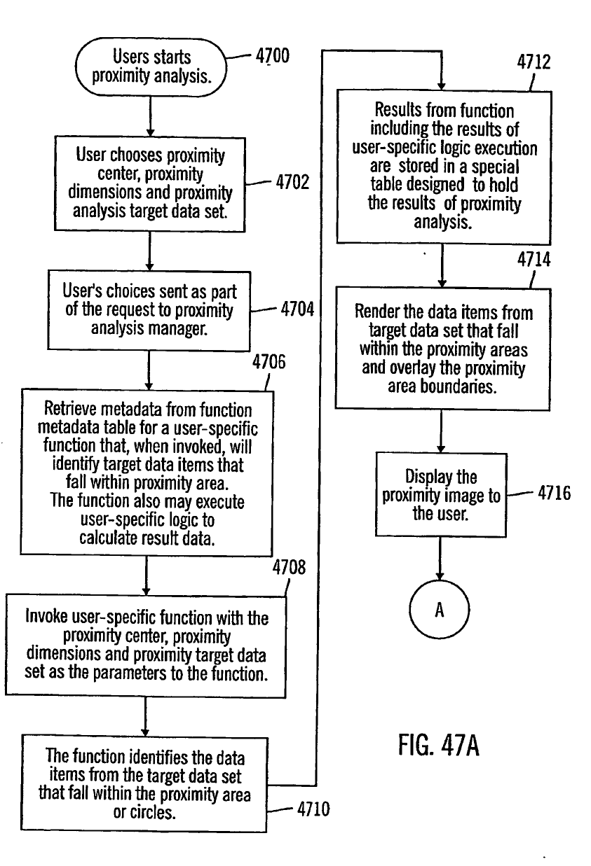

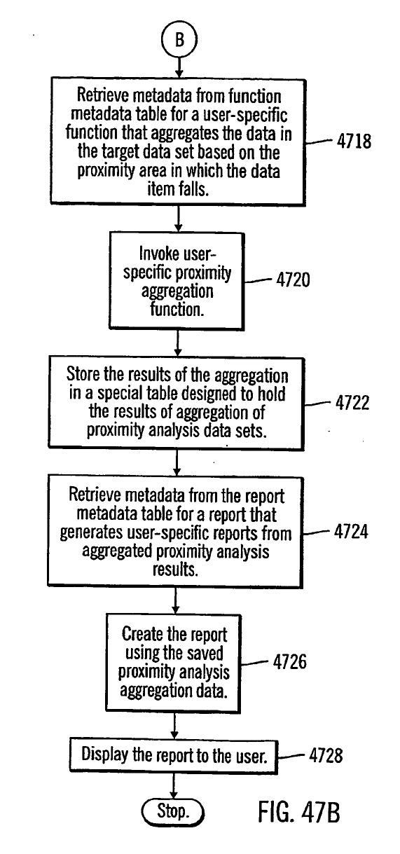

FIGS. 47A and 47B illustrate logic for proximity analysis in accordance with certain implementations of the invention. Control begins at block 4700 with a user starting proximity analysis (e.g., by selecting a tool provided by the risk manager 134). In block 4702, a user chooses a proximity center, proximity dimensions, and a proximity analysis target data set. In block 4704, the user's choices are sent as part of a request to a proximity analysis manager 136.

In block 4706, the proximity analysis manager 136 retrieves metadata from a function metadata table for a user-specific function. When the user-specific function is invoked, the target data items that fall within the proximity area (e.g., circles) are identified. The user-specific function also may execute user-specific logic to calculate result data tailored, for example, to an individual user. In block 4708, the proximity analysis manager invokes the user-specific function with the proximity center, proximity dimensions, and proximity target data set as the parameters to the user-specific function.

In block 4710, execution of the user-specific function identifies the data items from the target data set that fall within the proximity area or circles. In block 4712, the proximity analysis manager 136 stores results from the execution of the user-specific function, including the results of user-specific logic execution, in a special table designed to hold the results of proximity analysis. In block 4714, the proximity analysis manager 136 renders the data items from target data set that fall within the proximity areas and overlays the proximity area boundaries. In block 4716, the proximity analysis manager 136 displays a proximity image to the user. In block 4718, the proximity analysis manager 136 retrieves metadata from a function metadata table for a user-specific function that aggregates the data in the target data set based on the proximity area in which the data item falls. In block 4720, the proximity analysis manager invokes the user-specific proximity aggregation function. In block 4722, the proximity analysis manager 136 stores the results of the aggregation in a special table designed to hold the results of aggregation of proximity analysis data sets. In block 4724, a proximity analysis manager retrieves metadata from the report metadata table for a report that generates user-specific reports form aggregated proximity analysis results. In block 4726, the proximity analysis manager 136 creates a report using the saved proximity analysis aggregation data. In block 4728, the proximity analysis manager displays the report to the user.

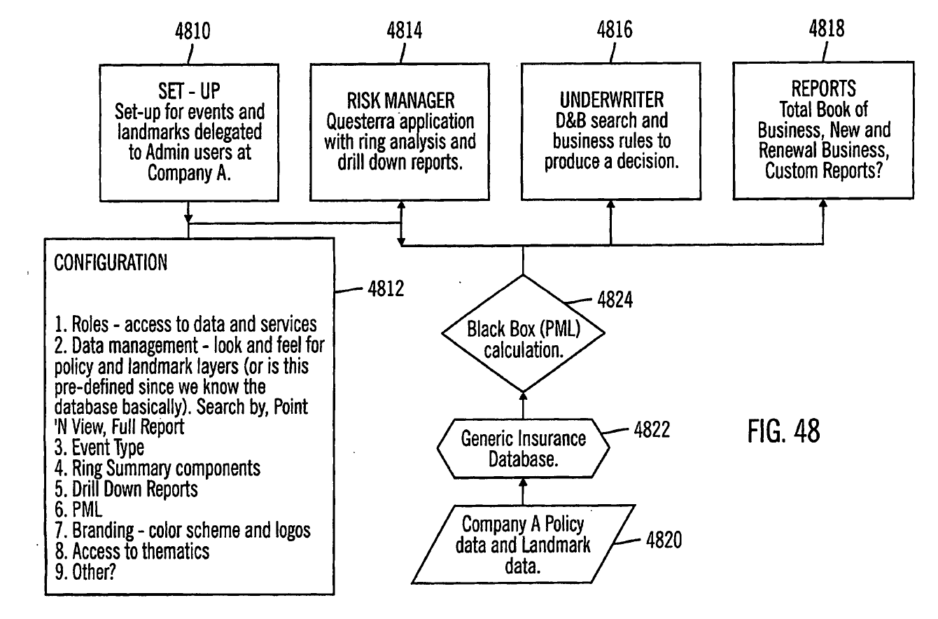

FIG. 48 illustrates an insurance solution flow in accordance with certain implementations of the invention. Initially (block 4810), setup is performed to set up events and landmarks, and (block 4812) configuration is performed. Company A policy data and landmark data 4820 are stored in a generic insurance data store (block 4822). In block 4824, PML calculation is performed. The PML calculation may interact with a risk manager 134 4814, an underwriting system 132 4816 (labeled “underwriter”), and a reports component 4818.

Also, the PML calculation is configurable. PML calculations are able to go across multiple layers (e.g., these may be multiple logical layers that correlate to physical layers). For example, proximity analysis may be performed that shows the combined analysis of prospects and total existing policies. These may be displayed to the user as two distinct layers. Additionally, PML calculation may be tied to events.

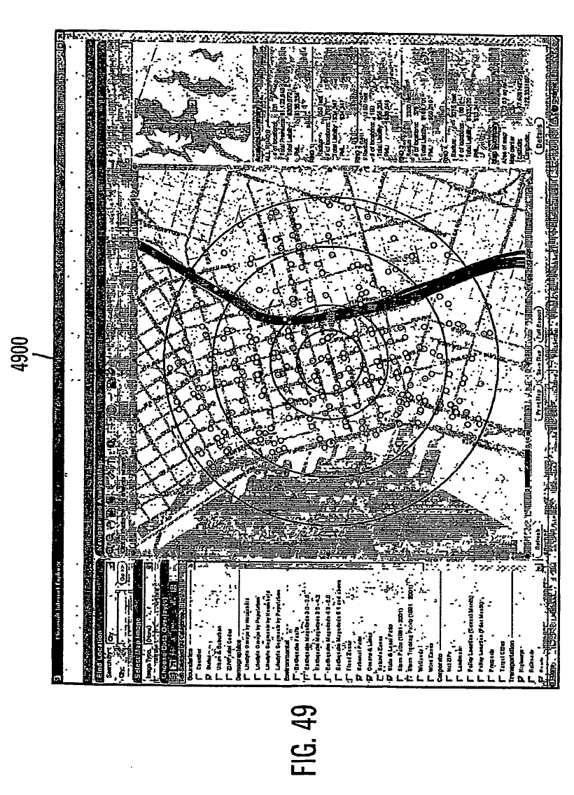

For ease of understanding, some usage scenarios for underwriting will be described herein. However, these usage scenarios are examples of applications of the invention and are not intended to limit the invention in any manner. For example, in an insurance scenario, an insurance company may want to estimate its exposure should an event occur at a specific location. An event may be described as either an act of man or an act of God. The proximity analysis manager 136 is able to assess exposure within 0.3, 0.6, and 0.9 miles of the epicenter of an event. In particular, using the proximity analysis manager 136, an insurance company representative may quickly assess which properties fall within the 0.3, 0.6, and 0.9 miles, as well as what the exposure level would be at each level. The epicenter may be found, for example, using a street address, latitude and longitude, an intersection. Using industry standards for damage at different distances from an epicenter, the user may receive estimates in seconds. FIG. 49 illustrates a screen 4900 showing proximity analysis with rings at different distances from an epicenter in accordance with certain implementations of the invention.

For a marketing scenario, a proximity image may be similar to the one illustrated in FIG. 49. However, for the marketing scenario, fields used for the proximity summary may be different. In situation 1, a financial services company wants to identify sales around their local sales offices and how many mailing pieces they need to produce to send to yield a certain increase in sales. The company knows that the return diminishes as the customer's location is further from the local office and it is proportional to last years' sales. The proximity analysis manager 136 may be used by a financial services representative to select a customer data layer, choose an event as local mailer, and choose a specific local office under analysis. A customer data layer may be described as a data layer that provides customer information, and there may be multiple customer data layers, each targeting customers in a different manner, where there may be either a different data type or there may be different temporal aspects to data layers. The proximity analysis manager 136 returns a proximity summary that shows the total number of customers per ring and calculates a 60% return from Ring 1, 50% from Ring 2, 30% from Ring 3 and 10% from Ring 4.

In situation 2, a financial services company wishes to identify all customers who have not purchased a product in the last five years within 20 miles of their local office. Using the proximity analysis manager 136, a financial services representative may perform a 20-mile proximity analysis on a customer locations data layer. Once selected, a full report may be used to further query the results on the last purchase date (e.g., going back 5 years). The representative may then view the limited results spatially (e.g., on a map) and print the report as well.

In situation 3, a financial services company wishes to identify all law firms within 20 miles of the branch office that employee 10 to 100 employees and that have no active retirement plan. Using the proximity analysis manager 136, a financial services representative may perform a 20 mile proximity analysis on the a specified data layer. Using the Full Report querying feature, the financial services representative may further select law firms with 10 to 100 employees. An additional query may be submitted to refine the search to those with no active retirement plan.

The proximity analysis manager 136 is able to make use of stored procedures, outside models or provide simple proximity selection. Furthermore, the proximity analysis manager 136 is enabled as a Web service by the enterprise spatial system in certain implementations. Additionally, proximity summary options are configurable (e.g., include the ability to not include an event type or differential damage rates) in that they are configurable by company and configurable as user-defined and on-the-fly. Proximity analysis is available across security zones (e.g., point data types for center point and selections are still valid). The proximity analysis manager 136 supports multiple event types. Aggregation on-the-fly is supported (e.g., not having an Extract, Transformation, and Load (ETL) pre-aggregation does not prevent an analysis).

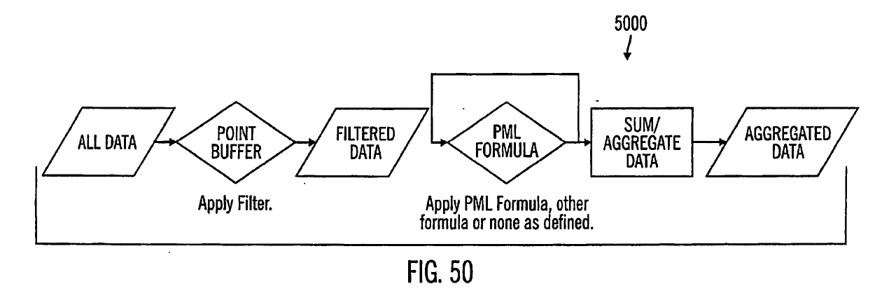

FIG. 50 illustrates a proximity analysis process 5000 in accordance with certain implementations of the invention. In FIG. 50, data is input to a point buffer that outputs filtered data. A point buffer may be described as an area around the point (e.g., if a city is a point, the point buffer may include cities around the point). After a point buffer is performed, information that is pre-defined for a target data layer may be summed in a proximity analysis summary. That is, FIG. 50 illustrates the process for generating measurable data for the proximity summary and reports (both the summary and detail). This process is the precondition for drill down. In the generic proximity analysis case, a simple proximity analysis may be performed that does not require applying a PML formula. In these cases, the filtered data may simply be aggregated. In certain implementations, generic proximity analysis refers to proximity analysis that is not event driven.

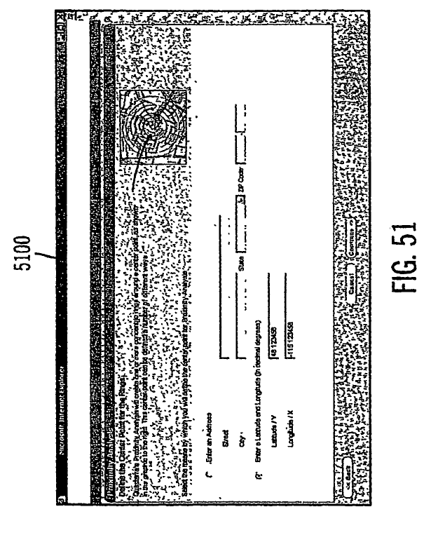

The proximity analysis manager 136 provides several techniques for selecting a center feature (e.g., a point, line or polygon) on a map for proximity analysis. In particular, selection of a center feature may be by a search by options feature, from a selected point or by manually selecting an XY coordinate on the map. The rule governing which selected or searched on point will be used, is that the last selected single feature is used, irrespective of how it was selected. FIG. 51 illustrates a proximity analysis screen 5100 in accordance with certain implantations of the invention. The population of an initial proximity analysis screen is through the latitude/longitude option. Whatever search by or selection is made (e.g., a single point), the latitude and longitude is populated when the user chooses proximity analysis. If an address search by is used (i.e., a search is based on an entered address), the address also pre-populates the initial proximity analysis screen in order for the user to verify the start point. If multiple points are selected, none are used to pre-populate the proximity analysis screen.

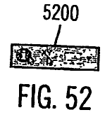

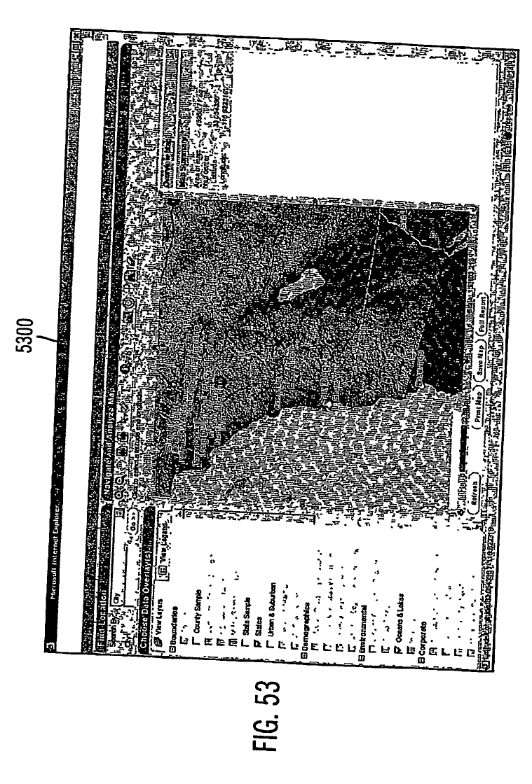

In certain implementations, a point is manually created on a map. A manual select tool may be provided in the selection toolset FIG. 52 illustrates manual point tools 5200 in accordance with certain implementations of the invention. A user's mouse click may capture a latitude and longitude, and an “x” may mark the spot representing the selected point on the map. The user may move the “x” by using the mouse, and the XY coordinates are updated in a status bar. The tool tip for the “x” may be “Select lat/long”, while the caption text may be: “Click to select a latitude and longitude”. FIG. 53 illustrates a screen 5300 showing a sample selection of an XY coordinate in accordance with certain implementations of the invention.

The proximity analysis manager 136 allows a proximity analysis with a project as it allows users to collaborate. This includes saving the center point, the proximity summary, and any drill down links to reports. In certain implementations, projects saved with one or more proximity analysis indicators turned on (either saved or temporary) should open with these “layers” turned on. That is, a policy locations layer had been previously turned on for a project and the project were saved, then, the policy locations layer would be saved, and opening the saved project would make the policy locations layer available. A project may be described as data associated with one or more tasks performed by a user.

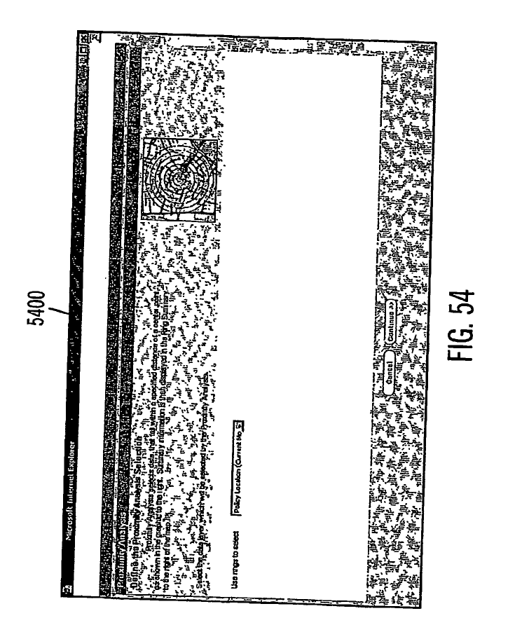

The proximity analysis manager 136 performs generic proximity analysis that allows for an industry neutral option. For example, the generic proximity analysis may not include the landmark option. Also, proximity weights are optional (e.g., in lieu of weights the rings may be summed). Also, any type of calculations (i.e., not just PML calculations) may be performed. For the generic proximity analysis, event type may not be defined. FIG. 54 illustrates an initial proximity analysis screen 5400 for generic proximity analysis in accordance with certain implementations of the invention.

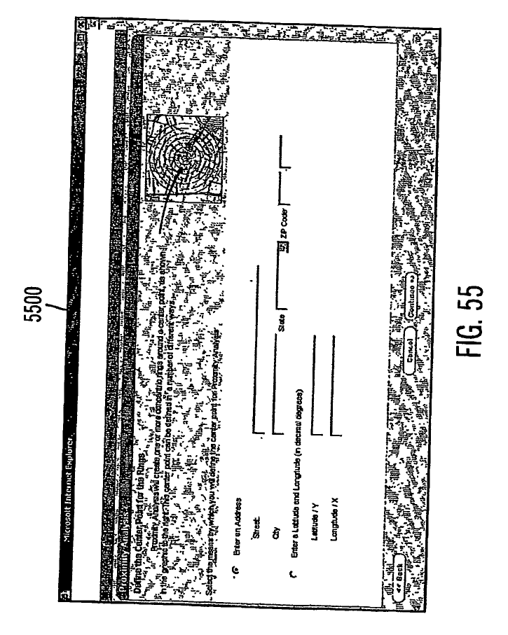

As part of a setup procedure, the proximity analysis manager 136 provides the ability to choose which layers are to be used for proximity analysis, so that targets are identified. In certain implementations, companies will be allowed to limit the layers available. FIG. 55 illustrates a second proximity analysis screen 5500 for generic proximity analysis in accordance with certain implementations of the invention. In the second screen, the center point may be defined by entering an address or by entering longitude and latitude values.

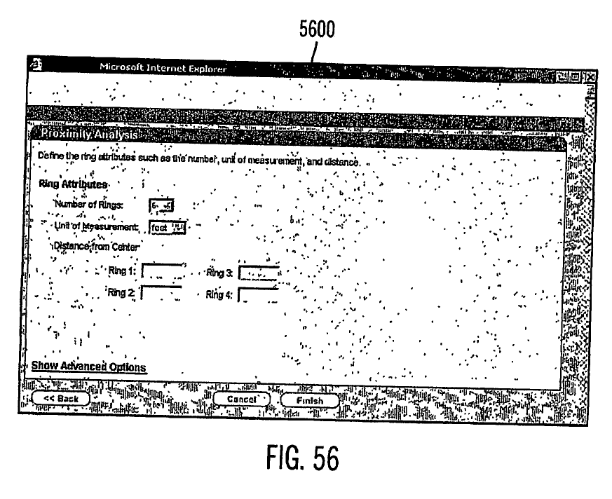

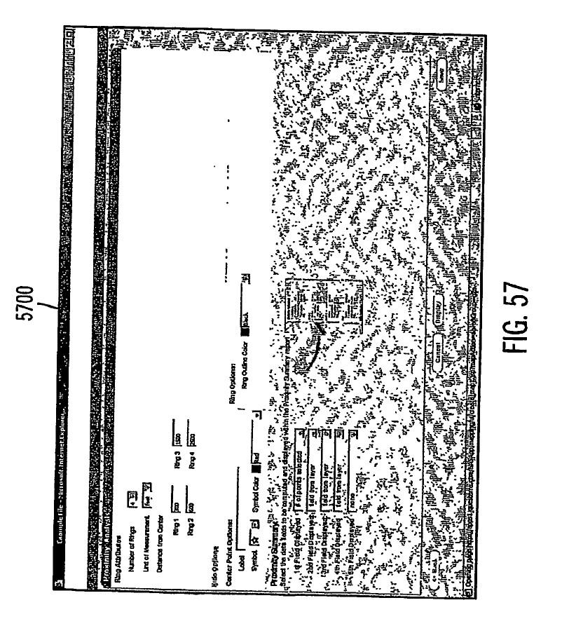

FIG. 56 illustrates a third proximity analysis screen 5600 for generic proximity analysis in accordance with certain implementations of the invention. In the third screen, ring attributes may be defined. In certain implementations, maximum number of rings (e.g., 12), a default number of rings (e.g., 6), a maximum ring size (e.g., 3 miles) may be defined. Moreover, the maximum ring size is not tied to layer scale. Also, the unit of measurement includes any available measurement options (e.g., feet, yards, miles, meters and kilometers). Since there is no event, the distances default to empty. Validation ensures that each ring is larger than the next FIG. 57 illustrates a third proximity analysis screen 5700 with summary options for generic proximity analysis in accordance with certain implementations of the invention. The ring options include choosing the label, symbol, and color for the center point and the ring. The proximity summary may be populated with default values. The proximity summary advanced option to choose custom fields for the summary is provided as an additional function.

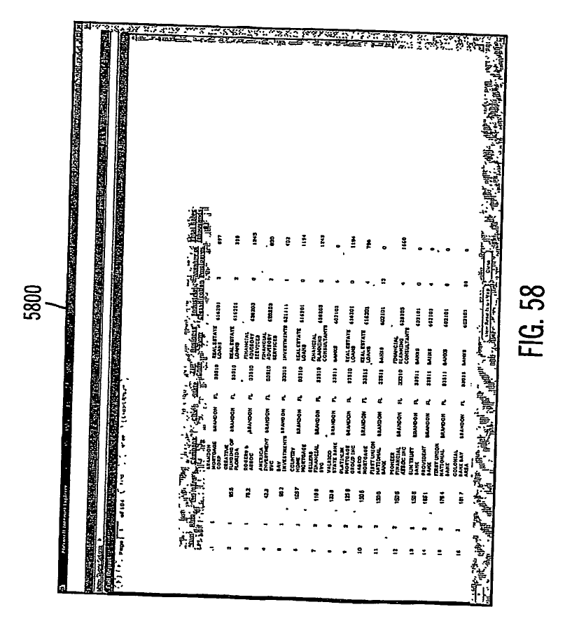

A proximity analysis full report includes the proximity number and the distance to the center point, in addition to other report fields. The distance category is configurable to whatever measurement unit is chosen (e.g., feet, meters, etc). When a query is made to limit the features selected by the proximity analysis and the user chooses to “View results on map”, the rings are still visible and the summary is re-calculated. FIG. 58 illustrates a screen 5800 provided by the proximity analysis manager 136 with a proximity analysis full report in accordance with certain implementations of the invention.

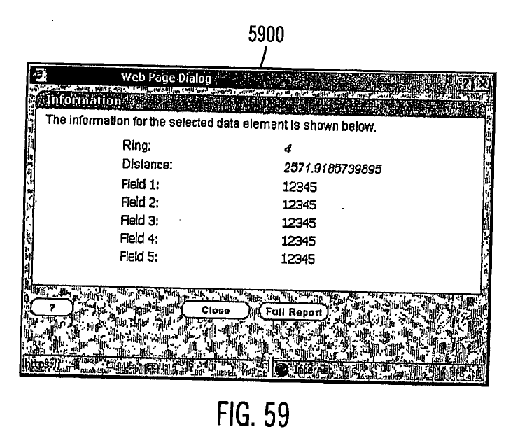

A proximity analysis point n′ view includes a proximity number and distance. Additional point n′ view fields are populated by the first five fields defined for generic point n′ view. A point n′ view may be described as an information tool that provides attributes for a selected item (e.g., if a state is selected on a map, the state name may be selected). FIG. 59 illustrates a screen 5900 provided by the proximity analysis manager 136 with a point n′ view report in accordance with certain implementations of the invention.

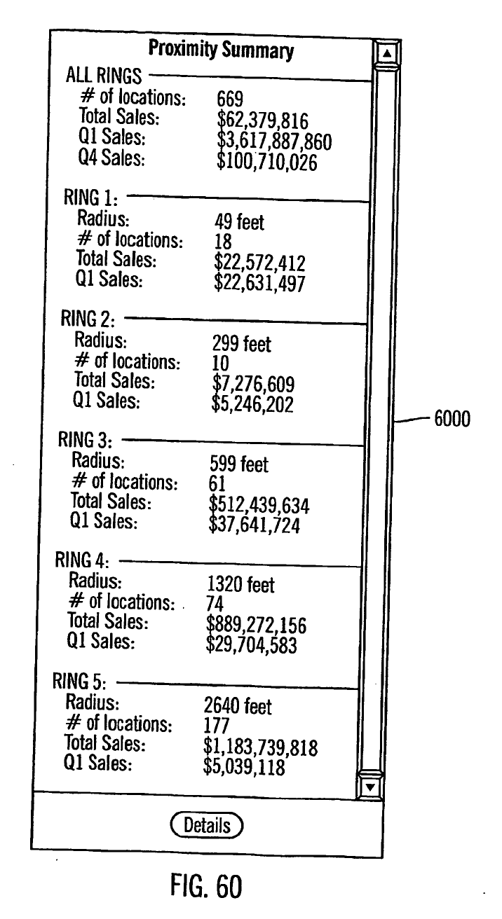

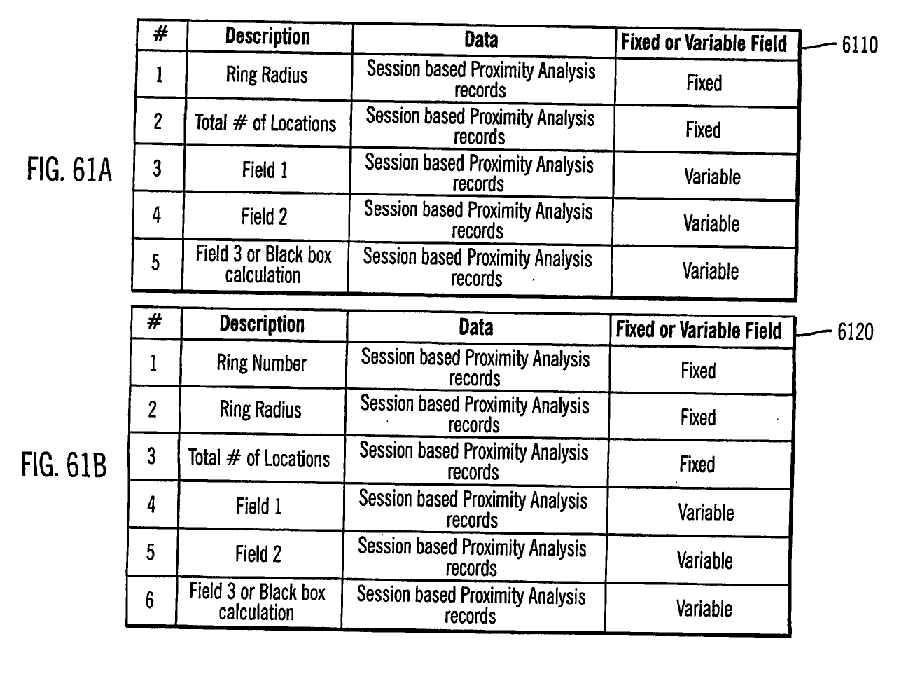

A generic proximity summary includes, for example, a sum of the values of the selected objects within each ring upon completion of a proximity analysis, as well as a total for all rings. FIG. 60 illustrates a screen 6000 provided by the proximity analysis manager 136 with a proximity summary in accordance with certain implementations of the invention. There are a variety of points that have been selected. Instead of a simple summing of certain fields, the summary calculates values of points within the various rings. Certain implementations of the invention provide flexibility to allow different customers to have more or fewer fields summed, various calculations performed, averages, and/or counts. FIG. 61A illustrates a table 6110 provided by the proximity analysis manager 136 of landmark proximity analysis totals in accordance with certain implementations of the invention FIG. 61B illustrates a table 6120 provided by the proximity analysis manager 136 of proximity aggregates in accordance with certain implementations of the invention. In certain implementations, if no policies are found within a ring, the proximity information may include: the ring number (1), the ring radius (2), and the total # of locations (3), with no data displayed for the total # of locations and any other fields.

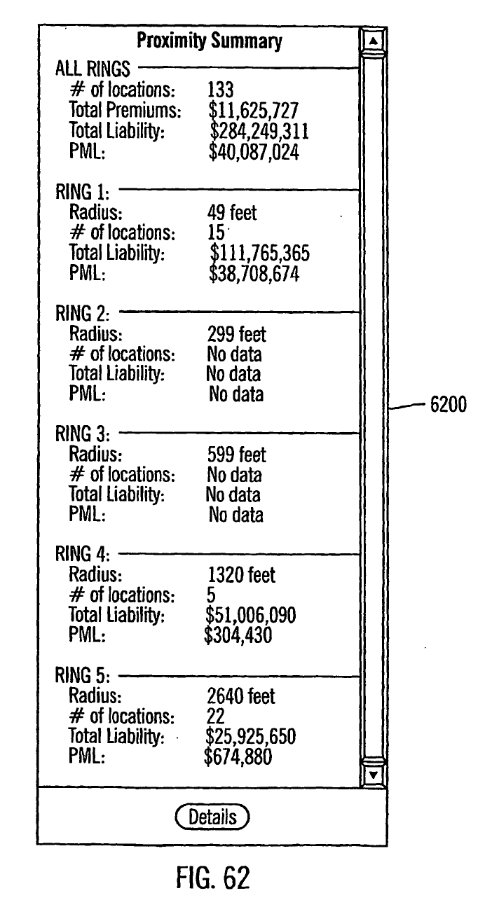

The proximity analysis manager 136 supports a generic hand-off report button for selection and proximity summary and layer report. The generic hand-off report button provides the user with the ability to link to the “Reporting” application services and display a report. The button may also be configured to meet user needs in terms of the report generated. FIG. 62 illustrates a proximity summary 6200 provided by the proximity analysis manager 136 in accordance with certain implementations of the invention. In FIG. 62, the generic hand-off button is labeled “Details”.

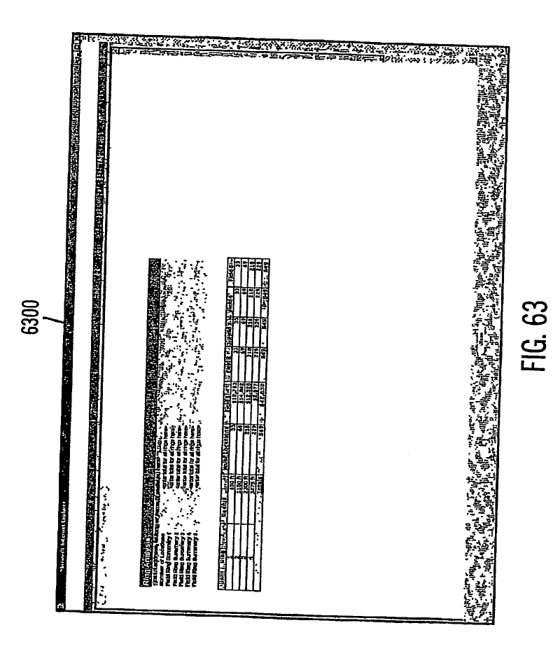

The proximity analysis manager 136 also provides a generic details report. In certain implementations, the generic details report includes the fields in the proximity summary. Additionally, from the generic details report, selection of a link by a ring number displays details (e.g., each location within that ring). FIG. 63 illustrates a screen 6300 of a details report in accordance with certain implementations of the invention.

Event driven proximity analysis makes use of modeling and business rules. An event may be, for example, a terrorist attack or earthquake for an insurance company or an advertising campaign for a marketing organization. In either case, the user is calling upon an event that provides ring weights and in some cases black box calculations. Black box calculations may be described as an abstraction of a device or system in which its externally visible behavior is considered and not its implementation or “inner workings”.

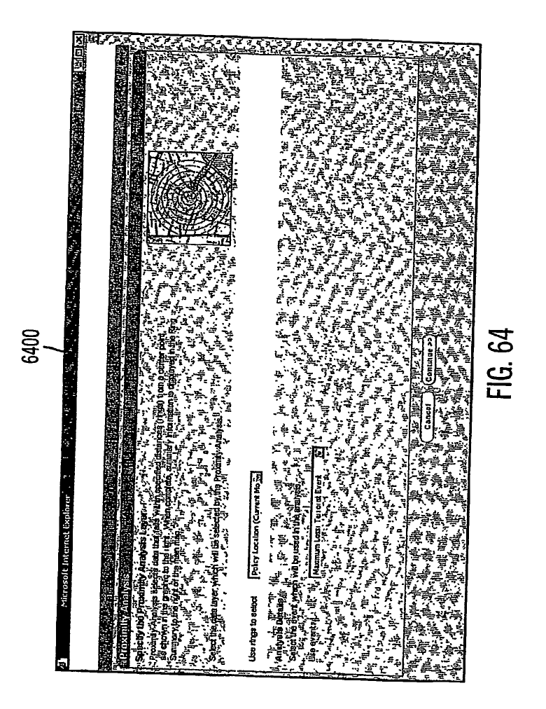

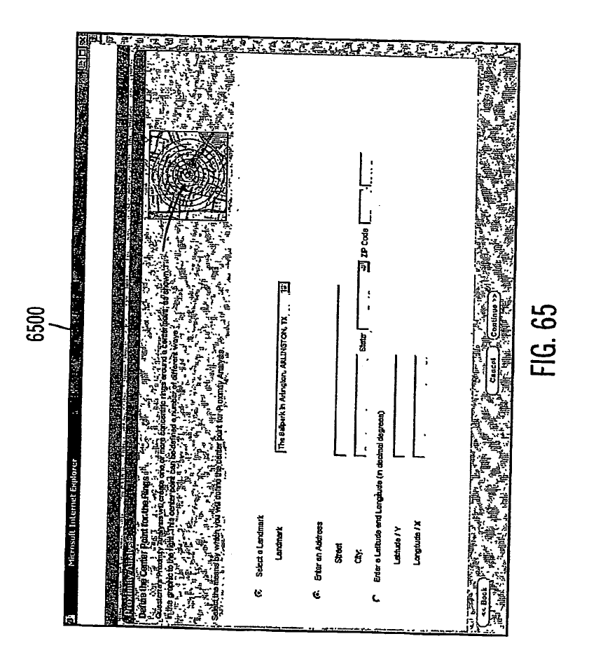

The proximity analysis manager 136 provides an event driven wizard in certain implementations. The event driven wizard includes events as screen elements. For example, the events may be displayed in a drop down list and are data driven based on the events available to a role. There is an option to use no event (i.e., in effect making it a generic proximity analysis). By having the target layer and event precede the center point (e.g., landmark) selection, the proximity analysis accommodates the event driving landmark issues. Multiple event options are allowed. For example: maximum loss, earthquake, mailing, phone interviews, site selection, etc. FIG. 64 illustrates an initial screen 6400 for an event driven wizard in accordance with certain implementations of the invention. FIG. 65 illustrates a second screen 6400 for an event driven wizard that shows the addition of a landmark option in accordance with certain implementations of the invention. The selection of a point layer is configurable, and the type of point layer that may be selected depends on the event previously selected.

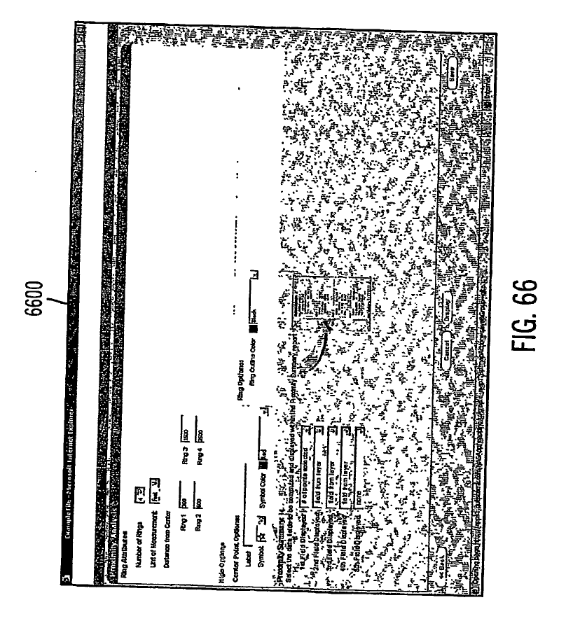

Thus, although a “landmark” is selected in the illustration, any point layer (e.g., system defined or customer defined), such as company locations, customers, policy locations etc. may be selected in various implementations of the invention. FIG. 66 illustrates a third screen 6600 for an event driven wizard that is displayed when the Continue button is selected in FIG. 65 in accordance with certain implementations of the invention.

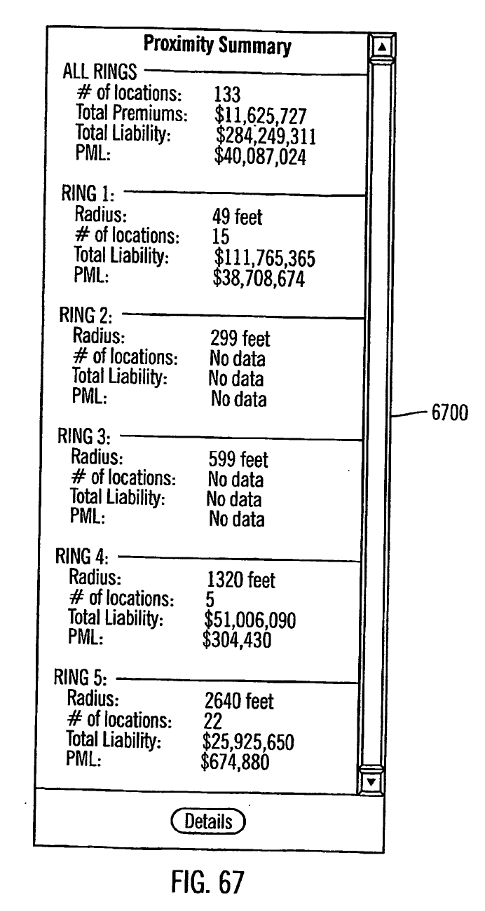

The proximity analysis manager 136 provides a full report, a point n view, a detail report, and a proximity summary for the event driven proximity analysis as for the generic proximity analysis. FIG. 67 illustrates a proximity summary 6700 in accordance with certain implementations of the invention. The proximity summary performs a PML calculation in this illustration. The proximity summary may include values that are retrieved by calling out to an external program or a stored procedure. For example, the “PML” may be a value returned from a stored procedure that undertakes calculations (e.g., that are in the control of a client computer).

For a Save and Edit feature provided by the proximity analysis manager 136, a temporary proximity analysis is displayed in the layer control, and is editable by clicking a name (e.g., a hyperlinked name). Saved proximity analysis is also editable in the same manner. In certain implementations, editing will bring up the proximity analysis wizard pre-populated with the stored information. In certain implementations, there are several proximity analysis roles or functions, including: a) create proximity analysis with temporary proximity analyses displayed in layer list and b) save & edit.

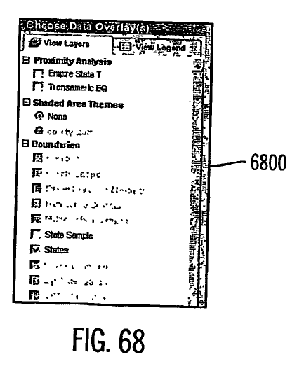

FIG. 68 illustrates a layer control 6800 provided by the proximity analysis in accordance with certain implementations of the invention. A layer control enables the viewing of a data layer. For example, under proximity analysis, two layers are available for selection. When proximity analysis is selected (e.g., “turned on”) for a previously saved proximity analysis, the proximity analysis manager 136 takes the user to a screen displaying the saved proximity analysis.

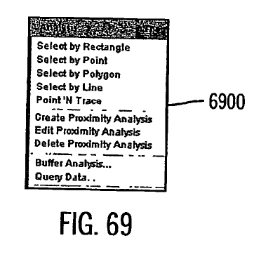

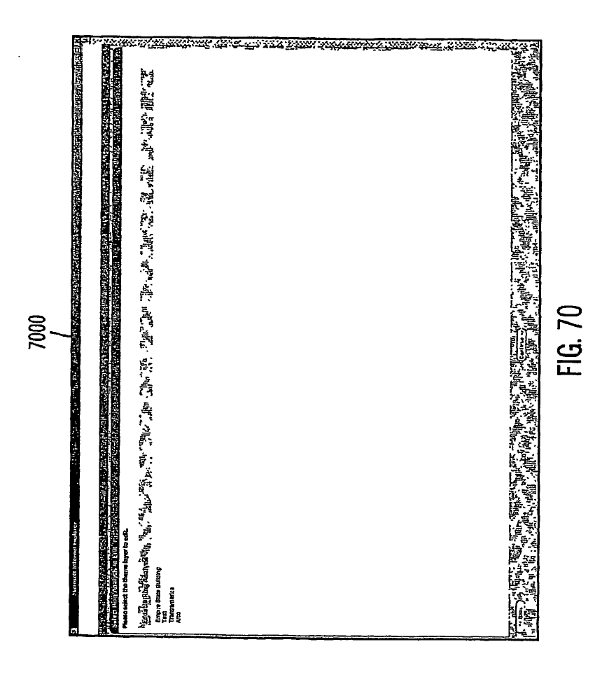

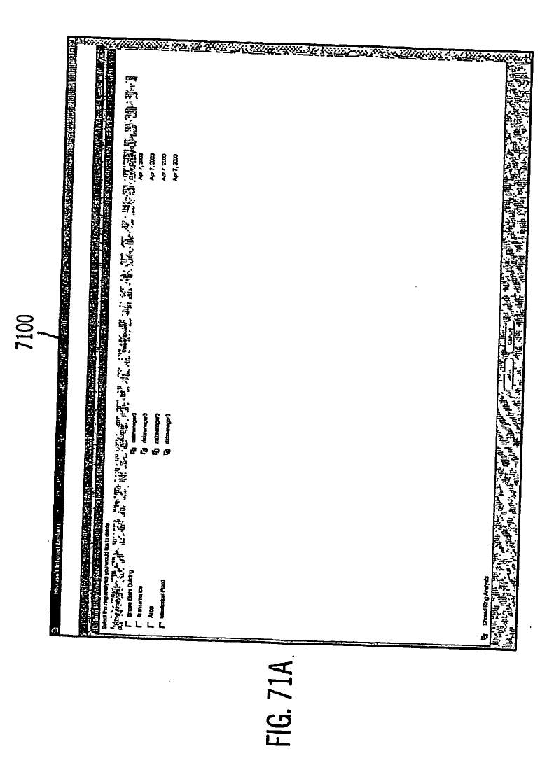

FIG. 69 illustrates proximity analysis menus 6900 in accordance with certain implementations of the invention. The menus include Create, Edit, and Delete proximity analysis. Also, proximity analysis may be initiated using a button on the tool bar or the Create proximity analysis menu. There are two ways to edit proximity analysis that are in the layer list 1) from a hyperlinked name or 2) from the Edit proximity analysis menu. For example, if the user clicks on a hyperlinked name, the proximity analysis wizard appears pre-populated, while if the user chooses the “Edit” proximity analysis menu, a screen for selecting the proximity analysis is presented that then leads to a pre-populated wizard. FIG. 70 illustrates a screen 7000 provided by the proximity analysis manager 136 to allow selection of a proximity analysis for editing in accordance with certain implementations of the invention. The proximity analysis may be deleted by choosing the “Delete” proximity analysis menu. A screen for selecting the proximity analysis for deletion may be provided to delete individual or multiple proximity analyses from the layer list. Temporary proximity analyses may be deleted when projects are closed or new projects are opened. FIGS. 71A and 71B illustrate screens 7100 and 7120, respectively, provided by the proximity analysis manager 136 to allow deletion of a proximity analysis for editing in accordance with certain implementations of the invention.

The proximity analysis manager 136 saves all or certain parts of the proximity analysis that is selected for saving. This includes, but is not limited to, the target layer, the center point, the number of rings, the distance of the rings, any weighting or black box calculations, proximity summary and reports, as well as options (ring color etc). In certain implementations, two types of proximity analysis may be saved (e.g., one that includes the center point and one that does not).

In certain implementations, only the creator of a proximity analysis is able to delete the proximity analysis. Moreover, saved proximity analysis layers as well as dynamically created proximity analyses are displayed in the list control. Saved proximity analyses may appear with the name given at time of saving as specified by the user. In certain implementations, proximity analysis layers that may be edited are hyperlinked for editing or saving.

Saved proximity analysis and temporary proximity analysis created by a user with the save role may be edited and saved. Users with a save role may “save as” any corporately saved proximity analysis. Users without the save role may edit their own temporary proximity analysis.

Temporary proximity analysis will save with a concatenated name followed by an asterisk. During a user's session, the temporary proximity analyses may be turned on or off like standard layers in the layer control. Temporary layers may be discarded if a user with a non-save role exits, opens a new project or chooses “New” project. The user is prompted with a popup dialog with “Information”, “You have temporary Proximity analysis layers which will be discarded,” and the user may select whether or not to allow the layers to be discarded. Temporary layers are discarded if a user with a save role exits, opens a new project or chooses “New” project. The user will be prompted with a pop-up dialog with “Information”, “You have temporary Proximity analysis layers which will be discarded”; “Click OK to discard temporary Proximity analysis layers and continue, or click Cancel to return and save any temporary Proximity analysis layers.” The user then makes a selection.

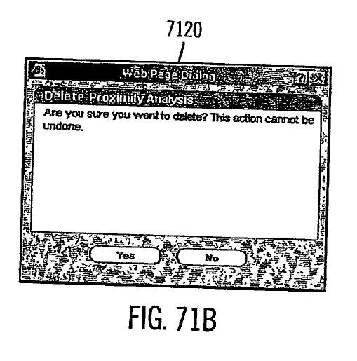

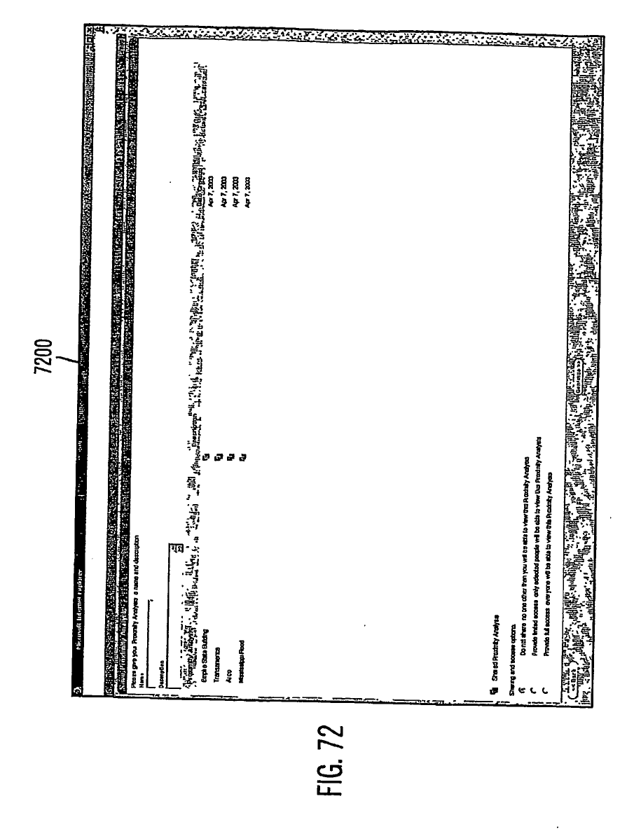

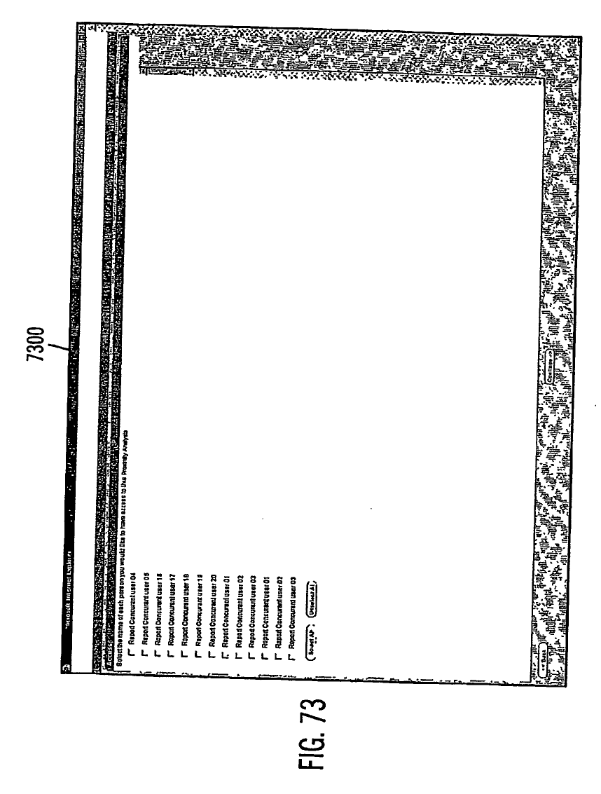

Saved and temporary proximity analysis layers are saved with a project that is saved. The saved layers are turned on when the project is loaded. FIG. 72 illustrates a screen 7200 provided by the proximity analysis manager 136 to save a proximity analysis in accordance with certain implementations of the invention. A user selects one or more proximity analyses to save and selects a sharing and access option, such as do not share, provide limited access or provide fill access. FIG. 73 illustrates a screen 7300 provided by the proximity analysis manager 136 that allows selection of users for assigning access privileges when an access option is selected in FIG. 72 in accordance with certain implementations of the invention.

If the name chosen by the user already exists and the user has the right to save over the file, the user may be prompted to determine whether the file should be saved over. If the name chosen by the user already exists and the user does not have right to save over the file, the user may be prompted to save with a different file name.

The proximity analysis manager 136 is also able to perform analysis based on multiple event types (e.g., dirty bomb, truck bomb, chemical attack, earthquake epicenter, earthquake fault line, etc.). For example, the proximity analysis manager 136 performs natural catastrophe analysis that may involve multiple events.

As for multiple proximity analysis, when an existing proximity analysis is displayed and a new proximity analysis is requested through the wizard, prior to the replacement of currently displayed proximity analysis with the new proximity analysis, a user is provided with the option of combining the two proximity analyses, displaying the two separately, or replacing the current one with the new one. If the user chooses display separately, both proximity analyses appear on the map and two distinct proximity summaries and details are displayed. If the user chooses combine, the map displays both proximity analyses, and, if both proximity analysis use the same target layer, the proximity summary details are combined.

Also, a save to layer or save landmark option is provided by the proximity analysis manager 136 to add new point features to an existing data layer. The requirements for any customer specific options are maintained while providing functionality at the event driven proximity analysis level. The layers available for this feature are editable. In certain implementations, the newly added landmarks may be incorporated into the landmark layer once the ETL process has been completed.

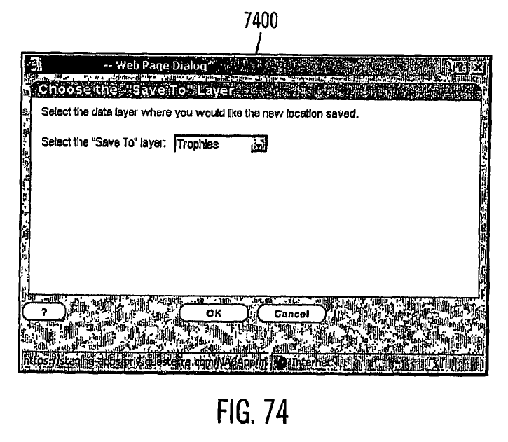

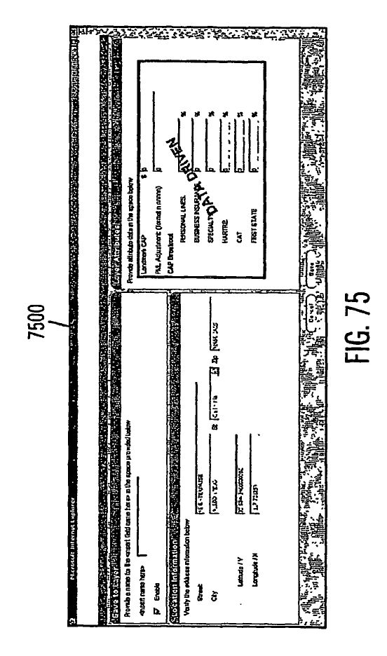

The Save to Layer process starts when an address or latitude/longitude is provided as input in the wizard (either directly or through search by) by a user with a role that allows the user save to layer. A user selects the Save To layer button, selects a layer to save to, and inputs layer name, location, and attribute information. FIG. 74 illustrates a screen 7400 provided by the proximity analysis manager 136 for Saving To a layer in accordance with certain implementations of the invention. FIG. 75 illustrates a screen 7500 provided by the proximity analysis manager 136 for inputting information for the Save To option in accordance with certain implementations of the invention. The layer attribute information is data driven to provide flexibility and scalability.

In certain implementations, a proximity summary has the following defaults for an insurance company: number of locations, exposure, ground up loss, total premiums, and PML. Also, insurance customers establish their Event Setup information such as default proximity details, damage rates and PML rating table via UIs provided by the proximity analysis manager 136.

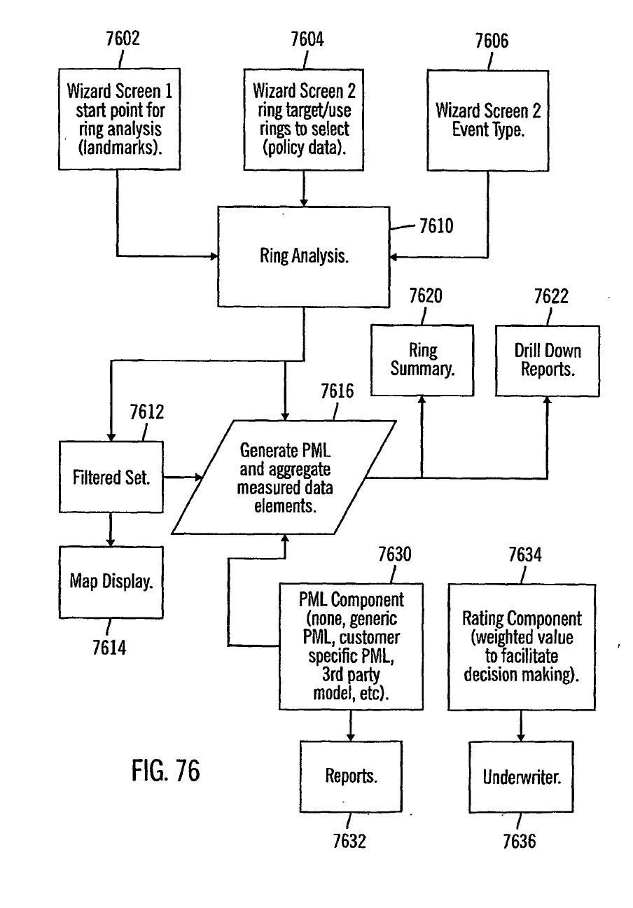

FIG. 76 illustrates proximity analysis for an insurance industry scenario in accordance with certain implementations of the invention. Ring analysis 7610 is started by selecting a landmark (7602), selecting policy data with rings (7604) or selecting an event type (7606). The output of ring analysis 7610 is a filtered set 7612 that is used for a map display 7614. Additionally, ring analysis 7610 leads to generating PML and aggregate measured data elements (7616) using the filtered set 7612. The output of the generation of PML and aggregate measured data elements 7616 is a ring summary 7620 and drill down reports 7622. In certain implementations, a starting point for ring analysis may be selected via a customer specific technique, an address, an intersection, a latitude/longitude, manually, or from a data layer.

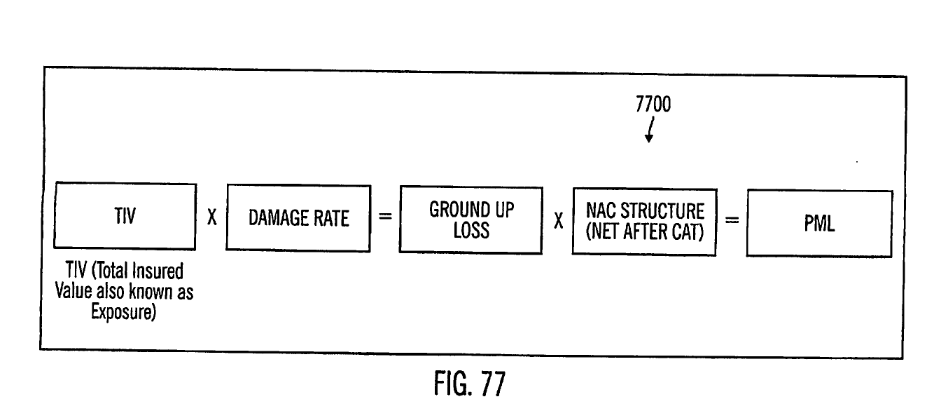

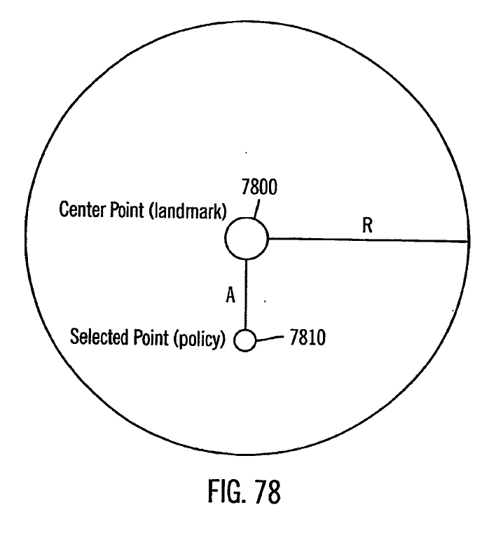

The PML may be generated with a system defined formula or a customer specific formula FIG. 77 illustrates customer specific inputs for a formula 7700 for generating PML in accordance with certain implementations of the invention. The PML formula starts with Total Insured Value (TIV, also known as exposure) and Damage Rate. Damage rate is affected by event type proximity to the event and may range from 0% to 100% (i.e., damages may range from none at all to a total or maximum loss). The event type and proximity to the event may be selected by a user. FIG. 78 illustrates a center point 7800 and a selected point 7810 for which a policy may be issued in accordance with certain implementations of the invention.

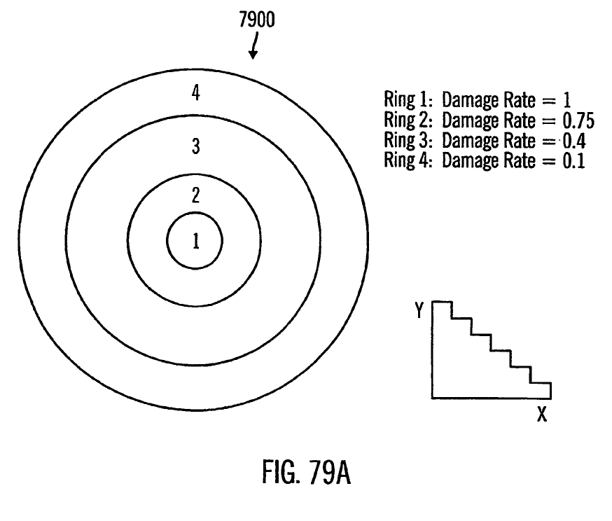

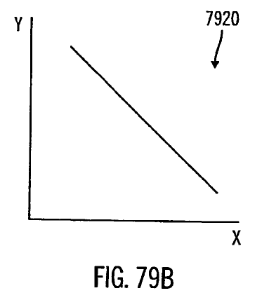

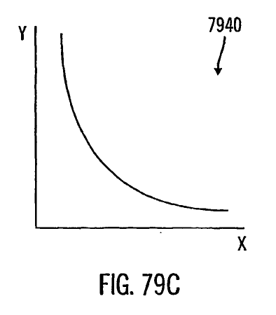

The proximity to the event factor may be selected by the user per event type to include a value that is stepped, linear or logarithmic. Stepped refers to allowing damage rates to change from proximity to proximity. A damage rate table shows the damage rate per proximity. FIG. 79A illustrates a stepped relationship 7900 in accordance with certain implementations of the invention. As for linear, when two variables are linearly related, the points of a scatter plot fall on a straight line. FIG. 79B illustrates a linear relationship 7920 in accordance with certain implementations of the invention. For a linear relationship, start and end points are selected, and the formula 1/r is used to form the line (where “r” is radius). With a logarithmic relationship, as values of X get larger, values of Y get smaller, but to a decreasing degree, and the formula is 1/r2 for drawing the curve between two points. FIG. 79C illustrates a logarithmic relationship 7940 in accordance with certain implementations of the invention.

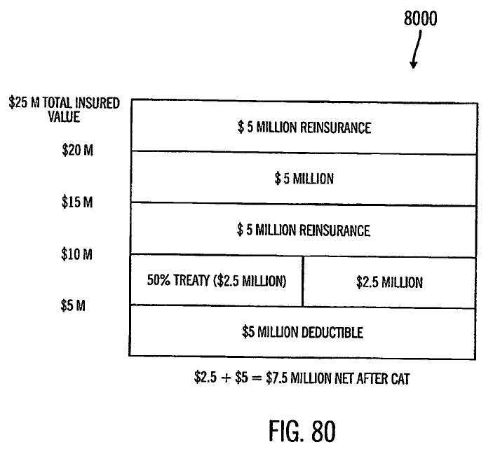

In FIG. 77, the TIV times the Damage Rate results in a Ground Up Loss. The Ground Up Loss times a Net After Catastrophe (NAC) results in PML. The NAC is a calculation that incorporates information from policy data, including, for example, a deductible, treaties, and reinsurance. FIG. 80 illustrates a NAC structure 8000 that is used to determine a NAC in accordance with certain implementations of the invention.

The proximity analysis provides rating for insurance scenarios. A simple rating may be described as a ratio of aggregate PML to CAP. A rating may be partially dependent on the event type.

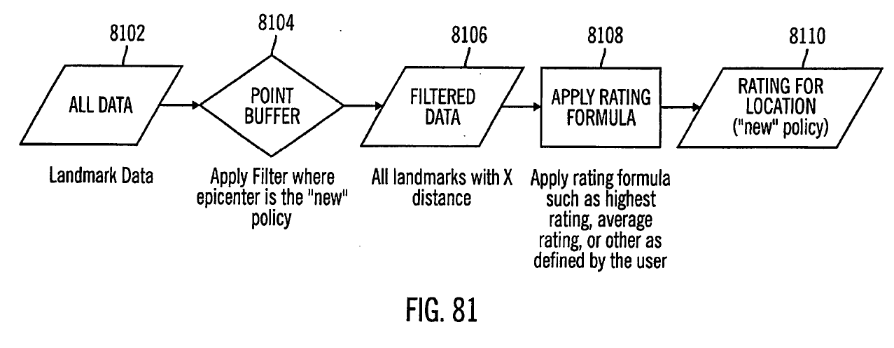

In certain implementations, for proximity analysis, rating is applied to landmarks through the ETL process. Contextually, the rating for a new policy is determined by finding the highest landmark rating with a specified distance (e.g., the maximum proximity for a building collapse). FIG. 81 illustrates a rating process in accordance with certain implementations of the invention. Landmark data 8102 is input to a point buffer 8104 that applies a filter to the landmark data 8102. The output of the filtering is filtered data 8106, to which a rating formula is applied 8108. The result of applying the rating formula 8108 is a rating for a location.

### D. PROXIMITY ANALYSIS—ARCHITECTURE

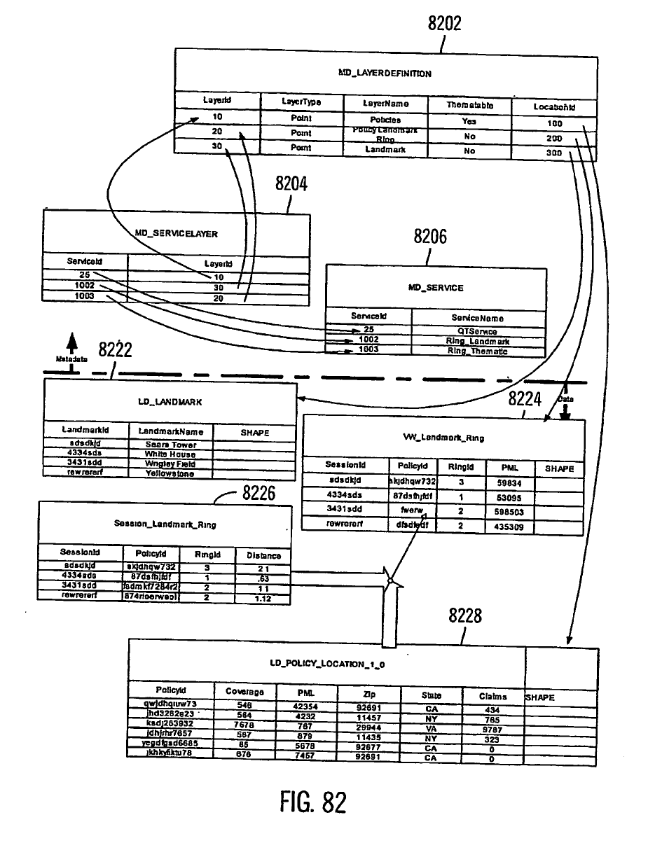

The enterprise spatial system provides an analysis manager to provide generic proximity analysis functionality. FIG. 82 illustrates metadata used to implement ring analysis in accordance with certain implementations of the invention. The metadata includes a MD_LayerDefinition table 8202, a MD_ServiceLayer 8204, and a MD_service table 8204. The data includes a LD_Landmark table 8222, a VW_Landmark Ring table 8224, a Session_Landmark Ring table 8226, and a LD_Policy Location_{—}1_{—}0 table 8228.

The insurance company landmark layer may be made part of the Ring_Landmark service. A Ring_Landmark_service may be described as a grouping of data layers and associated rules to present data to a client. The client retrieves the landmark layer identifier by, for example, a Get_Service_Info call on the Ring_Landmark service. Then, the Ring_Landmark service performs a get feature on the landmark layer to get the landmark names and identifiers to populate the landmark name dropdown in the UI.

The ring analysis target is a view called VW_Landmark_Ring, rather than a data layer. The VW_Landmark_Ring table 8224 represents a view created by joining the LD_Policy_Location_{—}10 table 8228 with the Session_Landmark_Ring table 8226. The Session_Landmark_Ring table 8226 may be viewed as a per session temporary table to hold the results of ring analysis. The client may retrieve the layer id of the VW_Landmark_Ring layer and then work with the VW_Landmark_Ring layer as though it were a ring analysis target layer (i.e., a policy location layer).

An event type drop down that allows a user to select an event type may be populated by JSP page doing a Get_Event_Type function call. A Get_Event_Type function is a function that retrieves from a data store a list of events available for a client. This function pulls the event type name and ring dimensions for the event types from the insurance company schema.

The policy location table (e.g., 8228) is one physical table that is separated into different logical layers based on data load batch number.

In certain implementations, the policy data for different months are identified by a batch number column rather than by a date that may be present in several tables in the customer's schema that contains data for more than one month. The usage of batch numbers ties the ring analysis logic into the Extract, Transformation, and Load (ETL) periodic load process.

In certain implementations, the ring analysis is performed by four different requests to the ESS server from the client computer. First the client computer sends the Generate Rings request with the options chosen by the user in the ring analysis wizard. The ESS server calls a stored procedure that does a spatial ring analysis and deposits the results of the analysis in the Session_Landmark_Ring table 8226 keyed by the sessionid of the current session. The client computer then does a Get_Features call to get a list of FIDS, which are unique identifiers that identify each individual item in a data set, followed by a Get_Image call on the ring analysis target layer (which in this case is the VW_Landmark_Ring table 8224). After displaying the ring image, the client computer calls the Generate Ring Summary call, which causes the ESS server to call an insurance company specific stored procedure to generate the data for the aggregate tables and PML calculations used for analysis summary and drill downs. The ring analysis target layer is set up with a system filter on sessionid. Therefore, the features generated by the last generate ring stored procedure call may be retrieved and rendered. The client computer then makes the fourth request to the ESS server to generate the analysis summary. The ESS server calls retrieves the analysis summary from the aggregate tables and returns the analysis summary to the client computer.

In certain implementations, the generic ring analysis architecture does not use predefined views that join non-spatial ring analysis results with spatial policy location data. Additionally, the generic ring analysis architecture may handle any customer with minimal customization.

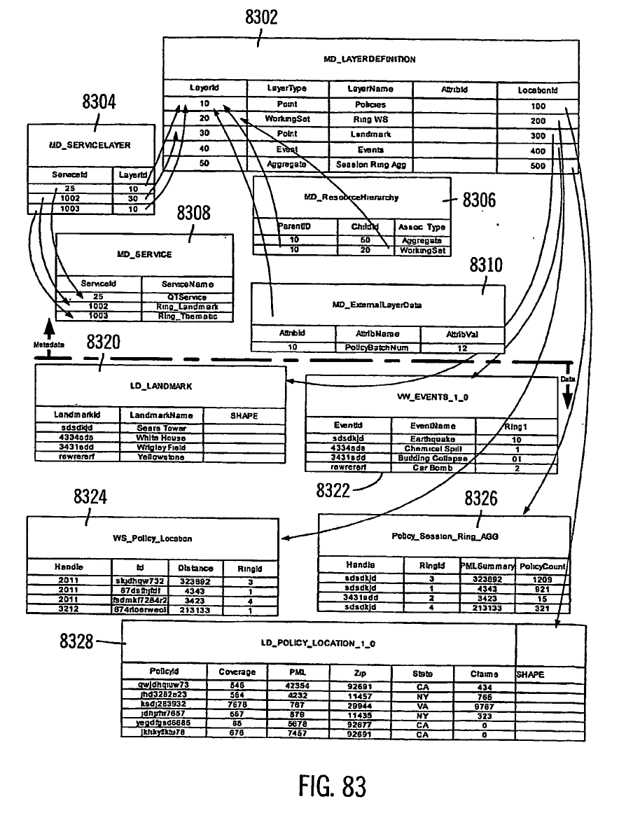

FIG. 83 illustrates metadata to support proximity analysis functionality for a customer in the insurance business in accordance with certain implementations of the invention. The metadata may vary for different customers in other lines of businesses and may vary for different customers in the insurance business. The metadata includes a MD_LayerDefinition table 8302, a MD_ServiceLayer table 8304, a MD_ResourceHierarchy table 8306, a MD_Service table 8308, and a MD_ExternalLayerData table 8310. The data includes a LD_Landmark table 8320, a VW_Events_{—}1_{—}0 table 8322, a WS_Policy_Location table 8324, a Policy_Session_Ring_AGG table 8326, and a LD_Policy_Location_{—}1_{—}0 table 8328.

One difference between the FIG. 82 and FIG. 83 is that, in FIG. 83, there is no predefined view that joins the temporary session based landmark ring table with the policy location table. Each layer in the MD_LayerDefinition table that is a proximity analysis target is made part of the Ring service (Ring service is a grouping of data layers and the associated rules for presentation of the data to the client). The results of a generate ring call go into a WS_Policy_Location table 8324. Each one of these layers also has an associated temporary table into which proximity analysis aggregates are deposited. The proximity target layer is associated with the WS_Policy_Location table 8324 through an entry in the MD_ResourceHierarchy table 8306.

When the client computer does a Get_Service_Info on the Ring service, the actual proximity target layer identifiers are returned. The client computer makes three additional requests to display the proximity and the proximity summary, but the call to generate the proximity image is via a new ESS server request instead of via a generic Get_Image request. The client computer makes a Get_Workingset_Image request on the target layer identifier. The ESS server retrieves the associated WS_Policy_Location table 8324 and sends the layer source data for the WS_Policy_location table 8324 along with the layer source data for the proximity target layer in the form of a JOINTABLE clause to a map server provided by implementations of the invention. The map server renders the features from the LD_Policy_Location_{—}1_{—}0 table 8328, for which there is a corresponding entry in the WS_Policy_Location table 8324.

Events and their associated attributes may be defined in an industry specific, customer specific schema. In the case of insurance customers, these attributes are resident in the GI_Peril, GI_Event and GI_EventZone tables of the Generic Insurance schema.

As for a customer neutral event view, each industry segment to which the analysis manager is applied works with an industry specific schema. If the industry specific schemas include event definitions, the attributes of the events may vary, but there are a set of core attributes that apply to the events that the analysis manager uses. These attributes include, for example, Event Name, Event Id, Event Zone Number, Event Zone Radius and Units of Distance. For each industry specific schema, a new view is defined that exposes this core set of attributes.

A new entry is added to the MD_LayerDefinition table 8302 with a layer type of “Event” that points at the industry specific schema event view through MD_LayerSource table. An MD_Layersource table is a metadata table that is used to associate a metadata definition for a data layer in the MD_LayerDefinition table with a physical database table in a schema that contains the actual data for the data layer. The MD_LayerDefinition entry is used to retrieve the event related attributes.

The analysis manager associates specific events with specific layers and specific functions in an enterprise spatial system (ESS) schema. Events are customer specific data records in a customer schema, and the association to the ESS schema resource entries uses a technique by which the external data elements may be referenced. The function of a UM_ElementType table and a UM_Element table is to allow references to customer specific data elements, so these two tables are leveraged to identify individual events in the ESS schema. Each entry in the UM_ElementType table has associated with it one or more entries in the UM_Element table. The UM_ElementType table includes at a minimum two columns, ElementTypeName and ElementTypeID. At a minimum the UM_Element table includes four columns: ElementID, ElementType, ElementValue and ExternalElementId. For example, the UM_ElementType table includes an entry whose ElementTypeName is “Event” and ElementTypeID is 10. This entry has associated with it two entries in the UM_Element table. For example, the first entry has an ElementID of 200, ElementTypeID of 10, ElementValue of “Earthquake” and ExternalElementID of 5000. In this example, the second entry has an ElementID of 300, ElementTypeID of 10, ElementValue of “Hurricane” and ExternalElementID of 6000. The value 10 in the ElementTypeID column in the UM_Element table associates these two entries with the corresponding entry in the UM_ElementType table. The value of 5000 and 6000 in the ExternalElementID column refers to identifiers in some table in the ESS schema that will be used to retrieve the attributes associated with these two events. The values of 200 and 300 in the ElementID column are unique identifiers for the UM_Element table entries.

The MD_LayerDefinition table 8302 entry for the event view has a predefined field called “Event_Ref”. This field has a “Field_Type” value of “Event”. The Element_Type_ID for this field refers to an entry in the UM_ElementType table. This element type table entry belongs to the same company that owns the event definition in the customer specific schema. This element type table entry has element values in the UM_Element table that correspond to each event defined in the customer's schema. The “Value” field in the UM_Element table has the event identifier, and the “Description” field has the event name. The event identifier in the “Value” field is used to retrieve the event attributes from the event view provided on the customer's schema.

Events are associated with resources in the MD_Resource table using a new table called UM_ElementResource. The MD_Resource table is a parent table to the MD_LayerDefinition table. The MD_Resource table contains a ResourceID column. The LayerId column value in the MD_LayerDefinition table 8302 will match the value in the ResourceID column in the MD_Resource table. UM_ElementResource table includes at a minimum two columns: a ResourceID column and a ElementID column. For example, if an entry appears in the UM_ElementResource table with a value of 10 in the ResourceID column and a value of 200 in the ElementID column, it means the event EarthQuake (from the example in discussed with reference to the UM_ElementType table and UM_Element table above) is associated with the layer named “Policies” with a LayerId of 10 in MD_LayerDefinition table 8302. The UM_Element_resource table provides an association table between the UM_Element table and the MD_Resource table. The UM_ElementResource table has a field called Association_Type, just as in the MD_ResourceHierarchy table. The EM_ElementResource table allows an entry in the UM_Element table to be associated with zero, one or more resources in the MD_Resource table. In reverse, any entry in the MD_Resource table may be associated with zero, one or more entries in the UM_Element table.

The UM_ElementResource table is used to associate specific events with proximity analysis target layers and source layers in the MD_LayerDefinition table. The UM_ElementResource table is also used to associate events with event specific stored procedures defined as functions in the MD_Function table. The analysis manager uses these associations to restrict the choice of events and source layers based on the user's selections in the proximity analysis wizard.

For all customers who use event based proximity analysis, the event set up tool enables population of the UM_Element table and the UM_ElementResource table in the ESS schema and enables populating the event related tables in the customer's own schema.

Events may be associated with specific custom functions defined in the MD_Function table using the UM_ElementResource table. Custom functions specific to proximity analysis have a function category value of “Proximity_Analysis”. If the function type for these functions is “Stored_Proc”, the function name is passed as a string parameter to the Create_Ring_Aggregates stored procedure. The Create_Ring_Aggregates stored procedure uses the custom function name to invoke the appropriate custom stored procedure. That is, the Create_Ring_Aggregates stored procedure may be pre-wired with a known function signature for the custom function.

The analysis manager offers many complex functions. Thus, the results of one operation may be stored for future use by another request from the client computer. As data sets get larger, sending the interim data to the client computer to be returned by the client computer on the next ESS server request is to be avoided. The analysis manager uses the concept of working set tables to accomplish this.

A working set table is a table that contains the results of a ESS server operation. Typically a working set table contains a set of features that were retrieved or identified as part of an operation. The records in the working set are grouped together by the use of, for example, a handle. All the records that are part of the same working set have the same handle value in the “handle” column in the working set table.

In certain implementations, the working set tables are named with a WS_prefix. A working set table has at least two columns. The at least two columns are “Handle” and “Id”. The “Handle” column contains a handle value that is used to group working set records within the table. Handles are unique values that are generated for each operation that creates a working set. Handles are managed using a handle table in the ESS schema. The “Id” column contains a unique identifier that identifies the records in the original table from which the working set is derived. For example, if a selection operation generates a working set of feature records from a spatial layer, the “Id” column may contain an alternate key identification (AKID) values for the features selected. An AKID may be described as a column or set of columns used to uniquely identify a row in a table.

The working set table may include additional, optional columns that vary by the usage of the working set table. For example, a working set table used to hold a set of selected features may not have any optional columns, but a working set table used for proximity analysis may contain a “RingId”, “PML” and “Distance from Landmark” as columns.

Each schema (i.e., the ESS schema and the customer specific schema) also has a global working set table. In certain implementations, the global working set table has the name WS_<CompanyName>. For example, the ESS schema has a working set table called WS_QT. An insurance company may have the global working set table called WS_insurance_company in the insurance company schema. The global working set table contains a minimal set of columns that are relevant across multiple source tables within a schema.

In addition to the global working set tables, layers may have associated working set tables set up to handle special functions. For example, a policy location table may have an associated working set table called WS_Policy_Location. This table may have additional columns used for proximity analysis. The layer specific working set tables are associated with the layers through the MD_Resource_Hierarchy table with an Association_Type value of “Working_Set”. In certain implementations, the layer specific working set table for a layer may reside in the schema in which the layer data is resident, while in alternative implementations, the layer specific working set table may reside elsewhere. Working set tables may be used to bridge data in disparate schemas in different locations. For example, the working set table may reside on a schema different from the source layer based on the intended use of the working set.

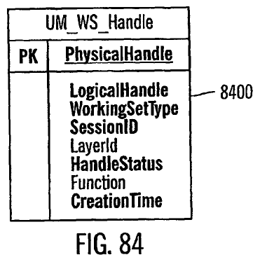

The handles used in the working set tables are managed using a global handle table in the ESS schema. This handle table maintains the handles used in all working set tables in all schemas. FIG. 84 illustrates a sample handle table 8400 in accordance with certain implementations of the invention. The LogicalHandle Field is the handle used by the client computer. In certain implementations, the logical handle is the same as the physical handle. The PhysicalHandle Field is an actual handle value that appears in the working set table. The separation of logical and physical handles allows more that one working set table to be associated with a logical handle. The separation of logical and physical handles also allows an external system or schema to generate handles using its own business rules.

The WorkingSetType Field identifies whether the working set table this handle applies to is a global working set table or the layer specific working set table. The possible values for the WorkingSetType field are “Global” and “Layer”. The SessionId Field provides a Session Identifier of the session that created the handle and is used to validate handles before the handles are used. The HandleStatus Field is used to garbage collect discarded data in working set tables, and possible values for this field are “Active” and “Obsolete”.

The LayerId Field identifies the source layer from which the data in the working set table is generated. If the WorkingSetType is “Global” this field is used to identify the schema in which the global working set table is resident. If the WorkingSetType is “Layer”, the working set table is identified using the MD_ResourceHierarchy working set entry associated with this layer id. In certain implementations, the working set table may be explicitly named in the handle table.

The Function Field specifies a function for which the data in the working set is created and may be used for tracking purposes. The CreationTime Field identifies the time at which the handle was created.

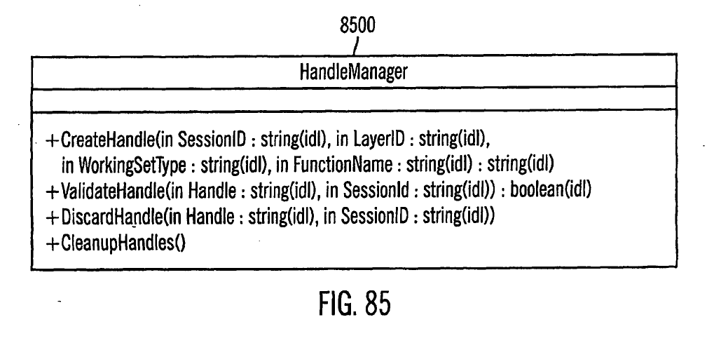

In certain implementations, a handle manager implements a set of methods to manage the handle table. FIG. 85 illustrates a representation of a HandleManager class 8500 in accordance with certain implementations of the invention.

Generic functions for proximity analysis are Create_Rings, Create_Ring_Aggregates, Ring_Summary and Get_WorkingSet_Image. The Create Rings Function is declared as a function in the MD_Function table. The following are the attributes of the MD_Function table entry for a Create Rings function: Function_Type: Stored_Proc;

Function_Category: Internal; Generic_Name: Create_Rings; Display_Name: Create Rings for company; and, Operational_Template: Create_Session_Landmark_Ring. The remaining fields may be null. In certain implementations, the Create Rings function is a function whose method parameter signature is known to the analysis manager. The Operational_Template in the MD_Function table is the stored procedure name.

The Create Ring Aggregates function creates the aggregate tables and possible PML calculations. The following are the attributes of the MD_Function table entry for the Create Rings Aggregates function: Function_Type: Stored_Proc; Function_Category: Internal; Generic_Name: Create_Ring_Aggregates;

Display_Name: Create Ring Aggregates for company, Operational_Template: Create_Session_Landmark_Ring_Aggregates. The remaining fields may be null. The Create Ring Aggregate function may be a stored procedure that is passed the field information for the fields that are associated with this function in the MD_FunctionLayerField table.

A proximity summary function is used to retrieve and display a proximity summary. The following are the attributes of the MD_Function table entry for the RingSummary function: Function_Type: Report;

Function_Category: Internal; Generic_Name: RingSumary; Display_Name: Ring Summary for company, and Operational_Template: company Ring_Summary Report. The remaining fields may be null.

In certain implementations, the ESS server finds the report name from the Operational_Template and forwards the request on to the report ESS server along with the field information associated with the RingSummary function.

The Get_WorkingSet_Image function may be a special case of the generic Get Image function that renders the features in the working set. The following is sample Extensible Markup Language (XML) for the client computer to the ESS server request.

```
<?xml version=“1.0” encoding=“UTF-8”?>
<QTXML version=“1.1” format=“QTXML”>
  <REQUEST>
    <GET_WORKINGSET_IMAGE timeout=“120”
    compositeoutput=“none”>
      <PROPERTIES>
        <ENVELOPE minx=“726472” miny=“−1618135”
        maxx=“1669150” maxy=“−675457”/>
        <IMAGESIZE height=“773” width=“773”/>
        <LAYERLIST nodefault=“true” order=“true”>
          <LAYERDEF id=“Rings” visible=“true”
          layertype=“Rings” serviceid=“10”/>
        </LAYERLIST>
        <BACKGROUND color=“255,255,255”
        transcolor=“255,255,255”/>
        <DRAW map=“true”/>
      </PROPERTIES>
      <LAYER type=“featureclass” name=“Policy Locations”
        id=“Rings” visible=“true” workingsethandle=“9027” >
        <DATASET fromlayer=“227”/>
        <RenderSpec>
          .
          .
        </RenderSpec>
      </LAYER>
    </GET_IMGE>
  </REQUEST>
</QTXML>
```

The ESS server identifies the working set table associated with the handle and calls the map server to render the working set features.

The map server is updated to accept working set tables in addition to the usual parameters for a render request for an image. This may be accomplished using a “JOINTABLE” structure, which is a structure used to merge the data from two or more database tables. The map server is updated to accept the working set for the features being rendered for render requests. The map server renders those features that are included in the list of records for the given handle in the working set table.

Certain data usage requirements require customer's data from different periods to be stored in the same physical table with a column that groups the data together. One such example is the concept of batch numbers for company data. The batch number is an artifact of the way data is stored in the tables. The analysis manager may not be aware of this. When the ESS server has to call a stored procedure on the customer's schema, the set of data that is identified on the ESS side with a layer identifier is actually identified by the batch number in the customer's schema. In various implementations, the data may be identified by more than one dimension in the customer's schema.

To allow easy logic flow between the ESS schema and the customer's schema, a new table called MD_ExternalLayerData is added to the ESS schema. This table contains a set of name value pairs for the resource identifier corresponding to a layer. Any time a stored procedure is called in the ESS schema, in which this layer resides, the set of name value pairs from this table is passed as a variable array parameter to the stored procedure. For example, the batch number corresponding to a layer appears in the MD_ExternalLayerData table as a name value pair for the attribute “Batch”. This allows the ESS server to pass the batch number corresponding to a layer to the stored procedure without the ESS server having any knowledge of batch numbers. Additionally, the MD_ExternalLayerData table is populated with the right set of attributes when this layer metadata/data is loaded.

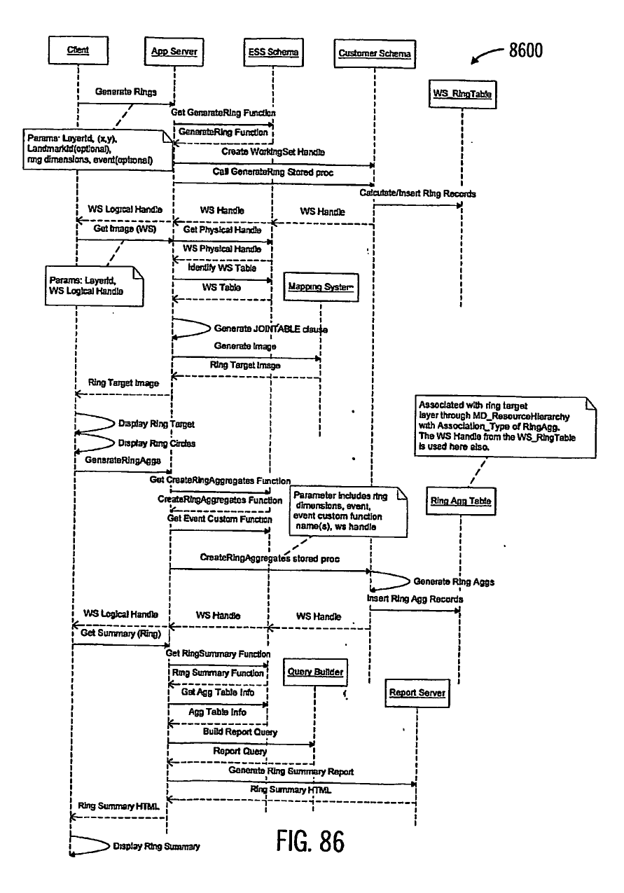

FIG. 86 illustrates a sequence diagram 8600 that describes the client computer and ESS server interaction for proximity image/proximity summary generation in accordance with certain implementations of the invention. In particular, the client computer submits requests to the ESS server. An analysis manager at the ESS server submits requests to the ESS schema and/or the customer schema, receives data, and returns data to the client computer. Also, the ESS server, the ESS schema, and the customer schema may access other functions or tables for their processing.

A proximity point n′ view includes two additional fields displayed in addition to the normal point n′ view fields. The fields are the proximity in which the feature lies and the distance from the occurrence of the event. These fields are added as virtual fields to the proximity target layers with a FIELD_TYPE value of “Proximity”. The MD_LAYERFIELDDATA table has an entry for each of these fields that point at the proximity working set table as the redirect table.

The two new fields may be designated as point n′ view fields and/or full report fields. The Get_Service_Info command returns the Field_Type value to the client computer. The client computer uses this Field_Type value to decide whether to ask for a field for the point n′ view Get_Features. The query builder logic in the ESS server looks at the field type value of “Proximity” to direct the query at the redirect table (i.e., the proximity working set table) to retrieve the values for the two extra field values.

The same logic as in proximity point n′ view will be used to retrieve the data for the proximity number and the distance from the occurrence of the event in addition to the normal full report fields for a proximity full report.

A proximity detail report is defined as a function in the MD_Function table and is associated with a report in the MD_Report table. This report information is returned as part of the layer information returned in the Get Service Info call. The client computer uses this information to do a Detail Report handoff from the client computer. In certain implementations, a proximity analysis summary may be provided that includes the total number of data points that fall within each proximity zone and/or a summation of one or more specific attribute values from these data points. The summary may also include the total number of data points that fall across all the proximity zones and/or the summation of specific attribute values from these data points.

### E. ADDITIONAL IMPLEMENTATION DETAILS FOR INSURANCE RISK MANAGEMENT AND UNDERWRITING

In certain implementations of the invention, a risk manager is provided as a risk manager application service, and an underwriting system is provided as an underwriting application service. Moreover, an additional data application service, a reporting application service, an administration application service, and a portal menu application service are provided. In certain implementations, the risk manager application service provides risk manager administrator and home office business manager mapping, analysis, and reporting functionality. In certain implementations, the underwriter application service provides underwriter new business inquiry landmark search functionality. In certain implementations, the additional data application service provides data source administrator functionality for adding policy location information to policy data and validating data using a landmark search. In certain implementations, the reporting application service provides policy data non-spatial reporting functionality. In certain implementations, the administration application service provides administration functionality for risk manager administrators to manage users, roles, landmarks, and supporting maintenance tables. In certain implementations, the portal menu application service provides portal interface functionality integrated with a site minder system and controls access to other services.

In certain implementations of the invention, the following data services are provided: reference data, business data, and policy data. Reference data services enable procurement, processing, staging, and hosting of standard reference data received from data vendors. Business data (e.g., Dun and Bradstreet data) services enable processing, staging and hosting of business data received from a customer (e.g., via a client computer). Policy data services include processing, staging, hosting, and scorecard reporting of policy data received from a customer (e.g., via a client computer).

In certain implementations of the invention, the following infrastructure services are provided: data center network connection, secure data facility, application service hosting, data storage, data integrity and security, and hot backup site. The data center network connection services support specifications, leased lines, access and integration between the client computer data center and the enterprise spatial system secure data facility. The secure data facility services support operation and maintenance of the secure data facility that hosts services provided by implementations of the invention. The application service hosting services support operation and maintenance of the highly available, scalable multi-tier server system that hosts services provided by implementations of the invention. A tier may be described as a group of computers performing the same type of service in a distributing computing environment. The 3-tier application model is a common way of organizing a program in a network. N-Tier applications (programs) are those that are tiered, but the number of tiers isn't specified or may vary.

The data storage services support operation and maintenance of the on-line, near-line and off-line data storage systems that host the enterprise storage system data. The data integrity and security services support operation and maintenance of the security, backup, and recovery processes, to avoid loss or compromise of business data. The hot backup site services support operation and maintenance of the enterprise spatial system secure data facility hot backup site that ensures timely reestablishment of services provided by implementations of the invention in the event of catastrophic failure at enterprise spatial system secure data facility.

In certain implementations, the following client services are provided: support, help desk, and training.

In certain implementations, the services provided by implementations of the invention are offered to customers as subscription services (i.e., customers select services and pay for the selected services). The subscription services may be used, for example, by risk manager administrators as well as individuals in the enterprise underwriting community. For ease of reference, these may be referred to as the ESS system service.

The ESS system service supports corporate underwriting programs and corporate control programs addressing terrorism. The ESS system provides enterprise data and summary reports for potential terrorism exposures throughout the U.S. based on street-level risk information and enables the assessment of exposure and Probable Maximum Loss (PML) at selected high-risk locations. This information may be made available to all levels of the business community.

Probable Maximum Loss (PML) may be described as the amount of loss expected based on the total liability underwritten for a specific area multiplied by a damage rate expected. A damage percentage rate is assigned to each geo-zone ring. Policies in that ring are totaled and then the damage rate is applied to determine the PML. In certain implementations, the application services may be used to analyze and manage a data value called Probable Maximum Loss (PML), The PML value may be described as the amount of the underwritten liability for a given policy location that is at risk for loss in the event that a landmark, within proximity to that policy location, is destroyed or damaged due to a man-made disaster.

The PML value may be calculated for a given policy location base of the type of event that occurs at the landmark. When the policy location data is loaded each month by the ETL process, PML may be pre-calculated for each policy location.

After the PML amount for each policy location is determined, each landmark is checked using a ring analysis process. The ring analysis results indicate the total or aggregate PML of the policy locations within proximity of the landmark as specified by the “total loss” event type ring dimensions. Based on the total PML amount that the landmark is exposed to, the landmark is assigned a landmark PML rating and risk code. The rating and code are then used by the underwriters, business managers and corporate risk managers to control overall (total book of business) and policy-by-policy (policy detail) risk incurred by policy underwriting in relation to the potential for loss due to any type of disaster (e.g., a man made disaster).

The PML value is a calculation that is based on the underwritten liability for each coverage type that the insurance company insures against a particular policy location. There are many factors that influence the PML formula, but these factors may be encapsulated in one or more stored procedures and supporting data provided to, and hosted by, the enterprise spatial system in order to generate the PML values. These PML values are generated during ETL for landmarks periodically (e.g., once a month). A second set of PML procedures are used to allow users of the risk manager application service to generate PML values in an ad hoc fashion. The ad hoc process includes performing ring analysis on a single landmark location, and associated policy locations, where one or more of the ring analysis parameters are different from the periodic (e.g., monthly) ETL process.

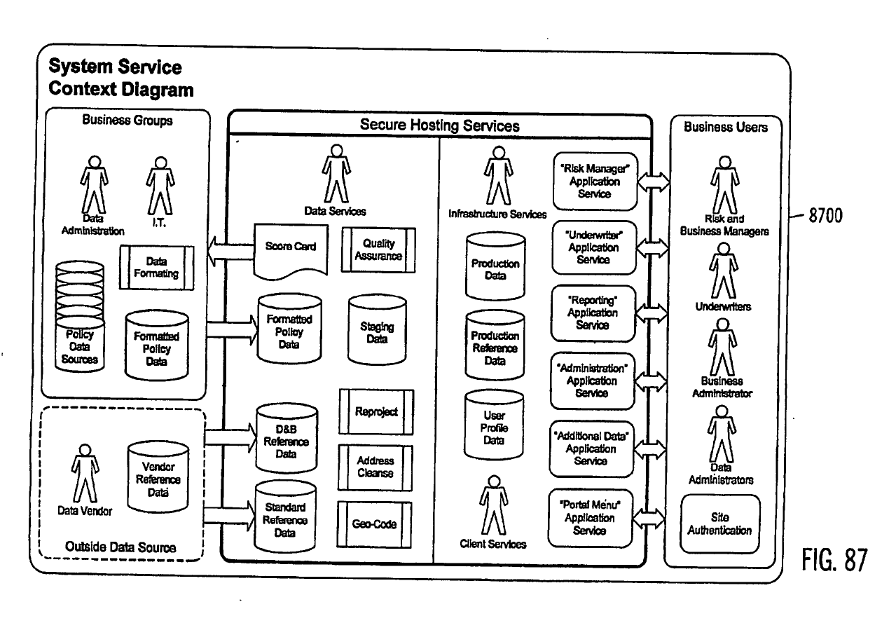

FIG. 87 illustrates an ESS system service context diagram 8700 in accordance with certain implementations of the invention. The diagram 8700 depicts the data components and processing steps provided to deliver the ESS system service. The facilities provided by the ESS system service include the following: business groups, outside data sources, secure hosting services, and business users. Business policy data sources are collected from business groups, and this policy data, aggregated and formatted, is the enterprise data source that is used by the ESS system service. Business policy data is cross-referenced and correlated against outside data sources to add policy location and spatial relevance to prepare the data for use in the ESS system service. ESS system services are made up of application, data, and infrastructure services that are employed in the transformation, secure hosting and delivery of policy data, vendor reference data. and system functionality to business users. Business users include personnel involved in the administration, management, analysis and reporting use of the ESS system service functionality. This includes both home office (e.g., headquarters) and remote regional users in risk management and underwriting that have a need to interact with the system in the policy underwriting process.

In certain implementations, provisioning of the component functionality for the ESS system service is divided between the client computer and the enterprise spatial system.

The client (e.g., customer who purchases subscription services) provides the following components and processing steps required in the delivery of the ESS system service: business data, vendor reference data, and infrastructure. Business data includes acquisition of policy data (e.g., collection of policy data provided from various business groups for provisioning into the ESS system service), a policy data formatting process (e.g., aggregation, cleanup, formatting and validation of policy data prior to delivery to the enterprise spatial system (e.g., as a single data object)); and period (e.g., monthly) upload of formatted policy data (e.g., encryption and provisioning of formatted policy data to the secure data facility over, for example, secure File Transfer Protocol (FTP) on a periodic basis. The vendor reference data includes acquisition of business data (e.g., license and media procurement from business data sources and provisioning to the enterprise spatial system). Infrastructure includes an authentication system (e.g., specifications, access and integration with the client's authentication system), and a data center network connection (e.g., specifications, leased lines, access and integration between the client's data center and enterprise spatial system's secure data facility).

The enterprise spatial system provides the subscription services, including application services (the risk manager application service, the underwriter application service, the additional data application service, the reporting application service, the administration application service, and the portal menu application service), data services (reference data and policy data); and infrastructure services. The infrastructure services include data center network connection services (e.g., specifications, leased lines, access and integration between the client's data center and enterprise spatial system's secure data facility), secure data facility services (e.g., operation and maintenance of enterprise spatial system's secure data facility that hosts the ESS system services); application service hosting services (e.g., operation and maintenance of the highly available, scalable multi-tier server system that hosts the ESS system services); data storage services (e.g., operation and maintenance of the on-line, near-line and off-line data storage systems that host the ESS system service's data); data integrity and security services (e.g., operation and maintenance of the security, backup and recovery processes ensuring no loss or compromise of critical business data); and, hot backup site services (e.g., operation and maintenance of enterprise spatial system's secure data facility hot backup site that ensures timely reestablishment of the ESS system services in the event of catastrophic failure at enterprise spatial system's secure data facility). In addition, client services, such as premium support (e.g., providing resources from account and product management, strategic architecture design, network operations and client support), help desk (e.g., providing 24/7 availability of telephone based application and technical support); and training (e.g., providing a comprehensive train the trainer program) are provided to clients of the ESS service system.

The enterprise spatial system is used to manage policy risk exposure to man-made catastrophes, such as terrorist attacks. Exposure may be managed by imposing landmark-based CAP limits on underwriters' and agents' ability to write and renew policies. There may be different users of the ESS system service. These users each play a role in the overall business processes of insurance underwriting, but are not all directly granted access to the system. An executive has no system access, but is provided high level information. A risk manager administrator may access system reporting and interactive mapping, and some may be granted setup/administrative functions. A home office business manager accesses summary and detailed reports the for business manager's division. An actuarial accesses summary reports across divisions and detailed reports for the actuarial's division. A regional manager/director (e.g., of an underwriter) accesses summary reports across all divisions and detailed reports by division and/or region. An underwriter accesses summary reports and new policy approval information for the underwriter's division and requests policy approval. An agent has no system access, but may submit new policy requests to the underwriter and then is notified of approval/denial of the policy requests. Thus, in certain implementations, the risk manager administrators and home office business managers use the interactive mapping functionality of the risk manager application service.

Several usage scenarios for use of the subscription services are described herein. However, these usage scenarios are examples of applications of the invention and are not intended to limit the invention in any manner.

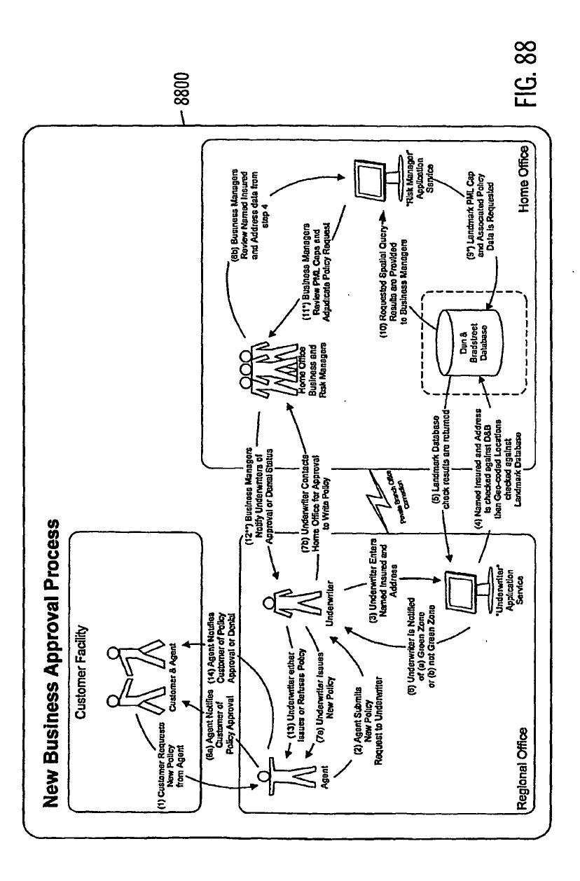

FIG. 88 illustrates a new business approval process 8800 in accordance with certain implementations of the invention. The new business approval process allows users to provide information regarding a new named insured. The process controls the evaluation and determination of which new business policies may be written. An underwriter checks the named insured information provided by the agent to verify if the policy was not within a landmark geo-zone. A geo-zone may be described as an entire area considered within a distance around a landmark that may result in some damages for which claims may be made under an insured policy. For example, a geo-zone may be described as either an address or a spatially defined area such as city, county, or state. If the policy were in an acceptable zone (e.g., a green zone), the underwriter would be allowed to write the policy. A green zone may be described as an address location of a policy that falls outside of all specified landmark geo-zones and for which PML is zero. If the policy is identified as being in a red or yellow zone (within a landmark geo-zone regardless of current CAP), then the underwriter would have to work with the home office business managers and the risk management group to evaluate if the policy was possible to underwrite. A red zone may be described as an address location of a policy that falls within a specified landmark geo-zone, and the PML of the total policy liability for that coverage type and business unit is at or above the allocated CAP. A yellow zone may be described as an address location of a policy that falls within a specified landmark geo-zone and the PML of the total policy liability for that coverage type and business unit below the allocated CAP.

To evaluate the possibility of underwriting the policy, the home office and/or risk management group would do “what if” scenarios by entering in coverage, premium, number of employees, and limits, for the proposed policy. This “what if” scenarios would be used to determine PML impact on any landmark zones. Other factors that would be evaluated are the current PML CAP and CAP distribution for the landmark and the total book of business for both the producer (i.e., a policy issuer) and the customer (i.e., a policy holder). A Book of Business may be described as the premium value and liability of a set of policies underwritten by the company.

In certain implementations, an agent and/or policy holder may query the total book of business. In certain implementations, inquiry information and approval status is saved to monitor PML versus CAPs.

The subscription services provide, for example, the ability to identify whether a policy is at risk and to drill-down capability to policy detail information. These functions serve to help the underwriter make more informed underwriting decisions.

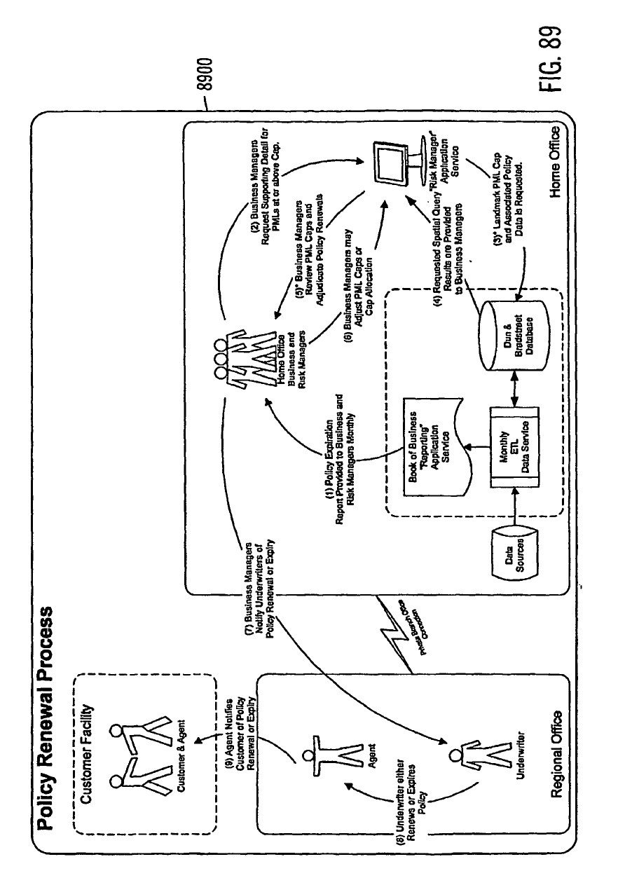

FIG. 89 illustrates a policy renewal process 8900 in accordance with certain implementations of the invention. The policy renewal module may be available to business units and remote users, to include in their underwriters standard procedures. A business unit may be described as an organizational sub-division of a business group.

The policy renewal process controls the evaluation and determination of which policies, soon to expire, may be renewed. This process uses a policy renewal report to identify businesses that are up for renewal (e.g., 90-120 days prior to their policy expiration date). Those policies that have locations that are at risk may be indicated as red and yellow zones on a map. The process may also indicate whether a policy is not at risk and indicate such locations with green zones on a map.

The policy renewal report may be limited to business units and regions based on access rights. Policies up for renewal may automatically be written if they are in a green zone. Policies that are in a yellow zone may be automatically renewed depending upon the business unit. Policies that are in a red zone may require the business unit to review the policy with the home office risk manager administrators. Factors that may influence the policy being renewed may include: whether an entire landmark is at CAP; whether a geo-zone ring that the policy is in is at CAP, while the landmark is not; whether the business unit writing the policy is at CAP, but others in that landmark geo-zone are not; whether the coverage type being written is at CAP, but others in that landmark geo-zone are not; the total book of business for the producer or customer, and/or the financial viability of the policy. Coverage type may be described as the type of policy sold as an individual product or as part of a group under a line of business (e.g.: Property, Casualty, Marine, Auto, Home, Life, etc.). A geo-zone ring may be described as the area between the landmark location and first concentric ring or between the concentric rings emanating outward from the landmark. A Line of Business (LOB) may be described as a group of coverage types (e.g.: Personal, Business, Specialty, Reinsurance, Umbrella, etc.).

The producer information may be determined by a query against the policy data store using that producers code and the total book of business summed up. The customer information may be determined by a query against the policy location list that was created as part of the Extract, Transform and Load (ETL) process using, for example, a Dun and Bradstreet data store, to identify an associated parent/subsidiary business hierarchy.

In certain implementations, an agent and/or policy holder may query the total book of business.

Thus, the enterprise spatial system provides a tool that allows identification of policies with locations at risk due to their proximity to a landmark. The location data is used to green light policies that are not in a PML CAP limited landmark geo-zone, and, when policies are in a PML CAP limited landmark geo-zone, additional supporting details about the current business in that landmark geo-zone or about the provider and the customer are made available.

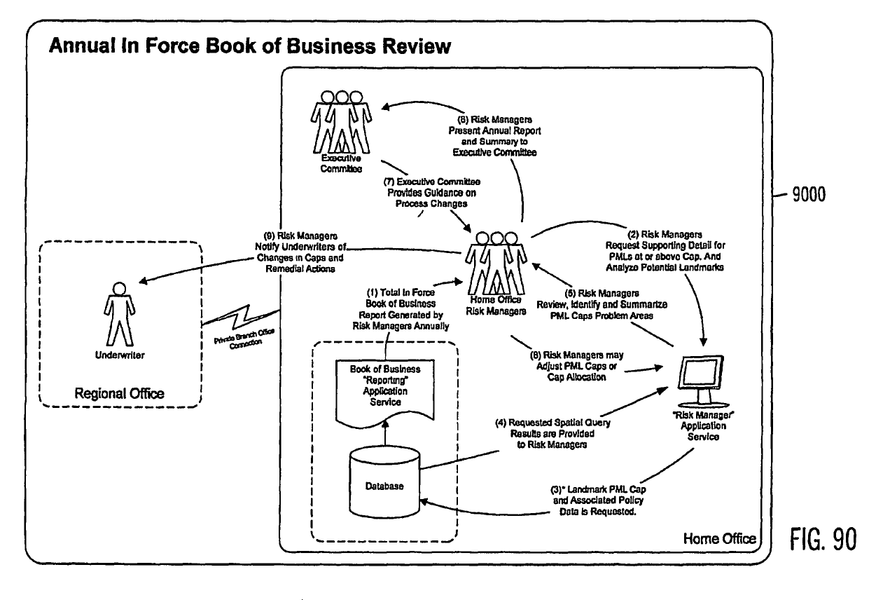

FIG. 90 illustrates a process 9000 of an annual in force book of business review in accordance with certain implementations of the invention. An in force book of business review may be available to business units to review predefined landmark in force book of business to determine whether adjustments should be made to control the Probable Maximum Loss (PML). The in force book of business review may be done periodically (e.g., on a monthly basis after each dataset is loaded and on an annual basis as part of the executive review process for adjusting operating parameters). The review may be conducted using the risk manager application, the total book of business and policy renewal reports, and the landmarks list and their associated CAP adjustments performed using the administration application. The review process uses the risk manager application and reports to review historical performance and CAP compliance and to plan up to five (5) quarters ahead based on current policy effective and expiry dates. The risk manager application has the ability to tag a policy for non-renewal status and save the supporting reports/information. The risk manager application also allows “what if” scenarios on an ad hoc basis to review the adjusted PML with inclusion and exclusion of policy information.

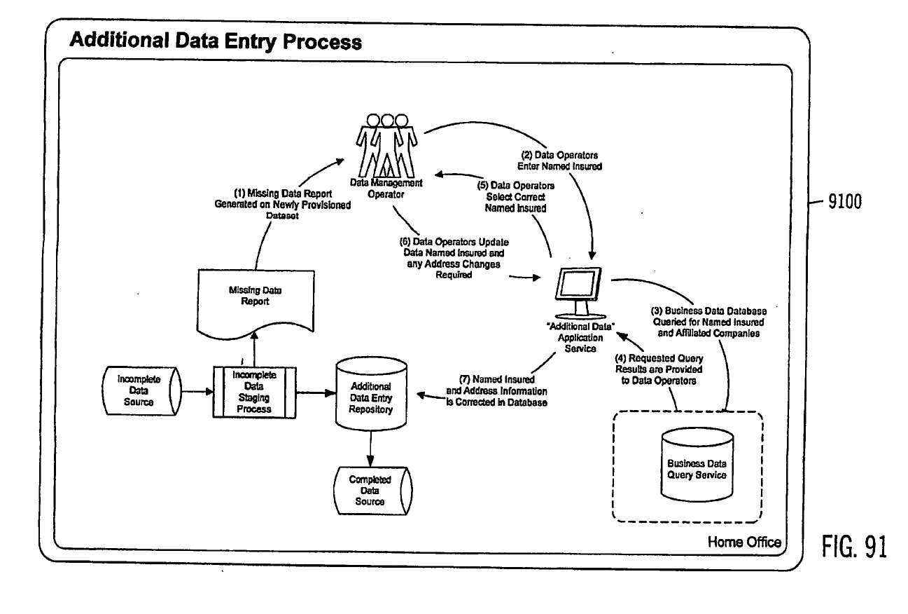

FIG. 91 illustrates an additional data entry process 9100 in accordance with certain implementations of the invention. The additional data application may be available to business units and to remote users. The additional data application is used to manage the entry of missing address information for some source data sets prior to provisioning the data as input to the ETL process. This may be used, for example, if existing business systems do not provide the ability to capture the data.

The additional data application provides a screen to enter location information and policy information used by the risk manager application for the in force book of business. The address and named insured information entered is then searched against the business data store and associated location information lists are generated for review. Moreover, the additional data application provides the ability to review, select, and adjust the retrieved business data, in addition to allowing the business dataset to be queried directly.

The administration functionality is used to set the parameters for the risk manager application operation and reporting capability. Some of the risk manager administrators are granted access to the setup administration functions. These risk manager administrators adjust the system setup parameters in response to the in force book of business review of current landmark liability. These parameters control the PML caps that are used to enforce both the new business and existing business renewals.

This setup information and definition of landmarks identifies the red zones (e.g., zones in which in force book of business PML exceeds a set CAP limit) and yellow zones (e.g., zones in which in force book of business is nearing the CAP limit or within a landmark zone).

Red zones are used to determine whether policies may be renewed. Both red and yellow zones are used to determine whether new business may be written. The CAPs for both red and yellow zones may be adjusted or reallocated based on evaluations of the aggregate business in each business unit, coverage type, specific producers, and specific customers.

The setup functions are used to adjust the list of landmarks that are monitored by the system, set to the total PML CAP for that landmark, and distribute the split of that CAP across business units and coverage types.

The PML caps may be adjusted for the entire or reallocated between business units or coverage types depending upon the outcome of the review. Additionally, geo-zone rings, disaster rates for event types, PML formulas, and other parameters may be managed.

The adjusted setup parameters may be applied in a simulation mode to allow comparisons between the different versions of parameters or temporal views of the parameters applied against multiple versions of the historical batch loads. Once comparisons are done, the setup parameters may be saved as a correct set that future landmark PML caps may be determined from.

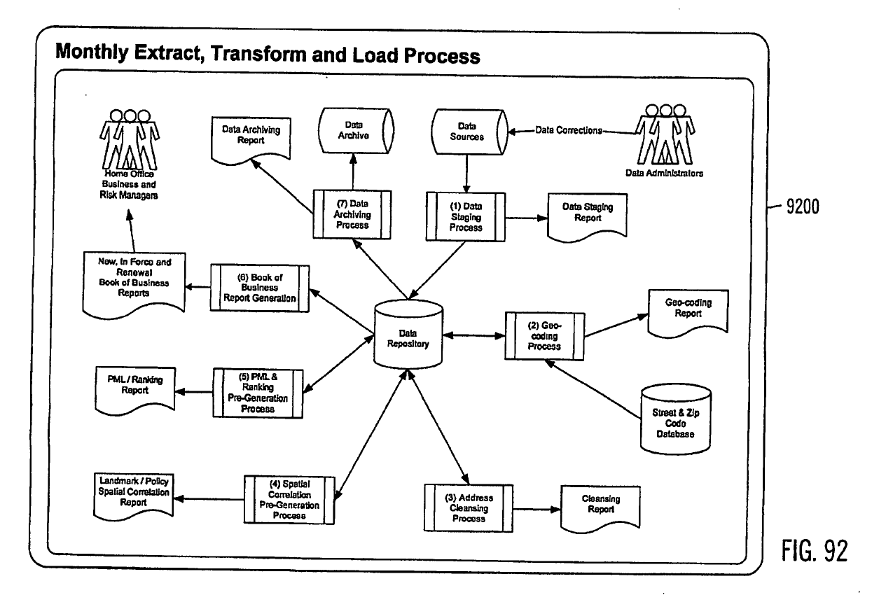

The data management process contains a set of system modules that handle different parts of the overall functionality and supporting processes. Each module plays a part in either moving the data from the current enterprise source to the end system user or delivering some associated business functionality related to the dataset. FIG. 92 illustrates an ETL process 9200 in accordance with certain implementations of the invention. The ETL process handles the movement of data sources provided by the various business units into the data repository. During this process, the data is cleansed, geo-coded and spatially provisioned for non-spatial batch reporting. Once loaded into the data repository, reports are automatically provided to the risk manager administrators and business managers. The loaded data becomes the current, active dataset used by the applications of the ESS system service.

The ESS system service may be organized into the following service categories: application services (e.g., hosted application functionality delivered as browser-to-Web server HTML services); data services (e.g., processing and deployment services for third party vendor data and client internal data); infrastructure services (e.g., management of production systems hosting application and data services); and client services (e.g., customer support for applications and operational issues).

In certain implementations, the ESS application service is provided as hosted application functionality delivered as Web server-to-browser HTML and other content services. The risk manager application service provides functionality with a spatial GUI interface for mapping and analysis by risk manager administrators. This functionality includes basic mapping, landmark ring analysis, address ring analysis, and spatially oriented reporting with policy detail drill-down capabilities.

Interactive mapping application services provide a set of menu options for choosing a Area of Interest (AOI) that a user is interested in. The AOI may be described as the specific location on earth and the surrounding viewing window that is used to locate and display a Web based map and the associated layers of pertinent information the user desires.

Additionally, the mapping application services display a graphical map view of the different data layers.

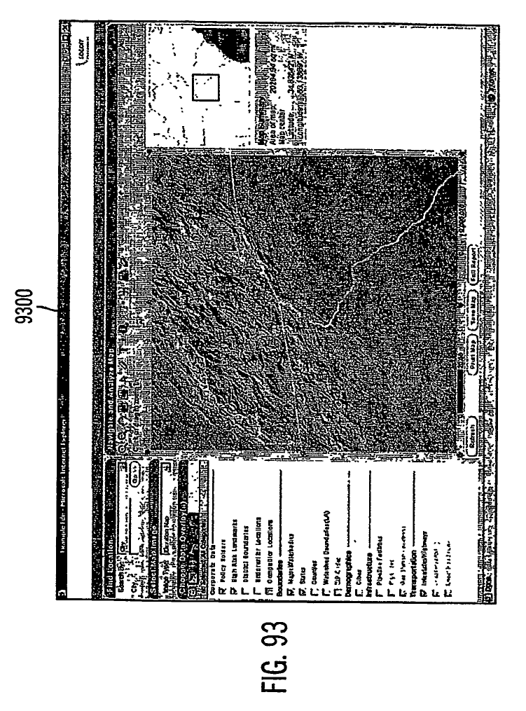

FIG. 93 illustrates a map view 9300 in accordance with certain implementations of the invention. From the map view of the mapping application services, the user selects relevant data intersections. Data intersections are navigable using the search by and layer views. The user may then access a summary PML report for the policies associated with a selected landmark.

Certain implementations of the invention provide for landmark risk ring analysis. For the landmark risk ring analysis scenario, a mapping application service is provided that interfaces with the user via user interfaces. The user begins at a main screen, selects landmark from a search by drop-down, and then selects a specific landmark from the associated drop-down (i.e., this associated drop-down is populated with the landmark data). The landmark location is displayed, and the user then selects the ring analysis tool from the toolbar. The user proceeds to the ring analysis screen, which allows the user to select an event type, and define the attributes of the ring analysis. Once the user selects an event type, the remaining values are pre-populated with the appropriate defaults previously set for the event. The user has the ability to over-write these defaults. The user is returned to the main screen where the ring analysis is undertaken. The rings identify policies that fall within them. A summary of the liability premium and PML information is shown in an analysis summary window on the main screen. The user may access additional reports by selecting a Details button.

Certain implementations of the invention provide an address risk ring analysis. The address risk ring analysis scenario may be used when a risk manager administrator is considering a policy that an underwriter has escalated (i.e., taken to a manager), or when conducting an ad-hoc landmark analysis. For this scenario, a mapping application service may be provided. For the address risk ring analysis scenario, a user begins at the main screen.

The user selects Address from the search by drop-down, and an address pop-up dialog appears. The user enters the address information. The address location appears in a Main Map Window. The user selects the ring analysis tool from the toolbar. The user proceeds to the ring analysis screen, which allows the user to select an event type, and define the attributes of the ring analysis. Once the user selects an event type, the remaining values are pre-populated with the appropriate defaults previously set for the event. The user has the ability to over-write these defaults. The user is returned to the main screen, the ring analysis undertaken. The rings identify policies that fall within them. A summary of the liability premium and PML information is shown in the Analysis Summary window on the main screen. The user may access additional reports by selecting the Details button.

Certain implementations of the invention provide spatial reporting. The risk manager application service provides policy report functionality using spatial dimensions defined by the geo-zone of a selected landmark and presents reports in both summary and detailed formats. Additional policy data filtering is provided to limit spatial dimensions by the business dimensions of either coverage type or business unit.

A summary report may be provided directly on the main application screen showing, for example, liability, premium, and PML totals within the geo-zone ring areas. Both summary and detail reports may provide policy data totals in tabular form organized by geo-zone ring showing, for example, liability, premium, PML, CAP and number of policies. Additional sub-totals may be provided for both spatial and business report dimensions.

Detailed drill-down reports may be displayable in a full report mode to provide a landmark detailed policy PML report. Data included in the detailed report may be limited to the set of policies requested, such as through the spatial and business dimensional filters used during navigation to the detailed report.

For spatial reporting, the user has access to the reports once a landmark or address risk ring analysis has been undertaken. Initially, the user selects the Details button from the bottom of the main screen. The user is taken to the first-level reporting screen. In certain implementations, by default, the tabular report shows the information for all business units and for all coverage types. A drop-down control at the top of the screen allows the user to select a specific business unit or coverage type, at which time the entire display may be updated to illustrate the selected business unit or coverage type. Additionally, after selecting business unit or coverage type, when appropriate data is displayed, a user may request details for the data, export the data (e.g., to a CSV file), print the data or show the data on a map. By selecting details, the user may drill-down into the data, for example, by zone, by selecting the zone number display within the table (e.g., a hyperlink). Upon selection of a zone, the drill-down pop-up is displayed. If the user was filtering on business unit, then the drill-down brings up the drilldown by business unit for that zone. If the user had filters on coverage type, then the drilldown launches the report pop-up for drilldown by coverage type for the zone. The user may drill-down one more level by selecting either the business unit or coverage type, and get to another pop-up that displays the policy information.

Additionally, a landmark summary policy PML report by business unit totals policies in a geo-zone and displays them in tabular form by business unit by geo-zone ring showing, for example, liability, premium, PML, CAP and number of policies. The landmark summary policy PML report by coverage type totals policies in a geo-zone and displays them in tabular form by coverage type by geo-zone ring showing, for example, liability, premium, PML, CAP, and number of policies. The landmark detailed policy PML report provides a detailed list of policies within a landmark geo-zone for a specific business unit or coverage type organized by geo-zone ring. The policy details includes the policy number, named insured, address, coverage type, business unit liability amount, PML amount, premium amount, effective date and expiration date. The detail report includes both vertical sub-totaling and full report totaling columns.

The underwriter application service allows the user to select a list of locations using a business data source (e.g., a Dun and Bradstreet data store) to perform a search by company name and then checks those locations against a customer-specific business rules to determine a location rating. The search results indicate whether any of the locations are in a landmark with a high risk rating indicating to the underwriter that they should contact the home office to secure approval to underwrite the new business.

The underwriter application service may be accessed through the portal menu application service. Once selected, a policy location search screen is displayed that allows the user to select a list of locations to check. After the locations are selected, the locations are retrieved, a check is performed, and the search results screen is displayed with search results.

In certain implementations, the first step in the underwriter application service is the policy location search using a business source data store. The underwriter application service provides a user interface connected to a business data store search interface to support the different functionality required by the underwriter application service and the additional data application service.

From the underwriter application service search screen, the user enters a Named Insured into an edit window. A name or partial name typed into the edit window controls the contents of a list of named insured locations in a list window below the edit window. The list below may be generated from the business data store and may contain location information. Any data entered helps limit the search list that is returned and from which the user selects the actual Named Insured (e.g., typing the first three characters would return the list with all matches containing those three characters regardless of position). The user then selects all desired locations to be checked against the data store to identify high-risk locations.

The business data store search interface provides access to, for example, the Dun and Bradstreet data store of companies containing 16 million records. The search interface provides two request-response style operations to find either all Child Companies or all Parent/Child Companies. The search request contains either a D-U-N-S number or Named Insured text identifier that specifies the parent company. The search response is configurable to provide a varying number of search result columns from the business data store. The Find All Child Companies operation obtains all child companies given a specified parent company. The Find All Parent/Child Companies operation uses the request-response style of operation to obtain the children, the parent, and any peer companies and associated child companies given a specified parent company.

For a landmark search, a policy location list selected from a Policy Location Search is geo-coded and then searched spatially against the landmark geo-zone s to decide whether an insurance policy for that landmark should be approved. The search screen contains the results of a policy location query against the landmark data store. A list of policy locations is displayed to the user containing a status indicating whether they are within a restricted landmark geo-zone. Any policy locations selected that could not be geo-coded may indicate a status of ‘Unknown’ in the results displayed in the search screen. Geo-coding any business data store prior to searching may reduce the ‘Unknown’ result and increases the screen display response time.

The additional data application service, like the underwriter application service, allows the user to select a list of locations through a Policy Location or business data store search and then checks those locations against the data store for locations that are near landmarks. The search results indicate whether any of the policy locations are in a landmark with a high risk rating indicating to the additional data application operator that the operation should research the location further and assure that all policy data available for those locations is accurate. In addition to the functionality available in the underwriter application service, the operator is allowed to save the list of high-risk locations out to an external data-store.

The additional data application service is accessed through the Portal Menu application service. Once selected, a Policy Location search screen is displayed to the user that allows the selection of a list of locations to check. After locations are selected, they are retrieved and checked. The search results screen is displayed for the user. Then, the user is allowed to write the list of locations to an external data store. The additional data application service is designed to work for an operator who is entering a list of policy named insured into the business data store user interface screen. The Policy Location Search for the additional data application service operates in the same manner as the Policy Location Search in the underwriter application service. The landmark search for the additional data application service operates in the same manner as the landmark search in the underwriter application service, with the addition of a Policy Location Saving option. That is, once the operator has been presented with the list of policy locations with the high-risk locations identified, the operator has the option of saving the list to an external, comma separated text file. If selected, the list of locations is written to the external text file using the named insured as the key associated with all records written.

The reporting application service provides non-spatial reporting functionality for the business data and includes at least the following management reports: total book of business by landmark, policy renewal by landmark, and new business by landmark. In certain implementations, each of the reports provides summarized views of total PML values organized monthly by division. Additionally, each report cell is linked to allow drill-down into the associated monthly sub-reports and viewing of policy details that were used to make up the summary reports roll-up.

The reports are run and cached automatically as part of the ETL process after data is pushed into the business data repository. Users with sufficient reporting rights are also able to run the report ad hoc. Contents of the report are filterable by division for divisional users who have limited rights to the report. These reports are used for managing the new business underwriting and renewal process and PML actual vs. CAP risk assessment.

The total book of business by landmark report is a list of all book of business (e.g., by division) using, for example, a 1-year or more range allowing review or projection. The report is calculated on date of policies that are within a given landmark's geo-zone that become effective or expire during the report period. This report is generated and cached automatically as part of the ETL process after data is pushed into the business data repository. Users with report rights are also able to run the report in an ad hoc mode. The contents of the report are filterable by division to support divisional users who have limited rights to the report.

In certain implementations, the following parameters describe the total book of business by landmark report layout and data organization: order (e.g., by landmark (if All selected) then by division); period (e.g., up to 15 month period); vertical axis (e.g., division); horizontal axis (e.g., monthly); data cells (e.g., total PML (based on in force book of business in effective or expiration month and year)); vertical totals (e.g., total PML for all divisions); horizontal totals (e.g., PML CAP per division); report total (e.g., sum of vertical totals (PML vs. CAP vertical total); detail drill-in (e.g., one month, one division cell, click to detailed report); and presentation (e.g., color coded).

The data cells of the total book of business by landmark report are used to link to one of two different drill-down reports: policy detail by landmark and policy detail by division. Use of either are either selected manually or automatically based on user role.

A policy detail by landmark sub-report may be available. The policy detail by division report contains a list of policies and associated details for the specific division and month data cell selected. The main report vertical axis is a policy list with an optional location sub-list. The horizontal axis columns of data include, for example, the following data: policy number, named insured; total liability; calculated PML; premium; effective date; expiration date; and number of locations.

The policy renewal by landmark report is a list of renewals (by division) using, for example, a 1-year or more range allowing review or projection. The report is calculated on the dates of policies that are within the landmark's geo-zone that expire during the report period. In certain implementations, the following parameters describe the policy renewal by landmark report layout and data organization: order (e.g., by landmark (if all selected) then by division); period (e.g., up to 15 month period); vertical axis (e.g., division); horizontal axis (e.g., monthly); data cells: (e.g., total PML up for renewal (expires) that month); vertical totals (e.g., total PML up for renewal for all divisions); horizontal totals (e.g., total PML per division, CAP per division (not applicable if all)); report total (e.g., sum of vertical totals (PML)); detail drill-in (e.g., one month, one division cell click to detailed report); and presentation (e.g., color coded).

The new business by landmark report is a list of new underwritten policies (by division) using, for example, a 1-year or more range allowing review or projection. The report is calculated on the dates of policies that are within the landmark's geo-zone that become effective during the report period. In certain implementations, the following parameters describe the new business by landmark report layout and data organization: order (e.g., by landmark (if all selected) then by division); period (e.g., up to 15 month period); vertical axis (e.g., division); horizontal axis (e.g., monthly); data cells: (e.g., total PML up new business (effective) that month); vertical totals (e.g., total PML up for new business for all divisions); horizontal totals (e.g., total PML per division, CAP per division (not applicable if all)); report total (e.g., sum of vertical totals (PML)); detail drill-in (e.g., one month, one division cell click to detailed report); and presentation (e.g., color coded).

As for policy by business dimension, non-spatial reports are provided to support policy detail reporting in the same format as the policy detail by landmark sub-report. In certain implementations, the policy detail reports are able to run by the following business dimensions: policy by business unit; policy by division; policy by department; policy by coverage; policy by line of business; policy by named insured; policy by policy number, and policy by landmark/division CAP limits.

The enterprise spatial system provides additional ad hoc reports as part of client services.

The administration application service provides ESS system service administration functionality for risk manager administrators to manage users, roles, auditing, landmarks and supporting maintenance tables. The ESS system service users are administered using the administration application service. The system administrator is able to add, configure, and audit each system user. As for identification, users are entered into the administration application service by an administrator and are assigned an appropriate role prior to their initial attempt to authenticate into the ESS system service.

The user authenticates into the ESS system service through, for example, a site minder or other authentication system. The authentication system passes the user to the Portal Menu application service with a session cookie and user identifier. The session cookie is verified by the Portal Menu application service using the authentication system Web plug-in interface over a back end connection. The user identifier is used to match the user, once the user is configured in the system using the administration application service. Once the user session is validated, the ESS system service session is created. Once the user has been authenticated, the ESS system service takes over and provides the access control. Based on the user's role, the user provided access to the ESS system service functionality and data as allowed.

Each ESS system service user is assigned a role that controls access to system functionality and data. The ESS system service administrator may be able to assign one of any number of system roles to each user.

Each ESS system service user is provided a user profile that contains data unique to that user and used to provide personalization to the user experience. The administration application service supports both standard and custom user profile information. In certain implementations, the administration application service standard user profile supports the following information: user identification; user full name; user e-mail address; and user role. In certain implementations, each ESS system service user is provided a set of additional profile information. The custom user profile data includes elements, such as the business unit of which the user is a member.

The ESS system service role is administered using the administration application service. The ESS system service administrator is able to add, configure, and audit each system role. The ESS system service administrator is able to create roles that provide any combination of system functionality and data to be configured under a single role. Each ESS system service user is assigned a role that controls their access to system functionality and data.

In certain implementations, several distinct user roles are implemented to support the different user types of the system, including, for example: super users (e.g., capable of administration, interactive mapping, and running reports); regional agent (e.g., capable of running reports limited by business unit and region); business units (e.g., capable of running reports limited by business unit); home office (e.g., capable of interactive mapping and running reports); and data administrator (e.g., capable of using additional data application). Each role is granted a set of functionality and data appropriate to that users usage profile.

The ESS system service provides a role based access control functionality that provides the ability to control who has access to any of, for example, the following: specific menu functionality and specific data sets.

The administration application service provides the ability to audit users usage of the ESS system service. For example, user activities are tracked for usage auditing and reporting. User activities are tracked in the ESS system service from initial authentication to logout. Items tracked include which site pages were used, which functions were executed, and which data was accessed. The administration application service allows searching and sorting of usage for individual users or across users. User errors or system violation attempts are tracked and made auditable within the administration application service.

The administration application service provides the ability to manage landmarks configured in the landmarks list or layer. Other administration features are done using the business data list maintenance section of the service, including, for example adjusting additional landmark business data such as PML CAP.

To define and save a new landmark, a user selects an address. Once the address is selected, the user may save the address as a landmark. For example, this may happen after the user has undertaken an address risk ring analysis. If the user's role allows, the user selects Save as landmark from the File Menu. Unauthorized users do not have access to this functionality. The Save landmark screen appears pre-populated with spatial information, and allows the user to input additional information, such as the landmark name, type (from a selection list), CAP limit, and rating. When the user selects to Save the landmark, the landmark is saved to a data store. Alternatively, a user may choose a Cancel option instead of the Save option.

In certain implementations, new landmarks may be enabled for saving to allow analysis but not included in overall policy PML calculations until the next ETL process is run in the staging data store and that data is then loaded into production.

The administration application service provides the ability to manage business data lists in support of the policy and landmark data layers. The business data list management screens are accessed as a channel from the Portal Menu application service and exposed to the user based on the user's role after the user is authenticated. The administration application service is also accessible through an external link on a menu bar.

The administration application service provides the ability to manage, for example, the following business data lists: landmarks, event types, coverage, business unit, and calculation factors.

The administration application service provides administration of the list of locations considered as landmarks in the system. A landmark is a specified geo-zone that is an area requiring in-force book of business monitoring. Current in-force book of business risk locations are identified, PML calculations performed, and the results stored during the ETL process for fast retrieval and reporting.

Each landmark is able to be assigned a total liability CAP. This CAP is unique to the landmark and may be adjusted based on annual review by the executive committee. In certain implementations, a single landmark CAP is in force on those landmarks that are active; the CAP is allocated, by percentage amount, across each business division; and reports show liability, premium, total CAP and total PML for the landmark and then by geo-zone for that landmark.

The administration application service provides administration of ratings for CAP against the calculated PML. Ratings may be assigned, for example, from a range of 1-10, where ten is a worst case. In certain implementations, zero (0) may be a default value for a rating in the landmark table when a landmark is not included in the stored PML to landmark results table. Ratings apply globally to landmarks and severity levels. The ratings represent a percent of PML. For example, a zero % rating would mean the record is not in any landmark. Policies are ranked and assigned a rating during the ETL process. In certain implementations, ratings for policies that appear in more than one landmark geo-zone may be treated as worst case, not additive.

The administration application service provides administration of the percent values of the total landmark CAP allocated to each of the Business divisions. The divisions are pulled from the business unit table (Type=division) and the landmark data is pulled from the landmark table. The values in this table may be in percent (%) format to eliminate modification when the landmark CAP changes. A divisional percentage of CAP may be decided, for example, once per year by an executive meeting. By division CAP percentages may be used for reports and may not be required in the risk manager application.

The administration application service provides administration of the list of event types enabled for each landmark. The landmark event type configuration may be implemented as an additional maintenance screen accessed from the landmarks main maintenance screen. The administration application service provides administration functionality that allows the addition of new event type severity geo-zones.

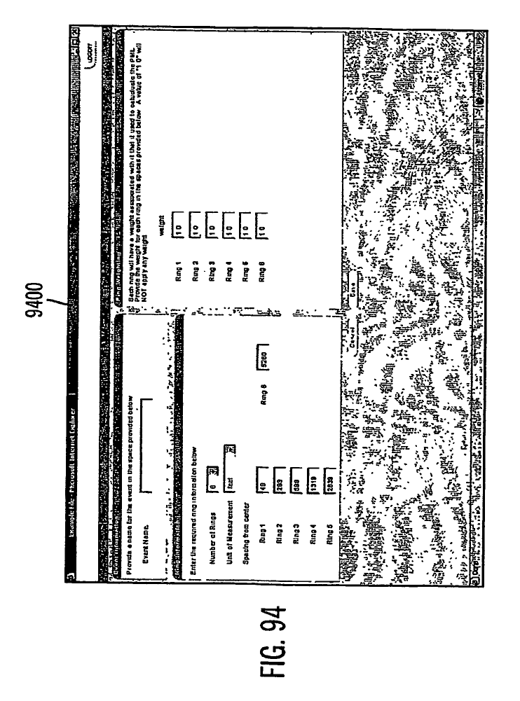

The administration application service provides administration of the geo-zone radius sizes and number of rings for each event type severity level. This is the concentric ring (zone) size from epicenter of the geo-zone. In certain implementations, the default is six (6) rings and is limited to a minimum of one (1) and a maximum of ten (10) rings. All geo-zone rings specified for a severity level may be the same for all landmarks. FIG. 94 illustrates a screen 9400 with event information, ring information, and ring weighting in accordance with certain implementations of the invention.

The administration application service provides administration of the damage rates for each geo-zone ring for each severity level. Damage rate may also be referred to as a severity factor that is used in the PML calculation.

In certain implementations, damage rates specified for a severity level are the same for all landmarks. The administration functionality includes the ability to copy another severity to minimize the data reentry work for the administrator. The geo-zone ring and damage factor are changeable for temporary “what if” scenarios applicable to a single landmark location. In certain implementations, setup changes that are applicable to an entire policy dataset require batch ETL reprocessing of current policy layer off-line.

The administration application service provides administration of the coverage that may be included in the PML calculations. Coverage values apply to all landmarks for all severities in all geo-zone rings. Each coverage type is assigned a line of business from a list managed from a sub-screen accessible from the coverage administration screen.

The administration application service provides administration of organizational structure broken down currently by division, group, and business unit. In certain implementations, landmark CAP percentages are assigned at the division level and reporting is drilled down to on the policy by business unit level.

The administration application service provides administration functionality to support parameters used in PL/SQL stored procedures that contain calculations for various business logic. PL/SQL may be described as a procedural language extension to Structured Query Language (SQL). The system supports parameter configuration for landmark ratings, probable maximum loss and workers compensation limit calculations.

PML calculations may be based on the total book of business liability for policies held in a given geo-zone ring multiplied by the damage rate assigned to that geo-zone ring. Landmark ratings may be determined based on summing PML values vs. each landmark CAP. Damage rates vary based on the type of event; therefore, PML is different for each type of event and for each landmark (e.g., due to number of policies in each geo-zone ring).

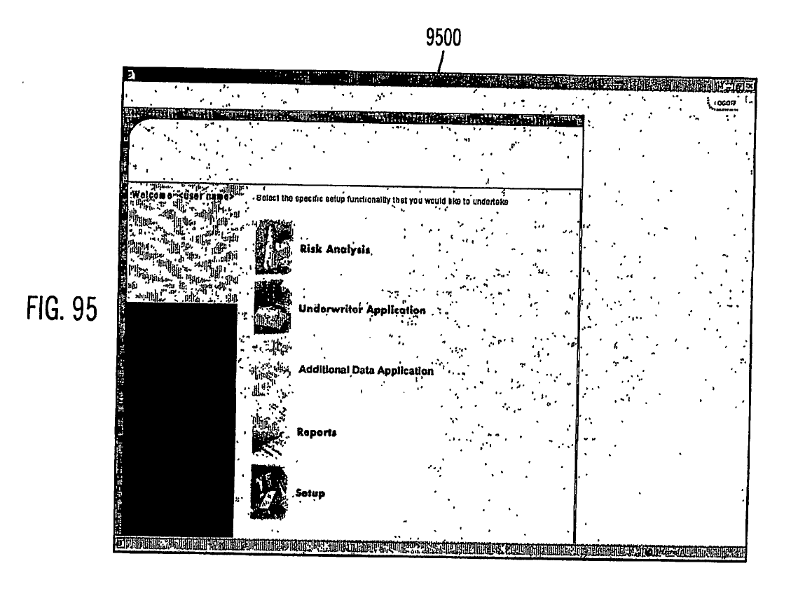

In certain implementations, access to the spatial and non-spatial application and data services provided by implementations of the invention is controlled through a portal service using a portal home page containing channels for each application. The portal service displays an entry (welcome) screen that may be unique and co-branded and that branches the user to appropriate functionality associated with the user's role. Access to the portal may be provided through client authentication. FIG. 95 illustrates a portal entry screen 9500 in accordance with certain implementations of the invention.

The portal may be a series of HTML pages that users first go through in order to access the ESS system services. Under the enterprise spatial system design, the portal displays different HTML pages depending on who the user is. This determination is made at the login stage when the user first logs into the service.

The ESS system service authentication is provided through integration with the client's authentication system, which is hosted and managed by the client. User authentication criteria, username, and password, are hosted and managed by the client in, for example, a domain services repository. Users desiring access to the ESS system service are explicitly added to the application services and their roles are assigned using the administration application service delegated to the risk manager administrators.

The authentication interface is integrated into the application service and replaces a native authentication service. In certain implementations, the integration consists of enterprise spatial system Web servers accepting a session cookie through URL parameters in an HTTPS post from the authentication Web server. The session cookie is then verified using, for example, a back end Web connector. Once the user session has been verified, the username may be used to create a portal and application service session, and the user is then presented with portal channel content and applications based on access control rights.

The enterprise spatial system maintains a Lightweight Directory Access Protocol (LDAP) data store that contains data on users and roles. This LDAP data store may be maintained using the delegated administration application service. In certain implementations, this LDAP data store is not externally accessible.

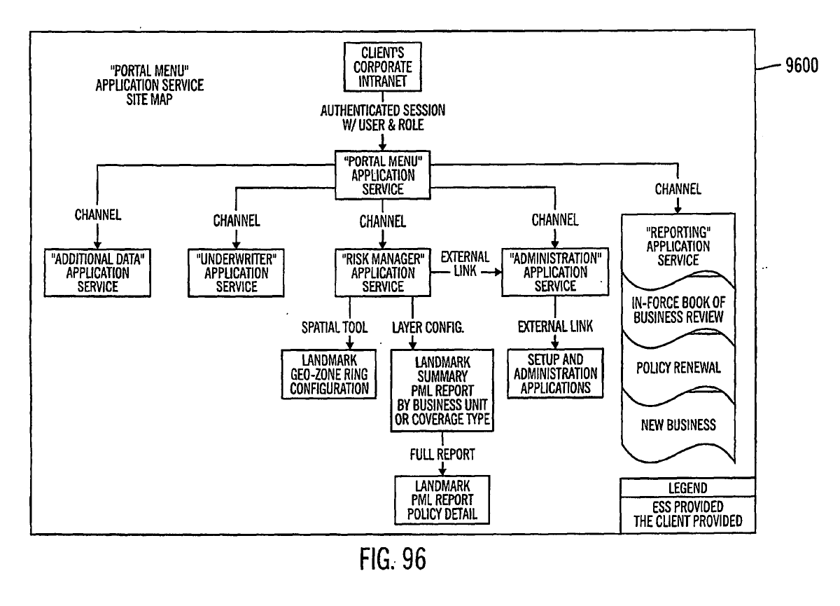

FIG. 96 illustrates a portal menu application service site map 9600 in accordance with certain implementations of the invention. The enterprise spatial system provides a hosted portal system to centralize access to ESS system services.

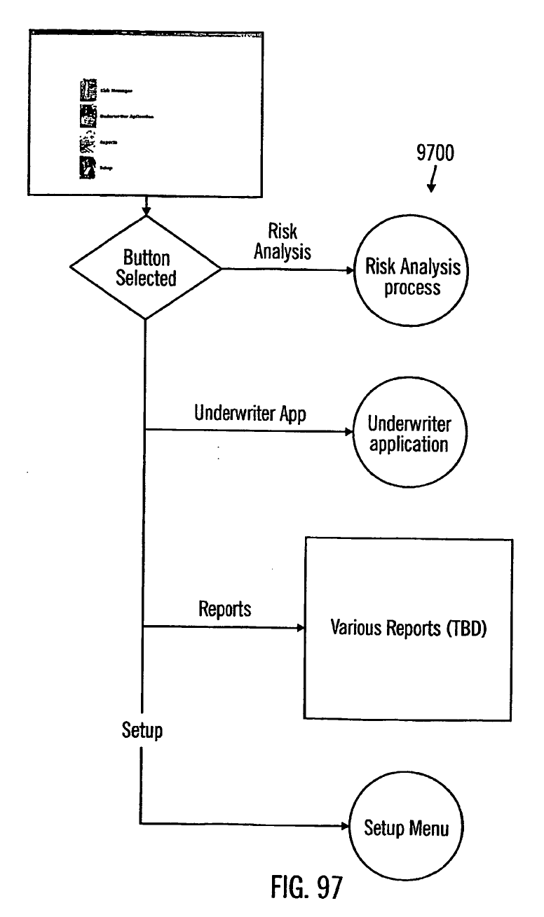

FIG. 97 illustrates a sample of a Portal Menu application service main page and subsequent screen flow 9700 based on user selections in accordance with certain implementations of the invention. For example, a super user (who has access to all of the enterprise spatial system functionality) enters into the ESS system service on the portal page and subsequently branches to main functional service areas.

In certain implementations, each of the ESS system services are accessed through application links from the portal channels. The portal service may be expanded based on changing system requirements.

In certain implementations, several additional standard application services are provided, including, for example: visual reporting; collaboration and workflow improvement; drill down into counties, ZIP codes, states, and census tracts; point n′ view information; spatial queries; printing and saving maps and reports; on screen summary section; cartography and map annotation tools; online help; application upgrades; and customizations.

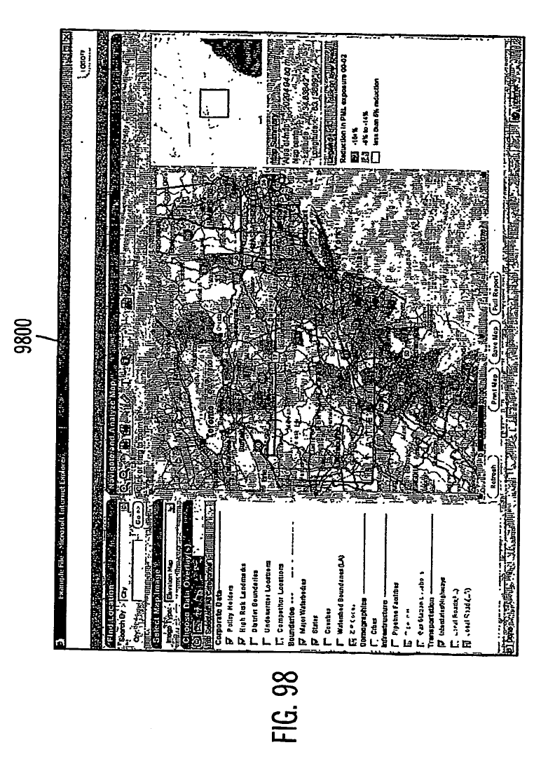

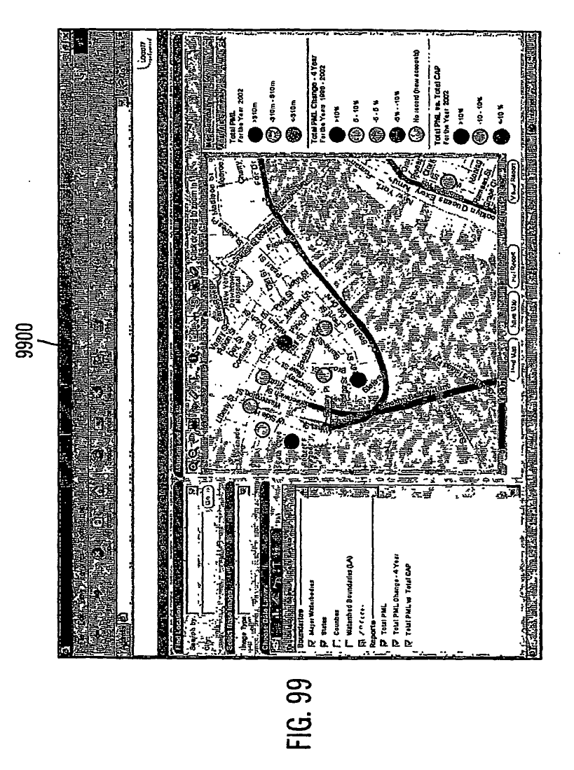

As for visual reporting, the enterprise spatial system enables data visualization. The enterprise spatial system integrated application services provides a better way for hundreds of decision makers within a large organization to better understand their business landscape and ultimately make better decisions as a result. For example, with thematic functionality, once risk analysis has been undertaken, clients may create visual reports that show how risk has been mitigated in key areas, changes in PML levels across key areas in the country, changes in the areas that are defined as high risk, etc. Ultimately, with visual reporting, risk analysts may communicate their successes in an intuitive manner to senior management, board members, stockholders, and more. In certain implementations, additional thematic reports may be configured for different point based views of the same PML data instead of boundary polygon versions. FIG. 98 illustrates a screen 9800 of a selected map image with a map summary in accordance with certain implementations of the invention. FIG. 99 illustrates a screen 9900 of a selected map image with an analysis summary in accordance with certain implementations of the invention.

As for collaboration and workflow improvement, the enterprise spatial system provides a highly collaborative environment for risk analysis and visual communications. With the enterprise spatial system application services, users may undertake “what if” scenarios, and save out an interactive project for colleagues to work with, conduct further analysis upon, or simply print out. The enterprise spatial system provides sophisticated capabilities that allow for users to share projects or graphic outputs in a way that ensures that those members on the team whom the author deems appropriate may have access to the project or graphic. There is no limit to the size of the collaborative group that enterprise spatial system may support. Effective utilization of enterprise spatial system's collaboration feature may result in improved policy review workflows.

A suite of analysis tools within the enterprise spatial system application services empower the user to drill-down into the details of a data set within specific boundary areas, including counties, ZIP codes, census tracts, and states. With these capabilities, clients may consider key information with respect to how the information is broken out within one or more of these geographic regions.

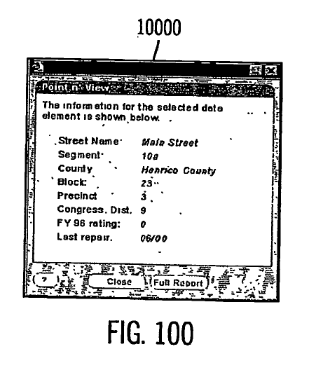

A point n′ view tool is provided that allows a user to quickly identify certain attributes of any feature that is currently available within the enterprise spatial system mapping work area. With a simple click of the mouse, the user gains access to the information describing the selected feature. FIG. 100 illustrates a point n′ view tool 10000 in accordance with certain implementations of the invention.

As for spatial queries, the enterprise spatial system provides extensive tabular reporting capabilities, and tied closely to this reporting is the system's ability to run complex Boolean queries consisting of multiple statements. With these capabilities, risk manager administrators may drill-down deeply into the data, and find exactly the information that they need in a timely manner.

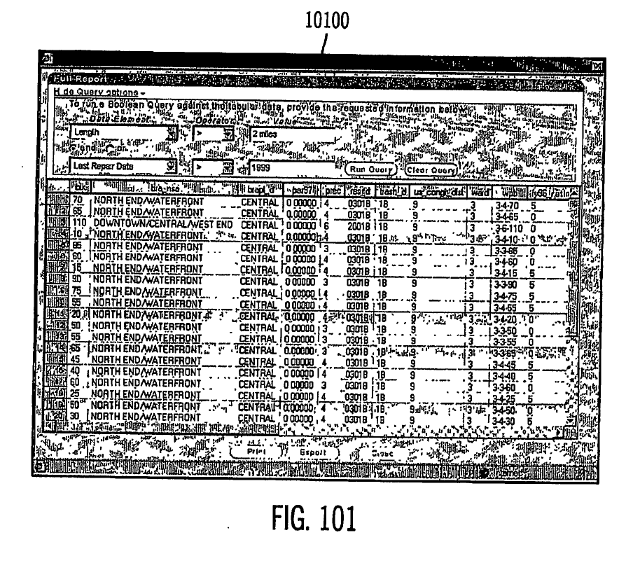

Often once an analysis is complete, it may be important to distribute the findings either through a visual representation or via a tabular report. The enterprise spatial system offers flexibility in this area that allows the user to print out visual reports to standard printers and plotters, and print tabular reports to printers. Additionally, visual reports may be saved, for example, to JPEG or PDF formats, for distribution by email or for archival purposes. Tabular reports may be easily exported to, for example, CSV format files for later use in reporting and spreadsheet applications. FIG. 101 illustrates a full report screen 10100 in accordance with certain implementations of the invention. A user may select a Print button or an Export button on screen 10100.

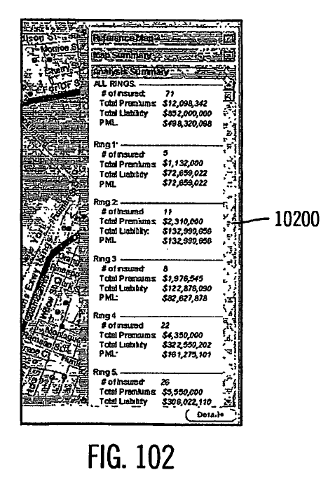

When undertaking any type of analysis, enterprise spatial system's application services user interface provides a view into certain data through a summary window. So, for example, when a ring analysis is undertaken, the user may see summary information even before launching a tabular report. In addition, the attributes shown in the summary window may be customized, so the attributes that are desired for any type of analysis are the ones that may be displayed within the summary window. FIG. 102 illustrates an analysis summary 10200 in accordance with certain implementations of the invention.

For Web-based application services, the enterprise spatial system provides annotation and cartographic tools that allow clients to output high quality reports and graphical risk representations. With the enterprise spatial system's annotation tool services, the user may add text, boxes, lines, arrows, and more.

The enterprise spatial system has a complete, integrated commercial-quality online help system to assist the user through the various tasks within the application services. Included in the help system are indexing and searching capabilities.

As part of the subscription services, clients who purchase the subscription services receive performance and feature enhancements as they become available.

In certain implementations, enterprise spatial system enables clients to customize and enhance the system without dependence on enterprise spatial system. For example, this may include Web services exposed through application Program Interfaces (API's) that enable clients to expand data layers and integration with other applications or application services.

The enterprise spatial system provides data services in support of the ESS system service implementation. The enterprise spatial system data services include management of both client business data and additional vendor data.

As for vendor reference data, the enterprise spatial system data services provide various supporting data layers for use in the ESS system service. The enterprise spatial system offers both standard and premium layers that may be requested at any time for integration into the ESS system service.

As for standard reference data layers, in certain implementations, the following data layers are available for use in the ESS system service on a nationwide basis included in enterprise spatial system's standard service subscription fee: spatial layers, state boundaries, county boundaries, ZIP code boundaries, city and town locations, metropolitan boundaries, detailed navigable roads, railroads, major % water-bodies, and a geo-code address data store.

Additionally, the following US Census Bureau (Census Information) may be provided as standard reference data layers: (e.g., year 2000) census boundaries and population statistics w/census information for block, block group, tract and county levels, where data is from first release from Census Bureau; total population, race (e.g., white, black, Native American, Asian, Pacific Islander, Hispanic, multi-racial, other); gender (e.g., males, females) and age (e.g., under 5, 5-17, 18-21, 22-29, 30-39, 40-49, 50-64, 65+, median male age, median female age); and household information (e.g., number of households, average household size), family distributions (e.g., single parents, married parents, married no kids, etc.), number of families, average family size, and housing unit information (e.g., vacant, occupied, owner-occupied, renter-occupied).

Additionally, the following US geological Survey information may be provided as standard reference data layers:

Digital Ortho Quarter Quads (DOQQ)—US-wide aerial photography (i.e., in certain implementations, ˜90% of the US is covered with most imagery being less than five (5) years old and 85% of the imagery is black and white with the remainder being color-infrared, with spatial resolution being 1 m; Digital Raster Graphics (DRG)—US-wide “topo” maps at three scales (1:250,000, 1:100,000 and 1:24,000), where data may be 10-20 years old with updated DRGs in some areas and where data shows general land cover, some infrastructure, administrative boundaries, and topographic information; and National Elevation Dataset (NED)—US-wide elevation data at 1 km, 300 m and 30 m resolutions.

As for premium reference data layers, the enterprise spatial system premium layers may be chosen following evaluation of the major data vendors for each product category. The enterprise spatial system has built an understanding of the underlying data quality that enables the enterprise spatial system to make informed recommendations to clients as to which data best suits their specific business use. The enterprise spatial system builds strategic relationships with several key data providers to ensure that enterprise spatial system's clients receive the most business value from their data investment, including, for example: business point data (e.g., Dun and Bradstreet, InfoUSA, Experian, etc.); lifestyle and demographic (e.g., AGS, Claritas, etc.); real-time and historic weather (e.g., Meteorlogix, etc.); high quality aerial and satellite imagery (e.g., Emerge, Digital Globe, etc.); healthcare industry information (e.g., IMS Health, etc.); detailed hydrology including rivers, streams, and flood plains; area codes; and any other layers from commercial or government sources as generally available.

The enterprise spatial system data service's Dun and Bradstreet data contains business name, parent-child hierarchy and address location information for companies in the United States provided by Dun and Bradstreet.

In certain implementations, the Dun and Bradstreet data is provided by Dun and Bradstreet under a license agreement between Dun and Bradstreet and the client that provides for external hosting of the data by the enterprise spatial system. The data may be provided as a single, comma separated ASCII format file and provided in its original form as delivered from Dun and Bradstreet The data may be provided with a data dictionary describing the data contents.

The Dun and Bradstreet data is loaded into a data repository (e.g., one from Oracle corporation) and then geo-coded and address cleansed to provide spatial referencing to each business location. Any data not cleansed and geocoded may be cleansed and geocoded as it is accessed. The geocoding service allows users to geocode an array of addresses using a specified spatial reference system. The geocode addresses operation uses the request-response style of operation to obtain a geocode for an array of addresses using the specified spatial reference system. The address cleansing service allows users to standardize an array of addresses according to the preferred US Postal service (USPS) addressing standards. The cleanse address operation uses the request-response style of operation to standardize an array of addresses according to the preferred USPS addressing standards.

As for a production data store, the Dun and Bradstreet data may be hosted on-line in a data store (e.g., one from Oracle corporation) in the enterprise spatial system secure data facility and access to the data may be provided via the underwriter application service, the additional data application service, and the business data store search application service.

Business data contains the client's policy data list and high-risk landmark data list, both configured with spatial dimensional indexing. Additionally, the business data contains associated lookup and associative entities to support business dimensional analysis of both the policy and landmark data.

An Extract, Transform and Load (ETL) process handles the movement of data sources provided by the various business units into the enterprise spatial system data store. During this process, the data is extracted, loaded, cleansed, geocoded and spatially provisioned for non-spatial batch reporting. Once loaded into the enterprise spatial system data store, the loaded data becomes the current, active dataset used by the ESS system services.

In certain implementations, the client is responsible for the Extract portion of the ETL process. For example, the business data is provided to enterprise spatial system by the client on a periodic basis in read-only format with the intent of the enterprise spatial system to prepare, load, and host this data in the enterprise spatial system data store to complete the Transform and Load steps of the ETL Process.

In certain implementations, the business data is provided as policy data in a comma separated, ASCII text file format. The business data may be provided from sources compliant to a consistent data specification. The business data may be provided to the enterprise spatial system with a data dictionary containing the data specification.

In certain implementations, policy data is not administered using the administration application service. Policy data is loaded using the ETL processes and associated enterprise spatial system data services.

In certain implementations, a policy supports up to 450 locations. In certain implementations, policy liability limits are stored at the policy level, and may be updated to be by location or umbrella type or other subdividing factor.

Policy liability and premium may be stored and organized by policy, rather than by policy location. Calculations of premium and liability caps are may not be applied by location. Any one location may be considered to be able to apply 100% liability for the entire policy.

Current liability and premium is determined from the actual data in the resulting spatial queries on the zone rings.

In certain implementations, premiums are not totaled or displayed at any intermediate level, such as by business unit or by coverage type to avoid a duplication calculation inclusion problem. Totaling and display may be at geo-zone ring level, or above, to support total premium vs. CAP and may be at the detailed policy level.

The client provides business data to the enterprise spatial system with complete policy and address data. In certain implementations, no additions to business data are done by the enterprise spatial system, with the exception of address cleansing and geocoding.

The client uploads the business data to the enterprise spatial system in, for example, an encrypted file format over a secure FTP interface hosted and managed by enterprise spatial system. The client uploads the business data on a periodic (e.g., monthly) basis.

The enterprise spatial system provides address cleansing, geocoding, and data store loading data services to transform and load the business data provided by the client into the operational data store in the enterprise spatial system secure data facility.

Policy location data is geocoded using the enterprise spatial system standard geo-coding engine and underlying street and boundaries datasets. Any policy locations that are not successfully geo-coded are then passed to an address cleansing system and then re-geocoded. Any policy locations that do not successfully geocode are then reported back to the client, for example, on a processing scorecard.

Thus, policy location data that does not initially geocode successfully is run through an address cleansing/matching system that standardizes the address data formant and validates the address data using the USPS address data store. The resulting policy location data is then re-geocoded.

Geocoded and cleansed policy and policy location data is loaded into a normalized data store schema by the enterprise spatial system using a loading procedure provided by the client.

The enterprise spatial system provides the client with a scorecard report on each dataset provided to the enterprise spatial system. The scorecard report contains a summary total of the number of policy and policy locations that successfully were processed and loaded. The report also contains the total number of policies that failed to process and the status of that associated failure. Additionally, a complete set of data that failed processing, along with failure result status, is provided to the client.

In certain implementations, a production data store contains the main data store that supports the ESS system services and all associated reporting. The production data store contains policy and landmark data and supporting tables, including, for example: two main spatial layers: landmarks and policies; a third geo-zone layer that defines zone rings per landmark and associated business data (e.g., edited by the administration system); spatial associations between landmarks and policies that are pre-generated to enable data warehouse reporting; period (e.g., monthly) complete data loads; up to five (5) quarters (15 Months) of data that are captured (e.g., on a monthly basis); specific event data that may be stored permanently; and temporal analysis that is expected on the datasets.

In certain implementations, the data is loaded into the operational data store monthly from the ETL process and carries a minimum of 15 months of historical data in addition to the most recent, current data load. The applications and reports work primarily on the current load, but may be run against historical datasets for analysis or temporal comparison. Specific datasets (e.g., possibly limited by region, city or other) are able to be marked for permanent on-line retention. Data greater than 15 months and not marked for permanent on-line retention may be purged to off-line tape storage. In certain implementations, the total amount of physical storage used is limited based on enterprise spatial system data services pricing.

In certain implementations, a physical schema contains tables for: policies, landmarks, event types, coverage, business units, Dun and Bradstreet data; and states worker's comp data. In certain implementations, the main data associations include: policy to coverage, policy to policy details and locations, policy location to coverage, coverage to event damage rates, landmarks to business units, and landmarks to event types. Additional tables may be added to support temporal version control and any supporting tables to house pre-generated periodic report data (e.g., monthly and yearly forecast report data).

In certain implementations, the operations data store contains PL/SQL stored procedure code that contains, for example, Intellectual Property (IP), for the client. The PL/SQL that contains this IP is provided by the client for use in the enterprise spatial system application and data services.

The ETL process stored procedure takes a non-normalized data record and normalizes the data record into the data store schema. Additionally, the ETL process adds any initial, static spatial relationships between the policy locations and landmarks that may be useful. The ETL process calls specialized stored procedures to generate Probable Maximum Loss (PML), landmark ratings, and workers compensation columns of data that are added to the policy data upon loading.

In certain implementations, a PML PL/SQL stored procedure generates the PML value column based on the total policy liability and a formula embodied in the PML PL/SQL stored procedure. The resulting data column is then used by the enterprise spatial system applications to delivery the information to the ESS system service users.

In certain implementations, a landmark ratings PL/SQL stored procedure generates the landmark ratings value column based on the policy and landmark data and a formula embodied in the landmark ratings PL/SQL stored procedure. The resulting data column is then used by the enterprise spatial system applications to delivery the information to the ESS system service users.

In certain implementations, a workers compensation PL/SQL stored procedure generates the workers compensation value column based on the total number of employees for a company and a formula embodied in the workers compensation PL/SQL stored procedure. The resulting data column is then used by the enterprise spatial system applications to deliver the information to the ESS system service users.

The operations data store is maintained by enterprise spatial system data store administration/operations personnel. This administration includes initial setup, periodic updating, data store storage and performance management and backup and recovery.

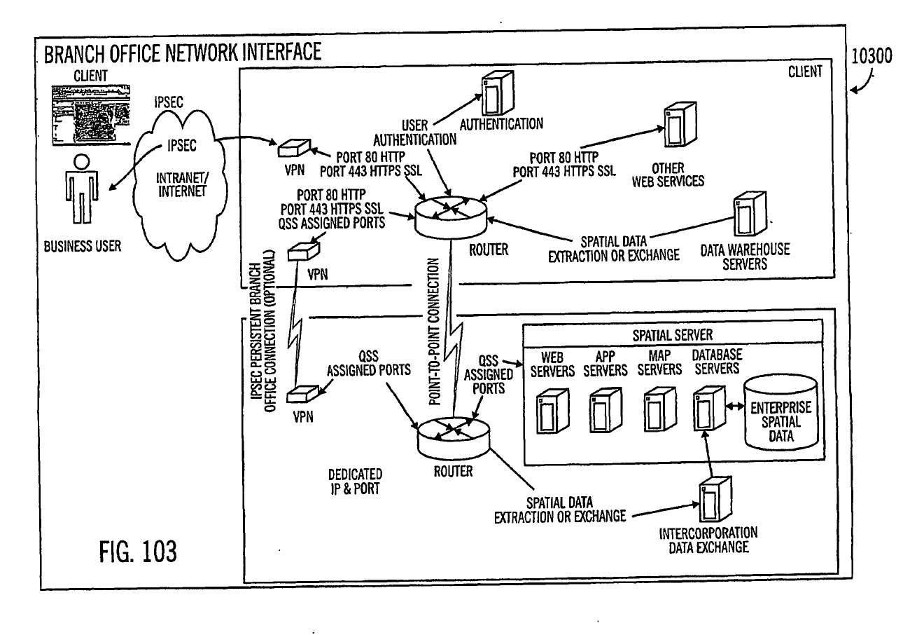

The enterprise spatial system provides infrastructure services. FIG. 103 illustrates a sample network 10300 implementation to connect a client data center and the enterprise spatial system secure data facility to enable real-time access to ESS system services in accordance with certain implementations of the invention.

The enterprise spatial system provides a secure data facility. The enterprise spatial system's secure data facilities were designed to provide high standards of secure data storage and system operation by providing system and structural integrity, complete redundancy, and advanced security solutions. In certain implementations, the enterprise spatial system maintains three data centers in various locations (e.g., Irvine Calif., Also Viejo Calif., and Charlottesville Va.). One of the data centers may be designated a primary secure data facility. In certain implementations, the secure data facility is a $100M state-of-the-art facility designed to provide a secure, liable environment to protect substantial investments in servers, networking, storage, and private data. The design includes redundant power and cooling systems, in addition to world-class hardware with advanced security tools and fast redundant networks.

In certain implementations, the primary secure data facility is an internet data center. In certain implementations, the internet data center may be located in a secure, vault-like facility staffed 24×7, every day of the year. The facility may utilize concrete bunker-style construction in a new, single floor, free standing, 145,000 square foot building. The design and implementation may surpass Exodus 6th generation facility requirements. The facility's physical design may include protection against physical attacks, seismic events, and severe weather. Pre-stressed monolithic slab construction may be utilized to provide enhanced stability and security. The building shell may be constructed with contiguous reinforced concrete to minimize the possibility of illegal entry. External doors and key internal doors may utilize high security steel doors, concrete jams, and bulletproof glass. All mechanical rooms may be completely enclosed and controlled with restricted access.

The facility may utilize tamper-proof infrastructure and equipment. The data floor may be segregated into individual cages that are enclosed on all six sides. The cages may be constructed of steel, instead of wire mesh, with small diameter holes designed to prevent the passage of a single network cable. Access to the area under the raised floor may not be allowed and is restricted to authorized personnel only. Motion detectors may be deployed under the raised floor to ensure compliance. Each cage may be locked electronically and access is restricted by cardkey controls. The facility may be designed to withstand seismic events. All racks, storage frames, and infrastructure equipment may be bolted to the concrete sub-floor to prevent movement during seismic activity.

Restricted access and site security may be ensured 24×7×365 by an onsite security force. The members of this team are dedicated to this site and well trained in its unique operational policies. Internal areas may be physically segregated into security zones, providing different access restrictions based on each area's sensitivity level. Access to all areas may be restricted to a minimum need-for-access level. Cardkeys and biometric palm scanners may be utilized at entry points. Computer controlled security systems with automated mantraps may control key internal entry points. High security monitoring stations with security personnel may be located at each perimeter entry point. Access between the data floor and shipping/receiving or mechanical areas may require escort by security personnel.

The building may be a non-descript concrete building with no external signage. The location may not be advertised and access may be available by invitation only. Also, there may be no known environmental risks in the area.

Comprehensive surveillance and security systems may cover all internal areas and full-perimeter high-resolution cameras monitor the exterior of the building, roof, and grounds. Motion detectors may be deployed in mechanical access areas, ceiling space, and floor space to ensure that these areas are not accessed without clearance.

Security personnel may actively monitor all access and traffic in the facility and external areas. Any items coming into or leaving the facility may be visually checked and, if necessary, inventoried by security. Roving security guards may monitor the site around the clock to facilitate policy compliance and confirm the integrity of site security.

All equipment arriving or leaving the site may be staged in a protected shipping area, inventoried, recorded, and signed for by two parties. On-site security and Network Operations Center (NOC) personnel may manage this process jointly.

The internet data center may utilize a tiered response fire security system consisting of, for example, a FM200 primary suppression system and an integrated dry-pipe suppression system as a backup. A FM200 fire suppression system may be described as a Halon alternative agent uses to protect essential applications traditionally protected by Halon 1301. This agent has many similar characteristics to Halon 1301 and is safe in normally occupied areas. The primary fire suppression system may be implemented using, for example, multiple independent FM200 suppression systems equipped with early warning detectors that monitor the air for smoke or hazardous fire-related gases. If the system is triggered, an audible and visible alarm may be activated in the data center to notify personnel to evacuate the area before the FM200 is discharged. Alerts may be concurrently activated at security and local fire departments. The internet data center's on-site security team may activate plans to protect life, ensure the internet data center is immediately evacuated, and then to ensure the security of the facility. A secondary fire suppression system may be implemented using a dry pipe sprinkler system with high-heat heads. This may be a backup system for the primary and may not activate unless the primary fails. The activation of the primary system proactively triggers the dry pipe system to charge the distribution pipes with water. In the event that the primary system does not extinguish the fire, the sprinkler system may be activated in the area affected by the fire. The high-heat fuse in the sprinkler nozzles inhibits the release of water in each nozzle until the temperature reaches 286 degrees. Each high heat head may activate independently so that water is released in the immediate vicinity of the fire. This primary and secondary fire suppression solution also protects the internet data center's mechanical, telecom, and computer support areas. The administrative offices and common areas may be protected by standard wet pipe sprinkler systems.

The power protection systems may provide completely separate and redundant grids from diesel generators to internal power supplies of the servers, storage, and network hardware. The facility may be located, for example, in the same utility power grid as an airport (e.g., the Orange County Airport). This provides a higher than normal level of grid dependability because of the need of the community to provide uninterrupted power to the airport. To date, there have been no intentional or accidental interruptions in this grid.

The facility may provide facilities for, for example, ten separate, two (2) megawatt diesel generators to be phased into service as power utilization increases, while initially there may be seven (7), two (2) megawatt diesel generators deployed with three generators online in a N+1 redundant configuration. The internet data center may maintain fuel (e.g., 90,000 gallons) on-site stored in underground tanks. This system may provide ten (10) days of continuous power operation at the full capacity load of the site without refueling.

Redundant Uninterruptible Power Supply (UPS) systems may be installed to provide clean regulated power in the event of any loss of utility power, and to provide that power until the generators come online. The UPS systems in place may provide twice the full capacity load of the entire site so that all critical and ancillary systems are protected. These systems and their support infrastructures may be designed to scale with the generators.

The internal power distribution grids consist of redundant sets of A-side and B-side transformers, UPSs, power distribution units, and power distribution circuits so that the power protection system provides true redundancy end-to-end.

Each server rack and Storage Area Network (SAN) frame utilizes multiple power distribution circuits evenly distributed between the A-side and B-side distribution systems. Each server, router, switch, firewall or other device may contain at least two power supplies each connected to a different A-side or B-side Power Distribution Unit (PDU). The devices that were not available with internal redundant power may be deployed as redundant pairs so that the primary and secondary unit is powered by separate PDUs. This implementation ensures the availability of redundant power to all systems. In certain implementations, external power to internal power distribution units may be available 100% of the time.

As for environmental controls, redundant air handlers and coolers may provide target humidity and ambient mom temperatures for each zone in the internet data center. The air handlers and coolers may be deployed in an N+1 redundant configuration. Supply air may be ducted to the data floor under the raised floor and may be forced up through the server rack where extra cooling is needed. The raised floor may be designed with a 42 clearance above the sub-floor so there is no risk that cables, cable trays, and conduit growth would restrict air flow.

The enterprise spatial system maintains a private, secure, and redundant network inside and outside of firewalls. The internal network and the external Wide Area Network (WAN) are fully meshed and redundant networks (e.g., powered by products from Cisco corporation). All production services exist on high-speed DS3 feeds provided by, for example, InterNap with Border Gateway Protocol (BGP) routing. DS3 refers to a 45 Mbs connection. Specifically, the Digital signal X is based on the ANSI T1.107 guidelines. DS0 is the base for the digital signal X series. DS1, used as the signal in the T-1 carrier, is 24 DS0 (64 Kbps) signals transmitted using pulse-code modulation (PCM) and time-division multiplexing (TDM). DS2 is four DS1 signals multiplexed together to produce a rate of 6.312 Mbps DS3, the signal in the T-3 carrier, carries a multiple of 28 DS1 signals or 672 DS0s or 44.736 Mbps. BGP may be described as a protocol for exchanging routing information between gateway hosts, each with their own routers. BGP is often the protocol used between gateway hosts on the Internet. The routing table contains a list of known routers, the addresses they may reach, and a cost metric associated with the path to each router so that the best available route is chosen. Hosts using BGP send updated router table information when one host has detected a change.

This combination allows enterprise spatial system to manage the way the world sees the routes to the secure data facility to provide the highest level of external routing performance to customers.

In certain implementations, the WAN and Internet feeds installed at each secure data center are private point-to-point lines owned by enterprise spatial system and dedicated to enterprise spatial system services. In such implementations, this network is not implemented on a co-located network and no other company shares any portion of the network.

In certain implementations, there is no single point of failure. Network devices: core switches, border routers, segment routers, load balancers, firewalls, and VPNs are deployed in redundant pairs with validated failover performance. Worst-case recovery time during a redundant pair failover was confirmed at two (2) pings, best case was invisible. Also, the WAN segments at the primary site utilize redundant DS3 point-to-point connections to separate InterNap Private Network Access Points (PNAPs) in other locations (e.g., Los Angeles Calif. and Anaheim Calif.) to ensure continuous high-speed service in the event of a local disruption. Each DS3 includes a separate Class C address space and real-time failover is managed through BGP implemented on Cisco 7200 Series Internet Routers. A Class C Address Space refers to the address space of 254 unique addresses and usually refers to external address space provided by Internet service Providers. The enterprise spatial system manages BGP routing rules and maintains private InterNic ASN numbers to ensure the security and reliability of this service. An Autonomous System Number (ASN Number) is provided by InterNic and the Amerimay Registry of Internet Numbers (ARIN). Autonomous systems are a group of IP networks that adhere to a single routing policy and that have a globally unique Autonomous System Number (ASN) in order to exchange exterior routing information and to identify the system itself. ARIN assigns ASNs to organizations for their use in exchanging information with other autonomous systems.

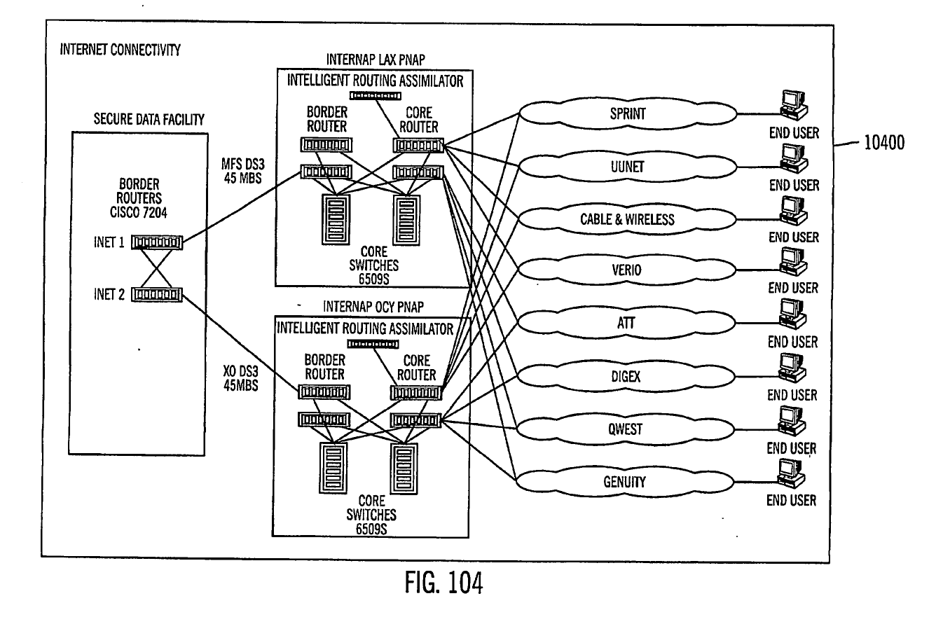

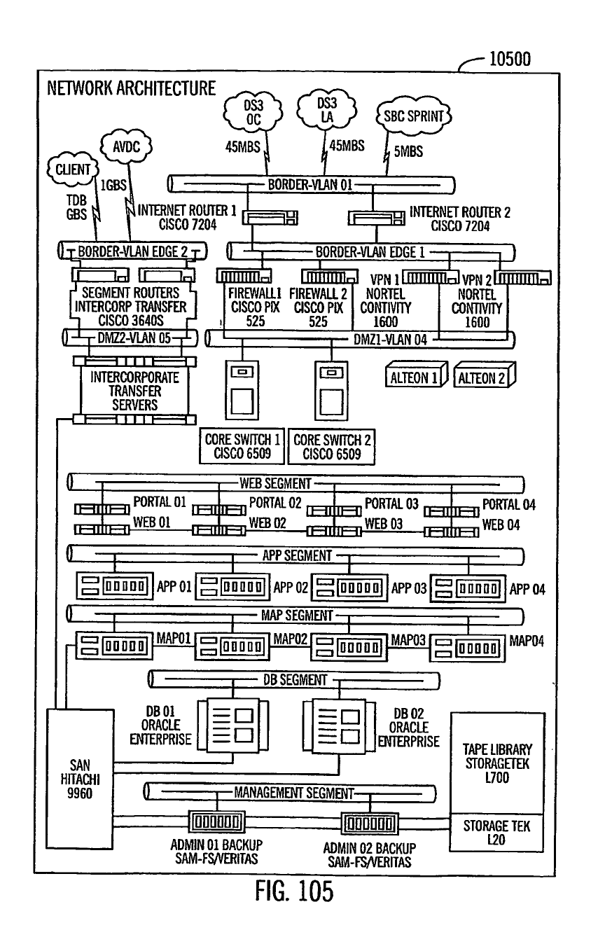

FIG. 104 illustrates an internet connectivity diagram 10400 in accordance with certain implementations of the invention. FIG. 105 illustrates a system architecture 10500 in accordance with certain implementations of the invention.

The enterprise spatial system maintains a third Internet feed via, for example, SBC/Sprint, as backup. This provides an optional dual-entrance and dual-path OC-12 access to the Internet scalable to OC-192 capacity. This feed fully provisioned and terminates in the secure data facility network racks but is not connected to the border routers. OC-12 refers to Optical Carrier level (OCx) 622.08 Mbps. The Synchronous Optical Network (SONET) includes a set of signal rate multiples for transmitting digital signals on optical fibre. The base rate (OC-1) is 51.84 Mbps. OC-192 refers to Optical Carrier level (OCx) 10 Gbps.

In certain implementations, the production system internal network is implemented on core Cisco 6509 switches providing a high-speed switched gigabit foundation with high speed Layer 3 routing integrating into the switch. This system hosts architecture of secure multi-tiered server segments, Demilitarized Zones (DMZs), and border segments, each providing redundant network paths for all servers and network devices. A Demilitarized Zone (DMZ) may be described as a computer host or small network inserted as a neutral zone between a company's private network and the outside public network that prevents outside users from getting direct access to a server that has company data.

In certain implementations, the enterprise spatial system utilized dedicated hardware firewalls on the border of all networks. For example, redundant Cisco PIX 525 firewalls may be utilized at all sites. Firewall routing rules include inbound and outbound access restrictions. All network addresses are translated with NAT (Network Address Translation). NAT may be described as the translation of an Internet Protocol address (IP Address) used within one network to a different IP address known within another network. All internal segments exist on non-routable private address space. All firewall system logs are retained on dedicated system log hosts. All admin access is authenticated and logged by a Terminal Access Controller Access Control System (TACACS). That is, TACACS is implemented to authenticate administrative access to all network devices and records the commands executed by administrators. The firewalls may be licensed with 3DES (data Encryption Standard) encryption providing an additional option for encrypted tunnel Virtual Private Network (VPN) connectivity.

In certain implementations, the production site core switches are built on Cisco Catalyst 6509s to provide multi-layer switching, gigabit scalability, and high availability. The core switches are configured with sets of gigabit fibre and 100 Mbps ethernet blades. All servers have redundant teamed Network Interface Controllers (NICs) and all operational servers have multi-homed gigabit fibre connections. Support and management servers are connected to multi-homed 100 Mbps segments.

The Cisco Catalys 6509s include Layer 3 routing modules integrated into the high-speed backplane of the switch. The tiered architecture of the production server cluster is implemented on these routers. The Web Servers, Applications Servers, Map Servers, and data store cluster each have dedicated segments with access restrictions between segments. This provides the foundation for a concentric ring security model implemented around the core data repositories.

Border routing may be implemented on Cisco 7200 Series Internet Routers, with private DS3s terminate into each of these routers. Private Inter-Corporate segments and dedicated WAN interfaces may be implemented on Cisco 3640 Routers. The switches and routers selected include a fully modular design with over 100 modular interface options. This design selection provides rapid scalability and flexible point-to-point connectivity options to customers. In certain implementations, the network infrastructure supports scaling to 4× the current server deployment. The switches and routers in the internet data center may be dedicated to production servers and may not be shared to provide or support enterprise spatial system corporate infrastructure.

A load balanced server farm may be implemented on redundant Alteon Ace Director 180e load balancers with gigabit interfaces connected directly to the 6509 switch segments. In certain implementations, the VPNs are Nortel Contivity VPNs. This provides persistent inter-corporate connection options including IPsec, authentication header (AH), encapsulating security protocol (ESP), and Internet key exchange (IKE). Nortel Contivity VPNs may be deployed in all data centers providing emergency management access and a backup to dedicated connections.

Core secure data facility network may be available to customers 100% of the time.

In certain implementations, the enterprise spatial system's server architecture is built on a SunONE solution. This includes Sun Solaris, iPlanet Web and application Servers, Veritas Clustering, and Oracle Enterprise DB deployed on flagship Sun, Hitachi, Brocade, and StorageTek hardware. These systems may be deployed in an nTier design with each tier in a protected A virtual (or logical) LAN (VLAN). A VLAN may be described as a local area network with a definition that maps workstations on some other basis than geographic location (e.g., by department, type of user or primary application). The virtual LAN controller may change or add workstations and manage load-balancing and bandwidth allocation more easily than with a physical picture of the LAN. The nTier design allows services to be distributed to dedicated servers so that a specific tier may be expanded independently of other tiers and provides a framework of layers of security around the data store protecting customer data. The tiered architecture includes, for example: front tier Web and portal servers, application servers, map servers, and data store servers.

In certain implementations, server code is implemented in a stateless design. As for a stateless server architecture, stateful means the computer or program keeps track of the state of interaction, usually by setting values in a storage field designated for that purpose, while sateless means there is no record of previous interactions and each interaction request has to be handled based entirely on information that comes with it. In other words, there is no recorded continuity. Each communication is discrete and unrelated to those that precede or follow. An easily expandable server farm is an inherent benefit in stateless server architecture. Because no transaction retains state, the transactions may be spread across multiple servers in a tier. Thus, any number of servers may be deployed into a tier. Increasing processing power involves nothing more than the procurement and deployment of additional servers.

Server performance metrics are collected and monitored to maintain current and historical operational profiles of the system. Tiers or servers are expanded when peak loading would exceed, for example, 50% saturation of any resource when one server in the farm is inoperative. This operational policy ensures crisp application response during peak load even when failures occur.

The enterprise spatial system is well aware that expansion in a 24×7 online operation takes substantial advance planning. All prudent steps have been taken to ensure that expansion of the infrastructure may be performed with very little impact or with no external visibility.

In certain implementations, the front tier sits behind firewalls that restrict inbound traffic to ports 80 and 443 and block outbound traffic. The Web tier serves HTML requests and runs no services that access data. The Web tier may initiate communication with the next tier, the Application Server tier, and this may occur on one port dedicated to Application Server requests. This process continues through each tier so that a breach from the front tier to the Data store tier, if possible, is expected to be a time-consuming endeavor. This time is enough for the intrusion detection systems to activate an effective response.

In order to have no single point of failure, operational servers, including Web, Application, Map, and Data store are deployed in load-balanced farms or clustered for failover purposes. Support servers, such as backup and monitoring servers, are deployed in redundant pairs. For internal redundancy, servers are deployed with hot-swappable boot drives in RAID1 or RAID5, redundant teamed Network Interface Controllers (NICs), redundant load-balanced Host Bus Adapters (HBAs), and connected to 2 or 3 power supplies. Operational servers may also run multiple Central Processing Units (CPUs).

In certain implementations, load balanced tiers ensure that all inbound requests are routed to an available server. This includes inbound HTML requests and tier-to-tier application level requests. The load balancer also performs health checks on each server in the farm and disables traffic to any server failing to respond. This turns a complex distributed processing system into a fault-tolerant environment and reduces the chance that a customer is impacted by the failure of an individual server.

Another benefit of load-balanced tiers is operational control of the transaction traffic in the site. The site may be split into on-line and off-line systems during deployment of system upgrades. This allows the operations group to deploy upgrades and security patches with no risk to the operation of the on-line servers and no external visibility.

In certain implementations, all tiers are load balanced except the Data store tier, which is clustered for dynamic fail-over. This is due to the unique requirements of writing into a transactional data store. The Data store cluster may be implemented under a Veritas Cluster Server. The Veritas Cluster Server monitors cluster resources and their dependencies, including Solaris services and Internet Protocol (IP) address. If any resource becomes unavailable, a failover occurs automatically and transaction processing is continued using a standby node.

In certain implementations, the Web and Portal Servers authenticate site access and serve HTML requests in a secure front tier segment. In certain implementations, the enterprise spatial system prohibits any service that would require data store access into the front tier Web servers. From this network segment, no route to the data store segment exists so that no connection to data may ever be established. All data access is handled by, for example, J2EE application Servers. J2EE may be described as a Java 2 Platform, Enterprise Edition, which is a Java platform designed for the mainframe-scale computing typical of large enterprises. The Web Servers may be implemented on a load balanced farm of Sun SunFire 280R Servers running hardened Solaris 8 and SunONE iPlanet Web Server.

In certain implementations, the Application servers provide a J2EE compliant application service layer. Business logic and data access is controlled from this tier. The Application servers may be implemented on a load balanced farm of Sun SunFire 280R Servers running hardened Solaris 8 and SunONE iPlanet application Server.

In certain implementations, the map servers provide dedicated raster and vector layer rendering with shared SAN volumes for high-speed rendering and transfer to the Web tier. The map servers may be implemented on a load balanced farm of Sun SunFire V480R Servers running hardened Solaris 8 and customized enterprise spatial system and Environmental Systems Research Institute

(ESRI) rendering engines.

In certain implementations, the data store servers may be implemented on a clustered set of Sun 4500 Enterprise Servers running Oracle 8i Enterprise Edition, hardened Solaris 8, and Veritas Cluster Server.

In certain implementations, the enterprise spatial system's storage architecture is built on a SunONE solution constructed of leading edge SAN and Tape software and hardware. All system software and hardware was selected and validated based on its system level performance and fault tolerance capabilities.

The SAN storage and switching systems were selected based on their bandwidth and capacity scalability, their redundant high availability architecture and their support for key software components including, for example, Sun Solaris 8 and SAM File System. System hardware includes, for example, a StorEdge 9960 Large Scale SAN Storage Arrays, StorEdge Tape Library systems, Brocade Silkworm 3800 2 Gigabit Fibre channel switches and Emulux LP9002 2 Gigabit Fibre channel server host bus adaptors.

The enterprise spatial system SAN system hosts multiple file system volumes containing different datasets used by the various system servers in different ways. The different client servers mount file systems volumes both in Read-Only and Read-Write mode depending upon use. The volumes may contain imagery data, application software, data stores, and other types of enterprise datasets. The volumes may be configured based on both the data contained in it and its intended application level use.

The enterprise spatial system SAN based file systems not only operate, but perform and scale in both normal operation and in all possible failure conditions in order to support the high availability architecture.

The enterprise spatial system SAN, switch, and network architectures are designed as high availability. Each of the components between the requesting server and SAN hosted data element are redundant for fault tolerance and no single point of failure. A benefit to redundancy is that it provides double bandwidth capacity for each server in normal operational mode. For example, a single server has effectively four (4) Gigabits of bandwidth to the SAN normally and two (2) Gigabit in failure mode.

Fail-over tests have been run to assure that there is a seamless switchover between I/O paths in the SAN or in the switching fabric. Seamless is defined as no error that impacts application functionality or other visible change except for bandwidth reduction in the case of multi-pathing.

In certain implementations, the enterprise spatial system SAN storage software is SunONE QFS and SAM-FS file system and tape management software. This software was selected for its high performance and fault tolerance capability under high volume, transactional and clustered server loading. Additionally, the unique capabilities of universal storage virtualization allows for long term capacity expansion in any performance dimension and storage hardware configuration required.

QFS and SAM-FS allow for volume virtualization on any mix of on-line, near-line or off-line disk and tape storage. This includes any hardware vendor or physical topology configuration. All possible expansion models have been validated under performance loading and all failure conditions to operate and perform without impact to system operations.

In certain implementations, the enterprise spatial system employs systems and network operations personnel to provide 24×7×365 continuous service operation. Stringent security policies for infrastructure deployment, operations and management are standard practice. These polices protect customer data, system integrity, and corporate assets in this order of priority. These protections extend to the few trusted resources that have administrative access to systems. Access to the secure data facility is restricted to key members of the Systems and Network Operations Group.

The server, network, storage, and security infrastructure was designed and deployed by the Systems and Network Operations Group and enterprise spatial system architects. The expertise required to manage and extend the service offering may be kept securely in-house. Exclusively trusted enterprise spatial system personnel may manage the infrastructure and operations. No outside entity may be given any degree of access or visibility to any production or corporate infrastructure.

Support, routine, and preventive maintenance, and upgrades for infrastructure in the secure data facility are provided. This includes staging and certifying upgrades and security patches through QA/Staging/Production release process prior to deployment.

Network and telecommunications software at the secure data facility is installed, maintained, upgraded, and supported, including maintaining current IOS releases for switches, routers and firewalls. Additionally, coordination with made with local exchange and inter-exchange carriers to maintain agreed-upon performance standards and provide expanded connectivity.

Installation and maintenance activities are scheduled in regularly scheduled off-hour maintenance windows. Customers are notified promptly of any problems that might be expected to adversely affect service availability within established schedules. Maintenance or upgrades which require an externally visible service interruption are rare events and are generally limited to, for example, data store schema changes. When a maintenance or upgrade activity necessitates system downtime, these activities are scheduled at night during the weekend and continue until service is restored.

The enterprise spatial system's Systems and Network Operations Group is responsible for all on-going infrastructure development, planning, support, and maintenance. The group works closely with customers to gather requirements and with vendors in order to offer new technologies and improvements. This group keeps abreast of the latest technologies and specifications not only to provide maximum capabilities but also to remain consistent with all regulatory requirements. As new technologies, components, and solutions are defined, they are validated for their potential use before they are offered to customers.

Multiple monitoring solutions are implemented, operating both internally and externally. External monitoring includes intelligent health checks that implicitly test the operation of all server tiers by executing special health check functions embedded in the front tier Web servers. External monitoring runs in multiple locations to validate operation from multiple network providers. This ensures that enterprise spatial system has constant visibility and awareness of the service level that a customer might experience; and, increases ability to respond to any change, including changes which exist beyond network. Various monitoring systems may be used.

The enterprise spatial system provides intrusion detection. In certain implementations, the intrusion detection utilizes Tripwire for Servers and Tripwire for Networks (Routers and Switches) to monitor systems for unauthorized changes and to ensure that all systems remain in their intended state. Tripwire baselines a system configuration by reading system files and creating a hashed index of the system and application files. Tripwire then compares the baseline to the current system configuration at specified intervals. If any file has changed, Tripwire triggers and sends notifications immediately to the operations and security teams. For example, Tripwire for Servers monitors: production servers, system management servers, data transfer servers, backup servers, source code control and build servers, domain controllers, and exchange servers.

Tripwire also assures the integrity and security of routers, switches and firewalls by monitoring network devices and providing notification of changes to configuration. When legitimate network configuration is completed, Tripwire takes a snapshot of trusted baseline configuration files. Integrity checks are run periodically on network devices to determine if changes have been made. Any change in either the saved or running configuration triggers notifications. For example, Tripwire for networks monitors: firewalls, border routers, segment routers, and core switches.

In certain implementations, a backup and recovery solution is provided. In certain implementations, enterprise spatial system's backup plan uses a combination of SAN, SAM-FS and Veritas Netbackup solutions. SAM-FS provides real-time replication of SAN volumes to near-line storage. Veritas is used to create the backups destined for off-site storage and to maintain images of server system partitions. All critical data, which includes Oracle data files and backups, exist on SAN volumes and are constantly replicated to tape by SAM-FS. All vector data, project data, and customer data is contained in the Oracle data store. The Oracle data files are periodically backed up to a separate, dedicated backup volume by Oracle's Recovery Manger (RMAN).

RMAN's ability to stream multiple channels of data files is used to optimize both the backup process time and enterprise spatial system's Mean Time To Recovery. Furthermore, RMAN compresses data files, backing up only sections of the files that actually contain data and stores the data in a secure format.

SAM-FS ensures that the backups are protected by near-line storage minutes after the file is written to SAN.

Also, Veritas ensures that tertiary backups are vaulted in off-site storage.

The enterprise spatial system maintains off-site vaulting of data (e.g., at Iron Mountain). The storage plan Includes:

rolling alternate backups maintained on-site in near-line tape library. For example, there may be fourteen weeks of rolling weekly backups stored off-site to provide point-in-time copies of data for each week in the previous quarter.

One backup per quarter may be stored off-site, which persists for one year, to provide point-in-time copies of data for each quarter in the previous year. One backup per year may be stored off-site which is not destroyed.

### F. ADDITIONAL IMPLEMENTATION DETAILS FOR INSURANCE RISK MANAGEMENT AND UNDERWRITING

In certain implementations, the application services may be accessed through the portal service and may be co-branded to a client's corporate look-and-feel. Additionally, the risk manager application service may include certain specialized screens for ring analysis, while other application services may be specialized extensions of Web services, reporting services, and admin services.

In certain implementations, the portal application service is the conduit by which users are granted access to individual application services. The portal service provides the user with, for example: login and authentication services, portal home page with role based application service menu options, and session based access to application service sites. In certain implementations, user level personalization may not be required beyond role based menu options. In certain implementations, any personalization information passed back from the authentication mechanism may be used as long as it is not stored in the portal LDAP data store.

When the user connects to the portal, the user may connect over a private branch office connection between an Intranet and the enterprise spatial system data center directly to the portal URL. In certain implementations, direct access from the Internet by users is not allowed. The users use the enterprise spatial system standard login page and authentication mechanism co-branded to their corporate Web style sheet. Once a user provides authentication criteria, the authentication criteria is verified against the LDAP data store and, if the provided authentication criteria matches, an associated user session is created for the user. The user session, associated user role and any available personalization information is returned to the portal system to then help direct the generation and presentation of the main portal page for that user.

The authentication criteria may be a standard username and password restrictions. Each user is identified in the LDAP and enterprise spatial system administration system as a combination of a company and user name. This ensures that user names are unique within a given company, but may be reused by other companies. This means that the list of unique companies configured in the admin system are distinct.

Usage restrictions may be applied at the application service level. This means that any valid user may authenticate into the main portal page without being rejected due to lack of available licenses. In certain implementations, license level usage rights may be applied against the application services accessed from the main portal page.

Each link on the main portal page directs the user to an application service. The application services that the user has rights to based on the user's role are displayed for selection. At the point that a user selects an application services link from the main portal page, a usage restrictions check is made to ensure that there are currently sufficient user licenses available to access that particular application service. If not, the user is presented with a “Licenses exceeded. Please try again later.” message.

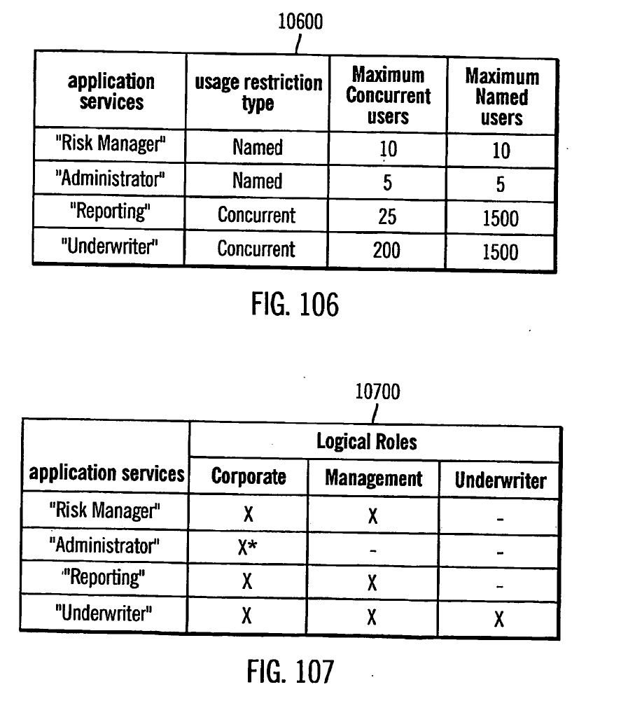

Each application service may have its own pool of available users and restriction models. FIG. 106 illustrates a table 10600 of application services in accordance with certain implementations of the invention.

The user roles work in conjunction with admin application enforced access control on both functionality and data, portal enforced role based UI control, and database enforced user account access control.

The admin application may be used to configure what roles have access to what application services and over what user account that user gets access to data. Application services configured using the admin application service may define what functionality is exposed by the portal to the user and then what data and function level access control is enforced on a click-by-click level once the user is logged in. Physical roles may be configured with varying access rights.

FIG. 107 illustrates a table 10700 of portal application service assignments in accordance with certain implementations of the invention. In certain implementations, there may be two roles for corporate—one has admin access, and the other does not.

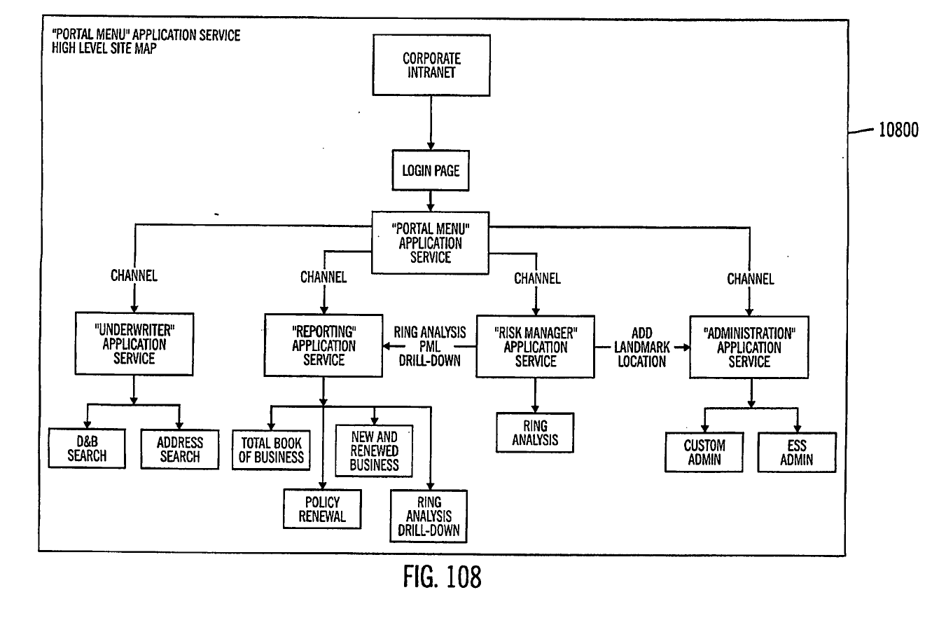

The co-branded portal may be configured with a screen flow that is used to navigate between each of the application services. FIG. 108 illustrates a top-level portal site map 10800 in accordance with certain implementations of the invention. Portal site map 10800 illustrates application service links from the main page and the general areas of functionality provide under each.

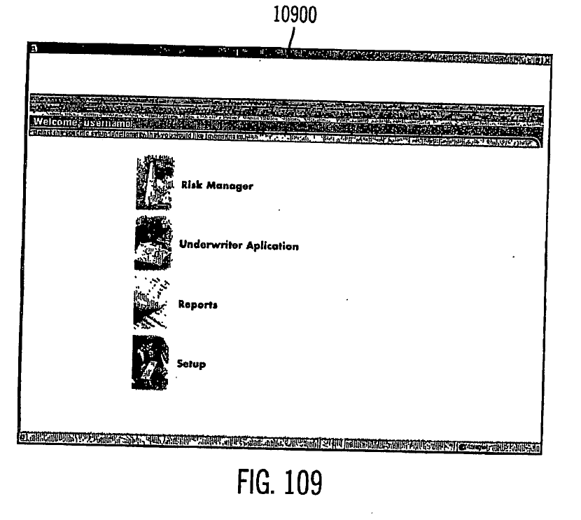

Once a user has authenticated into the portal system, the co-branded main portal menu page is displayed containing links to the application services. The list of application services exposed to the user is defined by the user's role. FIG. 109 illustrates a screen 10900 of a set of features available for the corporate risk manager user in accordance with certain implementations of the invention.

From the portal menu, the user may link directly to any of the external application service sites and additional portal menu pages that they have access to. In certain implementations, when an application service link is selected, the user's usage restrictions for that application service are checked, and the user is allowed to proceed if the usage limit has not been exceeded. If no free users are available, the user may be notified and may remain on the portal menu. The user is free to go into any application service that they have a menu option for and that has not yet reached its usage limit.

A successful link to an application service carries session and user profile information established when the user completed the authentication into the main portal menu page. Subsequent application service menu pages and sites may be co-branded in a manner consistent with the main portal menu page.

The banner header for portal menu pages for the portal may be co-branded in the same manner. For example, the top left corner may display the client's logo and serves as a click-point to return to the main portal menu page. Each menu screen displays a screen title appropriate for the particular menu's contents. The Powered By (e.g., enterprise spatial system) logo is shown in the top right of the screen. The color schema and boarder bitmaps show the client's corporate color scheme.

User personalization on the main portal menu page includes the user's name. This information is provided back to the portal, along with the user role, when the authentication process is complete, and the user session is officially created.

The menu options displayed to the user are represented by both an icon and text description. The icon and text may show a slight visual shift during mouse over so the user is aware of the click location for that particular menu option. The menu options that the user is allowed to see based on the user's role are displayed and accessible.

The risk manager link allows the user to go to the main application co-branded and customized as the risk manager application service.

The underwriter link allows the user to go to the underwriter application service co-branded and customized on enterprise spatial system Web services integrated with the client's data.

The reporting link allows the user to go to the reporting application service. The reporting application service may be additional portal page co-branded with links to a customized site built on the enterprise spatial system reporting service and integrated with the client's data store and associated Relational On-line Analytic Processing (ROLAP) drill-down structures.

The setup link allows the user to go to the admin application service. The admin application service may be an additional portal page co-branded with links to the enterprise spatial system admin services and a customized data store administration site.

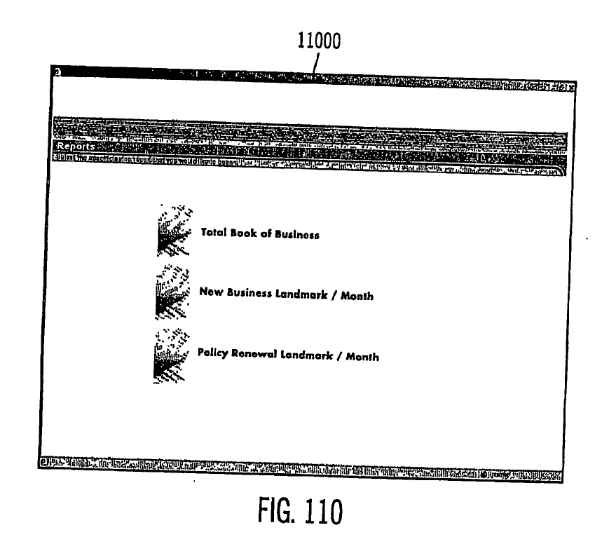

The reporting application service may be made up of a portal reporting menu page with parameterized links that connect to the customized enterprise spatial system reporting service site. This site may be a preconfigured set of report templates that allow the user to select one of three (3) report drill-down branches. FIG. 110 illustrates a screen 11000 that shows the reporting menu page and its associated links in accordance with certain implementations of the invention. Once one of the three links has been selected, the subsequent report screens are generated by the reporting service based on data and parameters selected by the user from drill-down context.

The total book of business link allows the user to go to the total book of business drill-down report. The link may contain the preconfigured report template identifier as a parameter for the reporting service to then generate the report.

The new and renewed business link allows the user to go to the new and renewed business drill-down report. The link may contain the preconfigured report template identifier as a parameter for the reporting service to then generate the report.

The policy renewal link allows the user to go to the policy renewal drill-down report. The link may contain the preconfigured report template identifier as a parameter for the enterprise spatial system reporting service to then generate the report.

The admin application service may be made up of a portal administration menu page with links that connect the user to either an enterprise spatial system admin service site or a customized admin site. The enterprise spatial system admin service site provides the user with access to the customer delegated administration screens that allow the user and role administration for that particular customer. The client's customized admin site provides the user with the ability to manage data store setup tables in three (3) groups: events, landmarks and business tables.

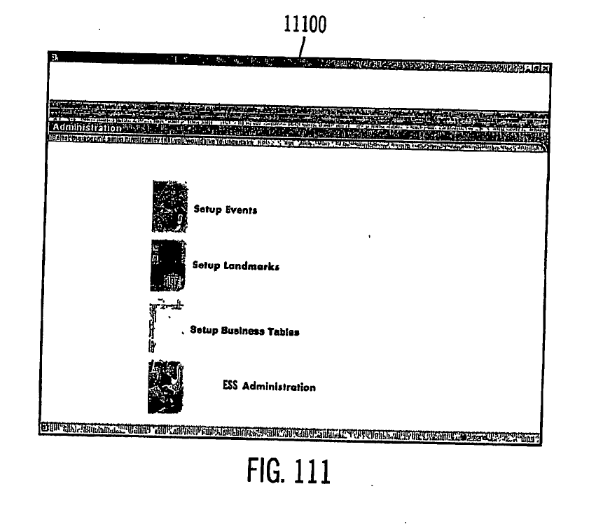

FIG. 111 illustrates a screen 11100 that shows an ESS admin menu page and its associated links in accordance with certain implementations of the invention. Once one of the four links has been selected, the screen flow branches to one of the two administration sites. The setup event types link allows the user to go to the event type list administration screen and view/modify an event type's settings. View and modification of the event types, total loss and ad hoc, are allowed.

The setup landmark link allows the user to go to the landmark list administration screen and view/modify landmark settings. In certain implementations, adding landmarks to the landmarks list is done through the risk manager application service ring analysis function, rather than from landmark setup. The setup business tables link allows the user to go to the business table administration screen and add/modify entries for the key supporting business table in the data store. The administration link allows the user to go to the admin service site. In order to manager users and roles, the user will have to authenticate with a higher level of authentication criteria.

In certain implementations, the risk manager application service is a specialized, insurance industry application. The enterprise spatial system service provides a co-branded user interface with data presentation and ring analysis features configured for risk manager users to use as part of their business workflow.

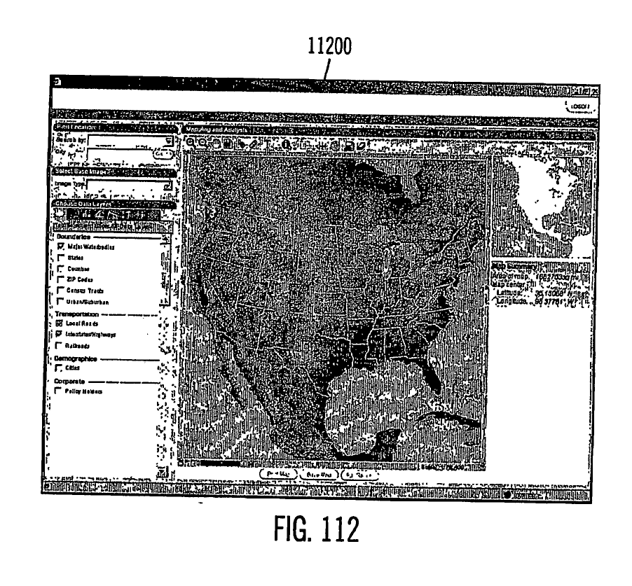

The main risk manager application service screen is an application main screen that is displayed upon selection of the risk manager option in the main portal menu page. The risk manager is licensed to clients under a named user license model, which means each user has a license reserved for them and is not rejected for lack of licenses when attempting to access the application service. On the other hand, the admin user may be notified and denied if the maximum licenses have been exceeded upon attempting to assign a new user to a role that includes the risk manager application service. The main screen contains a set of adjustments for each client, for example: co-branding, layer, search by, point n′ view, fill report and ring analysis function configurations. The standard application and tools in the screen layout may be adjusted to show corporate standards for banner headers, logos, and color scheme. FIG. 112 illustrates a screen 11200 in accordance with certain implementations of the invention.

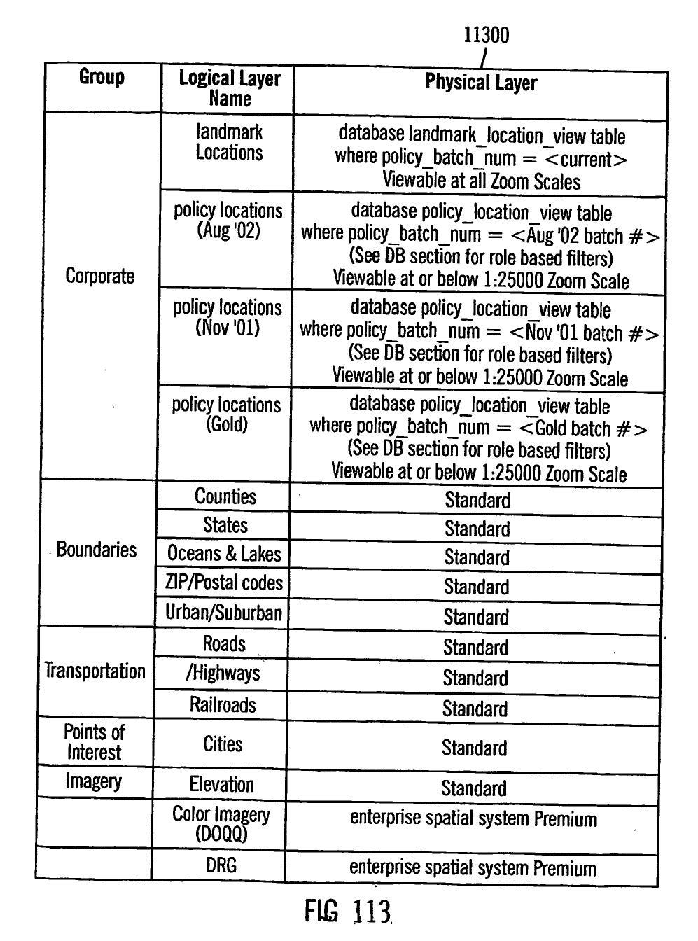

Corporate data layers are made of the standard enterprise spatial system data layers plus a set of corporate data layers that provide access to landmark and policy location data. FIG. 113 illustrates a table 11300 of data layers in accordance with certain implementations of the invention. The policy location Zoom scale of 1:25000 is an estimate and may be adjusted based on view of Manhattan in New York.

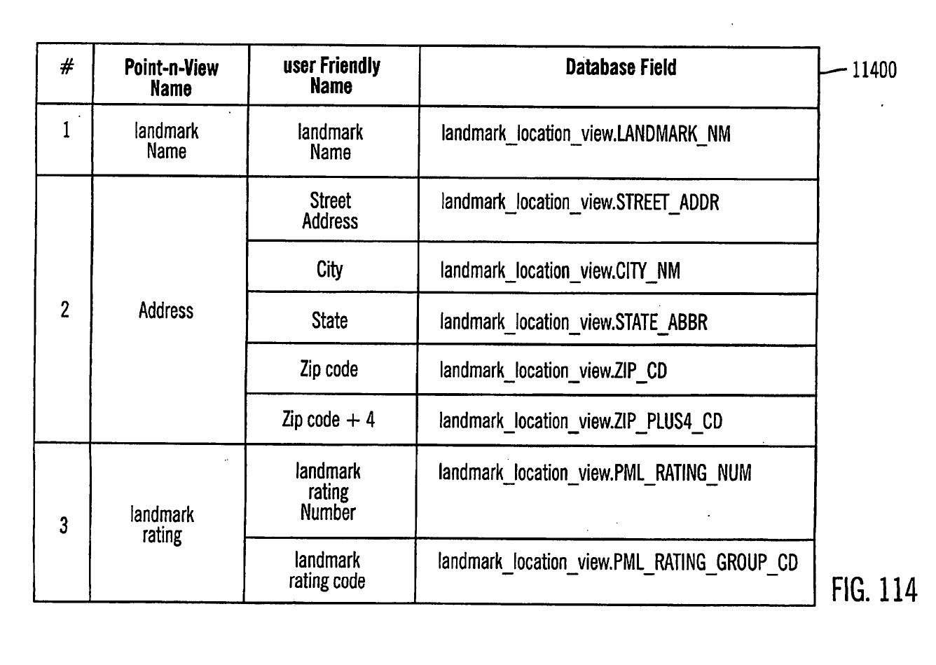

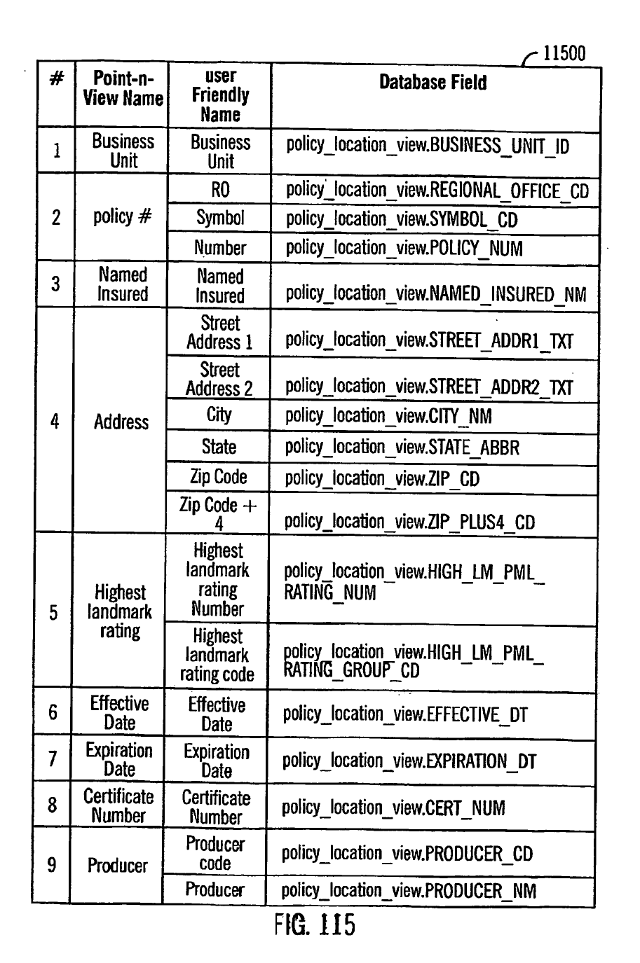

In certain implementations, two point n′ view configurations are provided for the two layer types that are supported: landmark locations and policy locations. FIG. 114 illustrates a table 11400 of landmark location fields in accordance with certain implementations of the invention. FIG. 115 illustrates a table 11500 of policy location fields in accordance with certain implementations of the invention.

In certain implementations, both the landmark locations and policy locations layers support all available data store view columns in their respective Full reports.

This risk manager application service may be used for ring analysis on individual landmark locations and their ring-by-ring relationship to policy locations. The ring analysis process is used to find a set of policy locations within a given proximity to the selected landmark location and then generate PML data on which the risk manager does analysis and policy detail drill down.

In certain implementations, the PML value determination process takes into account the set of policy locations in a given landmark's event ring zones before assigning a PML value to any one of the individual policy locations in the set. Therefore, any one parameter that may affect the number and position of policies included in the evaluation causes the PML process for that given landmark to be reassessed.

PML procedures are used by the risk manager application service to generate PML values. The PML procedures include a session-based option to enable the generation of PML data from a given landmark on-demand or in an ad hoc manner. The ad hoc PML process supports ring analysis on a single landmark location, and associated policy locations, where one or more of the ring analysis parameters are different from those used in the periodic (e.g., monthly) ETL process.

Two parameters that may differ between the periodic ETL and on-demand ad hoc processes are the location of the landmark and the number and/or dimensions of rings used in the ring analysis. Both parameters affect the list of policy locations that are included in the PML calculation process.

The ring analysis process allows for either of the two parameters to be adjusted in any combination desired and the associated PML data and drill-down reporting to be generated and provided.

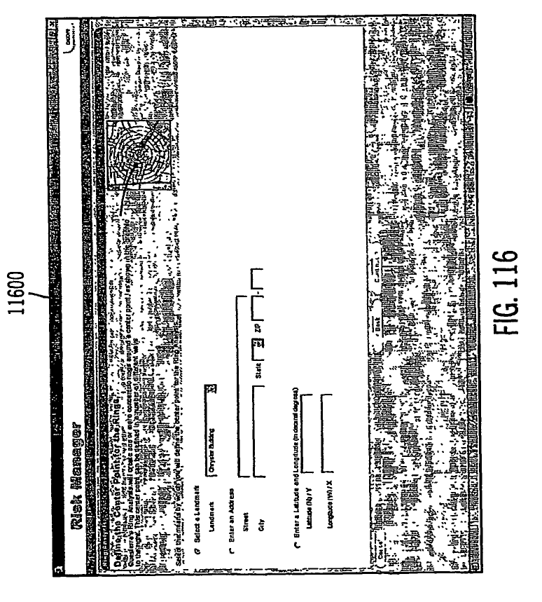

FIG. 116 illustrates a ring analysis wizard screen 11600 in accordance with certain implementations of the invention. The ring analysis process is implemented with the wizard based process when the ring analysis function is selected using a tool bar button or an option from the sub-menu option under the business analysis menu. In certain implementations, the forward and back tools do not display ring analysis and projects do not save ring analysis.

When the user selects the ring analysis function, from either the tool bar or menu, the ring analysis wizard is launched and displays the first screen H1100 in the wizard for center point selection. In certain implementations, the center point selection screen may be a modal dialog that provides the user with three (3) radio button options in which to select the ring analysis center point. The default radio button selection may be Option 1: Select a landmark.

The ring analysis wizard screens may be co-branded in a manner consistent with the client's corporate intranet. The title, banners, Powered by (e.g., enterprise spatial system) logo may be consistent with the main portal menu page layout. The main screen frame may be appropriately titled and follows with a general description of the reason and use for the center point selection screen.

The select a landmark option allows the user to select one of the landmark locations that are found in the landmark locations layer. The landmark location dropdown may be populated will the names of the landmarks from the landmarks layer, plus one blank entry. The default selection may be the blank entry, and select a landmark may be the default selected Radio Button.

The Enter an Address option allows the user to manually enter an address of a location for the landmark in question. This address may be geocoded on the fly and any error in the geocoding process reported to the user to influence correction in the address data to allow eventual successful geocoding.

The Street Entry field is a text data entry field that is, for example, 64 physical characters, 40 displayable characters and horizontally cursor scrollable. In certain implementations, the Street 1 Entry may have a minimum of 3 characters and may not contain a percent character ‘%’. The default is empty.

The City Entry field is a text data entry field that is, for example, 50 physical characters, 30 displayable characters, and horizontally cursor scrollable. In certain implementations, the City Entry may have a minimum of 3 characters and may not contain a percent character ‘%’. The default is empty.

In certain implementations, the State Dropdown may be populated with the standard 50 US states plus one blank entry to allow the user to select a state to include as search criteria in the Find Company query. The default is empty.

The ZIP Entry field is a two-part text data entry field. The first ZIP Entry may have a minimum of 5 characters and may not contain a percent character ‘%’. The first ZIP entry is separated from the second box by a - (hyphen). and the ZIP+4 extension is optional. If this second field is completed, however, it includes 4 characters and may not contain a percent character ‘%’. The default is empty.

The Enter a Latitude and Longitude (e.g., in decimal degrees) option allows the user to manually enter the location coordinates for the landmark in question. This coordinates may be verified as true latitude and longitude values for the 50 United States. Errors in the entry may be reported to the user for correction. The Latitude Entry is a numeric entry field, and the default is empty. The Longitude Entry is a numeric entry field, and the default is empty.

The Continue Button closes the dialog and displays a next ring analysis wizard screen (i.e., screen 2 dialog). If the Radio Button Option 4 was chosen, the manual selection dialog is displayed prior to the screen 2 dialog. The parameters entered in the manual selection map view (also referred to as screen 1 dialog) are carried along to the next wizard screen.

The Cancel Button closes the dialog, discards the selections and entry data, and returns the user's context to the main application screen.

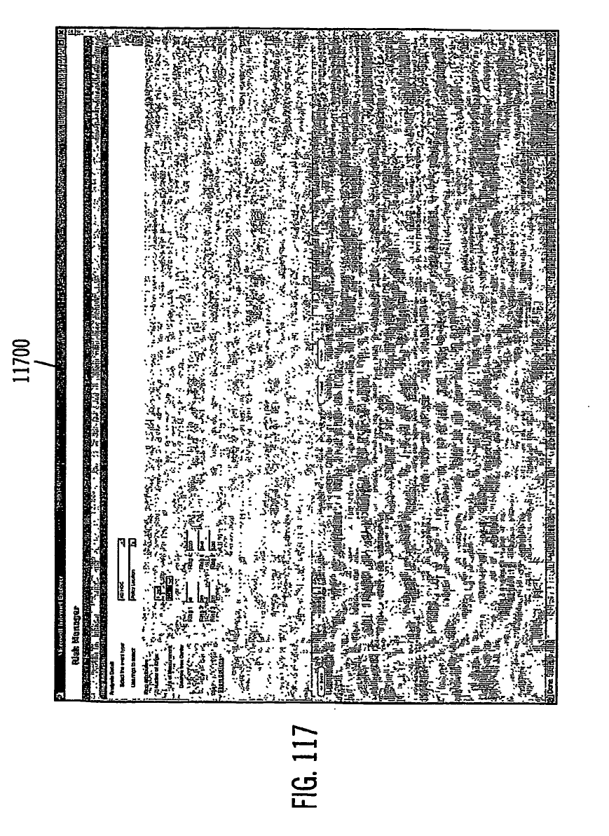

FIG. 117 illustrates screen 2 11700 in accordance with certain implementations of the invention. After the center point selection is complete, the wizard displays the ring analysis screen from which the user may select the ring analysis details to use. The ring analysis parameters screen displayed is defined as follows: the analysis details selection screen may be a modal dialog that provides the user with the ability to select an event type with a preconfigured set of ring dimension and the layer that the ring analysis may be performed against. Additionally, the user may readjust the ring number and dimensions if the ad hoc event type is selected.

The analysis details frame contains the elements that the user may configure related to the ring dimensions and target ring analysis layer. These parameters are controlled by the event type dropdown and target layer selection dropdown. The total loss is a data store driven event and may be referred to as building collapse. The event type parameters are populated from the event_type and event_type_zone tables in the data store. Both of the event type parameter sets may be configured by the admin user using the admin application service. The default value displayed in the event type dropdown is the ad hoc option.

The ad hoc event type option contains default ring dimensions that were entered using the admin application service. The user may choose to keep those parameters or override them with new ones. The user may specify the number of rings and the distance from epicenter for each of those rings. The changes made by the users are maintained during the ring analysis session and then discarded after.

The user may not select more rings than are available with the ad hoc event type due to the fact that the user may not specify damage rates per coverage type for rings that are added. The damage rates are required to be able to generate the PML values that are the basis of the analysis summary and PML drill-down. For the user to add additional rings, the user contacts a user that has access rights to the admin application service and has the admin user add the additional rings to the ad hoc event type as the defaults that may be shown in this screen. The admin user may then add the required damage rates so that the PML calculations may be run. If a user inputs into the ad hoc, chooses total loss, then goes back, the original inputs for ad hoc may be gone.

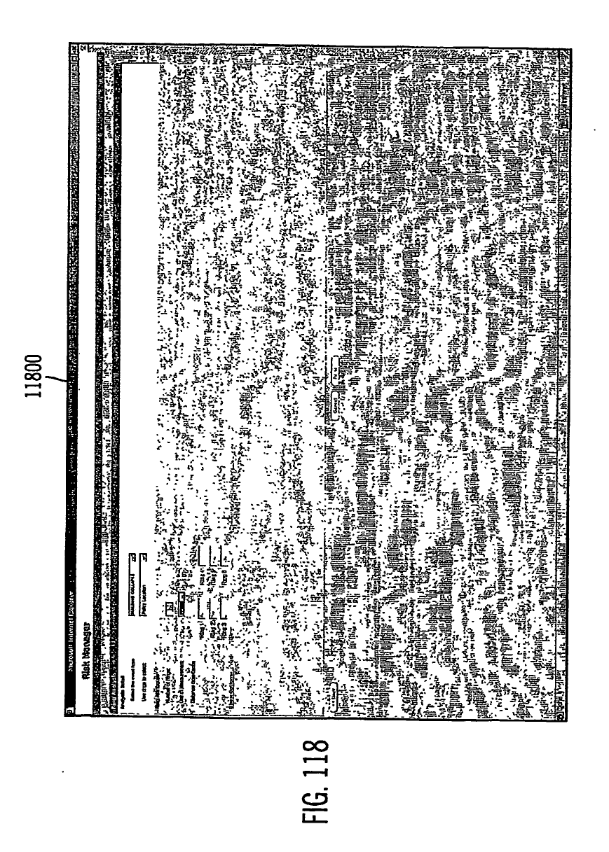

The total loss event type option, like the ad hoc option, may contain default ring dimensions that were entered using the admin application service. Unlike the ad hoc option, the user may not change any of the ring dimensions for the total loss option. FIG. 118 illustrates a screen 11800 in which the Ring Attributes section is disabled in accordance with certain implementations of the invention. When the total loss option is selected, the Ring Attributes section of the dialog frame is disabled for user entry as shown in FIG. 118.

The Rings to Select dropdown contains the layer that the ring analysis option may be performed against. The policy location layers are displayed in the dropdown. An attribute on the layer configuration indicates that the layer is available for ring analysis. The default value displayed in the Use Rings to Select dropdown may be the most current policy location Layer available.

If the user had selected an existing landmark on screen 1 and then selects the total loss event type and finally chooses a policy location layer that is not the current layer, the user is indicating that the user wants to look at a historical landmark ring analysis. In this case, the event type Ring Attributes from the matching batch number are reselected, and the screen is updated to reflect the total loss parameters at that time.

If the selected landmark did not exist or no landmark ring data was generated during that batch load, the selection may be considered a temporal ad hoc and the policy location and event type data from that historical batch may be used.

The Ring Attributes frame contains elements that control the ring analysis ring dimensions. These attributes include the Numbers of Rings, Unit of Measurement, and Spacing from Center elements. Each element controls a different aspect of the ring dimension and is mapped to the elements in the event_type_zone table in the client's data store.

The Number of Rings dropdown may be populated with a number from 1 to 10. When the event type is selected, the number of event_type_zone records associated with the event type is counted and then the default value set to that number in the Number of Rings dropdown. The default value displayed in the Number of Rings dropdown is the number of rings defined in the event_type_zone table for the ad hoc event type.

The Unit of Measurement dropdown has two different values in populated in it: Feet and Miles. The dropdown is set to the measurement_units field in the event_type table in the client data store when that particular event type is selected. The default value displayed in the Unit of Measurements dropdown may be the measurement_units defined in the event_type table for the ad hoc event type.

The Spacing from Center entry elements contain the distance from the landmark center point at which to draw each consecutive ring as specified by the Number of Rings dropdown. The number of rings that are specified are displayed as entry boxes. Each entry element is labeled with its associated ring number. When the Continue button is selected, the data elements entered are checked for validity. For example, each consecutive ring dimension is expected to be larger than the previous and the last ring does not exceed 3 miles. The values in the radius_in_feet field of the event_type zone table are stored in feet. The value entered in the Spacing from Center entries are converted to and from feet based on the Unit of Measurements selection. The default value displayed in the Spacing from Center entries are the values defined in the radius_in_feet field of the event_type_zone table for the ad hoc event type.

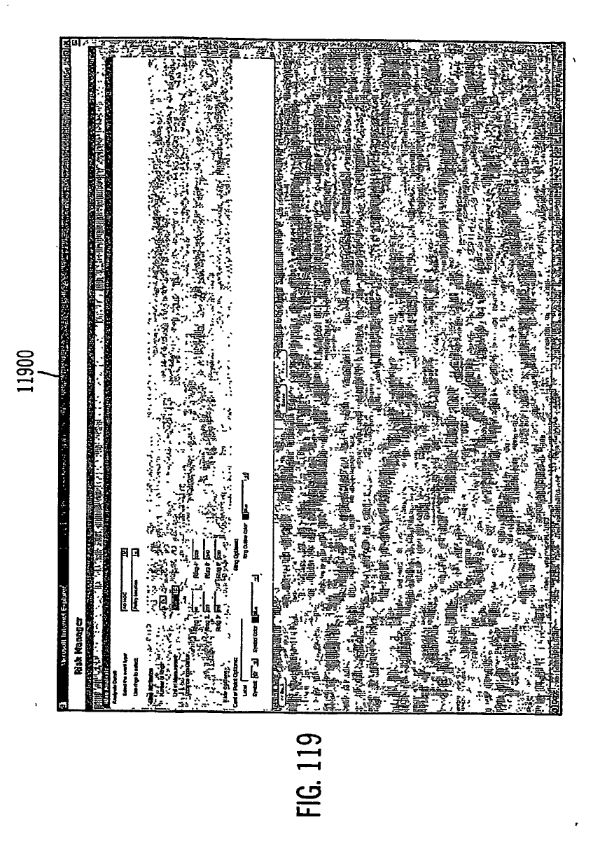

FIG. 119 illustrates a screen 11900 with the expanded Show Options link in accordance with certain implementations of the invention. The Show Options link allows the user to see an additional pair of user inputs that include a center point Name entry, a center point icon selection dropdown, icon color drop down, and ring color drop down. The user may enter the name of the selected landmark center point, assuming it was not picked form the landmark layer dropdown, and pick the particular icon desired to represent the center point or epicenter of the ring analysis. The default name is either blank or whatever the name of the existing landmark is. The default icon is a yellow star with a thin black border. The Show Options link will change to Hide Options when the options are displayed.

The Back Button closes the dialog and then redisplays screen 1 of the wizard and returns the user's context back to the landmark center point selection. The previously selected and entered elements from screen 1 are reestablished to the point where the user had clicked Continue on that screen. The Continue Button closes the dialog, runs the ring analysis Process with the selected parameters, and then displays a ring analysis results wizard screen 3. The Cancel Button closes the dialog, discards the selections and entry data, and returns the user's context to the main application screen.

The ring analysis process takes the parameters selected by the user and passes them to the ring analysis stored procedure that, if required, performs a spatial query on the selected layer and then passes the results to the PML stored procedure provided by the client. The result of the ring analysis is passed to the ring analysis Results and Summary screen in the main application. This process allows the user to immediately see the results plotted on the map display, view PML totals in the Analysis Summary view, and then drill down through multiple aggregate levels to policy location details.

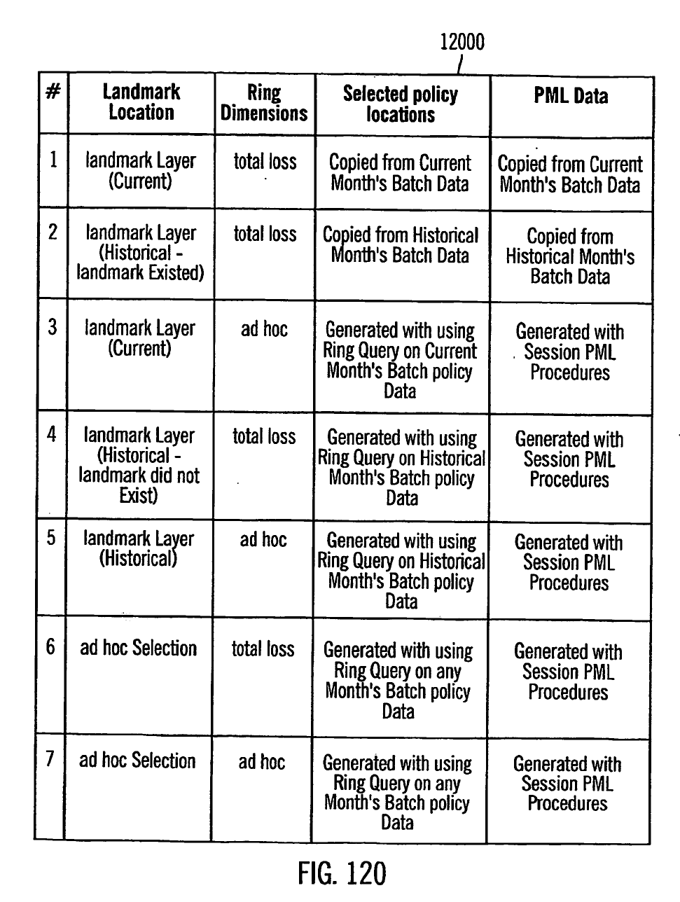

The ring analysis stored procedure may take into account the different options available to the user in how the results are located or generated. Depending upon the configuration selected by the user, some differences related to the processes may apply. FIG. 120 illustrates a table 12000 of different scenarios that may be requested by a user in accordance with certain implementations of the invention.

If the user selects options 1 and 2 (existing landmark using the total loss event type) from table 12000, the required data is copied from the dataset that was generated during the periodic ETL process instead of generating it on the fly. The data copied includes the set of policy locations identified from the spatial ring query and the associated PML value calculated for those locations on a coverage-by-coverage basis.

If the user selects any of options 3 thru 7, then one or more of the parameters that affect the PML calculations have been changed and therefore no data exists to copy from the periodic load. The ring analysis stored procedure may then perform the spatial query and use the client's stored procedure for the PML values.

Depending upon the diameter of the outer ring of the ring analysis or the density of the number of policy locations found in the spatial query results set, the process of generating the results for display may take some time. The user may be notified to wait for the results.

Some of the data that is required for the periodic ETL process is not available for the on-the-fly version so these values are fixed. In certain implementations, the following limitations may be used in the implementation and not modifiable by the ring analysis user: landmark CAP may be equal to total the PML for a new landmark, landmark PML adjustment factor may be zero for a new landmark, maximum number of rings limited to ad hoc event type, and damage rates may be from ad hoc event type.

The ad hoc ring analysis Ring Dimensions and resulting ring analysis results may be temporary and may not be saved outside of the ring analysis session. The ad hoc event type parameters (other than Ring Dimensions) may be administered using the admin application service and included as part of the existing landmark and total loss event type configurations during the next periodic batch ETL process.

The ring analysis data and PML information may be stored in a set of Session based tables that allow the user to maintain the state of the results between the ring analysis screens and the Analysis Summary and PML Drill-Down screens. This session data may be cleared before each ring analysis is run and also when the session is cleared by the user logging out or the session cleanup process runs.

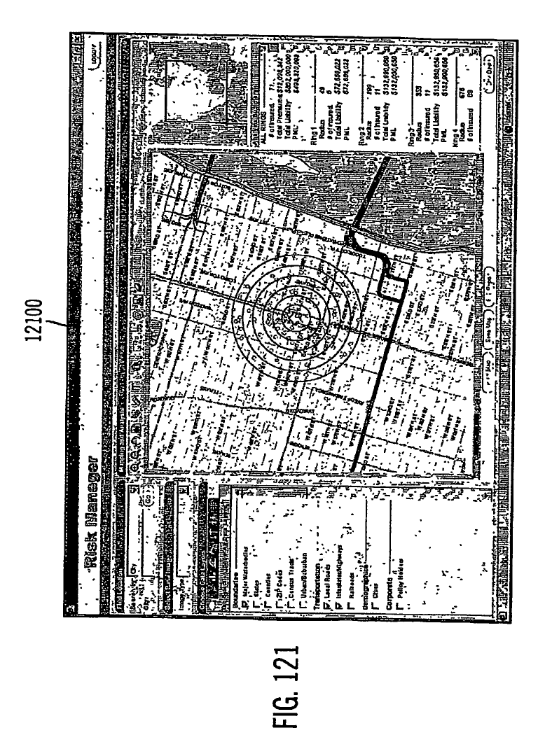

FIG. 121 illustrates a ring analysis Results and Summary screen 12100 in accordance with certain implementations of the invention. The ring analysis Results and Summary screen is displayed once the PML generation process is complete and the associated data is available to display. When the data is ready to display, the wizard displays the results including the map view with the ring analysis along with the Analysis Summary report.

The ring analysis results are displayed in the main application with the center point, Rings and policy locations plotted on a Map Image frame as was configured prior to the ring analysis being initiated. The Analysis Summary report is displayed on the right under the Map Summary information frame. Additionally, two buttons are provided at the bottom right of the screen: Save landmark and Drill-Down. The Save landmark may or may not be displayed depending upon the ring analysis parameters.

The Map Image frame contains a map image of the ring analysis results plotted over the top of the map view that was configured prior to the initiation of the ring analysis function. The ring analysis results include the landmark center point, Rings, and Selected policy locations. The user may be zoomed into the landmark and is shown all rings plus, for example, 15% extra map area.

The landmark center point plotted shows the location of the center of the ring analysis that was selected in screen 1 of the wizard and be displayed with the icon selected using the Show Options link.

The Ring dimensions selected in screen 2 of the wizard are plotted around the center point based on the specified distances. For example, ring pixel width may be 1. The rings are displayed to the user by zooming and panning to the landmark, showing the outer most ring plus, for example, 15%.

The Selected policy locations that were identified using the spatial query stored procedure are then plotted as a selected set of points using the application standard presentation for selected points in a given layer.

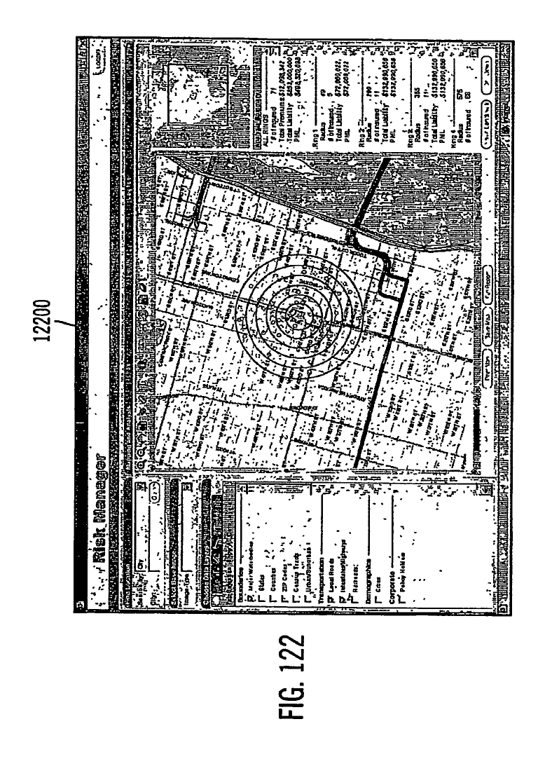

The Save landmark button provides the user with the ability to save the center point of the ring analysis to be saved as a new landmark in the landmark layer. The Save landmark button appears when the proper conditions are met and is displayed in the lower right of the screen beside the Drill-Down button as shown in FIG. 122. FIG. 122 illustrates a screen 12200 in accordance with certain implementations of the invention. The user is presented the Save landmark button if the following conditions are true: the user has the rights to the admin application service; the user did not select an existing landmark from the landmark Layer as the center point; and he user selected the total loss event type. If any of the criteria required are not met, the Save landmark button is not displayed to the user, and the user is not allowed to save the landmark as a new landmark.

When the user selects the Save landmark button, the setup landmark screen from the admin application service is displayed. However, unlike the admin version of the screen, the Update button may be changed to a Save button, and the landmark may be inserted into the landmark layer. The admin version of the screen allows the user to select an existing landmark and modify its parameters.

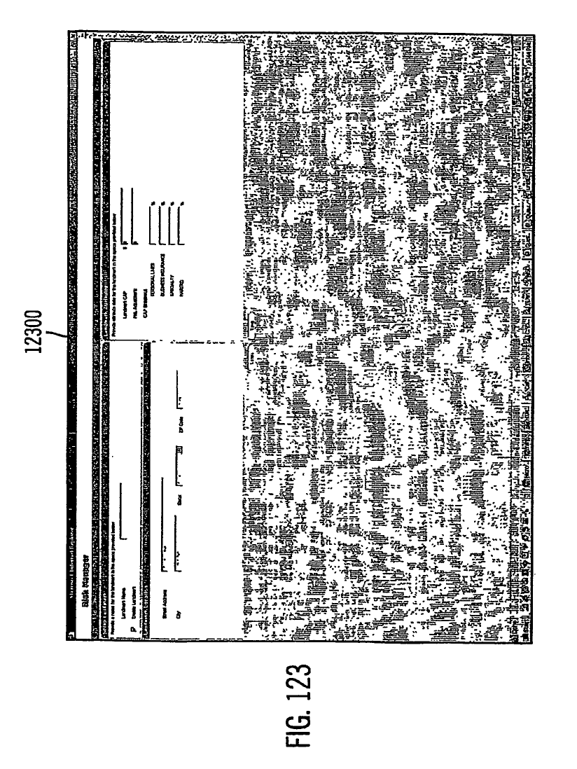

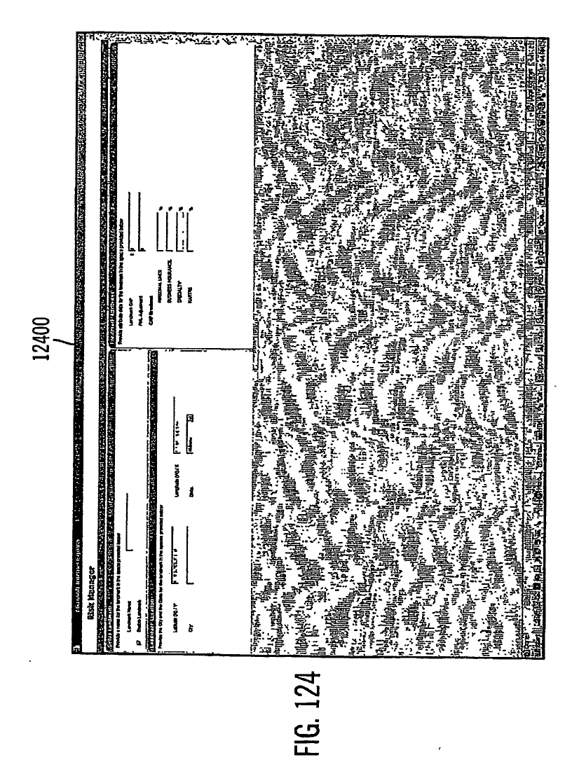

The new landmark does not have complete PML data generated for it for the current month of policy data and is not included as an active landmark until the next periodic ETL process is run. The new landmark name may be unique. FIG. 123 illustrates a screen 12300 of a save landmark address example in accordance with certain implementations of the invention. FIG. 124 illustrates a screen 12400 of a save landmark latitude/longitude example in accordance with certain implementations of the invention.

The input for landmark name does not need to be unique (e.g., City and State may be used to differentiate). In the case of an address created landmark, the address information is carried over from the ring analysis (disabled). In the case of a latitude/longitude created landmark, the latitude and longitude information is carried over from the ring analysis (disabled), however, the user may input City and State information (as it is used to differentiate between multiple landmarks with the same name. For landmark attributes: CAP default is 0 and user may change; PML default is 0 and user may change; and,

CAP Breakout may range from a minimum of 0 to a maximum of 100, where, for example, four divisions may add up to 100%.

The record in the LANDMARK_EVENT_TYPE table holds the landmark CAP and the PML Adjustment Factor. The table is also the Parent table to the LANDMARK_EVENT DIV CAP. A record is inserted in the LANDMARK_EVENT_TYPE table where EVENT_TYPE_ID=(SELECT EVENT_TYPE_ID FROM EVENT_TYPE WHERE EVENT_TYPE_DESC=‘BUILDING COLLAPSE’). One record is inserted in the table, and no record is required for the ‘ad hoc’ event type.

Additionally, the latitude, longitude, and Geocode Status fields may be displayed below the address.

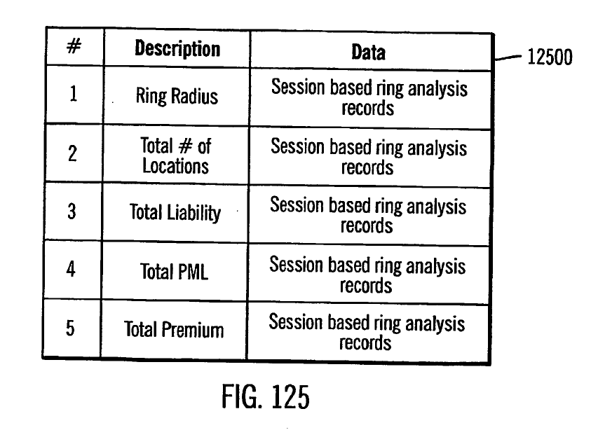

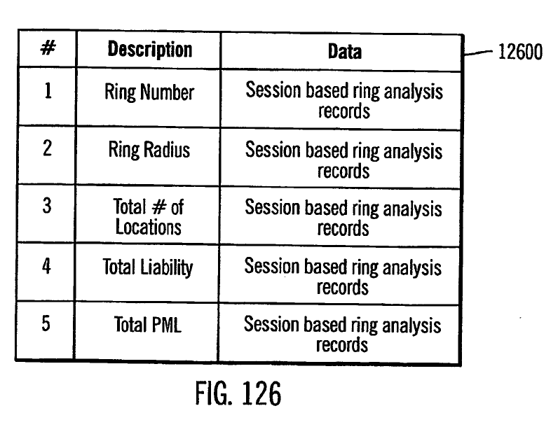

The Analysis Summary report frame contains a top-level report that provides the user with details about the ring analysis including, for example, ring dimensions, number of Liability, PML and Premium. FIG. 125 illustrates a table 125 of landmark ring analysis totals in accordance with certain implementations of the invention. FIG. 126 illustrates a table 12600 of landmark ring analysis by ring totals in accordance with certain implementations of the invention. If no policies are found within a ring, the ring information will include: the Ring Number (1), the Ring Radius (2), and the Total number of locations (3). For the Total number of locations and other fields no data may be displayed.

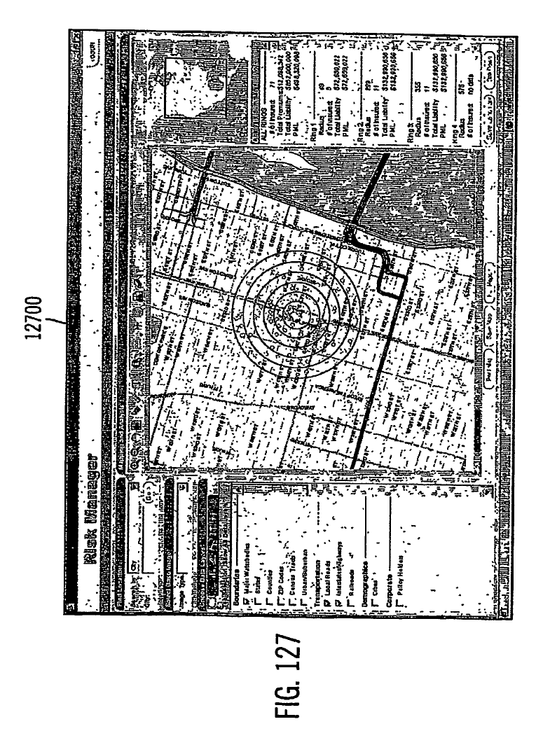

FIG. 127 illustrates a screen 12700 in accordance with certain implementations of the invention. The Drill-Down button provides the user with the ability to link to the reporting application services and display the By Ring view of data for a single landmark location. The data required for this report is stored in the session based ring analysis tables and allows the user to link through three (3) levels of drill-down screens to eventually get to the policy Detail data that is available directly from the screen using the Full report button. The initial levels of drill-down include By Ring, By Ring By Coverage, By Ring By business Unit and finally policy Detail.

The Log Off button may be clicked upon to return to the portal Main menu and will log off the user from the system. If the user does not click the Log Off button, the session is cleaned-up by a process that clears their session after, for example, approximately 2 hours or when the user attempts to re-login. During re-login, if a session is shown to exist, the user may be prompted to close the other session. No two sessions may be allowed at any one time. The actual session is not cleared unit the user logs out of the portal menu.

In certain implementations, the underwriter application service is a specialized, insurance industry application. The underwriter application service is built on a Web services framework and provides a co-branded, limited screen flow user interface for client users to access these tools as part of their business workflow. The underwriter application service is used to assemble a list of locations for a given company that the underwriter is considering writing insurance coverage policy(s) for. The underwriter may select a set of business locations from a combination of both business data (such as Dun and Bradstreet data) queries and manual address entries to query against a data store of high-risk landmark locations. The end result of the users' workflow may be a list of locations for a given company, where those that may be geocoded include a rating that indicates how close they are to a high-risk landmark. This list is then exported and passed to the business managers and corporate risk managers to adjudicate any policies that are in question. The business manager and corporate risk managers may use the risk manager and reporting application services to do further analysis in support of the decision process.

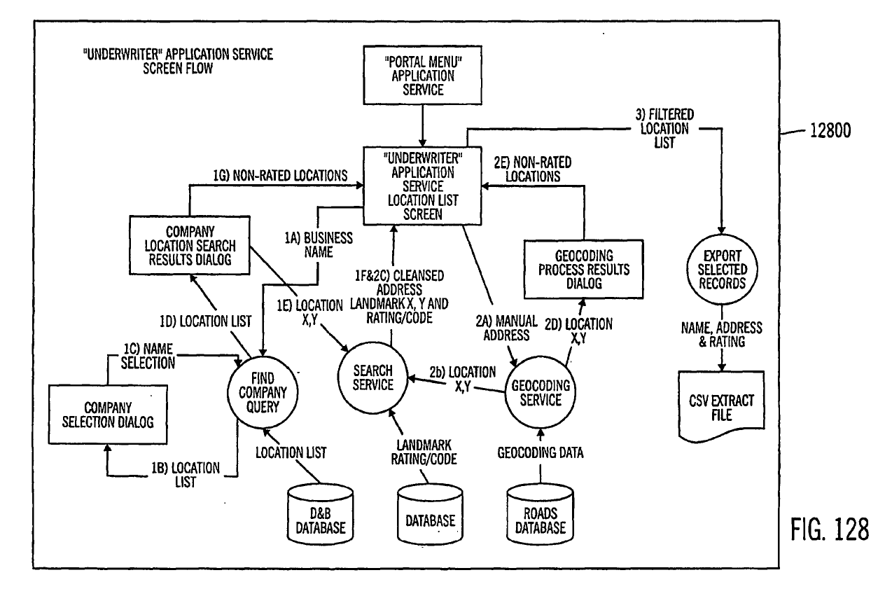

FIG. 128 illustrates an underwriter application service screen 12800 flow in accordance with certain implementations of the invention. The underwriter application service is comprised of a location list screen and additional Business Data store (e.g., D&B) Search and Manual Address Entry dialog pop-ups to support the assembly of the location list.

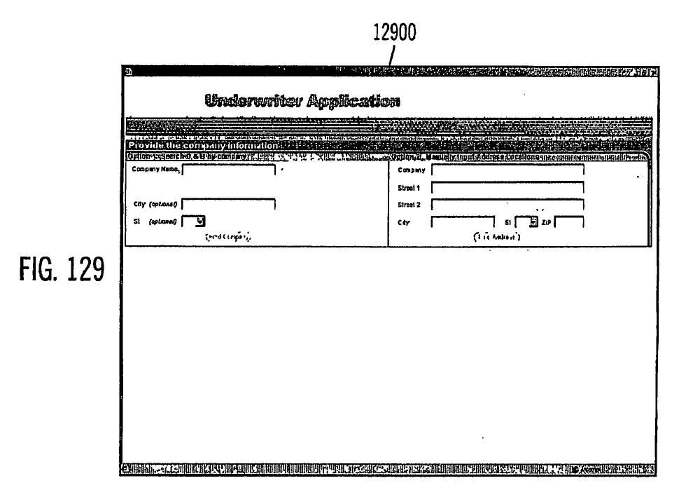

FIG. 129 illustrates a main underwriter application service screen 12900, which is a location list screen, in accordance with certain implementations of the invention. The screen is displayed upon selection of the underwriter option in the main portal menu page.

When a user enters the underwriter application service, one license is indicated as in use of the available (e.g., 200) concurrent users. As long as the user has not logged out or timed out, this user may count as one used license from the pool of 200 concurrent users.

The underwriter location list screen, like all application services, may be co-branded in a manner consistent with the client's corporate intranet. The company logo may be clicked upon to return to the portal Main menu and will log off the user from the system. The title, banners, and Powered by (e.g., enterprise spatial system) logo are consistent with the main portal menu page layout.

The Option1: Search D&B by Company frame is used to locate the name of a particular business that the user wants to select locations from. The Company Name Entry field allows the user to enter the business name on which to search. The user may enter a ‘Starts With’ string that may be a minimum of 3 characters and does not contain a percent character ‘%’. If there is no direct search match, the user is prompted with the following message ‘Company Not Found. Please try an alternate name.’ The default is empty.

The City Entry field is an optional field that allows the user to enter the city name to include as search criteria in the Find Company query. The city name search, if not omitted, is a full string search match, may have a minimum of 3 characters, and does not contain a percent character ‘%’. If there is no direct match, a second search may be made. If there are multiple matches, then an ambiguous name search dialog may be displayed. The default is empty.

The State Dropdown is an optional field that is populated with the standard 50 US states plus one blank entry to allow the user to select a state to include as search criteria in the Find Company query. The default is empty.

The Find Company Button initiates the Find Company Query by assembling the user data from the three data entry fields (Company Name, City and State) into a data store query, sending the query to the data store, and populating the results into the Company Selection dialog.

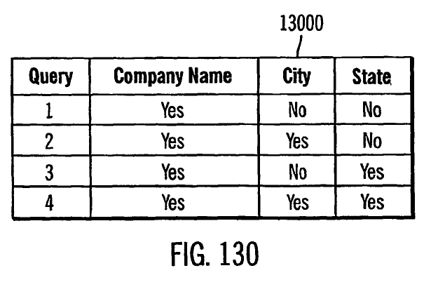

FIG. 130 illustrates a table 13000 of four combinations of user data entered for a Find Company Query in accordance with certain implementations of the invention. Each of the different combinations represents a separate ‘where clause’ search against the business data (e.g., D&B) normalized searching table. The results set from the four queries include the same four columns: Company Name, City, State and DUNS Number from the business data (e.g., D&B) normalized searching table.

A Company Selection dialog may be used to display the results of the Find Company Query. The dialog is a small popup modal dialog that uses the client's standard style sheet color scheme. The main frame of the dialog has a dialog title plus a short description of the dialog contents and use. Additional elements in the dialog include a Company Name List scrollable list box, an Ok button, and a Cancel button.

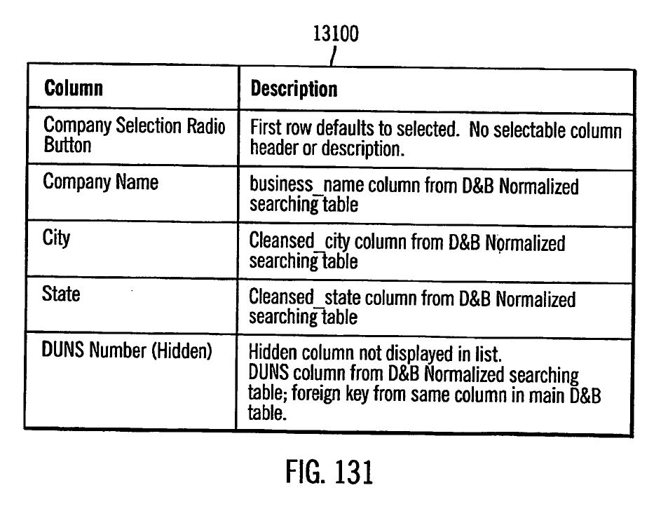

The Company Name List may be a standard list box with selectable column headers for the search results columns. FIG. 131 illustrates a table 13100 of columns for a Company Name List in accordance with certain implementations of the invention. The resulting Company Name List is sorted by default based on Company Name from lowest to highest alphabetically. Clicking on any column header, except the Company Selection Radio Button, re-sorts the list by that column in ascending order. Clicking on the column header subsequent times toggles the sort order between ascending and descending.

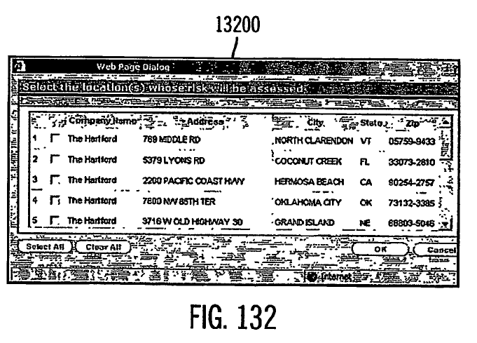

The Ok Button initiates the Find Company Locations Query by converting the selected Company Name row into a data store query, sending the query to the data store, and feeding the results into the Company location Search Results dialog. FIG. 132 illustrates a company location search results dialog 13200 in accordance with certain implementations of the invention.

The Find Company Locations Query is achieved using a hidden DUNS Number column from the Company Name row in the dialog. The main business data (e.g., D&B) table is searched using the DUNS Number column and location records found are returned and populated in the company location Search Results dialog.

The Cancel Button closes the dialog, discards the search results and returns the user's context to the location list screen The Company location Search Results dialog is used to display the results of the Find Company Locations Query. The dialog may be a pop-up modal dialog that uses the client's standard style sheet color scheme. The main frame of the dialog has a dialog title. Additional elements in the dialog include a location Results List scrollable list box, a Select All button, a Clear All button, an Ok button, and a Cancel button.

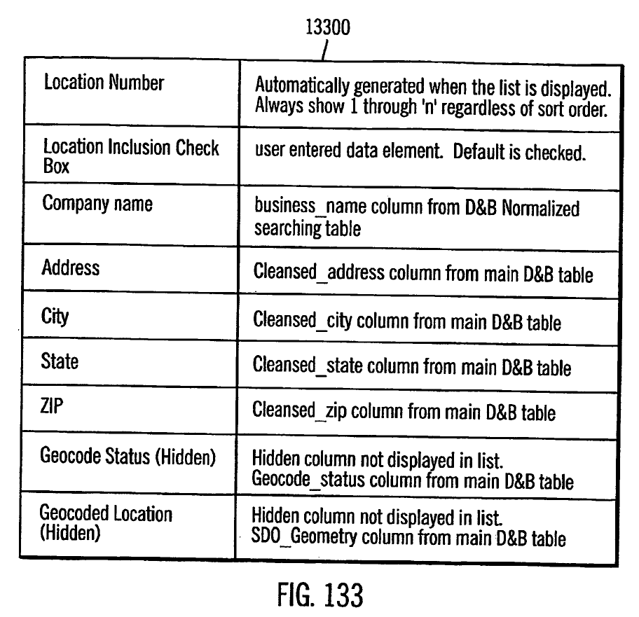

The location Results List is a standard list box with selectable column headers for the search results columns. FIG. 133 illustrates a table 13300 of columns for a location Results List in accordance with certain implementations of the invention.

The location Results List is assembled from a view between the business data (e.g., D&B) normalized searching table and the main business data (e.g., D&B) table. The resulting Company Name List is sorted by default based on Company Name from lowest to highest alphabetically. Clicking on any column header, except the location Number and Inclusion Check Box, re-sorts the list by that column in ascending order. Clicking on the column header subsequent times toggles the sort order between ascending and descending.

The Select All Button sets the location Inclusion Check Box in all list rows to Checked state. The Clear All Button sets the location Inclusion Check Box in all list rows to Unchecked state. The Ok Button closes the dialog and then causes the rows indicated by the location Inclusion Check Box to be processed and then placed into the location list screen. The selected items that fall below the minimum geocode level are moved directly to the rating Results Frame of the location list screen. Those that fall at or above the minimum geocode level are sent to the Landmark Rating Query and then moved to the rating Results Frame of the location list screen with the landmark rating columns added. The Cancel Button closes the dialog, discards the search results, and returns the user's context to the location list screen.

Returning to FIG. 129, if Option 2: Manually Input Address Locations is selected, the user may manually enter an address of a location for the company in question one at a time. The Company Entry field is a text data entry field that is, for example, 120 physical characters, 30 displayable characters and horizontally cursor scrollable. The Company Entry may have a minimum of 3 characters and may not contain a percent character ‘%’. The default is empty. The Street 1 Entry field is a text data entry field that is, for example, 64 physical characters, 40 displayable characters and horizontally cursor scrollable. The Street 1 Entry may have a minimum of 3 characters and may not contain a percent character ‘%’. The default is empty.

The Street 2 Entry field is a text data entry field that is, for example, 64 physical characters, 40 displayable characters and horizontally cursor scrollable. The Street 2 Entry is optional and may have a minimum of 3 characters and may not contain a percent character ‘%’. The default is empty. The City Entry field is a text data entry field that is, for example, 50 physical characters, 30 displayable characters, and horizontally cursor scrollable. The City Entry may have a minimum of 3 characters and may not contain a percent character ‘%’. The default is empty.

The State Dropdown may be populated with the standard 50 US states plus one blank entry to allow the user to select a state to include as search criteria in the Find Company query. The default is empty.

The ZIP Entry field is a text data entry field that is, for example, 16 characters. The ZIP Entry may have a minimum of 5 characters and may not contain a percent character ‘%’. The ZIP+4 extension is optional and may be separated by a fixed hyphen character ‘-’ as part of the entry field. The default is empty.

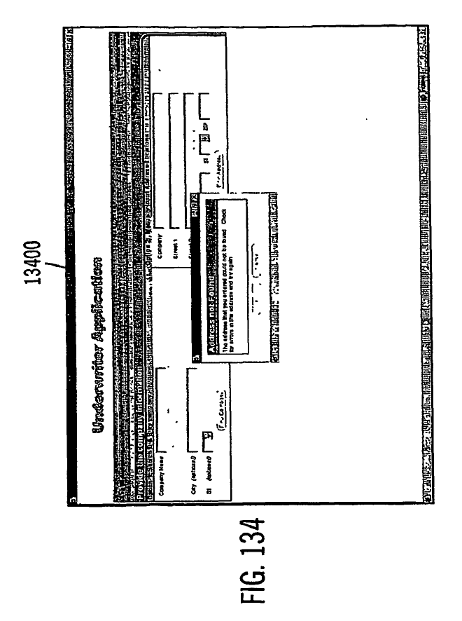

The Find Address Button (Geocode Address) initiates the enterprise spatial system geocode process on-the-fly using the Web services geocoding service and passing it the user entered address fields in, for example, an XML request format. The geocoded address, if successfully geocoded and above the minimum geocode level, is then automatically sent to the Landmark Rating Query and the final results passed to the rating Results Frame of the location list screen. If the address does not geocode to minimum geocode level the user is prompted with the geocoding process Results dialog. FIG. 134 illustrates a geocoding process Results dialog 13400 that is used to display the results of the geocoding process in accordance with certain implementations of the invention. The dialog may be a small pop-up modal dialog that uses the client's standard style sheet color scheme. The main frame of the dialog may have a dialog title plus a short description of the Geocode Results Status. Additional elements in the dialog include an Ok button and a Cancel button.

The Geocode Results Status field shows the geocode result status associated with the address geocode attempt. This status includes the short form result code, result description, and any hint available regarding changes that may be made to the address to correct the problem. A text description above the Ok and Cancel Buttons may read: Add to location list anyway. The Ok Button closes the dialog and passes the user entered address fields to the rating Results Frame of the location list screen without the landmark rating columns populated. The Cancel Button closes the dialog, discards the geocoded address results, and returns the user's context to the location list screen without adding a record to the rating Results Frame.

The Landmark Rating Query is achieved using a spatial intersection ‘within distance’ query between the geocoded location attribute of the location record and the landmark rating view. The result of the Landmark Rating Query is to add a single rating column to the location record made up of the Pml_rating_num and Pml_rating_group_cd columns from the query results set.

The ‘within distance’ query finds landmarks within, for example, 1 mile of the geocoded location of the location record. In certain implementations, a 1 mile distance is the size of the 6th ring dimension on the ‘total loss’ event type. This 1 mile value is stored in the ‘Other Items’ business Table list as a name/value pair; Name=landmarkQuery_Distance, Value=<distance>. The name/value pair table is called qt_other_items.

The Pml_rating num is a number from, for example, 1 to 10. The Pml_rating_group—cd is a code that has the possible results, for example, ‘High’, ‘Medium’ and ‘Low’. The resulting column test may be hyphenated together to form a string (e.g., ‘1-Low’). This column merging is done in the landmark rating view and returns one column because the landmark rating column is used in the reporting application service.

The Landmark Rating Query orders the query results by highest pml_rating_num and returns the first row (the highest rating number). Queries on location records with minimum geocode levels where no Landmark Rating Query row results may be returned receive a default value of ‘0-None’. Rating columns for location records without minimum geocode levels or no geocode may be left blank.

In certain implementations, the minimum geocode level are those records with a geocode status of ‘AS0’.

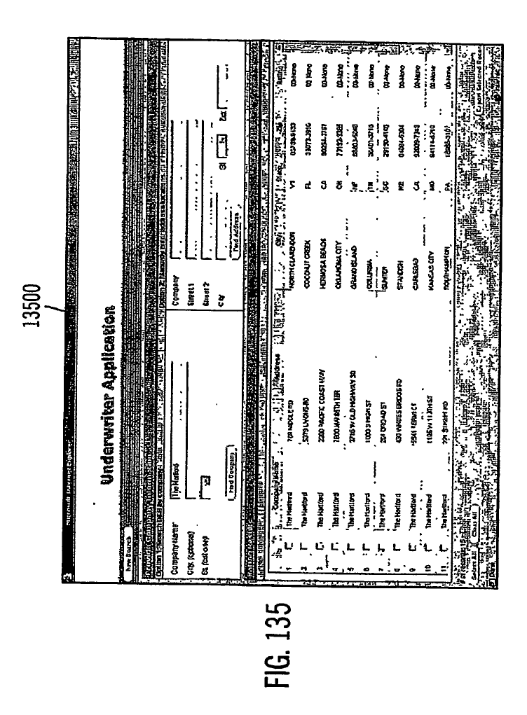

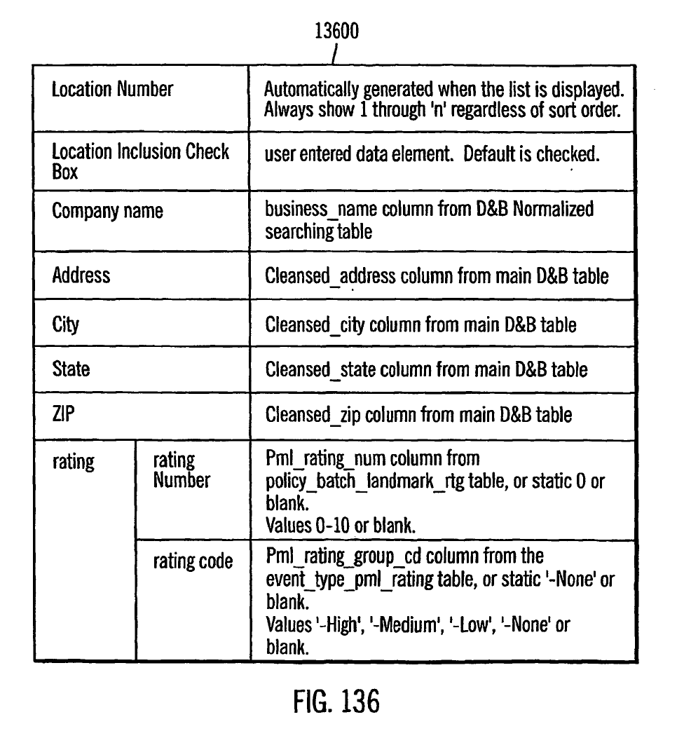

The main underwriter application service screen is then displayed with the location records, entered by either Option 1 or 2, listed in the location rating Results Frame. FIG. 135 illustrates a screen 13500 displaying location records in accordance with certain implementations of the invention. FIG. 136 illustrates a table 13600 describing a data source for the location list columns in accordance with certain implementations of the invention.

The resulting location list is sorted by default based on rating number from highest to lowest numerically. Clicking on any column header, except the location number and Inclusion Check Box, re-sorts the list by that column in ascending order. Clicking on the column header subsequent times toggles the sort order between ascending and descending. As locations are added to the list from either the business data (e.g., D&B) search or Manual Address entry, the list is resorted with those records included using the sort order last chosen by the user. The location Count Display indicates the number of records show in the location list The Select All Button sets the location Inclusion Check Box in all list rows to Checked state. The Clear All Button sets the location Inclusion Check Box in all list rows to Unchecked state. The Export Selected Records Button allows the user to save the location list to, for example, a CSV text output file on a local disk drive.

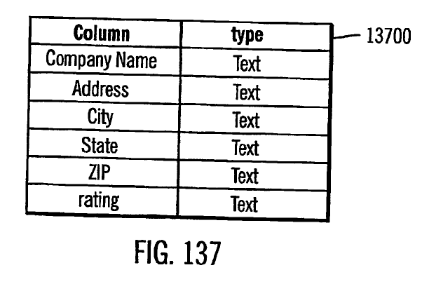

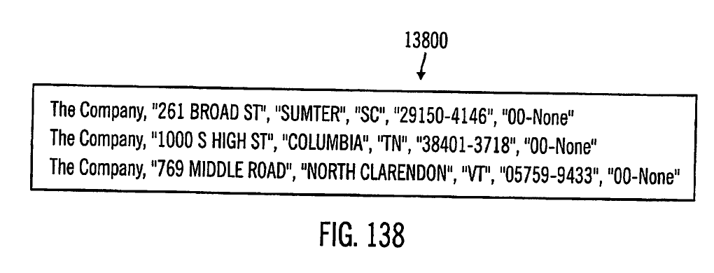

FIG. 137 illustrates a table 13700 listing columns of data that may be exported in accordance with certain implementations of the invention. Those location records with the location Inclusion Check Box are exported from the location list into the CSV file. The CSV file contains each column of data, bound in double quotation and separated by a comma. Each location record is delimited from other records by a carriage return and line feed character added to the end of the record as an end of record marker. FIG. 138 illustrates a sample CSV file 13800 in accordance with certain implementations of the invention.

A new Search Button clears the location rating Results Frame from the screen and clears the resets the Option 1 and 2 date entry fields to their default state.

The client's logo may be clicked upon to return to the portal Main menu and will log off the user from the system. If the user does not click the Log Off logo, the user may still count as one used license until the session cleanup process clears their session or the user attempts to re-login. During re-login, if a session is shown to exist, the user may be prompted to close the other session. No two sessions may be allowed at any one time.

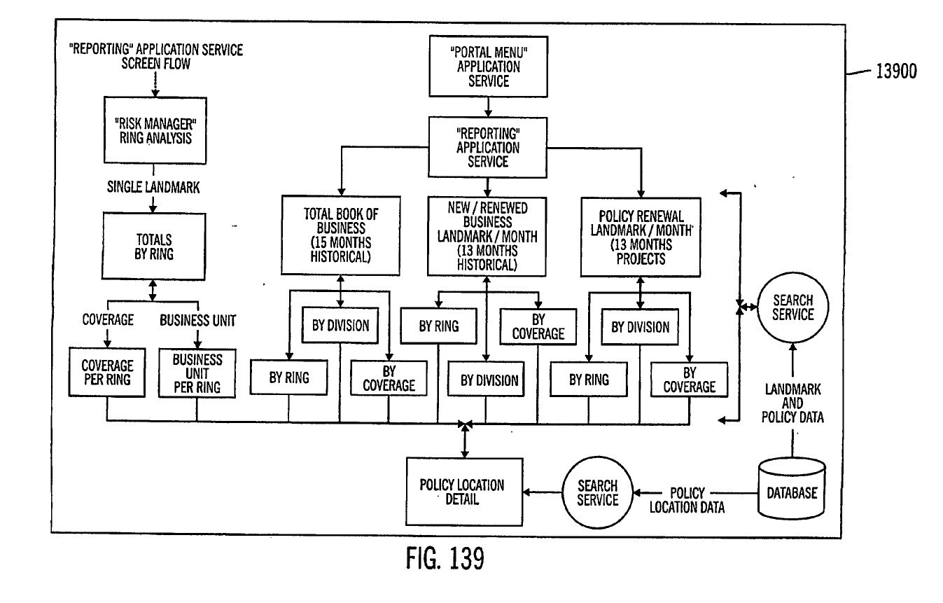

FIG. 139 illustrates a reporting application service screen flow 13900 in accordance with certain implementations of the invention. Flow 13900 shows the overall reporting site map starting from the high level landmark report links that through aggregate drill-down to the policy location Detail screen that underlies the landmark reports. Data displayed as part of the selected reports is filtered based on the users rights as assigned by their role.

The total book of business by landmark report shows policy location PML data aggregated by periodic batch load columns in 4 different views; 1 main report and 3 dimensional sub-report: by Ring, by Division and by Coverage. The report views allow row/column cell selection to display a policy location detail report that supports the cell's aggregate value.

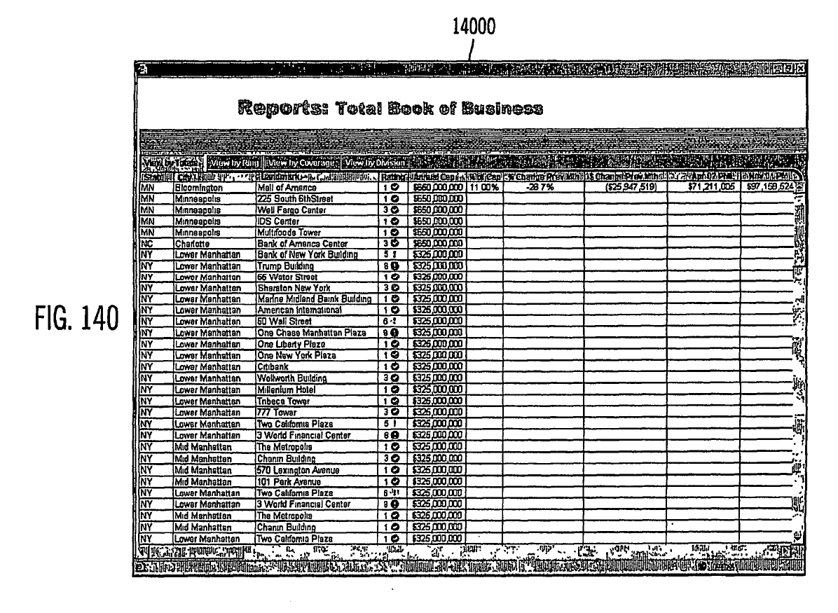

FIG. 140 illustrates a total book of business by landmark report 14000 in accordance with certain implementations of the invention. The report includes, for example: Level 1 Tab 1—landmark List; Level 1 Tab 2—landmark List with Ring Sub-List; Level 1 Tab 3—landmark List with Coverage Sub-List; Level 1 Tab 4—landmark List with Division Sub-List; and Level 2—policy Detail List.

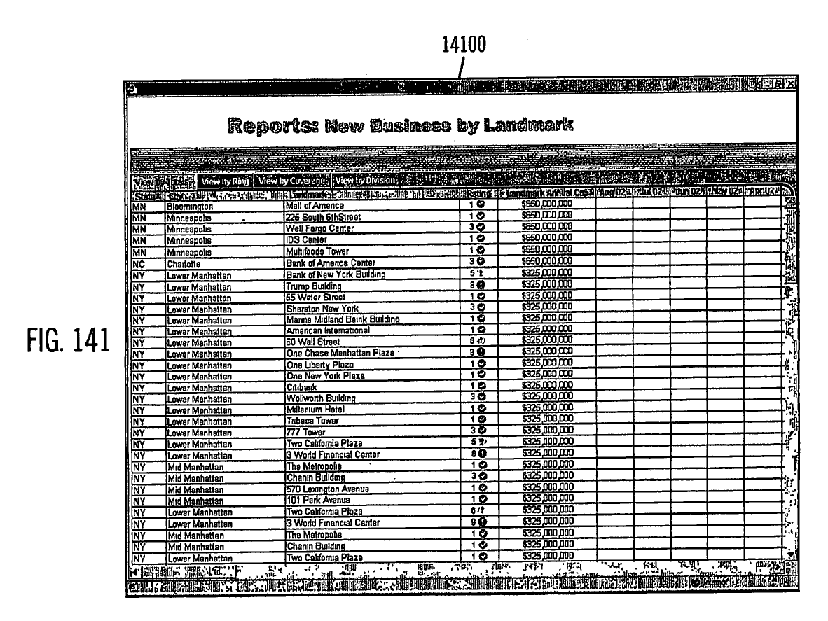

FIG. 141 illustrates a new business by landmark report 14100 in accordance with certain implementations of the invention. The report includes, for example: Level 1 Tab 1—landmark List; Level 1 Tab 2—landmark List with Ring Sub-List; Level 1 Tab 3—landmark List with Coverage Sub-List; Level 1 Tab 4—landmark List with Division Sub-List; and Level 2—policy Detail List.

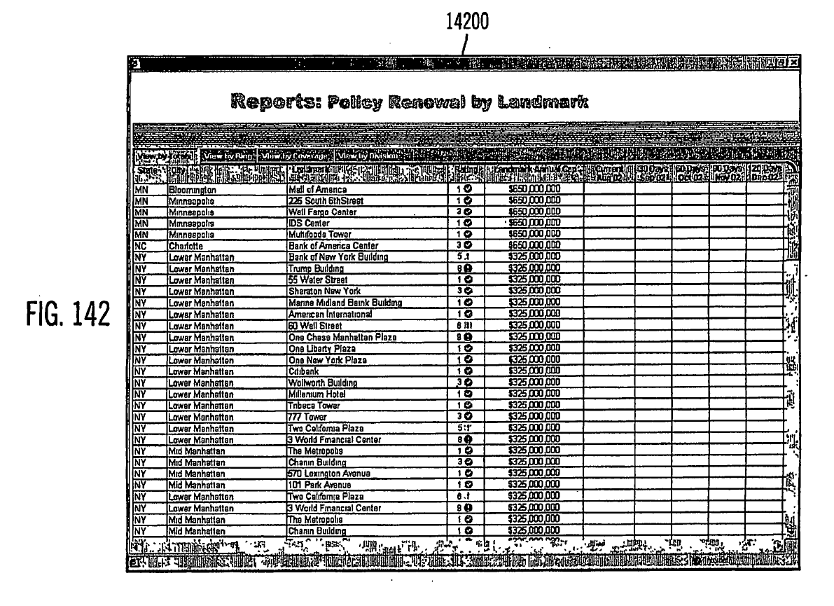

FIG. 142 illustrates a new business by landmark report 14200 in accordance with certain implementations of the invention. The report includes, for example: Level 1 Tab 1—landmark List; Level 1 Tab 2—landmark List with Ring Sub-List; Level 1 Tab 3—landmark List with Coverage Sub-List; Level 1 Tab 4—landmark List with Division Sub-List; and Level 2—policy Detail List.

As for Ring PML drill-down, a report may include, for example: Level 1—Ring List; Level 2 Tab 1—Single Ring business Unit List; Level 2 Tab 1—Single Ring Coverage List; and Level 3—policy Detail List.

In some cases, when the user drills-down from the aggregate values in the report cells to the policy detail report from which they were derived, the user may see a total for the detail report that is lower than the aggregate. This is due to policy detail that was included in the aggregate but that the user has no right to see at the detail level. Those policy detail entries may be omitted from the report.

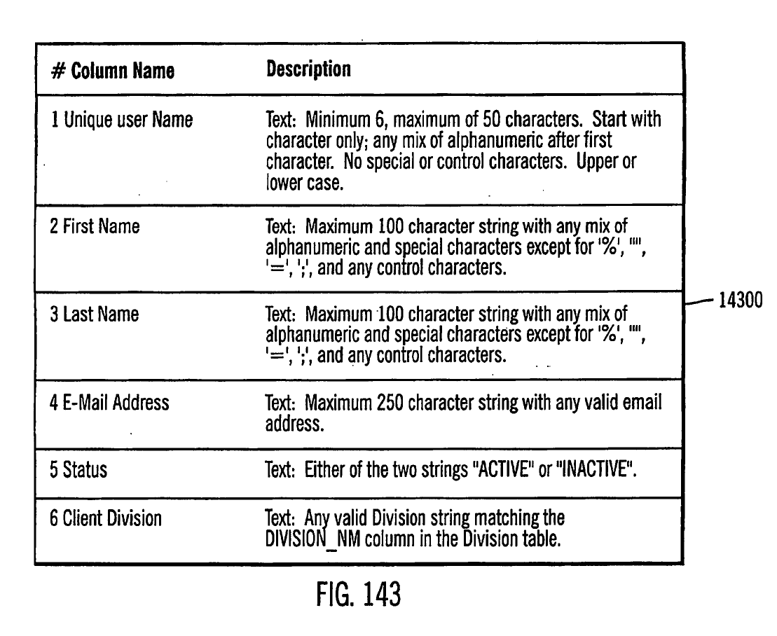

FIG. 143 illustrates a table 14300 of columns for a policy detail in accordance with certain implementations of the invention. Data may be provided, for example, in either an Excel spreadsheet in separate columns or in a CSV file with columns separated by commas and delimited by double quotation marks. Additional columns including role and other information may be added, but are not required for batch loading. The additional columns may be useful for managing the loading phases for users.

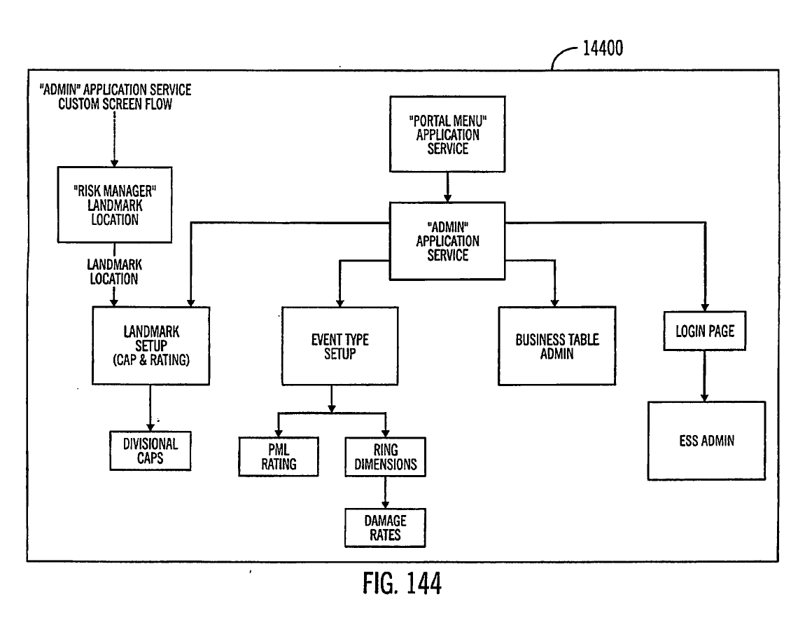

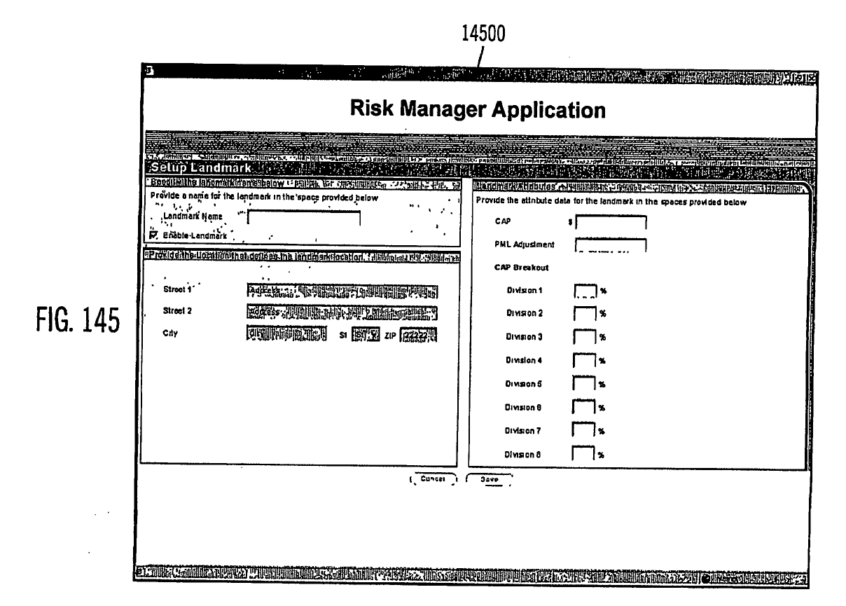

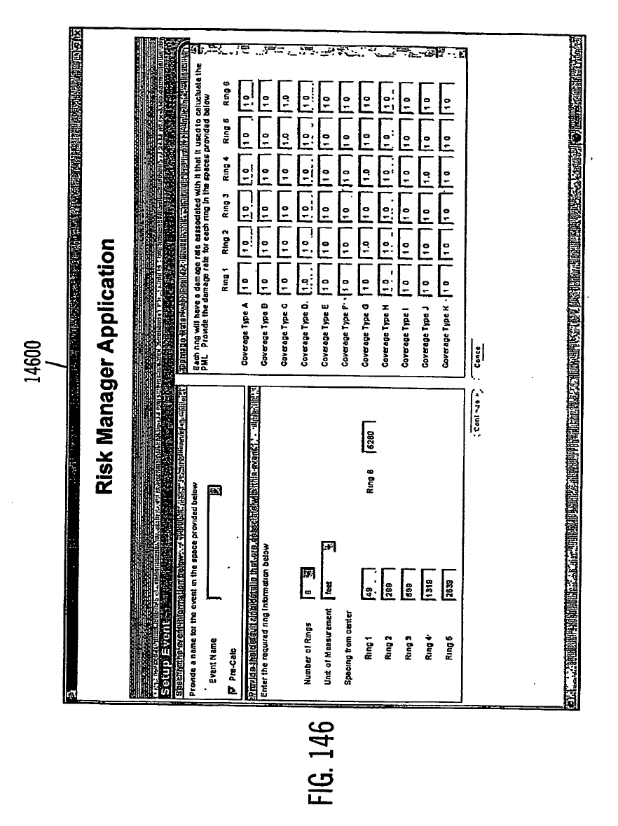

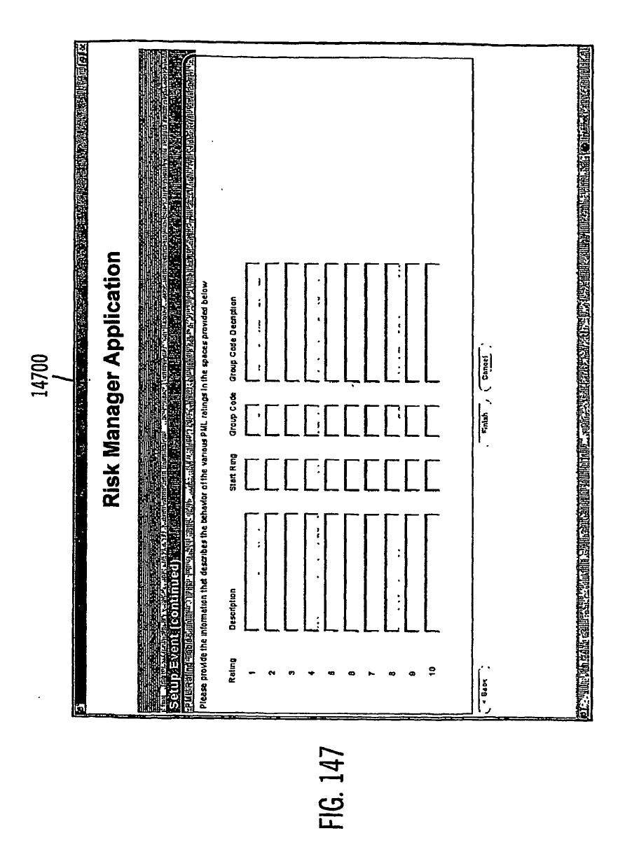

FIG. 144 illustrates an admin application service custom screen flow 14400 in accordance with certain implementations of the invention. FIG. 145 illustrates a screen 14500 for setting up landmarks in accordance with certain implementations of the invention. For landmark set up, location, PML CAP and adjustments, and division caps may be entered. FIGS. 146 and 147 illustrate a screen 14600 for setting up events in accordance with certain implementations of the invention. For event set up, ring details, damage rates per coverage type, and a PML rating table may be configured.

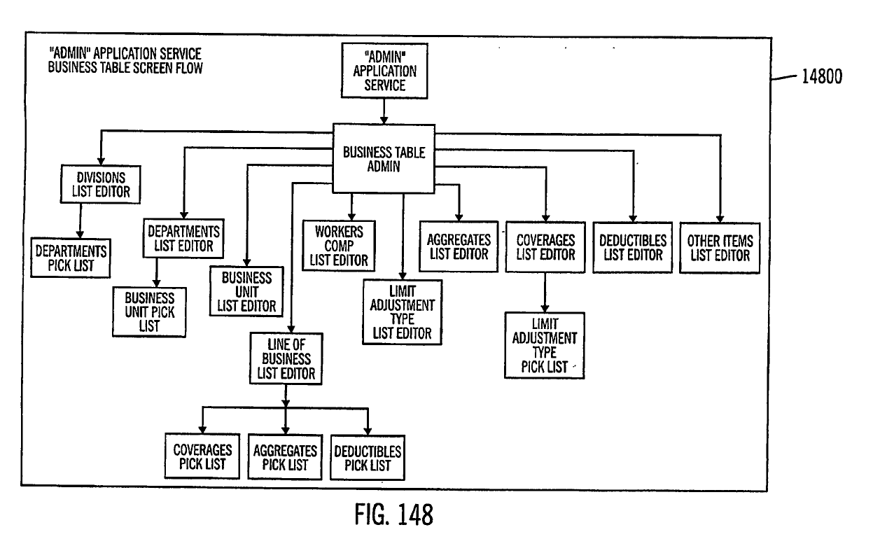

FIG. 148 illustrates an admin application service business table screen flow 14800 in accordance with certain implementations of the invention. As for business tables, line of business, coverage types, deductible types, aggregate types, limit adjustment types, division, department business unit, workers comp, and other setup items may be stored.

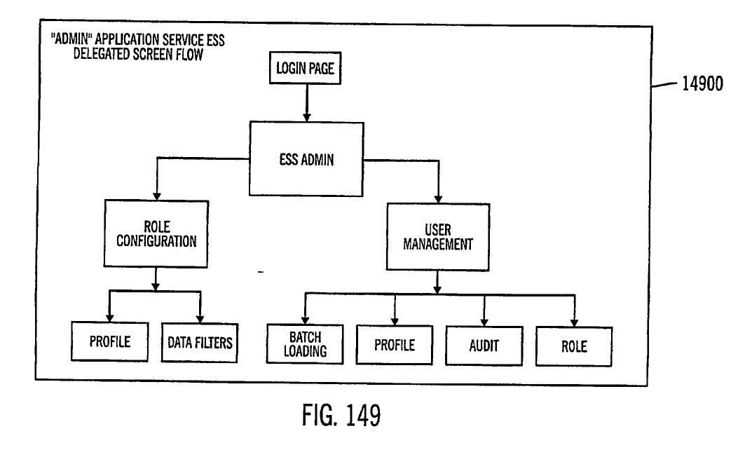

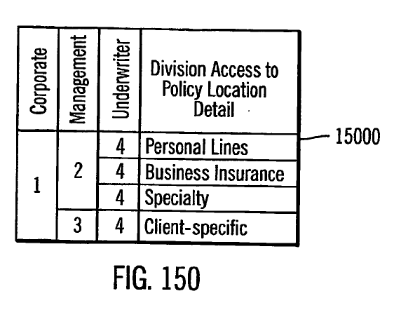

FIG. 149 illustrates an admin application service ESS delegated screen flow 14900 in accordance with certain implementations of the invention. FIG. 150 illustrates a table 15000 for policy data access rights in accordance with certain implementations of the invention.

A data services group makes sure that a strategy and process is developed to acquire and deploy data components required by the customer. Data services members work with Project Management members and the ETL and Data store development teams to define the processes and then develop and implement the schedules required to meet the customer commitments. Reference data is included as part of the standard base data layers and includes, for example, roads data and city, state and ZIP data for the 50 U.S. states.

The Roads data is used as the basis for the geocoding process used on the business (e.g., D&B) data, client data, and any ad hoc address search by functions in the applications. A controlled validation process is used to confirm system impact of updated releases of Roads data along with the geocoding process. Additional reference data layers may include the city, state, ZIP code and waterbodies boundary layers.

The underwriter application service accesses business data (e.g., D&B data). The business data (e.g., D&B data) locations selected are then combined with manually entered location addresses that were geocoded on the fly by the underwriter application service. These resulting locations are then spatially compared against the landmark location layer and rated.

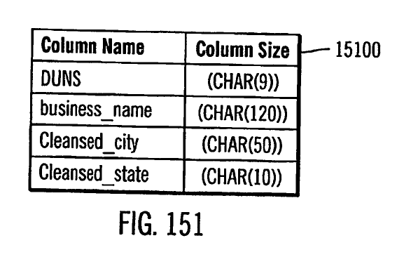

Since the dataset may be large (e.g., over 14 million records), a summarized business name table may be created for initial searching by the underwriter application service. FIG. 151 illustrates a primary table 15100 in accordance with certain implementations of the invention. The duplicate rows are removed from the table above to make it a distinct extraction of the main business data (e.g., D&B data) table.

The business name table is searched first and any combination of State, City and business_Name may be provided as keys. Also, a partial business_Name may be provided that is a right-hand wildcard name. This right-hand wildcard returns records where the business_Name begins with that partial string.

The business name results set, including DUNS, State, City and business_Name columns, are returned to the user for selection of correct business name. Once the business name is selected, the DUNS number is used to select all business location records from the main business data (e.g., D&B data) table where the DUNS number matches. These business location records are then returned to the user with a subset of columns.

The main business data (e.g., D&B) table may be converted into a spatial layer for spatial intersection querying of the landmark spatial layer in the client data store by the underwriter application.

The requirements for data deployment include the following: loading of fixed width ASCII source file into a data store table; creating normalized, derivative searching table with DUNS number, business name, City and State; creating of required foreign key relationships and searching indexes on the both business data (e.g., D&B) tables; creating a spatial layer for the main data store table; geocoding of main data store table; analyzing and adjustment of storage model; and preparation of transportable table space for production deployment. Since the business data (e.g., D&B data) may be provide on a quarterly basis, an automated ETL process for the business data (e.g., D&B) updates may be provided.

The following items may be validated on the production business data (e.g., D&B) data store: the total number of records from the original dataset are hosted; the total number of distinct business names from the original dataset are hosted in the business name table; the relationship between the business name table and the main business data (e.g., D&B) table are correct; cleansed addresses and geocode statuses are not null; the performance of the business name search on the business table is less than a predetermined time (e.g., 1 second); the performance of the DUNS location search on the main business data (e.g., D&B) table is less than a predetermined time (e.g., 1 second); and user accounts may execute required queries.

The business data (e.g., D&B) data store may be provisioned on a quarterly basis and validation procedures required may be developed into an automated sequence that may be repeated as each update is received. Each update may be a dataset replacement.

As for client business data, the business data includes policy location and high-risk landmark lists both configured with spatial layer indexing and dimensional analysis. Additionally the data contains associated lookup and associative entities to support business dimensional analysis of both the policy location and landmark data.

The risk manager, underwriter, reporting and admin application services may each access the client business data in a different way: the risk manager service uses spatial query access to both policy location and landmark layers; the underwriter service uses business data (e.g., D&B) location data to query against the landmark layer; the reporting service uses landmark Layer data to drill-down to policy location layer data; and the admin service manages the supporting business tables used for PML calculations and drill-down between the landmark layer and policy location layer.

The data store may be integrated into each application service through a custom implementation. In certain implementations, it is due to this custom schema that all but the risk manager application services are new sites fully independent from the main application leveraging the portal to navigate between them, and, in the case of the risk manager ring analysis functionality, custom screens and dataflow have been specifically designed to integrate the custom schema.

As for data sources, the data store is made up of three main source datasets: landmark data, policy location data, and setup data. The initial landmark and policy test data is provisioned using the Package Manager as two spatial layers. Real policy data provided by the client may be provisioned using the automated ETL process.

The setup data may be provided as factory setup data with the initial data store setup by the data store team. Setup data changes may be managed by the client in the production system directly using the admin application service.

The enterprise spatial system performs geocoding and spatial layer creation as part of the pre-production setup and deployment. Landmark data changes may be managed by the client in the production system directly using the risk manager application service ad hoc landmark ring analysis functionality.

The policy location data is business data that may be provided from the client on a periodic basis and deployed into the production system using the secure, automated ETL process. Each batch of data loaded may be, for example, approximately 2 million records.

The policy location data is provided to enterprise spatial system by the client on a periodic basis in, for example, a data store dump format in read-format. The policy location data is provisioned into production using an automated ETL process. Each periodic load is assigned a unique batch number with which all setup data for that period's (e.g., month's) load is associated.

The data store setup includes creation of production data from a data model, stored procedures, and setup data provided by the client.

The data store schema, along with ETL procedures to normalize and generate PML values, may be designed and provided by the client. The schema and ETL procedures may be run by the enterprise spatial system in conjunction with the geocoding and deployment process of getting the data into the production system.

The data store schema may be provided to enterprise spatial system in, for example, an ErWin model format by the client. The ErWin schema model and the associated production Data Definition Language (DDL) scripts are stored in PVCS at the at enterprise spatial system. PVCS is a software package available from a Merant, Inc. that may be used to store and maintain different versions of software and data. There are other such software packages available in the market from other companies that may also be used instead of or in addition to PVCS. The data store schema DDL are included in the enterprise spatial system production deployment process. Once launched, updates are deployed using schema modification DDL. Schema changes are controlled through enterprise spatial system's normal Quality Assurance (QA) validation and operational deployment process.

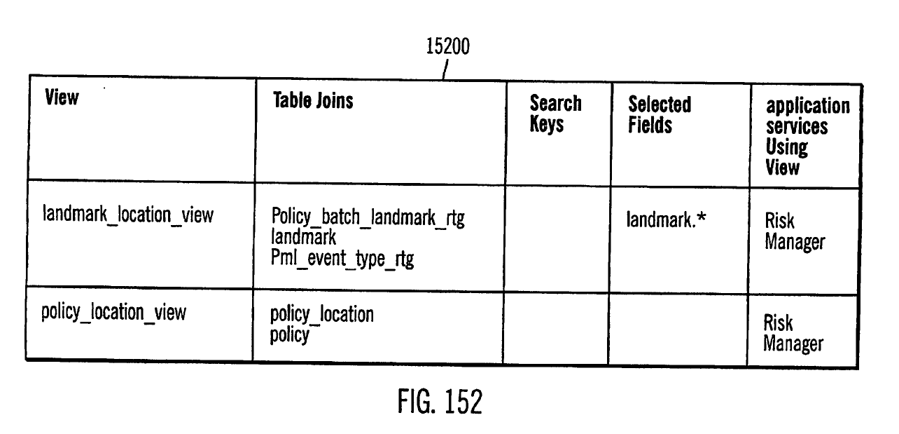

Various Application views are provided for simplified access and performance. FIG. 152 illustrates a table 15200 of views of the client data store in accordance with certain implementations of the invention.

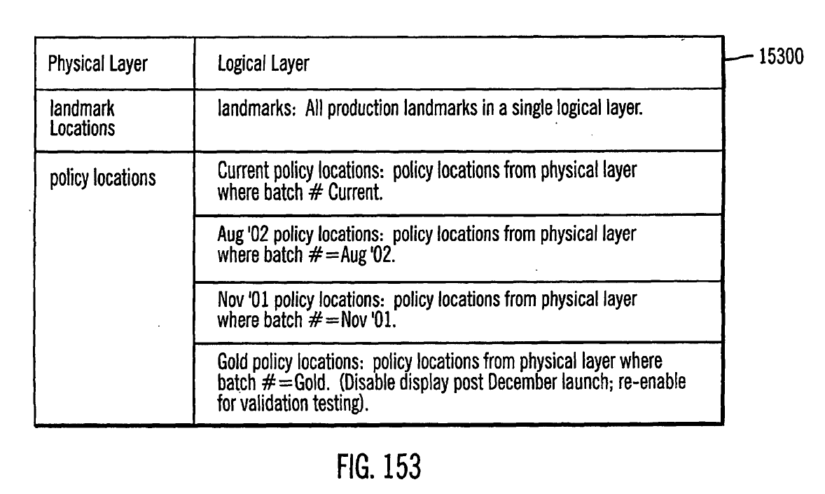

The meta data setup includes: layer setup, user friendly name setup, and point n′ view setup. For the risk manager application service, both the landmark and policy location data are provisioned as logical layers. For the landmark layer, a single logical layer may be provided for user access. However, the policy location layer is viewed as multiple logical layers, each shown as a different month and separated by the unique batch number in data selections on that single physical layer. FIG. 153 illustrates a table 15300 of physical and logical layers in accordance with certain implementations of the invention.

User access to the data in the policy location table is limited for the underwriter role. The underwriter role allows the user to see policy location data that is owned by a division that the user is a member of. The user division is stored in the user profile and applied at data layer query time to limit the record set to policy locations where the parent policy table contains an organization key that is part of that user's division. The remaining two system roles, Corporate and Management, are limited in their access to policy location data based on the user account that they have access to and their Views granted on the policy location data granted to that account.

The data dictionary contains user-friendly name information on data store tables.

The landmark layer includes available data elements in the landmark table as point n′ view elements. The policy location layer includes a subset of elements from a combination of both the policy and policy location layers.

In certain implementations, the policy location data set is the central business data to be provided by the client for use in the enterprise spatial system. The policy location data is critical to their business and highly confidential. As such, key aspects of the handling of this data are the security and accuracy of the data as it moves from the client's environment through the enterprise spatial system's processes and into the production system.

To ensure that no compromises are made related to the acceptance, processing and hosting of the client's critical policy location data, the data is provisioned to the production system by an automated ETL process. Additionally, testing and validation may be done using a manufactured test dataset to avoid unnecessary internal access and exposure of real customer data.

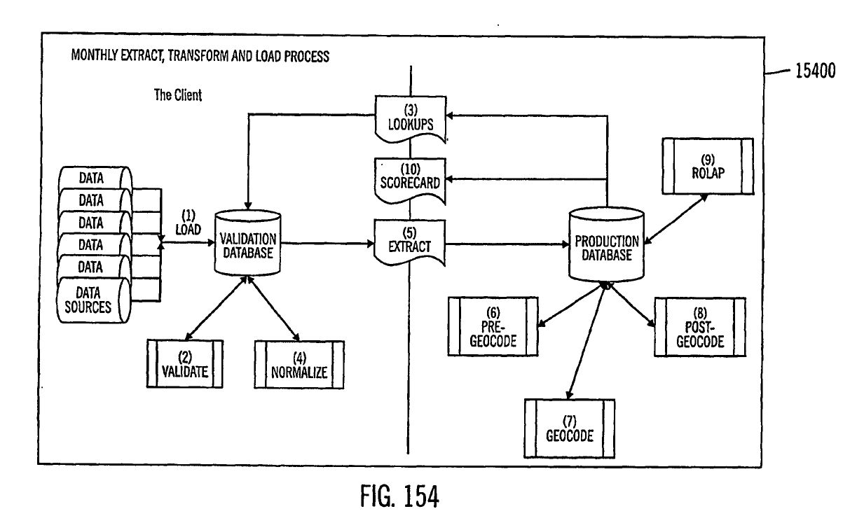

The ETL process may include components built by both the client and enterprise spatial system. FIG. 154 illustrates a ETL process 15400 in accordance with certain implementations of the invention. The enterprise spatial system ETL process may sequence the execution of these components based on the workflow defined in FIG. 154.

During this process, the data is extracted, loaded, cleansed, geocoded, and spatially provisioned for non-spatial batch reporting. Once loaded into the data store, the loaded data becomes the current, active dataset used by the enterprise spatial system services.

### G. DATA INTEGRATION SERVICES

In order to maximize effective use of the enterprise spatial system, a customer is able to obtain maps and visualizations based not only on geospatial and geo-demographic data but also based on corporate data. Data integration services 140 (also referred to as Extraction Transformation, and Loading (ETL)) get corporate data into the enterprise spatial system. This includes all forms of data including that which may be non-spatial in nature (e.g. revenue, number of purchases, mother's maiden name, etc.).

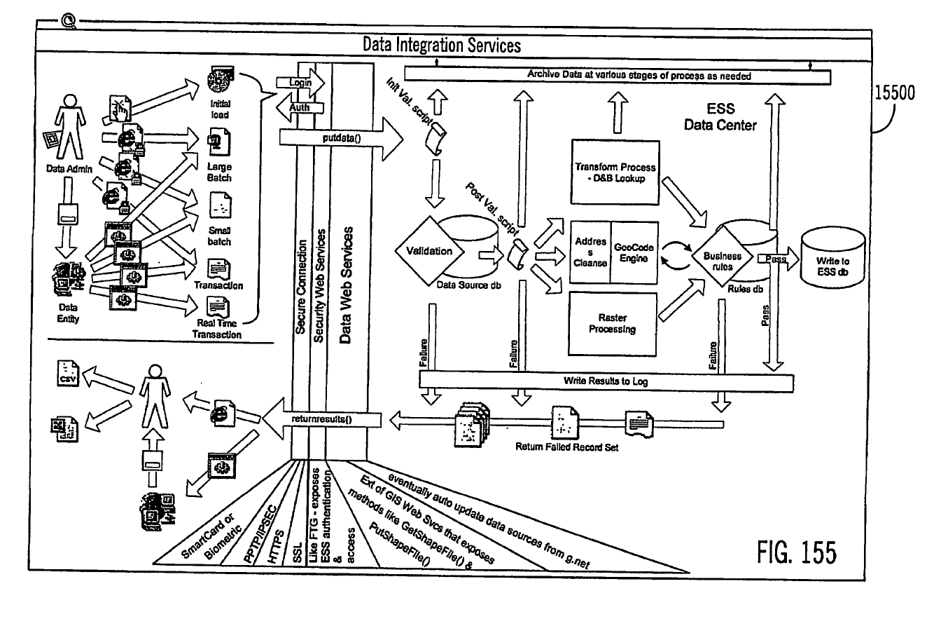

FIG. 155 illustrates a data integration services flow 15500 in accordance with certain implementations of the invention. In FIG. 155, after login and authentication, corporate data may be submitted to the data center in a secure manner. The data center performs, for example, validation, address cleansing, geocoding, transformation of data based on a Dun & Bradstreet data lookup, raster processing, and/or business rule application, before storing the data.

In one data integration services flow, a data administrator may submit a large batch of data to the data center for validation, geocoding, and storage.

The data integration services 140 track the user or process that is uploading data, open a log for a pre-validation and post-validation script for entering results, and output data to a file.

The data integration services 140 upload data to a temporary table (e.g., storing Binary Large Objects (BLOBs)) and then write referring records into an event/queue table that is monitored. Writing records into the event/queue table may also start up the validation/import process. A pre-validation script may be used for client specific, non-validation code that may change by data source/source (e.g., code to unZIP a file coming from a zipped source/application). The pre-validation script may also be used to update an inventory system or work order system for use by an enterprise spatial system team. A post-validation script may be used to start specific customer processes (e.g., a Dun & Bradstreet data lookup). The post-validation script may also be used to update an inventory system or work order system for use by an enterprise spatial system team.

The data integration services 140 provide historical retention. Historical retention may be described as a mechanism for automatically date/time stamping records uploaded to provide a time based map (e.g., prospects as of now versus three months ago). The data integration services 140 are connection agnostic, but security aware (e.g., accept secure posts (VPN or HTTPS).

Additionally, in certain implementations, processing may stop at first error, while in other implementations, processing of an entire record set may be completed before errors are returned. Thus, certain implementations provide for a batch versus transaction flag in data source, with a minimum percentage of good records threshold (e.g., a pass %) set for each process. The data integration services 140 cascade failures so that the user receives an error message that makes sense.

In certain implementations, data is accepted from an old data source version, which may be useful for programmatic integrations but may result in less than accurate data. The data may be accepted via use of the pre-validation script.

A business rules data store contains valid lookups and required fields for each data source/version combination. For transaction records, in certain implementations, the Web-form is automatically built from metadata, while in alternative implementations a URL of the Web-form may be submitted as input. A Web-form generically refers to HTML code that, when rendered by a client application, such as a browser, is manifested as a form on the screen into which the user enters their input to the application.

In various implementations, the data integration services 140 process various formats of data (e.g., delimited, Structured Query Language (SQL), vendor specific (e.g., data from Oracle), etc.). Also, the data integration services 140 provide a mechanism for restoration to state prior to loading of data.

The enterprise spatial system enables different roles to be assigned to users. For example, a system admin (i.e., an enterprise spatial system admin) role allows a user assigned to this role to administer companies, users, roles and data sources for integration. A customer admin role allows users assigned to this role to administer users, roles and longer term data sources for integration. A data admin role allows users assigned to this role by a system admin or a customer admin to upload data into the enterprise spatial system. A data entity role allows third party programs assigned to this role by a system admin or a customer admin to upload data into the enterprise spatial system.

Various actions related to data integration services 140 may be performed. A system admin may administer users (e.g., add, remove, edit, assign roles). For example, a system admin may assign one user to have a customer admin role and may assign another user to have a data admin role. The system admin also administers data sources with version control. A security level may be defined for the data sources (e.g., VPN, SSL, HTTPS, or None). Also, for the data sources may have defined validation entry and exit functions, defined metadata, define geocode rules, define minimum geo-code level, defined business rules, defined “Transactional” or “Batch” indicator (which determines whether each record will be processed end-to-end before the next record is processed or if all records will pass through each level before proceeding to the next level), and defined output options. The administrator entities (e.g., system admin or data admin) may be able to submit records (e.g., as users). Additionally, a results log may provide information such as, location, size, overwrite/append, etc. for data,

The customer admin administer users (e.g., add, remove, edit, assign roles). For example, the customer admin may assign a user to have a data admin role. The customer admin also administers data Sources with version control. A security level may be defined for the data sources (e.g., VPN, SSL, HTTPS, or None). Also, for the data sources may have defined validation entry and exit functions, defined metadata, define geocode rules, define minimum geo-code level, defined business rules, defined “Transactional” or “Batch” indicator (which determines whether each record will be processed end-to-end before the next record is processed or if all records will pass through each level before proceeding to the next level), and defined output options. The administrator entities may be able to submit records (e.g., as users). Additionally, a results log may provide information such as, location, size, overwrite/append, etc. for data.

In certain implementations, the data admin may handle batch integration. The data admin logs in (in which case security and access level are verified). Then, the data admin may upload a file selected from pre-defined data sources or by specifying a location of file (if not uploaded). The data admin performs a validation process on the file (e.g., to make sure the file conforms to the data source. A response (e.g., fails validation, records processed, records not processed—reason, etc.) is displayed. Then, the data admin may resubmit fixes or cancel the process (e.g., roll-back any changes). The data admin may also geocode data, store records, and output failed records to a file (e.g., comma separated values (CSV), delimited, spreadsheet, etc.). Results may be logged at each block.

In certain implementations, the data admin may perform transactional integration. The data admin logs in (in which case security and access level are verified). Then, the data admin may select data sources and submit a record (i.e., select a data source where the data the record can be found). The data admin performs a validation process on the file (e.g., to make sure the file conforms to the data source. A response (e.g., fails validation, records processed, records not processed—reason, etc.) is displayed. Then, the data admin may resubmit fixes or cancel the process (e.g., roll-back any changes). The data admin may also geocode data, store records, and output failed records to a file (e.g., comma separated values (CSV), delimited, spreadsheet, etc.). Results may be logged at each block.

In certain implementations, a data entity may perform batch integration. The data entity connects to a Web Service provided by the enterprise spatial system, calls the appropriate method to upload a file by passing parameters to indicate a data source, location, etc. The data entity performs a validation process on the file (e.g., to make sure the file conforms to the data source. An XML response (e.g., fails validation, records processed, records not processed—reason, etc.) is returned. The data entity may also geocode data, store records, and output failed records to a file (e.g., comma separated values (CSV), delimited, spreadsheet, etc.). Results may be logged at each block.

In certain implementations a data entity may perform transactional integration. The data entity connects to a Web Service provided by the enterprise spatial system, calls the appropriate method to upload a file by passing parameters to indicate a data source, location, etc. The data entity performs a validation process on the file (e.g., to make sure the file conforms to the data source. An XML response (e.g., fails validation, records processed, records not processed—reason, etc.) is returned. The data entity may also geocode data, store records, and output failed records to a file (e.g., comma separated values (CSV), delimited, spreadsheet, etc.). Results may be logged at each block.

For ease of understanding, some usage scenarios for data integration services 140 will be described herein. However, these usage scenarios are examples of applications of the invention and are not intended to limit the invention in any manner.

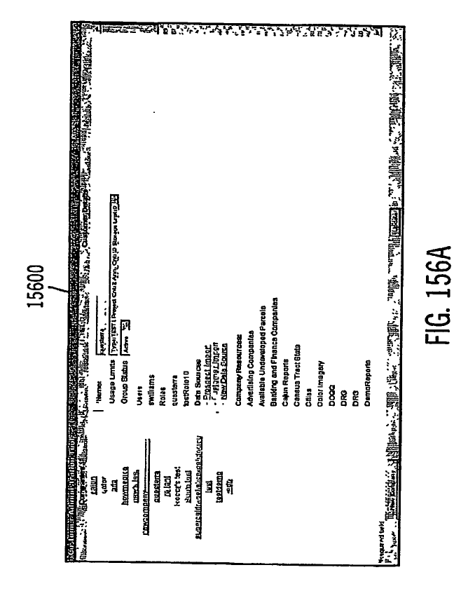

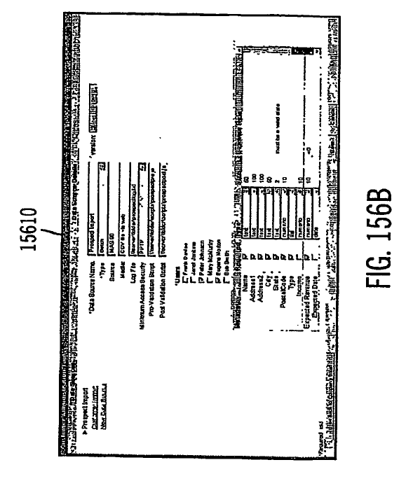

FIGS. 156A and 156B illustrate administration scenarios 1 and 2 with screens 15600 and 15610, respectively, in accordance with certain implementations of the invention. In scenario 1, in addition to integration of existing and new customers, the user with the system admin role sets up a new data source to allow for integration of prospects into the enterprise spatial system solution. In scenario 1, the user logs into an admin application. The user selects the company in question and a “New Data Source” from the list of data sources under company information. The user specifies a unique name of the data source (e.g., “Prospect Upload”). Upon adding a data source, the version is set to 1 automatically and is read-only. The user defines metadata for the data source (e.g., columns and column types). The user may optionally select a security protocol. The user defines the validation entry and exit function (e.g. a Dun & Bradstreet data lookup). The user defines geocode rules (e.g., geocoding engine, business rules, etc.). The user optionally selects data admins/entities who will be able to work with the data source. The user optionally specifies details of a results log (e.g., location, size, overwrite/append, etc.).

In scenario 2, the user with the system admin role modifies the “Prospect Upload” data. In scenario 2, the user logs into an admin application. The user selects the company in question and a “prospect Upload” from the list of data sources under company information. The version is automatically incremented to 1 and is read-only. The user optionally modifies metadata for the data source (e.g., adding and/or removing columns and column types). The user may optionally modify a security protocol. The user may optionally modify the validation entry and exit function (e.g. a Dun & Bradstreet data lookup). The user may optionally modify geocode rules (e.g., geocoding engine, business rules, etc.). The user optionally selects data admins/entities who will be able to work with the data source. The user optionally specifies details of a results log (e.g., location, size, overwrite/append, etc.).

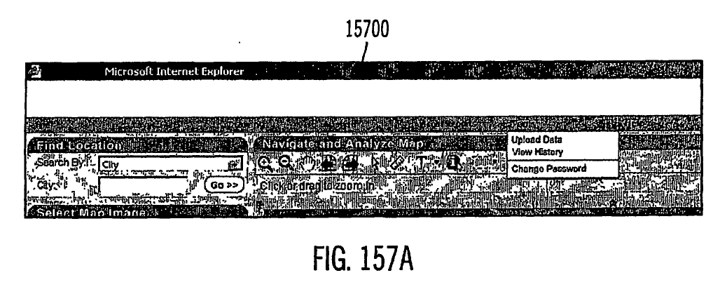

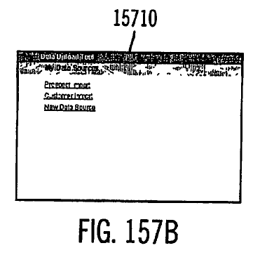

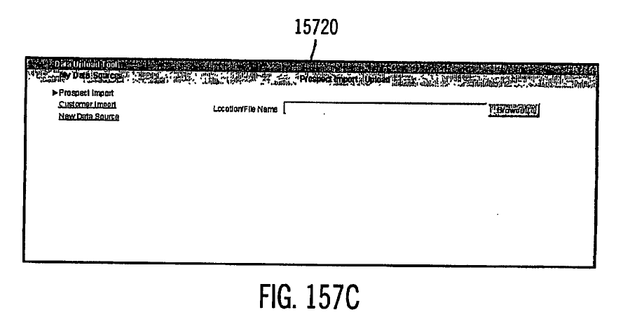

FIGS. 157A, 157B and 157C illustrate data integration services scenario 3 with screens 15700, 15710, and 15720, respectively, in accordance with certain implementations of the invention. In scenario 3, a user with a data admin role performs manual daily upload of prospect data from a lead generation program (e.g., manual or batch). The user with the data admin role may be a power-user level individual. The user logs into an enterprise spatial system application. Authentication of the user is performed to determine that the user has data admin privileges, and a UI changes the “Preferences” Menu to “Tools”. Then, the user is able to select “Upload Data” from the “Tools” menu to upload the prospect data. The user selects the “Prospect Upload” data source from the data integration service list of available data sources (e.g., which may already be filtered to show those for which the user has privileges), and, if there is only one data source, there is automatic selection of that data source. The user may select the “browse” button to locate the file for upload then selects “Continue” to begin Validation. If the file fails the Validation (e.g., the file is the “customers” file and not the “prospects” upload file), the user will get a message indicating the nature of the failure. If the file passes the Validation checks, the file is then handed off to the Validation exit function for further possible processing (e.g., a Dun & Bradstreet data lookup). If that function is completed without errors, then the geocoding process takes place. The user is presented with the records that did not meet the minimum geocoding minimum-level defined. The user can export failed records (e.g., CSV, delimited, spreadsheet, etc), elect to proceed with records that do meet the criteria or cancel and resubmit the whole batch once the records are completed. If “Proceed” is selected, then the records are added to the enterprise spatial system data store. The user may optionally view details of the results log (e.g., which indicates batch completed or aborted, number of records succeeded, number of records failed) and take appropriate action.

In a data integration services scenario 4, a third party system with a data entity role performs a daily upload of prospect data from a lead generation program (e.g., manual or batch). The third party system includes a third party program that connects to the DIS Web services provided by the enterprise spatial system and is authenticated as a data entity. The third party program passes a data file containing prospect data to the Web service for pre-processing with parameters (e.g., data source/version information, number of records, actions to take upon failure code, etc.). If the file fails the Validation (e.g., the file is the customer upload file and not the prospects upload file), the Web service returns a code indicating the nature of the failure. If the code matches the failure code of a specific action, the enterprise spatial system attempts to perform that action. If the file passes the Validation checks, the file is then handed off to the Validation exit function for further possible processing (e.g., a Dun & Bradstreet data lookup). If that function is completed without error, then the geocoding process takes place. The enterprise spatial system determines whether the percentage (%) of good records threshold has been reached. If so, then the “good” records are added to the enterprise spatial system data store, with the failed record information being posted back to the initiating program. If not, then the entire transaction is canceled, with the failed results being posted back to the initiating program. Then, the user may optionally view the details of the results log (e.g., which indicates batch completed or aborted, number of records succeeded, number of records failed) and take appropriate action.

In a data integration services scenario 5, a user with a data admin role performs manual periodic entry of customer data from an accounting application (e.g., manual/transactional). The user logs into the admin application. The user's authentication shows that the user has data admin privileges, and the UI changes the “Preferences” Menu to “Tools”. The user selects “Upload Data” from the “Tools” menu to enter the prospect data. The user selects the “Customer Import” data source from the data integration service list of available data sources (which may already be filtered to show those data sources for which the user has privileges), and, if there is only one data source, there is automatic selection of that data source. The user enters the customer data in the appropriate Web form and selects “Submit” to begin Validation. If the data fails the Validation (e.g., the data fails some required field business rule), the user will get a messaging indicating the nature of the failure. If the data passes the Validation checks, the data is then handed off to the Validation exit function for further possible processing (e.g., Dun & Bradstreet data lookup). If that function is completed without errors, then the geocoding process takes place. If geocoding fails for some reason, the user can elect to correct the form so that the data will meet the criteria or may cancel processing.

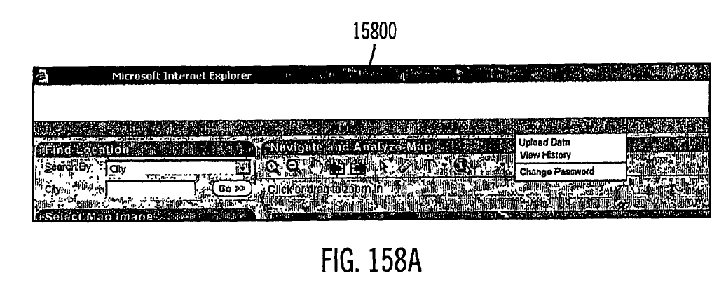

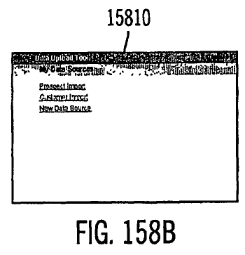

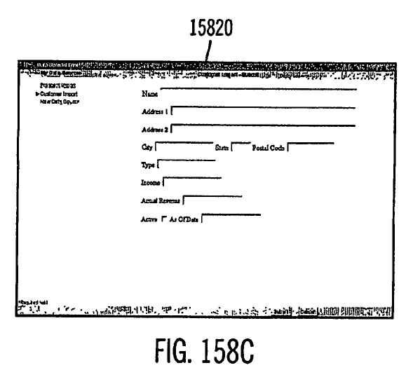

FIGS. 158A, 158B, and 158C illustrate another data integration services scenario with screens 15800, 15810, and 15820, respectively, in accordance with certain implementations of the invention.

In a data integration services scenario 6, a user performs data entry in some other program which then puts the data into the enterprise spatial system data store for mapping (e.g., automated/transactional). The user logs into a lead management application and adds a prospect to the lead tracking data store. The “Save Record” function is modified to call a Web service, passing the details of the record, the data source name/version number, user information and password, and possibly other parameters. If the data fails the Validation (e.g., the data is the customer upload file and not the prospects upload file), the Web service returns a code indicating the nature of the failure. If the code matches the failure code of a specific action above, the enterprise spatial system attempts to perform that action. If the data passes the Validation checks, the data is then handed of to the Validation exit function for further possible processing (e.g., Dun & Bradstreet data lookup). If that function is completed without errors, then the geocoding process takes place. The enterprise spatial system determines whether a record meets a minimum geocoding level. If so, then the record is added to the enterprise spatial system data store. If not, the enterprise spatial system passes a failure message back to the initiating system so the user can be presented with the form containing data that did not meet the geocoding minimum-level defined. The user may correct the data so that the data meets the criteria or may cancel the process in the other application. The user optionally views details of a results log (e.g., which indicates batch completed or aborted, number of records succeeded, number of records failed) and take appropriate action.

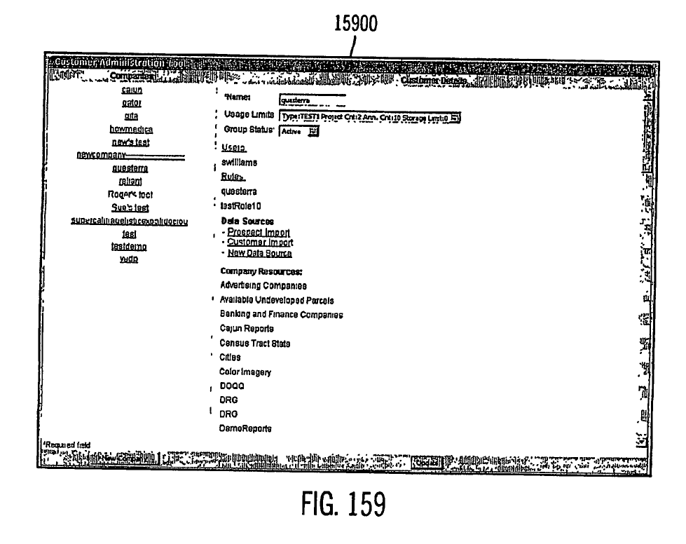

In certain implementations, various administration screens are provided by the enterprise spatial system. After selecting a company, the user is presented with the “Customer Details” screen that includes a section called Data Integrations. Selecting “Data Integrations” expands the selection to show the available paths (e.g., hyperlinks). These paths take a user to add new integrations or to edit/view the specific integration selected. FIG. 159 illustrates screen 15900 with a list of existing known data sources for a given customer in accordance with certain implementations of the invention.

The screen for Editing/Viewing an existing Integration may be the same as the screen for adding a new integration, except the fields may already be populated when the screen is presented.

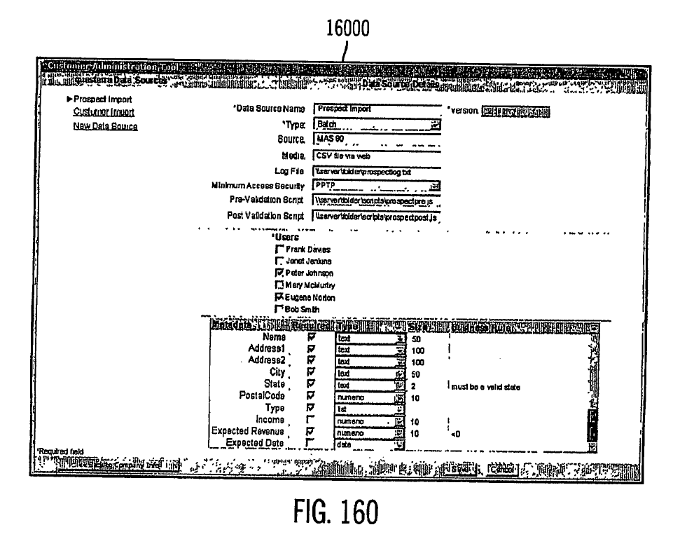

FIG. 160 illustrates a screen 16000 with an example of a possible treatment for how to add a new data source in accordance with certain implementations of the invention. In certain implementations, adding a data source may entail pointing to a saved instance of a Data Junction connection.

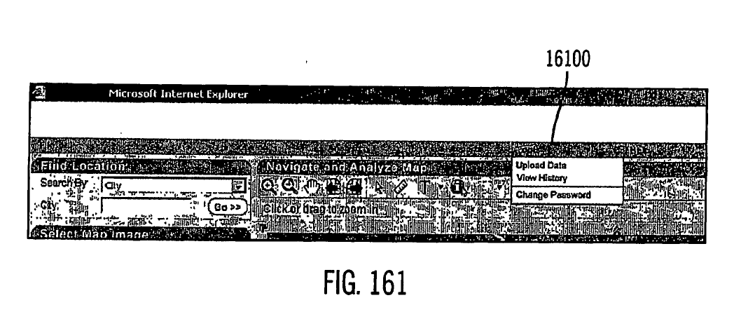

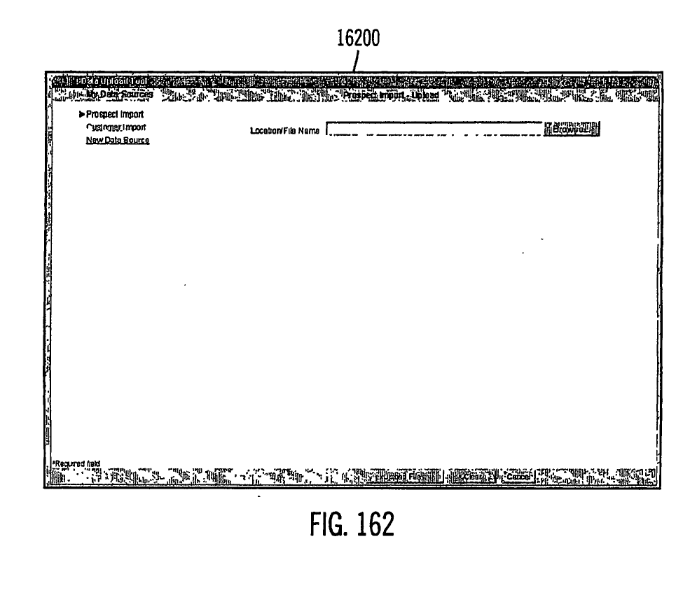

In certain implementations, if the user logged in has data admin privileges or data upload privileges, the “Preferences” menu item changes to “Tools” and the appropriate menu options are added for that user's access authority. FIG. 161 illustrates a preference menu 16100 in accordance with certain implementations of the invention. Selecting the “Upload Data” selection may take the user to a screen illustrated in FIG. 162, depending on the data sources the user has access to. FIG. 162 illustrates a screen 16200 with a list of data sources available to a give data admin in accordance with certain implementations of the invention.

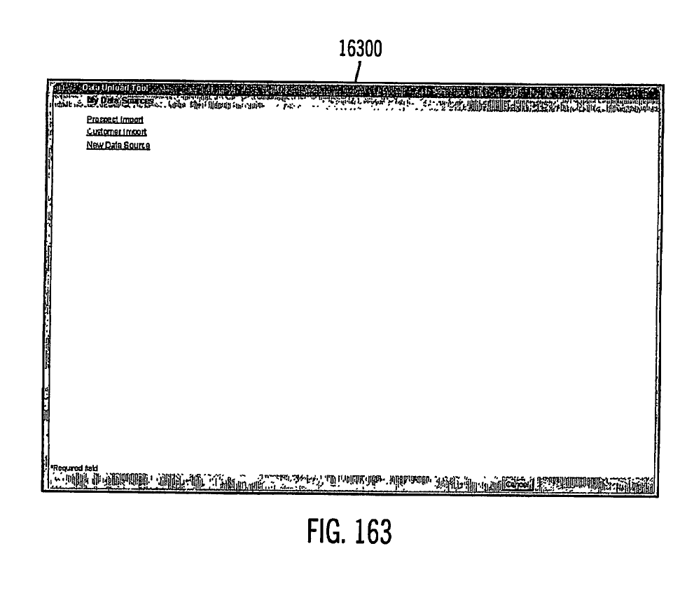

If the user selects the “Prospect Import” data source in FIG. 162 or if the user has access to one data source (e.g, the “Prospect Import” data source), the screen illustrated in FIG. 163 is displayed. FIG. 163 illustrates an example of a screen 16300 used for a batch type data source in accordance with certain implementations of the invention.

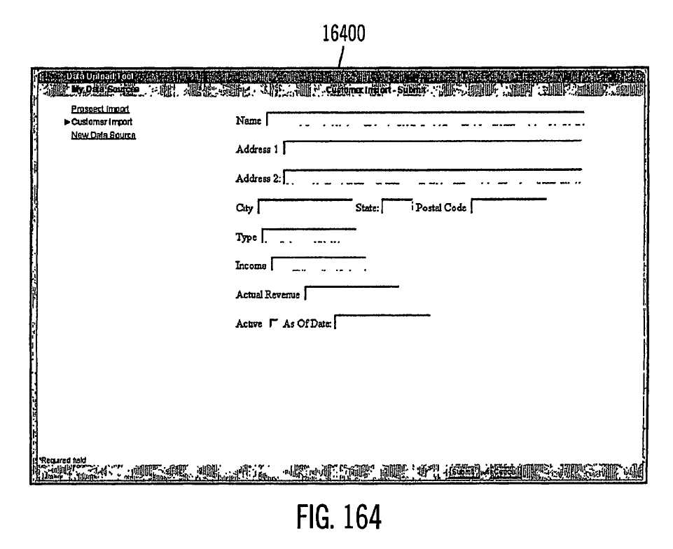

If the user selects the “Customer Import” data source or if the user has access to one data source (e.g., the “Customer Import” data source), the screen illustrated in FIG. 164 is displayed. FIG. 164 illustrates an example of a screen 16400 used for a transaction type data source. In certain implementations, when Web services are exposed, the screen in FIG. 164 may be replaced by a UI in a client application.

Appropriate error messages are displayed if the user inputs invalid file or data information. Example error messages include: Location or file name invalid—file not found; Required fields <list of fields> not completed. Please complete and try again; Data fails validation process. Please correct and resubmit: <reason returned from validation process>; Data fails percentage threshold for minimum GeoCoding level. Please correct and try again. <reason returned from GeoCoding process>; Data fails business rule checks. Please correct and resubmit: <reason returned from business rule checking process>.

### H. EDITING

In certain implementations, a spatial editor 138 is provided as part of an enterprise spatial system. The spatial editor 138 includes one or more custom user interfaces (UIs) that allows the spatial system to handoff control to an customer specific application that performs customer specific validations and computations based on the editing performed in the spatial system. The custom UI includes a drop down menu with data driven entries, which may be labeled “Advanced Edit” from an Edit Mode screen.

In certain implementations, the spatial editor 138 enables graphical editing, graphical shape validation, and execution of business logic associated with the graphical changes. With Web services and third party handoff, the spatial editor 138 may perform graphical editing, while graphical shape validation and execution of business logic may be performed at a client computer connected to the enterprise spatial system. The graphical editing features provide a broad-based generic editing feature set.

In certain implementations, a client handoff is performed to handoff, for example, a graphical element, to a client so that the client may perform graphical shape validation, business logic validation, and spatial updating. The client verifies that the spatial update has been committed to the enterprise spatial system before committing changes to a client data store. In certain implementations, rollbacks on the Enterprise spatial system are supported over a Web Services interface.

All editing and object manipulations may be performed on new or existing data layers (including a blank data layer).

The enterprise spatial system limits the commands available and the data layers that may be modified or viewed based on user rights. The role of the user is available to the client (e.g., after the client handoff), and any additional rights management related to specific business rules may then be performed at the client.

Editing commands may involve passing parameters to the client that have the basic format of selected items and a command. It is up to the client to validate the command and parameters, execute business logic, perform the requested spatial command, request that shape files are updated, and update any specific business tables. Thus graphical manipulation is performed with the spatial editor 138, while backend processing is performed with the client.

In certain implementations, once a save is started, the save may not be canceled. The UI waits for a response or a timeout A timeout will cause a flush of all temporary information and any loaded features followed by a refresh. The refresh is generated from spatial features in a data store in the server.

During each one of the extended editing operations for which there is a client handoff to the client to process and validate the command, there are two possible return scenarios. The first return scenario is normal completion of the command, which updates the spatial data on at the enterprise spatial system through Web services and then causes a refresh on the client. The refresh causes the updated shapes to appear on the client. The other return is typically due to error conditions or a requested cancel by the user. In this case, no spatial update is performed and no refresh occurs. The state of the client editor is just the same as when the handoff occurred.

In certain implementations, for extended editing features, there is no client side prompt asking whether the user wants to execute the command. For features that are implemented at the client, there is a client handoff to the client for execution. By immediately doing a client handoff, the client may first perform business specific logic before the prompt and vary the prompt based upon customer needs.

In addition to the client handoff, there are certain graphical editing extensions to the base enterprise spatial system. The graphical editing extensions include object interaction and multi-object editing.

As for object interaction, a first selected object has priority among two objects that are selected. Object interaction includes overlapping polygons and split objects. Overlapping polygons cover 1) absorbing overlap (e.g., first selected object takes overlapping area), 2) merging (e.g., first object merges in second object and internal lines disappear), and 3) creating new object from overlap (e.g., a new polygon is created from overlap and boundaries are modified). Split objects cover 1) intersection (e.g., first object is split at the intersection(s) with the second object and the second objects shape between the intersections) and 2) selected point(s) (e.g., closest point on object is selected and object is split there, with one point for lines and two points selected for polygons).

As for multi-object editing, multi-polygon and complex-polygon editing is supported. Multi-objects are sets of the same object type, either all lines or all polygons, which are logically associated with each other. When a multi-object is selected, the objects in the multi-object are highlighted. Auto merging may be performed at the client. After a multi-polygon is selected, then join or un-join is selected and a particular polygon is selected to be joined to the multi-polygon or split off from it A move object to back command is allows selection of interior polygons in complex polygon. In certain implementations, even though the interior polygon may be visible, the selection tool may be unable to select the internal polygon if the exterior polygon was first loaded into the layer.

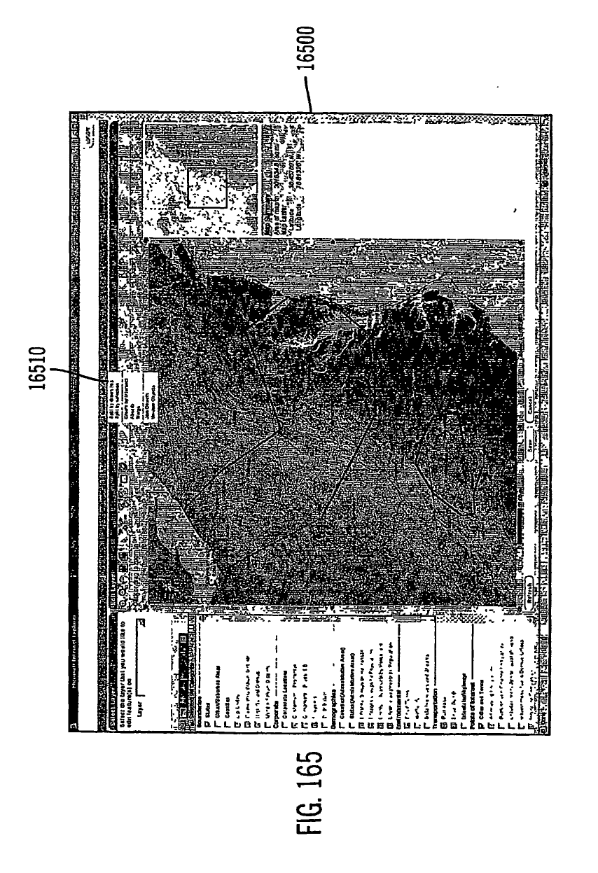

The spatial editor 138 provides advanced editing menu extensions. FIG. 165 illustrates a screen 16500 with advanced edit menus 16510 in accordance with certain implementations of the invention. The additional editing features may be available under the “Advanced Editing” drop down menu from the Edit Mode screen. The following menu items support the editing extensions: Group 1: Split by Drawn Line and Split by Selection; Group 2: Create by Intersect, Absorb, and Merge; Group 3: Join Objects, Un-join Objects, and Move to Back; Group 4: Sampling Grid and Activity by Batch.

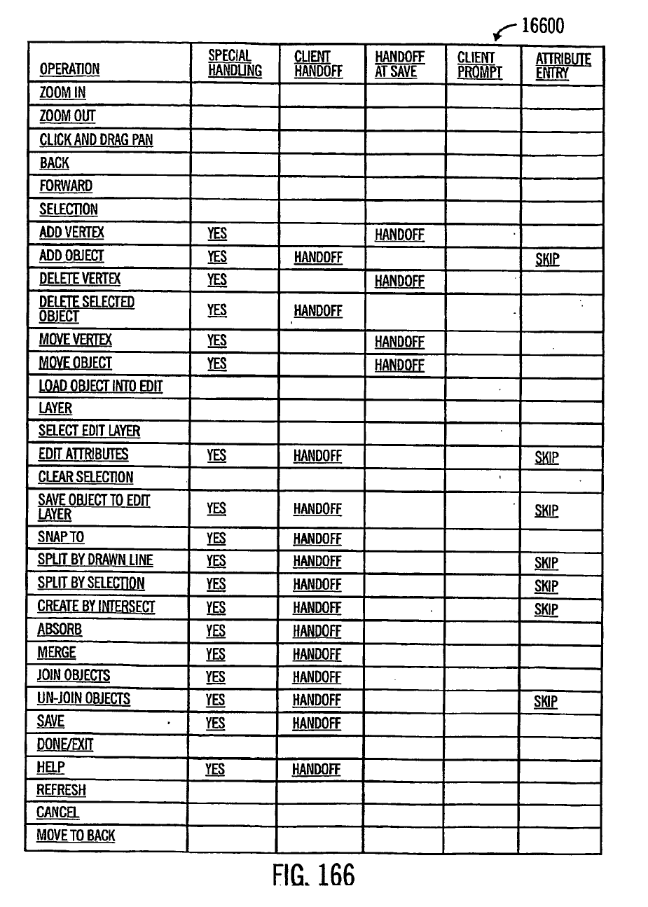

FIG. 166 illustrates a table 16600 of editing extension points in accordance with certain implementations of the invention. The table 16600 illustrates operations, indicates whether special handling is needed, indicates whether there is a client handoff, indicates whether there is a handoff at save, indicates whether there is a client prompt, and lists attribute entries. The operations listed are available under the normal plus extended client editing functions.

As illustrated, there are several client handoff points. A client handoff assumes that there is a client handoff after the client side has completed the graphical portion of the operation, and this handoff substitutes for the normal return to the enterprise spatial system platform. A handoff at save involves operations that do not cause a client handoff by themselves but that make changes to the shape. This may result in a Save operation to be requested, and, at the time of the Save operation, a client handoff occurs, instead of command processing by the enterprise spatial system. In terms of a client prompt, some operations may work better by skipping the client prompt and going directly to the client handoff so that some business logic on the client side may be checked before the prompting. This would allow the client side to prevent certain actions from being able to be started based upon specific needs. Additionally, some operations would normally trigger an Attribute Entry screen at the client. The client supports extended attributes in addition to the core attributes on the standard Attribute Entry screens. By skipping the Attribute Entry, clients have full control to do a combined attribute interface.

In certain implementations, a client specific help file supports the client application. This help file is built and maintained by the enterprise spatial system using a base help file and adding sections needed to support advanced editing, a contact screen, and a banner screen as provided by a customer.

There are several graphic use cases. After entering edit mode, the extension features are available from the Advanced Editing menu drop down list.

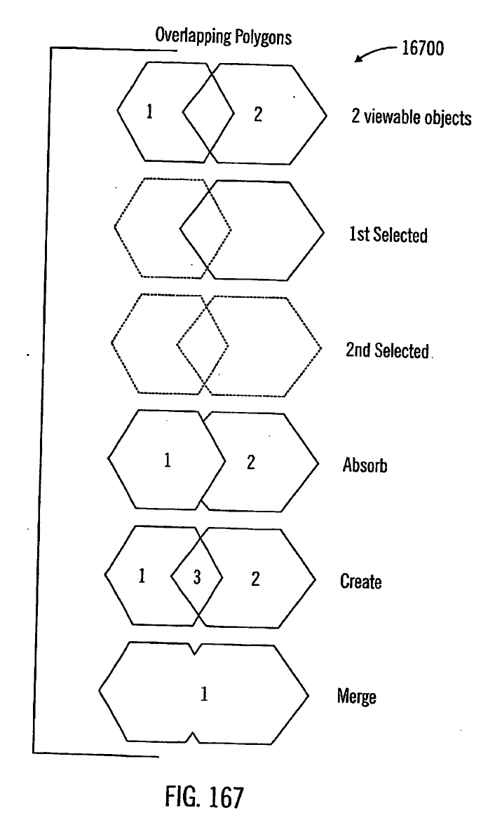

FIG. 167 illustrates how overlapping polygons 16700 may be modified in different ways in accordance with certain implementations of the invention. In particular, one object may absorb the overlap, two objects may merge into one object or two objects may create a new polygon from the overlap. In FIG. 167, initially, a first polygon is selected, the first polygon outline may be highlighted, and a color change is possible. Then, an operation (absorb, merge or create) is selected. Next, the second polygon is selected, the second polygon outline may be highlighted, and a color change is possible. At this point, there is a handoff to a client system where business logic may be applied, spatial manipulation may be performed, and any additional prompting (e.g., attribute entry) may be performed. From there, the processing returns from the client system, and the return causes either a refresh with updated objects or shows an error/status box with no refresh.

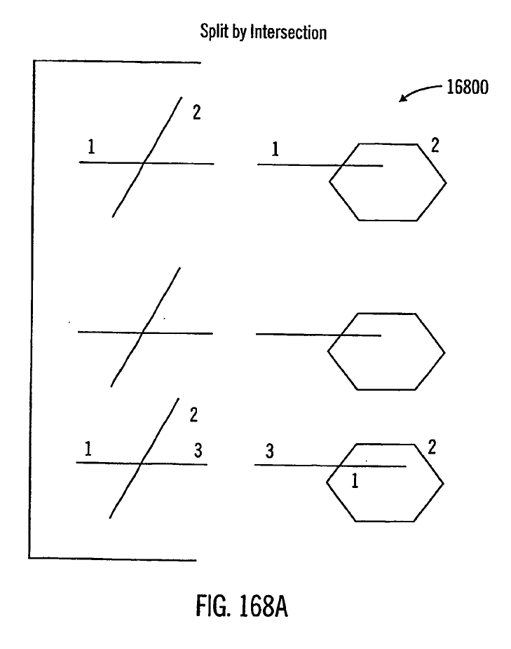

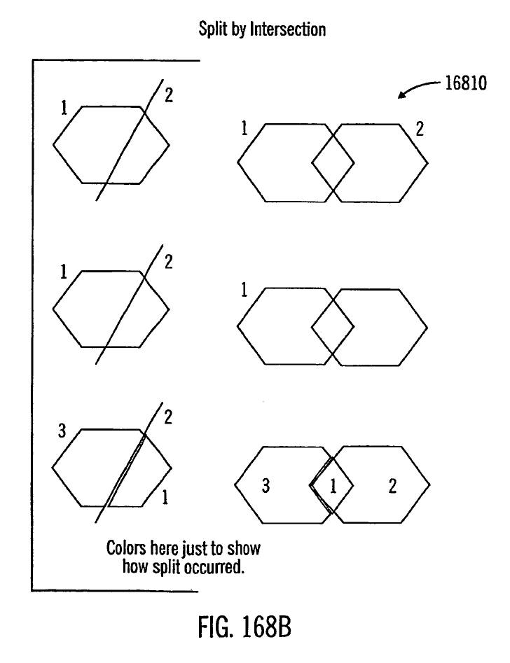

FIGS. 168A and 168B illustrate objects 16800, 16810 split by selection and/or intersection in accordance with certain implementations of the invention. Objects (e.g., lines or polygons) may be split by an intersection with another line or polygon. Note that the client backend has a technique of determining which of the object splits, if any, overwrites the original object. In certain implementations, client side software does not determine whether objects actually intersect. In particular, an object to split is selected. This object may be highlighted, and a color change is possible. Then, the Split by Selection tool is selected from the drop down menu. The second object (e.g., a line or polygon) is selected. The outline of the second object may be highlighted, and color change is possible. Then, there is a handoff to a client system where business logic may be applied, spatial manipulation may be performed, and any additional prompting (e.g., attribute entry) may be performed. From there, the processing returns from the client system, and the return causes either a refresh with updated objects or shows an error/status box with no refresh.

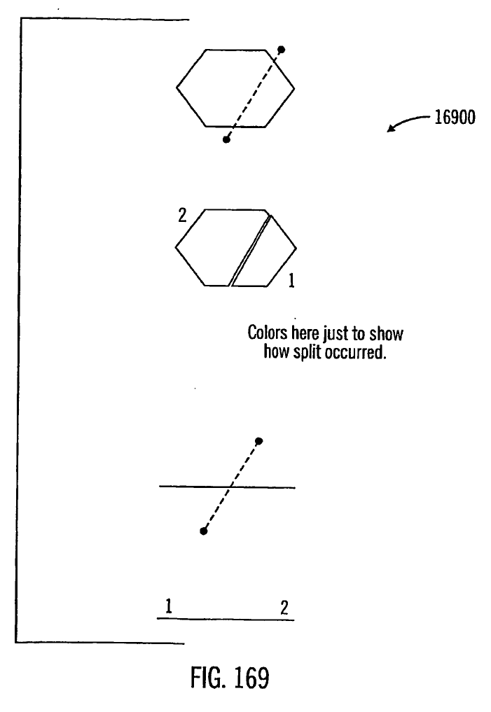

FIG. 169 illustrates objects 16900 to be split by a drawn line in accordance with certain implementations of the invention. Polygons or lines may be split by an intersection with a temporary drawn line. The client backend has a technique of determining which portion of the split item, if any, overwrites the original one. On return from the backend system whether by error or completion, the temporary line is cleared automatically. Initially, an object to split is selected. The object is highlighted, and a color change is possible. The Split by Drawn Line tool is selected from a drop down menu. Then, a first point of a temporary splitting line is placed on the object, and a second point of the temporary line is placed on the object A rubber banding line may be visible while the second point is being selected. Then, placement of points is continued until a signal (e.g., a double click of an input device) is received to signify that the line drawing is complete. Then, there is a handoff to a client system where business logic may be applied, spatial manipulation may be performed, and any additional prompting (e.g., attribute entry) may be performed. From there, the processing returns from the client system, and the return causes either a refresh with updated objects or shows an error/status box with no refresh. The temporary line is automatically erased when a refresh occurs.

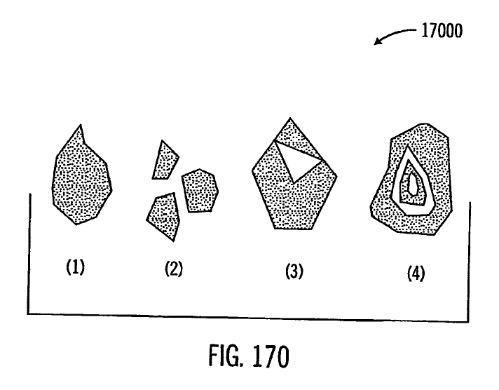

FIG. 170 illustrates multi-polygons 17000 in accordance with certain implementations of the invention. In FIG. 170, (1) is a simple polygon; (2) is a multi-polygon that does not include touching or enclosing; (3) is a complex polygon with one polygon enclosing another but not sharing a line segment; and, (4) is a multi-complex polygon, which is represented as at least two objects. The multi-polygons illustrated in FIG. 170 are from the open GIS standard. The spatial editor 138 supports manipulation of these multi-objects. Multi-objects are sets of the same object type, either all lines or all polygons, which are logically associated with each other. Multi-objects reside on a same data layer and may touch but do not cross. They are treated as one unit for certain operations, such as delete and move.

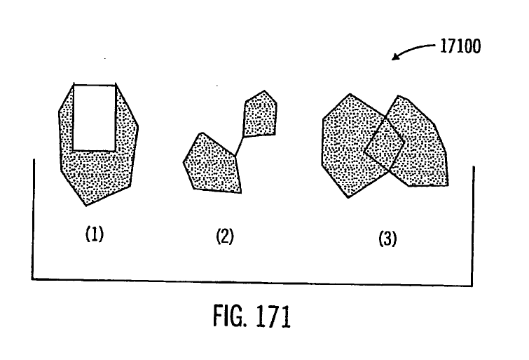

FIG. 171 illustrates examples of shapes 17100 that cannot be represented by a single multi-polygon in accordance with certain implementations of the invention. In FIG. 171, (1) represents polygons that may touch at a point but that do not share a line segment; (2) represents polygons that are not closed (i.e., a multi-polygon can not include a line); and (3) represents polygons that overlap. The spatial editor 138 UI does little or no relationship validations for multi and complex shapes in certain implementations. The spatial editor 138 UI allows the selection and manipulation of shapes, and then the commands are passed to the client for validation and execution. The client enforces that shape types, such as line or polygon, are matching.

Manipulations of multi-objects include selection of a multi-object, which highlights objects that are part of the multi-object with a special highlighting.

Deleting a multi-object is performed by executing delete with a highlighted multi-object. A multi-object may have features that are off the extent of the screen. Even though the high-lighted object may indicate that it has multiple objects (e.g., with special highlighting), deleting a multi-object may erase something that is not visible on the screen. This situation may be checked by the client backend system, and the user may be instructed to expand the extent to include the full multi-object. Deletion of multi-objects may also be prevented and the user required to un-join and delete each object separately.

When adding an object, the join operation is selected, and then the object to add is selected. If this creates a multi-object, then selection was performed on a single object before choosing the join command.

Removing an object requires choosing the un-join command and then selecting one of the highlighted objects. In certain implementations, this does not have to erase the un-joined object, and the decision of whether to erase the un-joined object maybe determined on the client. The un-joined object may need to have its attributes updated since un-joining is similar to creating a new object.

Editing may be performed to a single object in the multi-object at a time. All editing such as vertex editing must be performed on a single polygon of the multi-polygon. This allows vertex adding, deletion and moving of one polygon of a multi-polygon without a client handoff.

A move to back command places the selected object to the back most position in the current layer. This allows obscured polygons to move forward so that they may be selected for various actions.

In certain implementations, portions of a multi-polygon may not be separately moved. The multi-polygon moves as one unit. Changes in the relative position of one polygon to another is performed by first un-joining a particular polygon, moving the un-joined polygon, and then re-joining the polygon to the multi-polygon.

The Join operation may be used to create a multi-polygon, multi-line or a complex polygon. The Join operation may also be used to add additional polygons to existing multi or complex polygons or to add additional lines to multi-lines. Initially, an object (single, multi or complex) is selected that will have another object joined to it. A color change is possible with a special color for multi/complex object. The Join tool is selected from a drop down menu. The second object is selected, and the outline of the second object may be highlighted, with a color change possible for the second object.

Then, there is a handoff to a client system where business logic may be applied, spatial manipulation may be performed, and any additional prompting (e.g., attribute entry) may be performed. From there, the processing returns from the client system, and the return causes either a refresh with updated objects or shows an error/status box with no refresh.

The un-join operation may be used to remove a polygon from a multi-polygon or a complex polygon. The un-join operation may also be used to remove a line from a multi-line. If the resulting object after the un-join is a single object, then the object is no longer considered a multi or complex object. Attributes may be prompted for the un-joined object, since its attributes were the same as the multi-object before the un-join. Initially, an object (single, multi or complex) is selected that will have an object unjoined from it. A color change is possible with a special color for multi/complex object. The Un-join tool is selected from a drop down menu. One of the highlighted objects in the multi-object is selected as a second object, and the outline of the second object may be highlighted, with a color change possible for the second object. Then, there is a handoff to a client system where business logic may be applied, spatial manipulation may be performed, and any additional prompting (e.g., attribute entry) may be performed. From there, the processing returns from the client system, and the return causes either a refresh with updated objects or shows an error/status box with no refresh.

Polygons in complex polygons may partially or completely obscure another polygon, making it difficult to select the underlying polygon. Also, multiple identical shapes may have different attributes and occupy the same location. To allow easy access to the obscured objects the “Move to Back” command is available. This allows selecting the top item and pushing it to the back of the logical ordering of viewed items. This makes the next underlying item accessible. In the case of several overlying items, this operation may be performed several times until the desired object is available for selection.

In terms of Move to Front, if an object is selected, then the object is automatically moved to the front and all vertexes are accessible. If an object may not be selected then Move to Back is performed until the object may be selected. The Z-order in which objects are initially loaded is dependent upon the order that they are in the data store and the data layers selected. In certain implementations, Z-order is not preserved or maintained in the spatial data store.

### I. THEME MAPPING

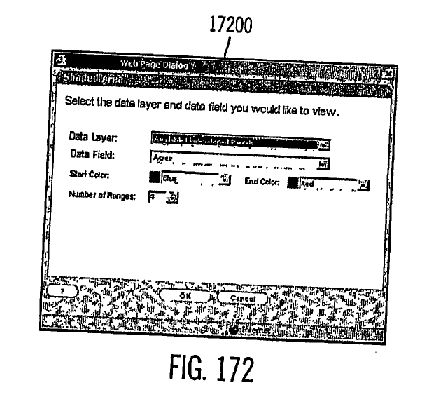

In certain implementations, a thematic mapping menu includes three types of thematic mapping: shaded area, sized symbols, and shaded symbols. FIG. 172 illustrates a screen 17200 for shaded area thematic mapping in accordance with certain implementations of the invention.

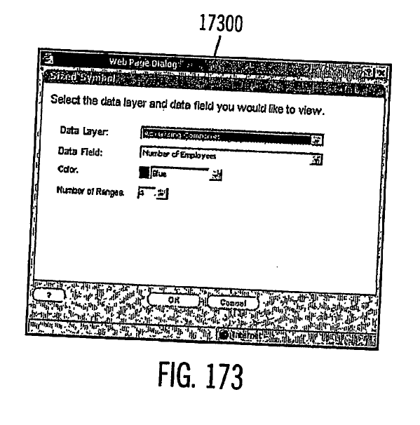

FIG. 173 illustrates a screen 17300 for sized symbols thematic mapping in accordance with certain implementations of the invention. Sized symbols expands thematic mapping to include point data. The sized, graduated or proportional symbol is a type of thematic mapping that sizes a circle, or any other symbol, based on the numeric values of a particular field with a set of data that has a single point of reference. This may be used, for example, for point data, but the centroids of zip codes, census tracts, states, or the like may also be used.

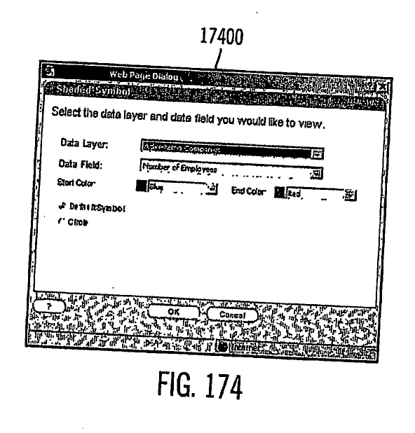

FIG. 174 illustrates a screen 17400 for shaded symbols thematic mapping in accordance with certain implementations of the invention. The shaded symbols show each unique data value as a different color. This is may be useful, for example, for non-numeric point data. For example, a data set of fast food restaurants is displayed by the restaurant type, such as the “name” field, where each name would be a different color or symbol.

### J. CONCLUSION

The foregoing description of implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims

appended hereto. The above specification, examples and data provide a complete description of the manufacture and use of the composition of the invention. Since many implementations of the invention can be made without departing from the spirit and scope of the invention, the invention resides in the claims hereinafter appended or any subsequently-filed claims, and their equivalents. Furthermore, the illustration of implementations in a particular field, such as the insurance industry, is not restrictive, as implementations of the invention may apply more generally and in a variety of other fields.

### K. ADDITIONAL IMPLEMENTATION DETAILS

The described techniques for real time insurance policy underwriting and risk management may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which various implementations are implemented may further be accessible through a transmission media or from a file ESS server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

The logic described herein refers to specific operations occurring in a particular order. In alternative implementations, certain of the logic operations may be performed in a different order, modified or removed. Moreover, operations may be added to the above described logic and still conform to the described implementations. Further, operations described herein may occur sequentially or certain operations may be processed in parallel, or operations described as performed by a single process may be performed by distributed processes.

The logic described herein may be implemented in software, hardware, programmable and non-programmable gate array logic or in some combination of hardware, software, or gate array logic.

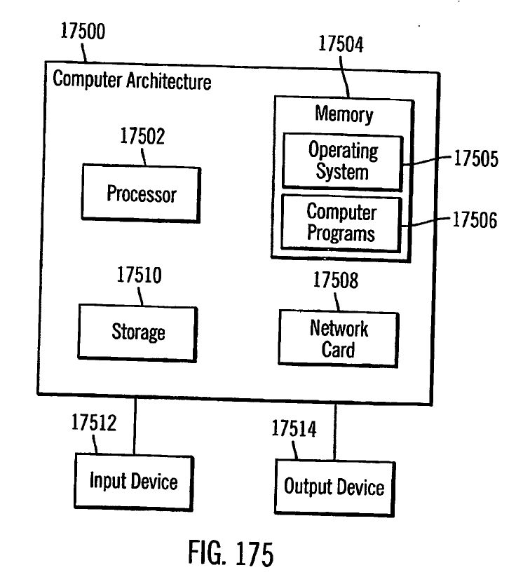

FIG. 175 illustrates an architecture of a computer system that may be used in accordance with certain implementations of the invention. Computer 100 or 120 may implement computer architecture 17500. The computer architecture 17500 may implement a processor 17502 (e.g., a microprocessor), a memory 17504 (e.g., a volatile memory device), and storage 17510 (e.g., a non-volatile storage area, such as magnetic disk drives, optical disk drives, a tape drive, etc.). An operating system 17505 may execute in memory 17504. The storage 17510 may comprise an internal storage device or an attached or network accessible storage. Computer programs 17506 in storage 17510 may be loaded into the memory 17504 and executed by the processor 17502 in a manner known in the art. The architecture further includes a network card 17508 to enable communication with a network. An input device 17512 is used to provide user input to the processor 17502, and may include a keyboard, mouse, pen-stylus, microphone, touch sensitive display screen, or any other activation or input mechanism known in the art. An output device 17514 is capable of rendering information from the processor 17502, or other component, such as a display monitor, printer, storage, etc. The computer architecture 17500 of the computer systems may include fewer components than illustrated, additional components not illustrated herein, or some combination of the components illustrated and additional components.

The computer architecture 17500 may comprise any computing device known in the art, such as a mainframe, server, personal computer, workstation, laptop, handheld computer, telephony device, network appliance, virtualization device, storage controller, etc. Any processor 17502 and operating system 17505 known in the art may be used.

The foregoing description of implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many implementations of the invention can be made without departing from the spirit and scope of the invention, the invention resides in the claims hereinafter appended.

1. A computer-implemented method for evaluating risk associated with underwriting an insurance policy, comprising:
receiving one or more locations to be covered under the insurance policy; and
automatically assessing risk associated with the one or more locations, including generating rating results for one or more perils, wherein the rating results indicate whether that peril may occur at each of the one or more locations.

2. The method of claim 1, wherein automatically assessing risk further comprises:
applying at least one business rule.

3. The method of claim 1, further comprising:
enabling selection of at least one of an underwriting analysis and a risk analysis.

4. The method of claim 1, further comprising:
enabling setup of an event that may impact assessment of risk.

5. A computer-implemented method for evaluating risk associated with underwriting an insurance policy, comprising:
displaying a setup events screen to enable setup of an event that may impact assessment of risk;
receiving an event type;
receiving at least one of ring details, damage rate information, and PML rating data;
receiving at least one location to be covered under the insurance policy; and
automatically assessing risk associated with the location based on the event type and the received at least one of ring details, damage rate information, and PML rating.

6. The method of claim 5, wherein ring details include a number of rings and ring distance between each of the rings.

7. The method of claim 5, wherein damage rate information is associated with each ring.

8. The method of claim 5, wherein the PML rating data includes an association of PML and CAP.

9. A computer-implemented method for evaluating risk associated with underwriting an insurance policy, comprising:
displaying a setup landmarks screen to enable setup of a landmark;
receiving a name of the landmark, a location of the landmark, a CAP associated with the landmark, and a PML adjustment to the landmark;
automatically assessing risk associated with the location based on the CAP and PML adjustment; and
displaying rating results for the location for one or more perils.

10. The method of claim 1, wherein a location may be selected by at least one of a company search, an address search, or uploading a file.

11. The method of claim 10, wherein selection of a location by company search further comprises:
receiving at least part of a company name;
searching for the company name in a business data store; and
retrieving at least one address from the searching.

12. The method of claim 11, further comprising:
determining that there are ambiguous addresses for the company name; and
enabling selection of at least one of the addresses.

13. The method of claim 10, wherein selection of a location by an address search further comprises.
receiving a street address and at least one of a zip code and a city and state.

14. The method of claim 10, wherein selection of a location by uploading a file further comprises:
associating data in the file with a predefined format.

15. The method of claim 10, further comprising:
attempting to automatically geocode the selected location.

16. The method of claim 15, wherein the location can not be automatically geocoded and further comprising:
enabling use of a spatial interface to manually geocode the location.

17. The method of claim 1, wherein automatically assessing risk further comprises:
performing a proximity analysis.

18. The method of claim 1, wherein the rating results for at least one peril are capable of being displayed on a map.

19. The method of claim 1, further comprising:
enabling drilldown into details of at least a portion of the rating results

20. The method of claim 1, further comprising:
enabling exporting of the rating results.

21. A computer-implemented method for evaluating risk associated with underwriting an insurance policy, comprising:
receiving at least one location to be covered under the insurance policy;
automatically assessing risk associated with the location for at least one peril by performing PML calculations for the peril at the location; and
providing rating results for the location and the at least one peril.

22. The method of claim 21, further comprising:
receiving insurance policy details;
receiving location details for one location associated with the insurance policy details; and
generating PML results for the location.

23. The method of claim 1, wherein assessing risk associated with the location further comprises:
assessing risk based on at least one of unbound policies and bound policies.

24. A computer-implemented method for proximity analysis, further comprising:
receiving selection of a proximity center, wherein the proximity center comprises a location;
executing a function with the proximity center to determine target data items that fall within one or more proximity areas around the proximity center; and
spatially representing the target data items.

25. The method of claim 24, further comprising:
receiving proximity dimensions and a proximity analysis target data set.

26. The method of claim 25, wherein the target data items are identified from the target data set.

27. The method of claim 24, wherein the function is a user-specific function.

28. The method of claim 24, wherein the function may execute user-specific logic to calculate result data.

29. The method of claim 24, further comprising:
retrieving metadata for the user-specific function.

30. The method of claim 24, further comprising:
rendering the target data items within at least one proximity area associated with the proximity center; and
overlaying the at least one proximity area with at least one area boundary.

31. The method of claim 24, wherein there are multiple proximity areas and wherein spatially representing the target data items further comprises:
displaying the target data items within the multiple proximity areas.

32. The method of claim 24, wherein the function is a first function and further comprising:
retrieving metadata for a second function that aggregates data in the target data set based on a proximity area in which the target data item falls.

33. The method of claim 32, further comprising:
executing the second function to obtain aggregated proximity analysis results.

34. The method of claim 33, further comprising:
retrieving metadata for a report that generates custom reports from the aggregated proximity analysis results; and
creating the report.

35. The method of claim 34, further comprising:
displaying the report.

36. The method of claim 34, wherein the report comprises at least one of a summary report and a fill report.

37. The method of claim 24, wherein the proximity center is selected by at least one of an address selection, a latitude and longitude selection, and manual creation on a map.

38. The method of claim 24, wherein proximity analysis is performed for an event.

39. The method of claim 24, further comprising:
saving proximity analysis data by saving at least the proximity center, proximity area data, report data, and at least one spatial data layer.

40. The method of claim 39, further comprising:
enabling editing of the proximity analysis data.

41. A computer-implemented method for proximity analysis, further comprising:
receiving selection of a proximity center;
executing a function with the proximity center to determine target data items that fall within a proximity area around the proximity center; and
spatially representing the target data items;
wherein the proximity center comprises a landmark and proximity areas comprise rings encircling the landmark.

42. An article of manufacture including a program for evaluating risk associated with underwriting an insurance policy, wherein the program causes operations to be performed, the operations comprising:
receiving one or more locations to be covered under the insurance policy; and
automatically assessing risk associated with the one or more locations, including generating rating results for one or more perils, wherein the rating results indicate whether that peril may occur at each of the one or more locations.

43. The article of manufacture of claim 42, wherein the operations for automatically assessing risk further comprise:
applying at least one business rule.

44. The article of manufacture of claim 42, wherein the operations further comprise:
enabling selection of at least one of an underwriting analysis and a risk analysis.

45. The article of manufacture of claim 42, wherein the operations further comprise:
enabling setup of an event that may impact assessment of risk.

46. An article of manufacture including a program for evaluating risk associated with underwriting an insurance policy, wherein the program causes operations to be performed, the operations comprising:
displaying a setup events screen to enable displaying a setup events screen to enable setup of an event that may impact assessment of risk;
receiving an event type;
receiving at least one of ring details, damage rate information, and PML rating data; and
automatically assessing risk associated with the location based on the event type and the received at least one of ring details, damage rate information, and PML rating.

47. The article of manufacture of claim 46, wherein ring details include a number of rings and ring distance between each of the rings.

48. The article of manufacture of claim 46, wherein damage rate information is associated with each ring.

49. The article of manufacture of claim 46, wherein the PML rating data includes an association of PML and CAP.

50. An article of manufacture including a program for evaluating risk associated with underwriting an insurance policy, wherein the program causes operations to be performed, the operations comprising:
displaying a setup landmarks screen to enable setup of a landmark;
receiving a name of the landmark, a location of the landmark a CAP associated with the landmark, and a PML adjustment to the landmark;
receiving at least one location to be covered under the insurance policy;
automatically assessing risk associated with the location based on the CAP and PML adjustment; and
displaying rating results for the location for one or more perils.

51. The article of manufacture of claim 42, wherein a location may be selected by at least one of a company search, an address search, or uploading a file.

52. The article of manufacture of claim 51, wherein the operations for selection of a location by company search further comprise:
receiving at least part of a company name;
searching for the company name in a business data store; and
retrieving at least one address from the searching.

53. The article of manufacture of claim 52, wherein the operations further comprise:
determining that there are ambiguous addresses for the company name; and
enabling selection of at least one of the addresses.

54. The article of manufacture of claim 51, wherein the operations for selection of a location by an address search further comprise:
receiving a street address and at least one of a zip code and a city and state.

55. The article of manufacture of claim 51, wherein the operations for selection of a location by uploading a file further comprise:
associating data in the file with a predefined format.

56. The article of manufacture of claim 51, wherein the operations further comprise:
attempting to automatically geocode the selected location.

57. The article of manufacture of claim 56, wherein the location can not be automatically geocoded and wherein the operations further comprise:
enabling use of a spatial interface to manually geocode the location.

58. The article of manufacture of claim 42, wherein the operations for automatically assessing risk further comprise:
performing a proximity analysis.

59. The article of manufacture of claim 42, wherein the rating results for at least one peril are capable of being displayed on a map.

60. The article of manufacture of claim 59, wherein the operations further comprise.
enabling drilldown into details of at least a portion of the rating results

61. The article of manufacture of claim 59, wherein the operations further comprise:
enabling exporting of the rating results.

62. An article of manufacture including a program for evaluating risk associated with underwriting an insurance policy, wherein the program causes operations to be performed, the operations comprising:
receiving at least one location to be covered under the insurance policy;
automatically assessing risk associated with the location for at least one peril by performing PML calculations for the peril at the location; and
providing rating results for the location and the at least one peril.

63. The article of manufacture of claim 62, wherein the operations further comprise:
receiving insurance policy details;
receiving location details for one location associated with the insurance policy details; and
generating PML results for the location.

64. The article of manufacture of claim 42, wherein the operations for assessing risk associated with the location further comprise:
assessing risk based on at least one of unbound policies and bound policies.

65. A article of manufacture including a program for proximity analysis, wherein the program causes operations to be performed, the operations comprising:
receiving selection of a proximity center, wherein the proximity center comprises a location;
executing a function with the proximity center to determine target data items that fall within one or more proximity areas around the proximity center; and
spatially representing the target data items.

66. The article of manufacture of claim 65, wherein the operations further comprise:
receiving proximity dimensions and a proximity analysis target data set.

67. The article of manufacture of claim 66, wherein the target data items are identified from the target data set.

68. The article of manufacture of claim 65, wherein the function is a user-specific function.

69. The article of manufacture of claim 65, wherein the function may execute user-specific logic to calculate result data.

70. The article of manufacture of claim 65, wherein the operations further comprise:
retrieving metadata for the user-specific function.

71. The article of manufacture of claim 65, wherein the operations further comprise:
rendering the target data items within at least one proximity area associated with the proximity center; and
overlaying the at least one proximity area with at least one area boundary.

72. The article of manufacture of claim 65, wherein there are multiple proximity areas and wherein the operations for spatially representing the target data items further comprise:
displaying the target data items within the multiple proximity areas.

73. The article of manufacture of claim 65, wherein the function is a first function and wherein the operations further comprise:
retrieving metadata for a second function that aggregates data in the target data set based on a proximity area in which the target data item falls.

74. The article of manufacture of claim 73, wherein the operations further comprise:
executing the second function to obtain aggregated proximity analysis results.

75. The article of manufacture of claim 74, wherein the operations further comprise:
retrieving metadata for a report that generates custom reports from the aggregated proximity analysis results; and
creating the report.

76. The article of manufacture of claim 75, wherein the operations further comprise:
displaying the report.

77. The article of manufacture of claim 75, wherein the report comprises at least one of a summary report and a full report.

78. The article of manufacture of claim 65, wherein the proximity center is selected by at least one of an address selection, a latitude and longitude selection, and manual creation on a map.

79. The article of manufacture of claim 65, wherein proximity analysis is performed for an event.

80. The article of manufacture of claim 65, wherein the operations further comprise:
saving proximity analysis data by saving at least the proximity center, proximity area data, report data, and at least one spatial data layer.

81. The article of manufacture of claim 80, wherein the operations further comprise:
enabling editing of the proximity analysis data.

82. An article of manufacture including a program for proximity analysis, wherein the program causes operations to be performed, the operations comprising:
receiving selection of a proximity center;
executing a function with the proximity center to determine target data items that full within a proximity area around the proximity center; and
spatially representing the target data items;
wherein the proximity center comprises a landmark and proximity areas comprise rings encircling the landmark.

83. A computer system having logic for evaluating risk associated with underwriting an insurance policy, wherein the logic is executed by the computer system, the logic comprising:
receiving one or more locations to be covered under the insurance policy; and
automatically assessing risk associated with the one or more locations, including generating rating results for one or more perils, wherein the rating results indicate whether that peril may occur at each of the one or more locations.

84. A computer system having logic for proximity analysis, wherein the logic is executed by the computer system, the logic comprising:
receiving selection of a proximity center, wherein the proximity center comprises a location;
executing a function with the proximity center to determine target data items that fall within one or more proximity areas around the proximity center; and
spatially representing the target data items.

85. A computer system having logic for evaluating risk associated with underwriting an insurance policy, wherein the logic is executed by the computer system, the logic comprising:
displaying a setup events screen to enable setup of an event that may impact assessment of risk;
receiving an event type;
receiving at least one of ring details, damage rate information, and PML rating data;
receiving at least one location to be covered under the insurance policy; and
automatically assessing risk associated with the location based on the event type and the received at least one of ring details, damage rate information, and PML rating data.

86. The article of manufacture of claim 85, wherein ring details include a number of rings and ring distance between each of the rings.

87. The article of manufacture of claim 85, wherein damage rate information is associated with each ring.

88. The article of manufacture of claim 85, wherein the PML rating data includes an association of PML and CAP.

89. A computer system having logic for evaluating risk associated with underwriting an insurance policy, wherein the logic is executed by the computer system, the logic comprising:
displaying a setup landmarks screen to enable setup of a landmark;
receiving name of the landmark a location of the landmark a CAP associated with the landmark, and a PML adjustment to the landmark;
automatically assessing risk associated with the location based on the CAP and PML adjustment; and
displaying rating results for the location for one or more perils.

90. A computer system having logic for evaluating risk associated with underwriting an insurance policy, wherein the logic is executed by the computer system, the logic comprising:
receiving at least one location to be covered under the insurance policy;
automatically assessing risk associated with the location for at least one peril by performing PML calculations for the peril at the location; and
providing rating results for the location and the at least one peril.

91. The computer system of claim 87, wherein the logic further comprises:
receiving insurance policy details;
receiving location details for one location associated with the insurance policy details; and
generating PML results for the location.

92. Previously Presented) A computer system having logic for proximity analysis, wherein the logic is executed by the computer system, the logic comprising:
receiving selection of a proximity center;
executing a function with the proximity center to determine target data items that fall within a proximity area around the proximity center; and
spatially representing the target data items;
wherein the proximity center comprises a landmark and proximity areas comprise rings encircling the landmark.
